(19) United States
(12) Patent Application Publication
(10) Pub. No.: US 2020/0389469 A1
(43) Pub. Date: Dec. 10, 2020

(54) SYSTEM AND METHOD FOR TUNNEL-BASED MALWARE DETECTION

(71) Applicant: Arilou Information Security Technologies Ltd., Ramat-Gan (IL)

(72) Inventors: Gil Litichever, Modiin (IL); Ziv Levi, Nahariya (IL); Moshe Karl, Petah Tikva (IL)

(21) Appl. No.: 16/766,687

(22) PCT Filed: Oct. 26, 2018
(86) PCT No.: PCT/IL2018/051147

§ 371 Date: May 24, 2020

Related U.S. Application Data
(60) Provisional application No. 62/610,217, filed on Dec. 24, 2017.
(60) Provisional application No. 62/620,494, filed on Jan. 23, 2018.
(60) Provisional application No. 62/674,040, filed on May 21, 2018.

(51) Int. Cl. H04L 29/06; H04L 12/46; H04L 12/18; H04L 12/24

(52) U.S. Cl. CPC H04L 63/145; H04L 12/4633; H04L 12/18; H04L 41/12; H04L 69/08; H04L 63/1425; H04L 12/4641; H04L 63/029; H04L 63/0272; H04L 63/0236; H04L 69/16

(57) ABSTRACT

A protected network connected to an external network is protected by analyzing messages received from the external network or from devices connected to the network that may be substituted, compromised, or otherwise malware infected. An analyzer functionality for detecting the malware in the received messages is located separately from the physical connection to the external network. The received messages are re-directed via a tunnel to the analyzer functionality for malware detection, and the tunnel may be Layer-2, Layer-3, or Software Defined Network (SDN) based tunnel. In case of no malware detection, the messages are directed to the original destination. In case of malware detection, various actions are taken. The network may be a wired network, such as an automotive network, PAN, LAN, MAN, or WAN, and may be configured as point-to-point or multi-point topology. The external network may be a wireless network or a public network such as the Internet.

### RELATED APPLICATIONS

This patent application claims the benefit of U.S. Provisional Application Ser. No. 62/610,217 that was filed on Dec. 24, 2017, U.S. Provisional Application Ser. No. 62/620,494 that was filed on Jan. 23, 2018. and U.S. Provisional Application Ser. No. 62/674,040 that was filed on May 21, 2018, which are all incorporated herein by reference.

### TECHNICAL FIELD

This disclosure relates generally to an apparatus, an arrangement, and a method for protecting a network (such as a vehicular or automotive network) from malware by performing analysis of received messages not at the point of entry of the messages, and in particular, redirecting (such as by tunneling) the received messages for analysis by an analyzer in the network.

### BACKGROUND

Unless otherwise indicated herein, the materials described in this section are not prior art to the claims in this application, and are not admitted to be prior art by inclusion in this section.

FIG. 1 shows a block diagram that illustrates a system 10 including a computer system 11 and an associated Internet 22 connection. Such configuration is typically used for computers (hosts) connected to the Internet 22 and executing a server, or a client (or a combination) software. The computer system 11 may be used as a portable electronic device such as a notebook/laptop computer, a media player (e.g., MP3 based or video player), a desktop computer, a laptop computer, a cellular phone, a Personal Digital Assistant (PDA), an image processing device (e.g., a digital camera or video recorder), any other handheld or fixed location computing devices, or a combination of any of these devices. Note that while FIG. 1 illustrates various components of the computer system 11, it is not intended to represent any particular architecture or manner of interconnecting the components.

Network computers, handheld computers, cell phones and other data processing systems that have fewer or more components, may also be used. For example, the computer of FIG. 1 may be an Apple Macintosh computer, a Power Book, or an IBM compatible PC. The computer system 11 may include a bus 13, an interconnect, or other communication mechanism for communicating information, and a processor 12, commonly in the form of an integrated circuit, coupled to the bus 13 for processing information, and for executing the computer executable instructions. The computer system 11 may also include a main memory 15a, such as a Random Access Memory (RAM), or other dynamic storage device, coupled to the bus 13 for storing information and instructions to be executed by the processor 12. The main memory 15a also may be used for storing temporary variables or other intermediate information during execution of instructions to be executed by the processor 12.

The computer system 11 further includes a Read Only Memory (ROM) 15b (or other non-volatile memory) or other static storage device coupled to the bus 13 for storing static information and instructions for the processor 12. A storage device 15c, that may be a magnetic disk or optical disk, such as a hard disk drive (HDD) for reading from and writing to a hard disk, a magnetic disk drive for reading from and writing to a magnetic disk, and/or an optical disk drive (such as DVD) for reading from and writing to a removable optical disk, is coupled to the bus 13 for storing information and instructions. The hard disk drive, magnetic disk drive, and optical disk drive may be connected to the system bus 13 by a hard disk drive interface, a magnetic disk drive interface, and an optical disk drive interface, respectively. The drives and their associated computer-readable media provide non-volatile storage of computer readable instructions, data structures, program modules and other data for the general-purpose computing devices.

Typically, the computer system 11 includes an Operating System (OS) stored in the non-volatile storage 15b for managing the computer resources and provides the applications and programs with access to the computer resources and interfaces. An operating system commonly processes system data and user input, and responds by allocating and managing tasks and internal system resources, such as controlling and allocating memory, prioritizing system requests, controlling input and output devices, facilitating networking and managing files. Non-limiting examples of operating systems are Microsoft Windows, Mac OS X, and Linux.

The computer system 11 may be coupled via the bus 13 to a display 17, such as a Cathode Ray Tube (CRT), a Liquid Crystal Display (LCD), a flat screen monitor, a touch screen monitor or similar means for displaying text and graphical data to a user. The display 17 may be connected via a video adapter for supporting the display. The display 17 allows a user to view, enter, and/or edit information that is relevant to the operation of the system 10. An input device 18, including alphanumeric and other keys, is coupled to the bus 13 for communicating information and command selections to the processor 12. Another type of user input device is a cursor control 18a, such as a mouse, a trackball, or cursor direction keys for communicating direction information and command selections to the processor 12 and for controlling cursor movement on the display 17. This cursor control 18a typically has two degrees of freedom in two axes, a first axis (e.g., x) and a second axis (e.g., y), that allows the device to specify positions in a plane.

The computer system 11 may be used for implementing the methods and techniques described herein. According to one embodiment, these methods and techniques are performed by the computer system 11 in response to the processor 12 executing one or more sequences of one or more instructions contained in the main memory 15a. Such instructions may be read into the main memory 15a from another computer-readable medium, such as the storage device 15c. Execution of the sequences of instructions contained in the main memory 15a causes the processor 12 to perform the process steps described herein. In alternative embodiments, hard-wired circuitry may be used in place of or in combination with software instructions to implement the arrangement. Thus, embodiments of the invention are not limited to any specific combination of hardware circuitry and software.

The term “processor” is used herein to include, but not limited to, any integrated circuit or any other electronic device (or collection of electronic devices) capable of performing an operation on at least one instruction, including, without limitation, a microprocessor (μP), a microcontroller (μC), a Digital Signal Processor (DSP), or any combination thereof. A processor, such as the processor 12, may further be a Reduced Instruction Set Core (RISC) processor, a Complex Instruction Set Computing (CISC) microprocessor, a Microcontroller Unit (MCU), or a CISC-based Central Processing Unit (CPU). The hardware of the processor 12 may be integrated onto a single substrate (e.g., silicon “die”), or distributed among two or more substrates. Furthermore, various functional aspects of the processor 12 may be implemented solely as a software (or firmware) associated with the processor 12.

A non-limiting example of a processor may be 80186 or 80188 available from Intel Corporation located at Santa Clara, Calif., USA. The 80186 and its detailed memory connections are described in the manual “80186/80188 High-Integration 16-Bit Microprocessors” by Intel Corporation, which is incorporated in its entirety for all purposes as if fully set forth herein. Other non-limiting example of a processor may be MC68360 available from Motorola Inc. located at Schaumburg, Ill., USA. The MC68360 and its detailed memory connections are described in the manual “MC68360 Quad Integrated Communications Controller—User's Manual” by Motorola, Inc., which is incorporated in its entirety for all purposes as if fully set forth herein. While exampled above regarding an address bus having an 8-bit width, other widths of address buses are commonly used, such as the 16-bit, 32-bit and 64-bit. Similarly, while exampled above regarding a data bus having an 8-bit width, other widths of data buses are commonly used, such as 16-bit, 32-bit and 64-bit width. In one example, the processor consists of, comprises, or is part of, Tiva™ TM4C123GH6PM Microcontroller available from Texas Instruments Incorporated (Headquartered in Dallas, Tex., U.S.A.), described in a data sheet published 2015 by Texas Instruments Incorporated [DS-TM4C123GH6PM-15842.2741, SPMS376E, Revision 15842.2741 June 2014], entitled: “Tiva™ TM4C123GH6PM Microcontroller—Data Sheet”, which is incorporated in its entirety for all purposes as if fully set forth herein, and is part of Texas Instrument's Tiva™ C Series microcontrollers family that provide designers a high-performance ARM® Cortex™-M-based architecture with a broad set of integration capabilities and a strong ecosystem of software and development tools. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions by integrating application-specific peripherals and providing a comprehensive library of software tools which minimize board costs and design-cycle time. Offering quicker time-to-market and cost savings, the Tiva™ C Series microcontrollers are the leading choice in high-performance 32-bit applications. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions.

A memory can store computer programs or any other sequence of computer readable instructions, or data, such as files, text, numbers, audio and video, as well as any other form of information represented as a string or structure of bits or bytes. The physical means of storing information may be electrostatic, ferroelectric, magnetic, acoustic, optical, chemical, electronic, electrical, or mechanical. A memory may be in the form of an Integrated Circuit (IC, a.k.a. chip or microchip). Alternatively or in addition, a memory may be in the form of a packaged functional assembly of electronic components (module). Such module may be based on a Printed Circuit Board (PCB) such as PC Card according to Personal Computer Memory Card International Association (PCMCIA) PCMCIA 2.0 standard, or a Single In-line Memory Module (SIMM) or a Dual In-line Memory Module (DIMM), standardized under the JEDEC JESD-21C standard. Further, a memory may be in the form of a separately rigidly enclosed box such as an external Hard-Disk Drive (HDD).

Various forms of computer-readable media may be involved in carrying one or more sequences of one or more instructions to the processor 12 for execution. For example, the instructions may initially be carried on a magnetic disk of a remote computer. The remote computer can load the instructions into its dynamic memory and send the instructions over a telephone line using a modem. A modem local to the computer system 11 can receive the data on the telephone line and use an infrared transmitter to convert the data to an infrared signal. An infrared detector can receive the data carried in the infrared signal, and appropriate circuitry may place the data on the bus 13. The bus 13 carries the data to the main memory 15a, from which the processor 12 retrieves and executes the instructions. The instructions received by the main memory 15a may optionally be stored on the storage device 15c either before or after execution by the processor 12.

The computer system 11 commonly includes a communication interface 9 coupled to the bus 13. The communication interface 9 provides a two-way data communication coupling to a network link 8 that is connected to a Local Area Network (LAN) 14. For example, the communication interface 9 may be an Integrated Services Digital Network (ISDN) card or a modem to provide a data communication connection to a corresponding type of telephone line. As another non-limiting example, the communication interface 9 may be a Local Area Network (LAN) card to provide a data communication connection to a compatible LAN. For example, Ethernet-based connection based on IEEE802.3 standard may be used, such as 10/100BaseT, 1000BaseT (gigabit Ethernet), 10 gigabit Ethernet (10GE or 10 GbE or 10 GigE per IEEE Std. 802.3ae-2002as standard), 40 Gigabit Ethernet (40 GbE), or 100 Gigabit Ethernet (100 GbE as per Ethernet standard IEEE P802.3ba). These technologies are described in Cisco Systems, Inc. Publication number 1-587005-001-3 (June 1999), “Internetworking Technologies Handbook”. In such a case, the communication interface 9 typically includes a LAN transceiver or a modem, such as a Standard Microsystems Corporation (SMSC) LAN91C111 10/100 Ethernet transceiver, described in the Standard Microsystems Corporation (SMSC) data-sheet “LAN91C111 10/100 Non-PCI Ethernet Single Chip MAC+PHY” Data-Sheet, Rev. 15 (Feb. 20, 2004), which is incorporated in its entirety for all purposes as if fully set forth herein. Ethernet is further described in chapter 7 entitled: “Ethernet Technologies” of The Internetworking Technology Overview by Cisco Systems, Inc. [published June 1999, Document No. 1-58705-001-3], which is incorporated in its entirety for all purposes as if fully set forth herein.

An Internet Service Provider (ISP) 16 is an organization that provides services for accessing, using, or participating in the Internet 22. The Internet Service Provider 16 may be organized in various forms, such as commercial, community-owned, non-profit, or otherwise privately owned. Internet services, typically provided by ISPs, include Internet access, Internet transit, domain name registration, web hosting, and collocation. ISPs may engage in peering, where multiple ISPs interconnect at peering points or Internet exchange points (IXs), allowing routing of data between each network, without charging one another for the data transmitted—data that would otherwise have passed through a third upstream ISP, incurring charges from the upstream ISP. ISPs requiring no upstream and having only customers (end customers and/or peer ISPs) are referred to as Tier 1 ISPs.

An arrangement 10a of a computer system connected to the Internet 22 is shown in FIG. 1a. A computer system or a workstation 7 includes a main unit box 6 with an enclosed motherboard that has the processor 12 and the memories 15a, 15b, and 15c are mounted. The workstation 7 may include a keyboard 2 (corresponding to the input device 18), a printer 4, a computer mouse 3 (corresponding to the cursor control 18a), and a display 5 (corresponding to the display 17). FIG. 1a further illustrates various devices connected via the Internet 22, such as a client device #1 24, a client device #2 24a, a data server #1 23a, a data server #2 23b, and the workstation 7, connected to the Internet 22 over a LAN 14 and via the router or gateway 19 and the ISP 16.

The client device #1 24 and the client device #2 24a may communicate over the Internet 22 for exchanging or obtaining data from the data server #1 23a and the data server #2 23b. In one example, the servers are HTTP servers, sometimes known as web servers.

The term “computer-readable medium” (or “machine-readable medium”) is used herein to include, but not limited to, any medium or any memory, that participates in providing instructions to a processor, (such as the processor 12) for execution, or any mechanism for storing or transmitting information in a form readable by a machine (e.g., a computer). Such a medium may store computer-executable instructions to be executed by a processing element and/or control logic and data, which is manipulated by a processing element and/or control logic, and may take many forms, including but not limited to, non-volatile medium, volatile medium, and transmission medium. Transmission media includes coaxial cables, copper wire, and fiber optics, including the wires that comprise the bus 13. Transmission media may also take the form of acoustic or light waves, such as those generated during radio-wave and infra-red data communications, or other form of propagating signals (e.g., carrier waves, infrared signals, digital signals, etc.). Common forms of computer-readable media include a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer may read.

Various forms of computer-readable media may be involved in carrying one or more sequences of one or more instructions to the processor 12 for execution. For example, the instructions may initially be carried on a magnetic disk of a remote computer. The remote computer may load the instructions into its dynamic memory and send the instructions over a telephone line using a modem. A modem local to the computer system 11 can receive the data on the telephone line, using an infrared transmitter to convert the data to an infrared signal. An infrared detector can receive the data carried in the infrared signal and appropriate circuitry may place the data on the bus 13. The bus 13 carries the data to the main memory 15a, from which the processor 12 retrieves and executes the instructions. The instructions received by the main memory 15a may optionally be stored on the storage device 15c either before or after execution by the processor 12.

The Internet is a global system of interconnected computer networks that use the standardized Internet Protocol Suite (TCP/IP), including Transmission Control Protocol (TCP) and the Internet Protocol (IP), to serve billions of users worldwide. It is a network of networks that consists of millions of private, public, academic, business, and government networks, of local to global scope, that are linked by a broad array of electronic and optical networking technologies. The Internet carries a vast range of information resources and services, such as the interlinked hypertext documents on the World Wide Web (WWW) and the infrastructure to support electronic mail. The Internet backbone refers to the principal data routes between large, strategically interconnected networks and core routers on the Internet. These data routers are hosted by commercial, government, academic, and other high-capacity network centers, the Internet exchange points and network access points that interchange Internet traffic between the countries, continents and across the oceans of the world. Traffic interchange between Internet service providers (often Tier 1 networks) participating in the Internet backbone exchange traffic by privately negotiated interconnection agreements, primarily governed by the principle of settlement-free peering.

OSI. The Open Systems Interconnection (OSI) model, which is defined by the International Organization for Standardization (ISO) and is maintained by the identification ISO/IEC 7498-1, includes seven-layers. OSI layers are further described in chapter 1 entitled: “Internetworking Basics” and various OSI protocols are described in chapter 30 entitled: “Internet Protocols” of The Internetworking Technology Overview by Cisco Systems, Inc. [published June 1999, Document No. 1-58705-001-3], which is incorporated in its entirety for all purposes as if fully set forth herein.

IP. The Internet Protocol (IP) is the principal communications protocol used for relaying datagrams (packets) across a network using the Internet Protocol Suite. Responsible for routing packets across network boundaries, it is the primary protocol that establishes the Internet. IP is the primary protocol in the Internet Layer of the Internet Protocol Suite and has the task of delivering datagrams from the source host to the destination host based on their addresses. For this purpose, IP defines addressing methods and structures for datagram encapsulation. Internet Protocol Version 4 (IPv4) is the dominant protocol of the Internet. IPv4 is described in Internet Engineering Task Force (IETF) Request for Comments (RFC) 791 and RFC 1349, and the successor, Internet Protocol Version 6 (IPv6), is currently active and in growing deployment worldwide. IPv4 uses 32-bit addresses (providing 4 billion: 4.3×10⁹ addresses), while IPv6 uses 128-bit addresses (providing 340 undecillion or 3.4×10³⁸ addresses), as described in RFC 2460. Various Internet protocols are further described in chapter 30 entitled: “Internet Protocols” of The Internetworking Technology Overview by Cisco Systems, Inc. [published June 1999, Document No. 1-58705-001-3], which is incorporated in its entirety for all purposes as if fully set forth herein. IPv6 is further described in chapter 32 entitled: “IPv6” of The Internetworking Technology Overview by Cisco Systems, Inc. [published June 1999, Document No. 1-58705-001-3], which is incorporated in its entirety for all purposes as if fully set forth herein.

The Internet Protocol (IP) is responsible for addressing hosts and routing datagrams (packets) from a source host to the destination host across one or more IP networks. For this purpose, the Internet Protocol defines an addressing system that has two functions: Identifying hosts addresses and providing a logical location service. Each packet is tagged with a header that contains the meta-data for the purpose of delivery. This process of tagging is also called encapsulation. IP is a connectionless protocol for use in a packet-switched Link Layer network, and does not need circuit setup prior to transmission. The aspects of guaranteeing delivery, proper sequencing, avoidance of duplicate delivery, and data integrity are addressed by an upper transport layer protocol (e.g., TCP—Transmission Control Protocol and UDP—User Datagram Protocol).

The main aspects of the IP technology are IP addressing and routing. Addressing refers to how IP addresses are assigned to end hosts and how sub-networks of IP host addresses are divided and grouped together. IP routing is performed by all hosts, but most importantly by internetwork routers, which typically use either Interior Gateway Protocols (IGPs) or External Gateway Protocols (EGPs) to help make IP datagram forwarding decisions across IP connected networks. Core routers serving in the Internet backbone commonly use the Border Gateway Protocol (BGP) as per RFC 4098 or Multi-Protocol Label Switching (MPLS). Other prior art publications relating to Internet related protocols and routing include the following chapters of the publication number 1-587005-001-3 by Cisco Systems, Inc. (July 1999) entitled: “Internetworking Technologies Handbook”, which are all incorporated in their entirety for all purposes as if fully set forth herein: Chapter 5: “Routing Basics” (pages 5-1 to 5-10), Chapter 30: “Internet Protocols” (pages 30-1 to 30-16), Chapter 32: “IPv6” (pages 32-1 to 32-6), Chapter 45: “OSI Routing” (pages 45-1 to 45-8) and Chapter 51: “Security” (pages 51-1 to 51-12), as well as in a IBM Corporation, International Technical Support Organization Redbook Documents No. GG24-4756-00, entitled: “Local area Network Concepts and Products: LAN Operation Systems and management”, 1st Edition May 1996, Redbook Document No. GG24-4338-00, entitled: “Introduction to Networking Technologies”, 1^{st} Edition April 1994, Redbook Document No. GG24-2580-01 “IP Network Design Guide”, 2^{nd} Edition June 1999, and Redbook Document No. GG24-3376-07 “TCP/IP Tutorial and Technical Overview”, ISBN 0738494682 8^{th} Edition December 2006, which are incorporated in their entirety for all purposes as if fully set forth herein.

TCP. The Transmission Control Protocol (TCP) is one of the core protocols of the Internet protocol suite (IP) described in RFC 675 and RFC 793, and the entire suite is often referred to as TCP/IP. TCP provides reliable, ordered and error-checked delivery of a stream of octets between programs running on computers connected to a local area network, intranet or the public Internet. It resides at the transport layer. Web browsers typically use TCP when they connect to servers on the World Wide Web, and used to deliver email and transfer files from one location to another. HTTP, HTTPS, SMTP, POP3, IMAP, SSH, FTP, Telnet and a variety of other protocols that are typically encapsulated in TCP. As the transport layer of TCP/IP suite, the TCP provides a communication service at an intermediate level between an application program and the Internet Protocol (IP). Due to network congestion, traffic load balancing, or other unpredictable network behavior, IP packets can be lost, duplicated, or delivered out of order. TCP detects these problems, requests retransmission of lost data, rearranges out-of-order data, and even helps minimize network congestion to reduce the occurrence of the other problems. Once the TCP receiver has reassembled the sequence of octets originally transmitted, it passes them to the receiving application. Thus, TCP abstracts the application's communication from the underlying networking details. The TCP is utilized extensively by many of the Internet's most popular applications, including the World Wide Web (WWW), E-mail, File Transfer Protocol, Secure Shell, peer-to-peer file sharing, and some streaming media applications.

While IP layer handles actual delivery of the data, TCP keeps track of the individual units of data transmission, called segments, which a message is divided into for efficient routing through the network. For example, when an HTML file is sent from a web server, the TCP software layer of that server divides the sequence of octets of the file into segments and forwards them individually to the IP software layer (Internet Layer). The Internet Layer encapsulates each TCP segment into an IP packet by adding a header that includes (among other data) the destination IP address. When the client program on the destination computer receives them, the TCP layer (Transport Layer) reassembles the individual segments and ensures they are correctly ordered and error free as it streams them to an application.

The TCP protocol operations may be divided into three phases. Connections must be properly established in a multi-step handshake process (connection establishment) before entering the data transfer phase. After data transmission is completed, the connection termination closes established virtual circuits and releases all allocated resources. A TCP connection is typically managed by an operating system through a programming interface that represents the local end-point for communications, the Internet socket. During the duration of a TCP connection, the local end-point undergoes a series of state changes.

Since TCP/IP is based on the client/server model of operation, the TCP connection setup involves the client and server preparing for the connection by performing an OPEN operation. A client process initiates a TCP connection by performing an active OPEN, sending a SYN message to a server. A server process using TCP prepares for an incoming connection request by performing a passive OPEN. Both devices create for each TCP session a data structure used to hold important data related to the connection, called a Transmission Control Block (TCB).

There are two different kinds of OPEN, named ‘Active OPEN’ and ‘Passive OPEN’. In Active OPEN the client process using TCP takes the “active role” and initiates the connection by actually sending a TCP message to start the connection (a SYN message). In Passive OPEN the server process designed to use TCP is contacting TCP and saying: “I am here, and I am waiting for clients that may wish to talk to me to send me a message on the following port number”. The OPEN is called passive because aside from indicating that the process is listening, the server process does nothing. A passive OPEN can in fact specify that the server is waiting for an active OPEN from a specific client, though not all TCP/IP APIs support this capability. More commonly, a server process is willing to accept connections from all corners. Such a passive OPEN is said to be unspecified.

In passive OPEN, the TCP uses a three-way handshake, and before a client attempts to connect with a server, the server must first bind to and listen at a port to open it up for connections. Once the Passive OPEN is established, a client may initiate an Active OPEN. To establish a connection, the three-way (or 3-step) handshake occurs:
1. SYN: The active open is performed by the client sending a SYN to the server. The client sets the segment's sequence number to a random value A.
2. SYN-ACK: In response, the server replies with a SYN-ACK. The acknowledgment number is set to one more than the received sequence number, i.e. A+1, and the sequence number that the server chooses for the packet is another random number, B.
3. ACK: Finally, the client sends an ACK back to the server. The sequence number is set to the received acknowledgement value, i.e. A+1, and the acknowledgement number is set to one more than the received sequence number i.e. B+1.

At this point, both the client and server have received an acknowledgment of the connection. The steps 1, 2 establish the connection parameter (sequence number) for one direction and it is acknowledged. The steps 2, 3 establish the connection parameter (sequence number) for the other direction and it is acknowledged, and then a full-duplex communication is established.

TCP keepalive. When two hosts are connected over a network via TCP/IP, TCP Keepalive Packets can be used to determine if the connection is still valid, and terminate it if needed. Most hosts that support TCP also support TCP Keepalive, where each host (or peer) periodically sends a TCP packet to its peer which solicits a response. The TCP keepalive scheme involves using timers when setting up a TCP connection, and when the keepalive timer reaches zero, a keepalive probe packet is sent with no data in it and the ACK flag turned on. This procedure is useful because if the other peers lose their connection (for example by rebooting) the broken connection is noticed, even no traffic on it is exchanged. If the keepalive probe is not replied to, the connection cannot be considered valid anymore. The TCP keepalive mechanism may be used to prevent inactivity from disconnecting the channel. For example, when being behind a NAT proxy or a firewall, a host may be disconnected without a reason. This behavior is caused by the connection tracking procedures implemented in proxies and firewalls, which keep track of all connections that pass through them. Due to the physical limits of these machines, they can only keep a finite number of connections in their memory. The most common and logical policy is to keep newest connections and to discard old and inactive connections first.

A keepalive signal is often sent at predefined intervals, and plays an important role on the Internet. After a signal is sent, if no reply is received the link is assumed to be down and future data will be routed via another path until the link is up again. A keepalive signal can also be used to indicate to Internet infrastructure that the connection should be preserved. Without a keepalive signal, intermediate NAT-enabled routers can drop the connection after timeout. Since the only purpose is to find links that don't work or to indicate connections that should be preserved, keepalive messages tend to be short and not take much bandwidth.

Transmission Control Protocol (TCP) keepalives are an optional feature, and if included must default to off. The keepalive packet contains null data, and in an Ethernet network, a keepalive frame length is 60 bytes, while the server response to this, also a null data frame, is 54 bytes. There are three parameters related to keepalive: Keepalive time is the duration between two keepalive transmissions in idle condition where TCP keepalive period is required to be configurable and by default is set to no less than 2 hours, Keepalive interval is the duration between two successive keepalive retransmissions, if acknowledgement to the previous keepalive transmission is not received, and Keepalive retry is the number of retransmissions to be carried out before declaring that remote end is not available.

IEEE 802.3bv™. Changes to IEEE Std 802.3-2015 that adds Clause 115 and Annex 115A are described in IEEE Std 802.3bv-2017 entitled: “Amendment 9: Physical Layer Specifications and Management Parameters for 1000 Mb/s Operation Over Plastic Optical Fiber” approved 14 Feb. 2017 [ISBN 978-5044-3721-9], which is incorporated in its entirety for all purposes as if fully set forth herein. This amendment adds point-to-point 1000 Mb/s Physical Layer (PHY) specifications and management parameters for operation on duplex plastic optical fiber (POF) targeting use in automotive, industrial, home-network, and other applications.

IEEE 802.3bp™. Changes to IEEE Std 802.3-2015 that adds Clause 97 and Clause 98 are described in IEEE Std 802.3 bp-2016 entitled: “Amendment 4: Physical Layer Specifications and Management Parameters for 1 Gb/s Operation over a Single Twisted-Pair Copper Cable” approved 30 Jun. 2016 [ISBN 978-1-5044-2288-8], which is incorporated in its entirety for all purposes as if fully set forth herein. This amendment adds point-to-point 1 Gb/s Physical Layer (PHY) specifications and management parameters for operation on a single balanced twisted-pair copper cable in automotive and other applications not utilizing the structured wiring plant.

IEEE 802.1X. Port-based Network Access Control (PNAC) allows a network administrator to restrict the use of IEEE 802 LAN service access points (ports) to secure communication between authenticated and authorized devices. An architecture, functional elements, and protocols that support mutual authentication between the clients of ports attached to the same LAN and secure communication between the ports are described in IEEE Std 802.1X™-2010 Published 5 Feb. 2010 [ISBN 978-0-7381-6145-7 STD96008] by IEEE Standard for Local and metropolitan area networks and entitled: “Port-Based Network Access Control”, which is incorporated in its entirety for all purposes as if fully set forth herein.

IEEE 802.1X defines the encapsulation of the Extensible Authentication Protocol (EAP) over IEEE 802, which is known as “EAP over LAN”—EAPOL. The EAPOL protocol was also modified for use with IEEE 802.1AE (“MACsec”) and IEEE 802.1AR (Secure Device Identity, DevID) in IEEE 802.1X-2010 to support service identification and optional point to point encryption over the local LAN segment. IEEE 802.1X authentication involves three parties: a supplicant, an authenticator, and an authentication server. The supplicant is a client device (such as a laptop) that wishes to attach to the LAN/WLAN. The term ‘supplicant’ is also used interchangeably to refer to the software running on the client that provides credentials to the authenticator. The authenticator is a network device, such as an Ethernet switch or wireless access point; and the authentication server is typically a host running software supporting the RADIUS and EAP protocols. In some cases, the authentication server software may be running on the authenticator hardware.

The authenticator acts like a security guard to a protected network. The supplicant (i.e., client device) is not allowed access through the authenticator to the protected side of the network until the supplicant's identity has been validated and authorized. With IEEE 802.1X port-based authentication, the supplicant provides credentials, such as user name/password or digital certificate, to the authenticator, and the authenticator forwards the credentials to the authentication server for verification. If the authentication server determines the credentials are valid, the supplicant (client device) is allowed to access resources located on the protected side of the network. EAPOL operates at the network layer on top of the data link layer, and in Ethernet II framing protocol has an EtherType value of 0x888E.

IEEE 802.1X-2001 defines two logical port entities for an authenticated port—the “controlled port” and the “uncontrolled port”. The controlled port is manipulated by the 802.1X PAE (Port Access Entity) to allow (in the authorized state) or prevent (in the unauthorized state) network traffic ingressing and egressing to/from the controlled port. The uncontrolled port is used by the 802.1X PAE to transmit and receive EAPOL frames.

A typical authentication procedure consists of: (1) Initialization—On detection of a new supplicant, the port on the switch (authenticator) is enabled and set to the “unauthorized” state. In this state, only 802.1X traffic is allowed; other traffic, such as the Internet Protocol (and with that TCP and UDP), is dropped; (2) Initiation—To initiate authentication the authenticator will periodically transmit EAP-Request Identity frames to a special Layer 2 address (01:80:C2:00:00:03) on the local network segment. The supplicant listens on this address, and on receipt of the EAP-Request Identity frame it responds with an EAP-Response Identity frame containing an identifier for the supplicant such as a User ID. The authenticator then encapsulates this Identity response in a RADIUS Access-Request packet and forwards it on to the authentication server. The supplicant may also initiate or restart authentication by sending an EAPOL-Start frame to the authenticator, which will then reply with an EAP-Request Identity frame; (3) Negotiation—(Technically EAP negotiation) The authentication server sends a reply (encapsulated in a RADIUS Access-Challenge packet) to the authenticator, containing an EAP Request specifying the EAP Method (The type of EAP based authentication it wishes the supplicant to perform). The authenticator encapsulates the EAP Request in an EAPOL frame and transmits it to the supplicant. At this point the supplicant can start using the requested EAP Method, or do an NAK (“Negative Acknowledgement”) and respond with the EAP Methods it is willing to perform; and (4) Authentication—If the authentication server and supplicant agree on an EAP Method, EAP Requests and Responses are sent between the supplicant and the authentication server (translated by the authenticator) until the authentication server responds with either an EAP-Success message (encapsulated in a RADIUS Access-Accept packet), or an EAP-Failure message (encapsulated in a RADIUS Access-Reject packet). If authentication is successful, the authenticator sets the port to the “authorized” state and normal traffic is allowed, if it is unsuccessful the port remains in the “unauthorized” state. When the supplicant logs off, it sends an EAPOL-logoff message to the authenticator, the authenticator then sets the port to the “unauthorized” state, once again blocking all non-EAP traffic.

IEEE 802.1AE. MAC Security standard (also known as MACsec) defines connectionless data confidentiality and integrity for media access independent protocols, and is described in IEEE Std 802.1AE™-2006 Published 18 Aug. 2006 [ISBN 0-7381-4991-8 SS95549] by IEEE Standard for Local and metropolitan area networks and entitled: “Media Access Control (MAC) Security”, which is incorporated in its entirety for all purposes as if fully set forth herein. MAC Security (MACsec), as defined by this standard, allows authorized systems that attach to and interconnect LANs in a network to maintain confidentiality of transmitted data and to take measures against frames transmitted or modified by unauthorized devices.

The IEEE 802.1AE standard specifies the implementation of a MAC Security Entities (SecY) that can be thought of as part of the stations attached to the same LAN, providing secure MAC service to the client. The standard defines MAC sec frame format, which is similar to the Ethernet frame, but includes additional fields: Security Tag, which is an extension of the EtherType, Message authentication code (ICV), and Secure Connectivity Associations that represent groups of stations connected via unidirectional Secure Channels. Security Associations within each secure channel—Each association uses its own key (SAK), and more than one association is permitted within the channel for the purpose of key change without traffic interruption (standard requires devices to support at least two). A default cipher suite of GCM-AES-128 (Galois/Counter Mode of Advanced Encryption Standard cipher with 128-bit key), and GCM-AES-256 using a 256 bit key is also defined the standard.

Security tag inside each frame in addition to EtherType includes: association number within the channel, packet number to provide unique initialization vector for encryption and authentication algorithms as well as protection against replay attack, and optional LAN-wide secure channel identifier (not required on point-to-point links).

The IEEE 802.1AE (MACsec) standard specifies a set of protocols to meet the security requirements for protecting data traversing Ethernet LANs. MACsec allows unauthorized LAN connections to be identified and excluded from communication within the network. In common with IPsec and SSL, MACsec defines a security infrastructure to provide data confidentiality, data integrity and data origin authentication. By assuring that a frame comes from the station that claimed to send it, MACSec can mitigate attacks on Layer 2 protocols.

User. The term “user” is used herein to include, but not limited to, the principal using a client to interactively retrieve and render resources or resource manifestation, such as a person using a web browser, a person using an e-mail reader, or a person using a display such as the display 17.

The term ‘client’ typically refers to an application (or a device executing the application) used for retrieving or rendering resources, or resource manifestations, such as a web browser, an e-mail reader, or a Usenet reader, while the term ‘server’ typically refers to an application (or a device executing the application) used for supplying resources or resource manifestations, and typically offers (or hosts) various services to other network computers and users. These services are usually provided through ports or numbered access points beyond the server's network address. Each port number is usually associated with a maximum of one running program, which is responsible for handling requests to that port. A daemon, being a user program, can in turn access the local hardware resources of that computer by passing requests to the operating system kernel.

A mobile operating system (also referred to as mobile OS), is an operating system that operates a smartphone, tablet, PDA, or another mobile device. Modern mobile operating systems combine the features of a personal computer operating system with other features, including a touchscreen, cellular, Bluetooth, Wi-Fi, GPS mobile navigation, camera, video camera, speech recognition, voice recorder, music player, near field communication and infrared blaster. Currently, the popular mobile OSs include Android, Symbian, Apple iOS, BlackBerry, MeeGo, Windows Phone, and Bada. Mobile devices with mobile communications capabilities (e.g. smartphones) typically contain two mobile operating systems: a main user-facing software platform is supplemented by a second low-level proprietary real-time operating system that operates the radio and other hardware.

Android is a Linux-based, open source mobile operating system (OS) based on the Linux kernel that is currently offered by Google. With a user interface based on direct manipulation, Android is designed primarily for touchscreen mobile devices such as smartphones and tablet computers with specialized user interfaces for televisions (Android TV), cars (Android Auto), and wrist watches (Android Wear). The OS uses touch inputs that loosely correspond to real-world actions, such as swiping, tapping, pinching, and reverse pinching to manipulate on-screen objects, and a virtual keyboard. Despite being primarily designed for touchscreen input, it also has been used in game consoles, digital cameras, and other electronics. The response to user input is designed to be immediate and provides a fluid touch interface, often using the vibration capabilities of the device to provide haptic feedback to the user. Internal hardware such as accelerometers, gyroscopes and proximity sensors are used by some applications to respond to additional user actions. For example, adjusting the screen from portrait to landscape depending on the device orientation, or allowing the user to steer a vehicle in a racing game by rotating the device, a process that simulates control of a steering wheel.

Android devices boot to the homescreen, the primary navigation and information point on the device, which is similar to the desktop found on PCs. The homescreens on Android are typically made up of app icons and widgets. App icons launch the associated app, whereas widgets display live, auto-updating content such as the weather forecast, the user's email inbox, or a news ticker directly on the homescreen. A homescreen may be made up of several pages that the user can swipe back and forth between pages. A heavily-customizable Android homescreen interface allows the user to adjust the look and feel of the device to their liking. Third-party apps available on Google Play and other app stores can extensively re-theme the homescreen, and even mimic the look of other operating systems, such as Windows Phone. The Android OS is described in a publication entitled: “Android Tutorial”, downloaded from tutorialspoint.com on July 2014, which is incorporated in its entirety for all purposes as if fully set forth herein.

iOS (previously iPhone OS) from Apple Inc. (headquartered in Cupertino, Calif., U.S.A.) is a mobile operating system distributed exclusively for Apple hardware. The user interface of the iOS is based on the concept of direct manipulation, using multi-touch gestures. Interface control elements consist of sliders, switches, and buttons. Interaction with the OS includes gestures such as swipe, tap, pinch, and reverse pinch, all of which have specific definitions within the context of the iOS operating system and its multi-touch interface. Internal accelerometers are used by some applications to respond to shaking the device (one common result is the undo command), or rotating it in three dimensions (one common result is switching from portrait to landscape mode). The iOS is described in a publication entitled: “IOS Tutorial”, downloaded from tutorialspoint.com on July 2014, which is incorporated in its entirety for all purposes as if fully set forth herein.

A server device (in server/client architecture) typically offers information resources, services, and applications to clients, using a server dedicated or oriented operating system. A server device may consist of, be based on, include, or be included in the work-station 7, the computer system 10, or the computer 11. Current popular server operating systems are based on Microsoft Windows (by Microsoft Corporation, headquartered in Redmond, Wash., U.S.A.), Unix, and Linux-based solutions, such as the ‘Windows Server 2012’ server operating system, which is a part of the Microsoft ‘Windows Server’ OS family, that was released by Microsoft in 2012. ‘Windows Server 2012’ provides enterprise-class datacenter and hybrid cloud solutions that are simple to deploy, cost-effective, application-specific, and user-centric, and is described in Microsoft publication entitled: “Inside-Out Windows Server 2012”, by William R. Stanek, published 2013 by Microsoft Press, which is incorporated in its entirety for all purposes as if fully set forth herein.

Unix operating system is widely used in servers. It is a multitasking, multiuser computer operating system that exists in many variants, and is characterized by a modular design that is sometimes called the “Unix philosophy”, meaning the OS provides a set of simple tools, which each performs a limited, well-defined function, with a unified filesystem as the primary means of communication, and a shell scripting and command language to combine the tools to perform complex workflows. Unix was designed to be portable, multi-tasking and multi-user in a time-sharing configuration, and Unix systems are characterized by various concepts: the use of plain text for storing data, a hierarchical file system, treating devices and certain types of Inter-Process Communication (IPC) as files, the use of a large number of software tools, and small programs that can be strung together through a command line interpreter using pipes, as opposed to using a single monolithic program that includes all of the same functionality. Unix operating system consists of many utilities along with the master control program, the kernel. The kernel provides services to start and stop programs, handles the file system and other common “low level” tasks that most programs share, and schedules access to avoid conflicts when programs try to access the same resource, or device simultaneously. To mediate such access, the kernel has special rights, reflected in the division between user-space and kernel-space. Unix is described in a publication entitled: “UNIX Tutorial” by tutorialspoint.com, downloaded on July 2014, which is incorporated in its entirety for all purposes as if fully set forth herein.

A client device (in server/client architecture) typically receives information resources, services, and applications from servers, and is using a client dedicated or oriented operating system. The client device may consist of, be based on, include, or be included in, the workstation 7, the computer system 10 or the computer 11. Current popular client operating systems are based on Microsoft Windows (by Microsoft Corporation, headquartered in Redmond, Wash., U.S.A.), which is a series of graphical interface operating systems developed, marketed, and sold by Microsoft. Microsoft Windows is described in Microsoft publications entitled: “Windows Internals—Part 1” and “Windows Internals—Part 2”, by Mark Russinovich, David A. Solomon, and Alex Ioescu, published by Microsoft Press in 2012, which are both incorporated in their entirety for all purposes as if fully set forth herein. Windows 8 is a personal computer operating system developed by Microsoft as part of Windows NT family of operating systems, that was released for general availability on October 2012, and is described in Microsoft Press 2012 publication entitled: “Introducing Windows 8—An Overview for IT Professionals” by Jerry Honeycutt, which is incorporated in its entirety for all purposes as if fully set forth herein.

RTOS. A Real-Time Operating System (RTOS) is an Operating System (OS) intended to serve real-time applications that process data as it comes in, typically without buffer delays. Processing time requirements (including any OS delay) are typically measured in tenths of seconds or shorter increments of time, and is a time bound system which has well defined fixed time constraints. Processing is commonly to be done within the defined constraints, or the system will fail. They either are event driven or time sharing, where event driven systems switch between tasks based on their priorities while time sharing systems switch the task based on clock interrupts. A key characteristic of an RTOS is the level of its consistency concerning the amount of time it takes to accept and complete an application's task; the variability is jitter. A hard real-time operating system has less jitter than a soft real-time operating system. The chief design goal is not high throughput, but rather a guarantee of a soft or hard performance category. An RTOS that can usually or generally meet a deadline is a soft real-time OS, but if it can meet a deadline deterministically it is a hard real-time OS. An RTOS has an advanced algorithm for scheduling, and includes a scheduler flexibility that enables a wider, computer-system orchestration of process priorities. Key factors in a real-time OS are minimal interrupt latency and minimal thread switching latency; a real-time OS is valued more for how quickly or how predictably it can respond than for the amount of work it can perform in a given period of time.

Common designs of RTOS include event-driven, where tasks are switched only when an event of higher priority needs servicing; called preemptive priority, or priority scheduling, and time-sharing, where task are switched on a regular clocked interrupt, and on events; called round robin. Time sharing designs switch tasks more often than strictly needed, but give smoother multitasking, giving the illusion that a process or user has sole use of a machine. In typical designs, a task has three states: Running (executing on the CPU); Ready (ready to be executed); and Blocked (waiting for an event, I/O for example). Most tasks are blocked or ready most of the time because generally only one task can run at a time per CPU. The number of items in the ready queue can vary greatly, depending on the number of tasks the system needs to perform and the type of scheduler that the system uses. On simpler non-preemptive but still multitasking systems, a task has to give up its time on the CPU to other tasks, which can cause the ready queue to have a greater number of overall tasks in the ready to be executed state (resource starvation).

RTOS concepts and implementations are described in an Application Note No. RES05B00008-0100/Rec. 1.00 published January 2010 by Renesas Technology Corp. entitled: “R8C Family—General RTOS Concepts”, in JAJA Technology Review article published February 2007 [1535-5535/$32.00] by The Association for Laboratory Automation [doi:10.1016/j.jala.2006.10.016] entitled: “An Overview of Real-Time Operating Systems”, and in Chapter 2 entitled: “Basic Concepts of Real Time Operating Systems” of a book published 2009 [ISBN—978-1-4020-9435-4] by Springer Science+Business Media B.V. entitled: “Hardware-Dependent Software—Principles and Practice”, which are all incorporated in their entirety for all purposes as if fully set forth herein.

QNX. One example of RTOS is QNX, which is a commercial Unix-like real-time operating system, aimed primarily at the embedded systems market. QNX was one of the first commercially successful microkernel operating systems and is used in a variety of devices including cars and mobile phones. As a microkernel-based OS, QNX is based on the idea of running most of the operating system kernel in the form of a number of small tasks, known as Resource Managers. In the case of QNX, the use of a microkernel allows users (developers) to turn off any functionality they do not require without having to change the OS itself; instead, those services will simply not run.

FreeRTOS. FreeRTOS™ is a free and open-source Real-Time Operating system developed by Real Time Engineers Ltd., designed to fit on small embedded systems and implements only a very minimalist set of functions: very basic handle of tasks and memory management, and just sufficient API concerning synchronization. Its features include characteristics such as preemptive tasks, support for multiple microcontroller architectures, a small footprint (4.3 Kbytes on an ARM7 after compilation), written in C, and compiled with various C compilers. It also allows an unlimited number of tasks to run at the same time, and no limitation about their priorities as long as used hardware can afford it.

FreeRTOS™ provides methods for multiple threads or tasks, mutexes, semaphores and software timers. A tick-less mode is provided for low power applications, and thread priorities are supported. Four schemes of memory allocation are provided: allocate only; allocate and free with a very simple, fast, algorithm; a more complex but fast allocate and free algorithm with memory coalescence; and C library allocate and free with some mutual exclusion protection. While the emphasis is on compactness and speed of execution, a command line interface and POSIX-like IO abstraction add-ons are supported. FreeRTOS™ implements multiple threads by having the host program call a thread tick method at regular short intervals.

The thread tick method switches tasks depending on priority and a round-robin scheduling scheme. The usual interval is 1/1000 of a second to 1/100 of a second, via an interrupt from a hardware timer, but this interval is often changed to suit a particular application. FreeRTOS™ is described in a paper by Nicolas Melot (downloaded July 2015) entitled: “Study of an operating system: FreeRTOS—Operating systems for embedded devices”, in a paper (dated Sep. 23, 2013) by Dr. Richard Wall entitled: “Carebot PIC32 MX7ck implementation of Free RTOS”, FreeRTOS™ modules are described in web pages entitled: “FreeRTOS™ Modules” published in the www.freertos.org web-site dated 26 Nov. 2006, and FreeRTOS kernel is described in a paper published 1 Apr. 2007 by Rich Goyette of Carleton University as part of ‘SYSC5701: Operating System Methods for Real-Time Applications’, entitled: “An Analysis and Description of the Inner Workings of the FreeRTOS Kernel”, which are all incorporated in their entirety for all purposes as if fully set forth herein.

SafeRTOS. SafeRTOS was constructed as a complementary offering to FreeRTOS, with common functionality but with a uniquely designed safety-critical implementation. When the FreeRTOS functional model was subjected to a full HAZOP, weakness with respect to user misuse and hardware failure within the functional model and API were identified and resolved. Both SafeRTOS and FreeRTOS share the same scheduling algorithm, have similar APIs, and are otherwise very similar, but they were developed with differing objectives. SafeRTOS was developed solely in the C language to meet requirements for certification to IEC61508. SafeRTOS is known for its ability to reside solely in the on-chip read only memory of a microcontroller for standards compliance. When implemented in hardware memory, SafeRTOS code can only be utilized in its original configuration, so certification testing of systems using this OS need not re-test this portion of their designs during the functional safety certification process.

VxWorks. VxWorks is an RTOS developed as proprietary software and designed for use in embedded systems requiring real-time, deterministic performance and, in many cases, safety and security certification, for industries, such as aerospace and defense, medical devices, industrial equipment, robotics, energy, transportation, network infrastructure, automotive, and consumer electronics. VxWorks supports Intel architecture, POWER architecture, and ARM architectures. The VxWorks may be used in multicore asymmetric multiprocessing (AMP), symmetric multiprocessing (SMP), and mixed modes and multi-OS (via Type 1 hypervisor) designs on 32- and 64-bit processors. VxWorks comes with the kernel, middleware, board support packages, Wind River Workbench development suite and complementary third-party software and hardware technologies. In its latest release, VxWorks 7, the RTOS has been re-engineered for modularity and upgradeability so the OS kernel is separate from middleware, applications and other packages. Scalability, security, safety, connectivity, and graphics have been improved to address Internet of Things (IoT) needs.

μC/OS. Micro-Controller Operating Systems (MicroC/OS, stylized as μC/OS) is a real-time operating system (RTOS) that is a priority-based preemptive real-time kernel for microprocessors, written mostly in the programming language C, and is intended for use in embedded systems. MicroC/OS allows defining several functions in C, each of which can execute as an independent thread or task. Each task runs at a different priority, and runs as if it owns the central processing unit (CPU). Lower priority tasks can be preempted by higher priority tasks at any time. Higher priority tasks use operating system (OS) services (such as a delay or event) to allow lower priority tasks to execute. OS services are provided for managing tasks and memory, communicating between tasks, and timing.

Vehicle cybersecurity. Modern automobiles are no longer mere mechanical devices; they are pervasively monitored and controlled by dozens of digital computers coordinated via internal vehicular networks. While this transformation has driven major advancements in efficiency and safety, it has also introduced a range of new potential risks. Experimentally evaluated issues on a modern automobile that demonstrate the fragility of the underlying system structure are described in a paper that appeared in 2010 IEEE Symposium on Security and Privacy, entitled: “Experimental Security Analysis of a Modern Automobile” by Karl Koscher, Alexei Czeskis, Franziska Roesner, Shwetak Patel, and Tadayoshi Kohno, all of Department of Computer Science and Engineering, University of Washington, Seattle, Wash. 98195-2350 and by Stephen Checkoway, Damon McCoy, Brian Kantor, Danny Anderson, Hovav Shacham, and Stefan Savage of the Department of Computer Science and Engineering, University of California San Diego, La Jolla, Calif. 92093-0404, which is incorporated in its entirety for all purposes as if fully set forth herein. In this paper, it is demonstrated that an attacker who is able to infiltrate virtually any Electronic Control Unit (ECU) can leverage this ability to completely circumvent a broad array of safety-critical systems. Over a range of experiments, both in the lab and in road tests, the ability to adversarially control a wide range of automotive functions and completely ignore driver input—including disabling the brakes, selectively braking individual wheels on demand, stopping the engine, and so on, is demonstrated.

Modern automobiles are pervasively computerized, and hence potentially vulnerable to attack. However, while previous research has shown that the internal networks within some modern cars are insecure, the associated threat model—requiring prior physical access—has justifiably been viewed as unrealistic. Thus, it remains an open question if automobiles can also be susceptible to remote compromise. A work that seeks to put this question to rest by systematically analyzing the external attack surface of a modern automobile is described in a 2011 published paper entitled: “Comprehensive Experimental Analyses of Automotive Attack Surfaces”, by Stephen Checkoway, Damon McCoy, Brian Kantor, Danny Anderson, Hovav Shacham, and Stefan Savage, all of University of California, San Diego, and by Karl Koscher, Alexei Czeskis, Franziska Roesner, and Tadayoshi Kohno, all of University of Washington, which is incorporated in its entirety for all purposes as if fully set forth herein. The paper discover that remote exploitation is feasible via a broad range of attack vectors (including mechanics tools, CD players, Bluetooth and cellular radio), and further, that wireless communications channels allow long distance vehicle control, location tracking, in-cabin audio exfiltration and theft. Finally, we discuss the structural characteristics of the automotive ecosystem that give rise to such problems and highlight the practical challenges in mitigating them.

Surface Vehicle Recommended Practice SAE J3061 entitled: “Cybersecurity Guidebook for Cyber-Physical Vehicle Systems” issued January 2016 establishes a set of high-level guiding principles for Cybersecurity as it relates to cyber-physical vehicle systems. This recommended practice provides guidance on vehicle Cybersecurity and was created based off of, and expanded on from, existing practices which are being implemented or reported in industry, government and conference papers. The best practices are intended to be flexible, pragmatic, and adaptable in their further application to the vehicle industry as well as to other cyber-physical vehicle systems (e.g., commercial and military vehicles, trucks, busses). Other proprietary Cybersecurity development processes and standards may have been established to support a specific manufacturer's development processes, and may not be comprehensively represented in this document, however, information contained in this document may help refine existing in-house processes, methods, etc.

A system and method for detection of at least one cyber-attack on one or more vehicles are disclosed in U.S. Patent Application Publication No. 2017/02303852 to Ruvio et al. entitled: “Vehicle correlation system for cyber attacks detection and method thereof”, which is incorporated in its entirety for all purposes as if fully set forth herein. The method includes steps of transmitting and/or receiving by a first on-board agent module installed within one or more vehicles and/or a second on-board agent module installed within road infrastructure and in a range of communication with said first on-board agent module metadata to and/or from an on-site and/or remote cloud-based detection server including a correlation engine; detecting cyberattacks based on correlation calculation between the metadata received from one or more first agent module installed within vehicles and/or from one or more second agent modules installed within road infrastructure; indicating a probability of a cyber-attack against one or more vehicle based on correlation calculation; initiating blocking of vehicle-to-vehicle communication to present and/or stop a spread of an identified threat.

Identification of vehicle-specific challenges, discussing existing solutions and their limitations, and presenting a cloud-assisted vehicle malware defense framework that can address these challenges, are described in a paper by Tao Zhang published in IEEE Internet of Things Journal, Vol. 1, No. 1, February 2014, entitled: “Defending Connected Vehicles Against Malware: Challenges and a Solution Framework”, which is incorporated in its entirety for all purposes as if fully set forth herein.

Methods and systems for protecting components of a linked vehicle from cyber-attack are disclosed are disclosed in U.S. Pat. No. 9,686,294 to Kantor et al. entitled: “Protection of communication on a vehicular network via a remote security service”, which is incorporated in its entirety for all purposes as if fully set forth herein. These methods and systems comprise elements of hardware and software for receiving a packet; tunneling the packet to a terrestrial-based security service, analyzing whether the packet is harmful to a component in the vehicle, and at least one action to protect at least one component.

Network node modules within a vehicle that are arranged to form a reconfigurable automotive neural network are disclosed in U.S. Pat. No. 8,953,436 to Diab et al. entitled: “Automotive neural network”, which is incorporated in its entirety for all purposes as if fully set forth herein. Each network node module includes one or more subsystems for performing one or more operations and a local processing module for communicating with the one or more subsystems. A switch coupled between the one or more subsystems and the processing module re-routes traffic from the one or more subsystems to an external processing module upon failure of the local processing module.

A gateway apparatus that supports differentiated secure communications among heterogeneous electronic devices is disclosed in U.S. Pat. No. 9,380,044 to Zhang et al. entitled: “Supporting differentiated secure communications among heterogeneous electronic devices”, which is incorporated in its entirety for all purposes as if fully set forth herein. A communication port communicates via communication networks of different types with two or more associated devices having diverse secure communication capabilities. The gateway logic selectively authenticates the associated devices for group membership into a Secure Communication Group (SCG), and selectively communicates Secure Communication Group Keys (SCGKs) to the devices having the diverse secure communication capabilities for selectively generating session keys locally by the associated devices for mutual secure communication in accordance with the group membership of the associated devices in the SCG.

A system and method for managing remote reprogramming of flash memory in a vehicle electronic control unit is disclosed in U.S. Patent Application Publication No. 2007/0185624 to Duddles et al. entitled: “Method for remote reprogramming of vehicle flash memory”, which is incorporated in its entirety for all purposes as if fully set forth herein. A vehicle state manager process is used to first determine if the vehicle conditions are suitable for reprogramming of a particular ECU and, if so, the vehicle state manager then maintains the proper vehicle configuration during the reprogramming operation. The system and method can be used to automatically reprogram a vehicle ECU using new programming received by digital satellite broadcast or other wireless transmission to the vehicle.

A method and a device for recording data or for transmitting stimulation data, which are transmitted in Ethernet-based networks of vehicles, are disclosed in U.S. Patent Application Publication No. 2015/0071115 to Neff et al. entitled: “Data Logging or Stimulation in Automotive Ethernet Networks Using the Vehicle Infrastructure”, which is incorporated in its entirety for all purposes as if fully set forth herein. A method for recording data is described, wherein the data are transmitted from a transmitting control unit to a receiving control unit of a vehicle via a communication system of the vehicle. The communication system comprises an Ethernet network, wherein the data are conducted from a transmission component to a reception component of the Ethernet network via a transmission path, and wherein the data are to be recorded at a logging component of the Ethernet network, which does not lie on the transmission path. The method comprises the configuration of an intermediate component of the Ethernet network, which lies on the transmission path, to transmit a copy of the data as logging data to the logging component; and the recording of the logging data at the logging component.

Methods for allocating an address to an Electronic Control Unit (ECU) on an in-vehicle Ethernet network and devices therefor are disclosed in U.S. Patent Application Publication No. 2016/0308822 to Chae et al. entitled: “Method and system for providing optimized ethernet communication for vehicle”, which is incorporated in its entirety for all purposes as if fully set forth herein. A method may include allocating a first address value identifying the in-vehicle Ethernet network, allocating a second address value identifying a domain corresponding to the ECU, allocating a third address value identifying a group of ECUs in the allocated domain, allocating a fourth address value identifying the ECU in the group, and generating an IP address including the allocated first to fourth address values. The generated IP address is set as a fixed IP address of the ECU.

Communication methods in a divided vehicle network are disclosed in U.S. Patent Application Publication No. 2017/0250905 to Park et al. entitled: “Communication method in divided vehicle network”, which is incorporated in its entirety for all purposes as if fully set forth herein. An operation method of a first end node includes: generating a frame; and transmitting the frame to a switch connected to the first end node. A source internet protocol (IP) address of the frame is set to an IP address of the first end node, a destination IP address of the frame is set to an IP address of a second end node belonging to a second domain in the vehicle network, a source medium access control (MAC) address of the frame is set to a MAC address of the first end node, and a destination MAC address of the frame is set to a MAC address of a gateway supporting inter-domain communications.

A method for operating a switch device (3) of a motor vehicle communication network (2) is disclosed in PCT Application Publication No. WO 2016/134855 to Schmidt et al. entitled: “Motor vehicle communication network with switch device”, which is incorporated in its entirety for all purposes as if fully set forth herein. A device identifier (21) of a device (5) of the motor vehicle (1) is received at a first port (8). An authentication check is carried out on the basis of the device identifier (21). If the check result of the authentication check is positive, device (5) communication data (15) addressed to at least one additional device (4) of the motor vehicle (1) is received at the first port (8) and transmitted to the at least one additional device (4) in a first VLAN (16) of the communication network (2). If the check result is negative, the communication data (15) is rejected at the first port (8). A diagnosis request (23) for the device (5) is received at a second port (9) of the switch device (3) from a diagnosis device (10). Regardless of the check result, the diagnosis request (23) is forwarded to the device (5) via the first port (8) in a second VLAN (24) of the communication network (2).

A method and a filter system for filtering messages which are received, via a serial data bus of a communications network, in a communication module of a user connected to the data bus, is disclosed in U.S. Pat. No. 9,154,324 to Hartwich et al. entitled: “Method and filter system for filtering messages received via a serial data bus of a communication network by a user of the network”, which is incorporated in its entirety for all purposes as if fully set forth herein. To allow particularly simple and efficient filtering of incoming messages, even when there is a large number of filtering criteria, it is proposed that the filter system includes a list in which multiple identifier pairs are stored which define a range delimited in each case by a first identifier and a second identifier. The identifier for an incoming message is compared at least to selected identifier pairs from the list, and a query is made concerning whether the identifier for the incoming message is greater than, or greater than or equal to, the selected first identifier, and is less than, or less than or equal to, the selected second identifier. The incoming message is forwarded to the application or rejected, depending on the configuration bit specification, if the identifier for the incoming message is within the range delimited by the first identifier and the second identifier.

An apparatus for protecting a vehicle electronic system is disclosed in U.S. Patent Application Publication No. 2015/0020152 to Litichever et al. entitled: “Security system and method for protecting a vehicle electronic system”, which is incorporated in its entirety for all purposes as if fully set forth herein. The protecting is by selectively intervening in the communications path in order to prevent the arrival of malicious messages at ECUs, in particular at the safety critical ECUs. The security system includes a filter, which prevents illegal messages sent by any system or device communicating over a vehicle communications bus from reaching their destination. The filter may, at its discretion according to preconfigured rules, send messages as is, block messages, change the content of the messages, request authentication or limit the rate such messages can be delivered, by buffering the messages and sending them only in preconfigured intervals.

A mobile application on a mobile device communicates with a head-unit of a navigation system is disclosed in U.S. Pat. No. 8,762,059 to Balogh entitled: “Navigation system application for mobile device”, which is incorporated in its entirety for all purposes as if fully set forth herein. The mobile application may retrieve data such as map data, user input data, and other data and communicate the updates to the head unit. By retrieving map data through the mobile application, the head unit may be updated much easier than systems of the prior art. The data may be retrieved through cellular networks, Wi-Fi networks, or other networks which accessible to a user and compatible with the mobile device. Updates may be stored in the mobile device and automatically uploaded to the navigation system head unit when the user is in the vicinity of the head unit. The mobile application may establish a logical connection with one or more head units. The logical connection bounds the mobile application to the head unit and allows for data sharing and synchronization.

A multi-screen display device and program of the same is disclosed in U.S. Patent Application Publication No. 2009/0171529 to Hayatoma entitled: “Multi-screen display device and program of the same”, which is incorporated in its entirety for all purposes as if fully set forth herein. Any navigation device herein may be based on, or may comprise, the navigation system described therein. The multi display screen is constituted of a wide-screen displaying simultaneously two or more of a navigation search control screen setting necessary requirements to search for a route from a place of departure to a destination of a vehicle, a navigation map screen displaying the position of the vehicle on a map, a night vision screen recognizing an object on a road at night by infrared, a back guide monitor screen for recognizing a rear side of the vehicle, a blind corner monitor screen for recognizing an orthogonal direction of the vehicle, and a handsfree transmission/reception screen of a car phone. Screens to be displayed on the multi-display screen constituted of the wide screen is selected according to a vehicle driving state detected in a vehicle driving state detecting unit, and a display on the multi-display screen of a “screen 1”, a “screen 2”, and a “screen 3” constituted of the wide screen is determined according to the vehicle driving state detected in the vehicle driving state detecting unit.

An engine control device and method for use in a vehicle incorporating an internal combustion engine and a motor that are capable of transmitting motive power to an axle is disclosed in U.S. Patent Application Publication No. 2010/0280737 to Ewert et al. entitled: “Engine Control Device and Method for a Hybrid Vehicle”, which is incorporated in its entirety for all purposes as if fully set forth herein. The device has an engine utilization reduction portion configured to reduce the power supplied by the engine when a requested engine power is above a predefined engine power minimum value when the device is in a hybrid mode thereby increasing power provided by the electric motor. The device also may have a computer readable engine off portion configured to prevent the engine from starting or consuming fuel thereby causing the vehicle to be directionally powered by the electric motor only. The device may also have a warm up portion configured to operate the engine in warmup mode and limit the power supplied by the engine when the engine temperature is below a predefined engine operating temperature thereby reducing emissions during engine warmup.

A handsfree apparatus is disclosed in U.S. Patent Application Publication No. 2010/0210315 to Miyake entitled: “Handsfree Apparatus”, which is incorporated in its entirety for all purposes as if fully set forth herein. The apparatus notifies a user of the reception of a mail if the reception of the mail by a cellular phone happens during a call, and stores an unread history of the received mail in a memory unit if a mail content display operation is not performed. Further, the handsfree apparatus notifies the user of the unread history of the received mail when Bluetooth connection link to the cellular phone having received the mail is disconnected, thereby enabling the received mail to be recognized by the user.

A system and method for implementing cross-network synchronization of nodes on a vehicle bus is disclosed in U.S. Patent Application Publication No. 2012/0278507 to Menon et al. entitled: “Cross-network synchronization of application s/w execution using flexray global time”, which is incorporated in its entirety for all purposes as if fully set forth herein. The system and method include periodically sampling a notion of time from a first network, transmitting a message from the first network to a node on a second network, wherein the message includes the notion of time, and updating a local clock on the second network node based on the notion of time in the message.

Methods and devices supporting the management of a plurality of electronic devices and processing of update information for updating software and/or firmware in the electronic devices are disclosed in U.S. Patent Application Publication No. 2012/0210315 to Kapadekar et al. entitled: “Device management in a network”, which is incorporated in its entirety for all purposes as if fully set forth herein. Prompting of users may be made using a language associated with the electronic device, and authorization to update an electronic device may be secured using a subscriber identity module

An in-car information system that includes a portable information terminal and an in-car device is disclosed in U.S. Patent Application Publication No. 2013/0298052 to NARA et al. entitled: “In-Car Information System, Information Terminal, And Application Execution Method”, which is incorporated in its entirety for all purposes as if fully set forth herein. The information terminal identifies a specific application being executed in the foreground and transmits restriction information pertaining to the particular application to the in-car device. The in-car device either allows or disallows, based upon the restriction information transmitted from the information terminal, image display corresponding to the application being executed in the foreground and transmission of operation information corresponding to an input operation.

A vehicle control system that includes a display device located in a vehicle. The display device displays a plurality of display icons with one of the display icons representing an active display icon is disclosed in U.S. Patent Application Publication No. 2015/0378598 to Takeshi entitled: “Touch control panel for vehicle control system”, which is incorporated in its entirety for all purposes as if fully set forth herein. A touchpad is located in the vehicle remote from the display device. The touchpad provides virtual buttons corresponding to the display icons that have relative orientations corresponding to the display icons. The touchpad establishes a home location on the touchpad based on a location where a user of the vehicle touches the touchpad. The home location corresponds to the active display icon such that the virtual button representing the active display icon is located at the home location and the other virtual buttons are oriented about the home location.

A WiFi wireless rear view parking system comprises a main body, a camera sensor, a Wifi transmission module, a mobile personal electronics device, is disclosed in U.S. Patent Application Publication No. 2016/0127693 to Chung entitled: “WiFi Wireless Rear View Parking System”, which is incorporated in its entirety for all purposes as if fully set forth herein. The main body is installed at a license plate of an automobile. The camera sensor is provided in the main body for sensing images and video of rear regions of the automobile and generating images and video data. The Wifi transmission module transmits the image and video data from the camera. The mobile personal electronic device is for receiving image and video data transmitted by the Wifi transmission module and displaying them. The WiFi wireless rear view parking system provides rear view of the automobile to a driver. The mobile personal electronic device includes a smartphone.

Wireless. Any embodiment herein may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Any wireless network or wireless connection herein may be operating substantially in accordance with existing IEEE 802.11, 802.11a, 802.11b, 802.11g, 802.11k, 802.11n, 802.11r, 802.16, 802.16d, 802.16e, 802.20, 802.21 standards and/or future versions and/or derivatives of the above standards. Further, a network element (or a device) herein may consist of, be part of, or include, a cellular radio-telephone communication system, a cellular telephone, a wireless telephone, a Personal Communication Systems (PCS) device, a PDA device that incorporates a wireless communication device, or a mobile/portable Global Positioning System (GPS) device. Further, a wireless communication may be based on wireless technologies that are described in Chapter 20: “Wireless Technologies” of the publication number 1-587005-001-3 by Cisco Systems, Inc. (July 1999) entitled: “Internetworking Technologies Handbook”, which is incorporated in its entirety for all purposes as if fully set forth herein. Wireless technologies and networks are further described in a book published 2005 by Pearson Education, Inc. William Stallings [ISBN: 0-13-191835-4] entitled: “Wireless Communications and Networks—second Edition”, which is incorporated in its entirety for all purposes as if fully set forth herein.

Wireless networking typically employs an antenna (a.k.a. aerial), which is an electrical device that converts electric power into radio waves, and vice versa, connected to a wireless radio transceiver. In transmission, a radio transmitter supplies an electric current oscillating at radio frequency to the antenna terminals, and the antenna radiates the energy from the current as electromagnetic waves (radio waves). In reception, an antenna intercepts some of the power of an electromagnetic wave in order to produce a low voltage at its terminals that is applied to a receiver to be amplified. Typically an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna. Antennas can be designed to transmit and receive radio waves in all horizontal directions equally (omnidirectional antennas), or preferentially in a particular direction (directional or high gain antennas). In the latter case, an antenna may also include additional elements or surfaces with no electrical connection to the transmitter or receiver, such as parasitic elements, parabolic reflectors or horns, which serve to direct the radio waves into a beam or other desired radiation pattern.

ISM. The Industrial, Scientific and Medical (ISM) radio bands are radio bands (portions of the radio spectrum) reserved internationally for the use of radio frequency (RF) energy for industrial, scientific and medical purposes other than telecommunications. In general, communications equipment operating in these bands must tolerate any interference generated by ISM equipment, and users have no regulatory protection from ISM device operation. The ISM bands are defined by the ITU-R in 5.138, 5.150, and 5.280 of the Radio Regulations. Individual countries use of the bands designated in these sections may differ due to variations in national radio regulations. Because communication devices using the ISM bands must tolerate any interference from ISM equipment, unlicensed operations are typically permitted to use these bands, since unlicensed operation typically needs to be tolerant of interference from other devices anyway. The ISM bands share allocations with unlicensed and licensed operations; however, due to the high likelihood of harmful interference, licensed use of the bands is typically low. In the United States, uses of the ISM bands are governed by Part 18 of the Federal Communications Commission (FCC) rules, while Part 15 contains the rules for unlicensed communication devices, even those that share ISM frequencies. In Europe, the ETSI is responsible for governing ISM bands.

Commonly used ISM bands include a 2.45 GHz band (also known as 2.4 GHz band) that includes the frequency band between 2.400 GHz and 2.500 GHz, a 5.8 GHz band that includes the frequency band 5.725-5.875 GHz, a 24 GHz band that includes the frequency band 24.000-24.250 GHz, a 61 GHz band that includes the frequency band 61.000-61.500 GHz, a 122 GHz band that includes the frequency band 122.000-123.000 GHz, and a 244 GHz band that includes the frequency band 244.000-246.000 GHz.

ZigBee. ZigBee is a standard for a suite of high-level communication protocols using small, low-power digital radios based on an IEEE 802 standard for Personal Area Network (PAN). Applications include wireless light switches, electrical meters with in-home-displays, and other consumer and industrial equipment that require a short-range wireless transfer of data at relatively low rates. The technology defined by the ZigBee specification is intended to be simpler and less expensive than other WPANs, such as Bluetooth. ZigBee is targeted at Radio-Frequency (RF) applications that require a low data rate, long battery life, and secure networking. ZigBee has a defined rate of 250 kbps suited for periodic or intermittent data or a single signal transmission from a sensor or input device.

ZigBee builds upon the physical layer and medium access control defined in IEEE standard 802.15.4 (2003 version) for low-rate WPANs. The specification further discloses four main components: network layer, application layer, ZigBee Device Objects (ZDOs), and manufacturer-defined application objects, which allow for customization and favor total integration. The ZDOs are responsible for a number of tasks, which include keeping of device roles, management of requests to join a network, device discovery, and security. Because ZigBee nodes can go from a sleep to active mode in 30 ms or less, the latency can be low and devices can be responsive, particularly compared to Bluetooth wake-up delays, which are typically around three seconds. ZigBee nodes can sleep most of the time, thus the average power consumption can be lower, resulting in longer battery life.

There are three defined types of ZigBee devices: ZigBee Coordinator (ZC), ZigBee Router (ZR), and ZigBee End Device (ZED). ZigBee Coordinator (ZC) is the most capable device and forms the root of the network tree and might bridge to other networks. There is exactly one defined ZigBee coordinator in each network, since it is the device that started the network originally. It is able to store information about the network, including acting as the Trust Center & repository for security keys. ZigBee Router (ZR) may be running an application function as well as may be acting as an intermediate router, passing on data from other devices. ZigBee End Device (ZED) contains functionality to talk to a parent node (either the coordinator or a router). This relationship allows the node to be asleep a significant amount of the time, thereby giving long battery life. A ZED requires the least amount of memory, and therefore can be less expensive to manufacture than a ZR or ZC.

The protocols build on recent algorithmic research (Ad-hoc On-demand Distance Vector, neuRFon) to automatically construct a low-speed ad-hoc network of nodes. In most large network instances, the network will be a cluster of clusters. It can also form a mesh or a single cluster. The current ZigBee protocols support beacon and non-beacon enabled networks. In non-beacon-enabled networks, an unslotted CSMA/CA channel access mechanism is used. In this type of network, ZigBee Routers typically have their receivers continuously active, requiring a more robust power supply. However, this allows for heterogeneous networks in which some devices receive continuously, while others only transmit when an external stimulus is detected.

In beacon-enabled networks, the special network nodes called ZigBee Routers transmit periodic beacons to confirm their presence to other network nodes. Nodes may sleep between the beacons, thus lowering their duty cycle and extending their battery life. Beacon intervals depend on the data rate; they may range from 15.36 milliseconds to 251.65824 seconds at 250 Kbit/s, from 24 milliseconds to 393.216 seconds at 40 Kbit/s, and from 48 milliseconds to 786.432 seconds at 20 Kbit/s. In general, the ZigBee protocols minimize the time the radio is on to reduce power consumption. In beaconing networks, nodes only need to be active while a beacon is being transmitted. In non-beacon-enabled networks, power consumption is decidedly asymmetrical: some devices are always active while others spend most of their time sleeping.

Except for the Smart Energy Profile 2.0, current ZigBee devices conform to the IEEE 802.15.4-2003 Low-Rate Wireless Personal Area Network (LR-WPAN) standard. The standard specifies the lower protocol layers—the PHYsical layer (PHY), and the Media Access Control (MAC) portion of the Data Link Layer (DLL). The basic channel access mode is “Carrier Sense, Multiple Access/Collision Avoidance” (CSMA/CA), that is, the nodes talk in the same way that people converse; they briefly check to see that no one is talking before they start. There are three notable exceptions to the use of CSMA. Beacons are sent on a fixed time schedule, and do not use CSMA. Message acknowledgments also do not use CSMA. Finally, devices in Beacon Oriented networks that have low latency real-time requirement, may also use Guaranteed Time Slots (GTS), which by definition do not use CSMA.

Z-Wave. Z-Wave is a wireless communications protocol by the Z-Wave Alliance (http://www.z-wave.com) designed for home automation, specifically for remote control applications in residential and light commercial environments. The technology uses a low-power RF radio embedded or retrofitted into home electronics devices and systems, such as lighting, home access control, entertainment systems and household appliances. Z-Wave communicates using a low-power wireless technology designed specifically for remote control applications. Z-Wave operates in the sub-gigahertz frequency range, around 900 MHz. This band competes with some cordless telephones and other consumer electronics devices, but avoids interference with WiFi and other systems that operate on the crowded 2.4 GHz band. Z-Wave is designed to be easily embedded in consumer electronics products, including battery-operated devices such as remote controls, smoke alarms, and security sensors.

Z-Wave is a mesh networking technology where each node or device on the network is capable of sending and receiving control commands through walls or floors, and use intermediate nodes to route around household obstacles or radio dead spots that might occur in the home. Z-Wave devices can work individually or in groups, and can be programmed into scenes or events that trigger multiple devices, either automatically or via remote control. The Z-wave radio specifications include bandwidth of 9,600 bit/s or 40 Kbit/s, fully interoperable, GFSK modulation, and a range of approximately 100 feet (or 30 meters) assuming “open air” conditions, with reduced range indoors depending on building materials, etc. The Z-Wave radio uses the 900 MHz ISM band: 908.42 MHz (United States); 868.42 MHz (Europe); 919.82 MHz (Hong Kong); and 921.42 MHz (Australia/New Zealand).

Z-Wave uses a source-routed mesh network topology and has one or more master controllers that control routing and security. The devices can communicate to another by using intermediate nodes to actively route around, and circumvent household obstacles or radio dead spots that might occur. A message from node A to node C can be successfully delivered even if the two nodes are not within range, providing that a third node B can communicate with nodes A and C. If the preferred route is unavailable, the message originator will attempt other routes until a path is found to the “C” node. Therefore, a Z-Wave network can span much farther than the radio range of a single unit; however, with several of these hops, a delay may be introduced between the control command and the desired result. In order for Z-Wave units to be able to route unsolicited messages, they cannot be in sleep mode. Therefore, most battery-operated devices are not designed as repeater units. A Z-Wave network can consist of up to 232 devices with the option of bridging networks if more devices are required.

WWAN. Any wireless network herein may be a Wireless Wide Area Network (WWAN) such as a wireless broadband network, and the WWAN port may be an antenna and the WWAN transceiver may be a wireless modem. The wireless network may be a satellite network, the antenna may be a satellite antenna, and the wireless modem may be a satellite modem. The wireless network may be a WiMAX network such as according to, compatible with, or based on, IEEE 802.16-2009, the antenna may be a WiMAX antenna, and the wireless modem may be a WiMAX modem. The wireless network may be a cellular telephone network, the antenna may be a cellular antenna, and the wireless modem may be a cellular modem. The cellular telephone network may be a Third Generation (3G) network, and may use UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network and may use or be compatible with HSPA+, Mobile WiMAX, LTE, LTE-Advanced, MBWA, or may be compatible with, or based on, IEEE 802.20-2008.

WLAN. Wireless Local Area Network (WLAN), is a popular wireless technology that makes use of the Industrial, Scientific and Medical (ISM) frequency spectrum. In the US, three of the bands within the ISM spectrum are the A band, 902-928 MHz; the B band, 2.4-2.484 GHz (a.k.a. 2.4 GHz); and the C band, 5.725-5.875 GHz (a.k.a. 5 GHz). Overlapping and/or similar bands are used in different regions such as Europe and Japan. In order to allow interoperability between equipment manufactured by different vendors, few WLAN standards have evolved, as part of the IEEE 802.11 standard group, branded as WiFi (www.wi-fi.org). IEEE 802.11b describes a communication using the 2.4 GHz frequency band and supporting communication rate of 11 Mb/s, IEEE 802.11a uses the 5 GHz frequency band to carry 54 MB/s and IEEE 802.11g uses the 2.4 GHz band to support 54 Mb/s. The WiFi technology is further described in a publication entitled: “WiFi Technology” by Telecom Regulatory Authority, published on July 2003, which is incorporated in its entirety for all purposes as if fully set forth herein. The IEEE 802 defines an ad-hoc connection between two or more devices without using a wireless access point: the devices communicate directly when in range. An ad hoc network offers peer-to-peer layout and is commonly used in situations such as a quick data exchange or a multiplayer LAN game, because the setup is easy and an access point is not required.

A node/client with a WLAN interface is commonly referred to as STA (Wireless Station/Wireless client). The STA functionality may be embedded as part of the data unit, or alternatively be a dedicated unit, referred to as bridge, coupled to the data unit. While STAs may communicate without any additional hardware (ad-hoc mode), such network usually involves Wireless Access Point (a.k.a. WAP or AP) as a mediation device. The WAP implements the Basic Stations Set (BSS) and/or ad-hoc mode based on Independent BSS (IBSS). STA, client, bridge and WAP will be collectively referred to hereon as WLAN unit. Bandwidth allocation for IEEE 802.11g wireless in the U.S. allows multiple communication sessions to take place simultaneously, where eleven overlapping channels are defined spaced 5 MHz apart, spanning from 2412 MHz as the center frequency for channel number 1, via channel 2 centered at 2417 MHz and 2457 MHz as the center frequency for channel number 10, up to channel 11 centered at 2462 MHz. Each channel bandwidth is 22 MHz, symmetrically (+/−11 MHz) located around the center frequency. In the transmission path, first the baseband signal (IF) is generated based on the data to be transmitted, using 256 QAM (Quadrature Amplitude Modulation) based OFDM (Orthogonal Frequency Division Multiplexing) modulation technique, resulting a 22 MHz (single channel wide) frequency band signal. The signal is then up converted to the 2.4 GHz (RF) and placed in the center frequency of required channel, and transmitted to the air via the antenna. Similarly, the receiving path comprises a received channel in the RF spectrum, down converted to the baseband (IF) wherein the data is then extracted.

In order to support multiple devices and using a permanent solution, a Wireless Access Point (WAP) is typically used. A Wireless Access Point (WAP, or Access Point—AP) is a device that allows wireless devices to connect to a wired network using Wi-Fi, or related standards. The WAP usually connects to a router (via a wired network) as a standalone device, but can also be an integral component of the router itself. Using Wireless Access Point (AP) allows users to add devices that access the network with little or no cables. A WAP normally connects directly to a wired Ethernet connection, and the AP then provides wireless connections using radio frequency links for other devices to utilize that wired connection. Most APs support the connection of multiple wireless devices to one wired connection. Wireless access typically involves special security considerations, since any device within a range of the WAP can attach to the network. The most common solution is wireless traffic encryption. Modern access points come with built-in encryption such as Wired Equivalent Privacy (WEP) and Wi-Fi Protected Access (WPA), typically used with a password or a passphrase. Authentication in general, and a WAP authentication in particular, is used as the basis for authorization, which determines whether a privilege may be granted to a particular user or process, privacy, which keeps information from becoming known to non-participants, and non-repudiation, which is the inability to deny having done something that was authorized to be done based on the authentication. An authentication in general, and a WAP authentication in particular, may use an authentication server that provides a network service that applications may use to authenticate the credentials, usually account names and passwords of their users. When a client submits a valid set of credentials, it receives a cryptographic ticket that it can subsequently be used to access various services. Authentication algorithms include passwords, Kerberos, and public key encryption.

Prior art technologies for data networking may be based on single carrier modulation techniques, such as AM (Amplitude Modulation), FM (Frequency Modulation), and PM (Phase Modulation), as well as bit encoding techniques such as QAM (Quadrature Amplitude Modulation) and QPSK (Quadrature Phase Shift Keying). Spread spectrum technologies, to include both DSSS (Direct Sequence Spread Spectrum) and FHSS (Frequency Hopping Spread Spectrum) are known in the art. Spread spectrum commonly employs Multi-Carrier Modulation (MCM) such as OFDM (Orthogonal Frequency Division Multiplexing). OFDM and other spread spectrum are commonly used in wireless communication systems, particularly in WLAN networks.

Bluetooth. Bluetooth is a wireless technology standard for exchanging data over short distances (using short-wavelength UHF radio waves in the ISM band from 2.4 to 2.485 GHz) from fixed and mobile devices, and building personal area networks (PANs). It can connect several devices, overcoming problems of synchronization. A Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein. Any Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein.

Bluetooth operates at frequencies between 2402 and 2480 MHz, or 2400 and 2483.5 MHz including guard bands 2 MHz wide at the bottom end and 3.5 MHz wide at the top. This is in the globally unlicensed (but not unregulated) Industrial, Scientific and Medical (ISM) 2.4 GHz short-range radio frequency band. Bluetooth uses a radio technology called frequency-hopping spread spectrum. Bluetooth divides transmitted data into packets, and transmits each packet on one of 79 designated Bluetooth channels. Each channel has a bandwidth of 1 MHz. It usually performs 800 hops per second, with Adaptive Frequency-Hopping (AFH) enabled. Bluetooth low energy uses 2 MHz spacing, which accommodates 40 channels. Bluetooth is a packet-based protocol with a master-slave structure. One master may communicate with up to seven slaves in a piconet. All devices share the master's clock. Packet exchange is based on the basic clock, defined by the master, which ticks at 312.5 μs intervals. Two clock ticks make up a slot of 625 μs, and two slots make up a slot pair of 1250 μs. In the simple case of single-slot packets the master transmits in even slots and receives in odd slots. The slave, conversely, receives in even slots and transmits in odd slots. Packets may be 1, 3 or 5 slots long, but in all cases the master's transmission begins in even slots and the slave's in odd slots.

A master Bluetooth device can communicate with a maximum of seven devices in a piconet (an ad-hoc computer network using Bluetooth technology), though not all devices reach this maximum. The devices can switch roles, by agreement, and the slave can become the master (for example, a headset initiating a connection to a phone necessarily begins as master—as initiator of the connection—but may subsequently operate as slave). The Bluetooth Core Specification provides for the connection of two or more piconets to form a scatternet, in which certain devices simultaneously play the master role in one piconet and the slave role in another. At any given time, data can be transferred between the master and one other device (except for the little-used broadcast mode). The master chooses which slave device to address; typically, it switches rapidly from one device to another in a round-robin fashion. Since it is the master that chooses which slave to address, whereas a slave is supposed to listen in each receive slot, being a master is a lighter burden than being a slave. Being a master of seven slaves is possible; being a slave of more than one master is difficult.

Bluetooth Low Energy. Bluetooth low energy (Bluetooth LE, BLE, marketed as Bluetooth Smart) is a wireless personal area network technology designed and marketed by the Bluetooth Special Interest Group (SIG) aimed at novel applications in the healthcare, fitness, beacons, security, and home entertainment industries. Compared to Classic Bluetooth, Bluetooth Smart is intended to provide considerably reduced power consumption and cost while maintaining a similar communication range. Bluetooth low energy is described in a Bluetooth SIG published Dec. 2, 2014 standard Covered Core Package version: 4.2, entitled: “Master Table of Contents & Compliance Requirements—Specification Volume 0”, and in an article published 2012 in Sensors [ISSN 1424-8220] by Caries Gomez et al. [Sensors 2012, 12, 11734-11753; doi:10.3390/s120211734] entitled: “Overview and Evaluation of Bluetooth Low Energy: An Emerging Low-Power Wireless Technology”, which are both incorporated in their entirety for all purposes as if fully set forth herein.

Bluetooth Smart technology operates in the same spectrum range (the 2.400 GHz-2.4835 GHz ISM band) as Classic Bluetooth technology, but uses a different set of channels. Instead of the Classic Bluetooth 79 1-MHz channels, Bluetooth Smart has 40 2-MHz channels. Within a channel, data is transmitted using Gaussian frequency shift modulation, similar to Classic Bluetooth's Basic Rate scheme. The bit rate is 1 Mbit/s, and the maximum transmit power is 10 mW. Bluetooth Smart uses frequency hopping to counteract narrowband interference problems. Classic Bluetooth also uses frequency hopping but the details are different; as a result, while both FCC and ETSI classify Bluetooth technology as an FHSS scheme, Bluetooth Smart is classified as a system using digital modulation techniques or a direct-sequence spread spectrum. All Bluetooth Smart devices use the Generic Attribute Profile (GATT). The application programming interface offered by a Bluetooth Smart aware operating system will typically be based around GATT concepts.

Cellular. Cellular telephone network may be according to, compatible with, or may be based on, a Third Generation (3G) network that uses UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network that uses HSPA+, Mobile WiMAX, LTE, LTE-Advanced, MBWA, or may be based on or compatible with IEEE 802.20-2008.

DSRC. Dedicated Short-Range Communication (DSRC) is a one-way or two-way short-range to medium-range wireless communication channels specifically designed for automotive use and a corresponding set of protocols and standards. DSRC is a two-way short-to-medium range wireless communications capability that permits very high data transmission critical in communications-based active safety applications. In Report and Order FCC-03-324, the Federal Communications Commission (FCC) allocated 75 MHz of spectrum in the 5.9 GHz band for use by intelligent transportations systems (ITS) vehicle safety and mobility applications. DSRC serves a short to medium range (1000 meters) communications service and supports both public safety and private operations in roadside-to-vehicle and vehicle-to-vehicle communication environments by providing very high data transfer rates where minimizing latency in the communication link and isolating relatively small communication zones is important. DSRC transportation applications for Public Safety and Traffic Management include Blind spot warnings, Forward collision warnings, Sudden braking ahead warnings, Do not pass warnings, Intersection collision avoidance and movement assistance, Approaching emergency vehicle warning, Vehicle safety inspection, Transit or emergency vehicle signal priority, Electronic parking and toll payments, Commercial vehicle clearance and safety inspections, In-vehicle signing, Rollover warning, and Traffic and travel condition data to improve traveler information and maintenance services.

The European standardization organization European Committee for Standardization (CEN), sometimes in co-operation with the International Organization for Standardization (ISO) developed some DSRC standards: EN 12253:2004 Dedicated Short-Range Communication—Physical layer using microwave at 5.8 GHz (review), EN 12795:2002 Dedicated Short-Range Communication (DSRC)—DSRC Data link layer: Medium Access and Logical Link Control (review), EN 12834:2002 Dedicated Short-Range Communication—Application layer (review), EN 13372:2004 Dedicated Short-Range Communication (DSRC)—DSRC profiles for RTTT applications (review), and EN ISO 14906:2004 Electronic Fee Collection—Application interface. An overview of the DSRC/WAVE technologies is described in a paper by Yunxin (Jeff) Li (Eveleigh, NSW 2015, Australia) downloaded from the Internet on July 2017, entitled: “An Overview of the DSRC/WAVE Technology”, and the DSRC is further standardized as ARIB STD—T75 VERSION 1.0, published September 2001 by Association of Radio Industries and Businesses Kasumigaseki, Chiyoda-ku, Tokyo 100-0013, Japan, entitled: “DEDICATED SHORT-RANGE COMMUNICATION SYSTEM—ARIB STANDARD Version 1.0”, which are both incorporated in their entirety for all purposes as if fully set forth herein.

IEEE 802.11p. The IEEE 802.11p standard is an example of DSRC and is a published standard entitled: “Part 11: Wireless LAN Medium Access Control (MAC) and Physical Layer (PHY) Specifications Amendment 6: Wireless Access in Vehicular Environments”, that adds wireless access in vehicular environments (WAVE), a vehicular communication system, for supporting Intelligent Transportation Systems (ITS) applications. It includes data exchange between high-speed vehicles and between the vehicles and the roadside infrastructure, so called V2X communication, in the licensed ITS band of 5.9 GHz (5.85-5.925 GHz). IEEE 1609 is a higher layer standard based on the IEEE 802.11p, and is also the base of a European standard for vehicular communication known as ETSI ITS-G5.2. The Wireless Access in Vehicular Environments (WAVE/DSRC) architecture and services necessary for multi-channel DSRC/WAVE devices to communicate in a mobile vehicular environment is described in the family of IEEE 1609 standards, such as IEEE 1609.1-2006 Resource Manager, IEEE Std 1609.2 Security Services for Applications and Management Messages, IEEE Std 1609.3 Networking Services, IEEE Std 1609.4 Multi-Channel Operation IEEE Std 1609.5 Communications Manager, as well as IEEE P802.11p Amendment: “Wireless Access in Vehicular Environments”.

As the communication link between the vehicles and the roadside infrastructure might exist for only a short amount of time, the IEEE 802.11p amendment defines a way to exchange data through that link without the need to establish a Basic Service Set (BSS), and thus, without the need to wait for the association and authentication procedures to complete before exchanging data. For that purpose, IEEE 802.11p enabled stations use the wildcard BSSID (a value of all 1s) in the header of the frames they exchange, and may start sending and receiving data frames as soon as they arrive on the communication channel. Because such stations are neither associated nor authenticated, the authentication and data confidentiality mechanisms provided by the IEEE 802.11 standard (and its amendments) cannot be used. These kinds of functionality must then be provided by higher network layers. IEEE 802.11p standard uses channels within the 75 MHz bandwidth in the 5.9 GHz band (5.850-5.925 GHz). This is half the bandwidth, or double the transmission time for a specific data symbol, as used in 802.11a. This allows the receiver to better cope with the characteristics of the radio channel in vehicular communications environments, e.g., the signal echoes reflected from other cars or houses.

An Operating System (OS) is software that manages computer hardware resources and provides common services for computer programs. The operating system is an essential component of any system software in a computer system, and most application programs usually require an operating system to function. For hardware functions such as input and output and memory allocation, the operating system acts as an intermediary between programs and the computer hardware, although the application code is usually executed directly by the hardware and will frequently make a system call to an OS function or be interrupted by it. Common features typically supported by operating systems include process management, interrupts handling, memory management, file system, device drivers, networking (such as TCP/IP and UDP), and Input/Output (I/O) handling. Examples of popular modern operating systems include Android, BSD, iOS, Linux, OS X, QNX, Microsoft Windows, Windows Phone, and IBM z/OS.

A server device (in server/client architecture) typically offers information resources, services, and applications to clients, and is using a server dedicated or oriented operating system.

Current popular server operating systems are based on Microsoft Windows (by Microsoft Corporation, headquartered in Redmond, Wash., U.S.A.), Unix, and Linux-based solutions, such as the ‘Windows Server 2012’ server operating system is part of the Microsoft ‘Windows Server’ OS family, that was released by Microsoft on 2012, providing enterprise-class datacenter and hybrid cloud solutions that are simple to deploy, cost-effective, application-focused, and user-centric, and is described in Microsoft publication entitled: “Inside-Out Windows Server 2012”, by William R. Stanek, published 2013 by Microsoft Press, which is incorporated in its entirety for all purposes as if fully set forth herein.

Unix operating systems are widely used in servers. Unix is a multitasking, multiuser computer operating system that exists in many variants, and is characterized by a modular design that is sometimes called the “Unix philosophy,” meaning the OS provides a set of simple tools that each perform a limited, well-defined function, with a unified filesystem as the main means of communication, and a shell scripting and command language to combine the tools to perform complex workflows. Unix was designed to be portable, multi-tasking and multi-user in a time-sharing configuration, and Unix systems are characterized by various concepts: the use of plain text for storing data; a hierarchical file system; treating devices and certain types of Inter-Process Communication (IPC) as files; and the use of a large number of software tools, small programs that can be strung together through a command line interpreter using pipes, as opposed to using a single monolithic program that includes all of the same functionality. Under Unix, the operating system consists of many utilities along with the master control program, the kernel. The kernel provides services to start and stop programs, handles the file system and other common “low level” tasks that most programs share, and schedules access to avoid conflicts when programs try to access the same resource or device simultaneously. To mediate such access, the kernel has special rights, reflected in the division between user-space and kernel-space. Unix is described in a publication entitled: “UNIX Tutorial” by tutorialspoint.com, downloaded on July 2014, which is incorporated in its entirety for all purposes as if fully set forth herein.

A client device (in server/client architecture) typically receives information resources, services, and applications from servers, and is using a client dedicated or oriented operating system. Current popular server operating systems are based on Microsoft Windows (by Microsoft Corporation, headquartered in Redmond, Wash., U.S.A.), which is a series of graphical interface operating systems developed, marketed, and sold by Microsoft. Microsoft Windows is described in Microsoft publications entitled: “Windows Internals—Part 1” and “Windows Internals—Part 2”, by Mark Russinovich, David A. Solomon, and Alex Ioescu, published by Microsoft Press in 2012, which are both incorporated in their entirety for all purposes as if fully set forth herein. Windows 8 is a personal computer operating system developed by Microsoft as part of Windows NT family of operating systems, that was released for general availability on October 2012, and is described in Microsoft Press 2012 publication entitled: “Introducing Windows 8—An Overview for IT Professionals” by Jerry Honeycutt, which is incorporated in its entirety for all purposes as if fully set forth herein.

Chrome OS is a Linux kernel-based operating system designed by Google Inc. out of Mountain View, Calif., U.S.A., to work primarily with web applications. The user interface takes a minimalist approach and consists almost entirely of just the Google Chrome web browser; since the operating system is aimed at users who spend most of their computer time on the Web, the only “native” applications on Chrome OS are a browser, media player and file manager, and hence the Chrome OS is almost a pure web thin client OS.

The Chrome OS is described as including a three-tier architecture: firmware, browser and window manager, and system-level software and userland services. The firmware contributes to fast boot time by not probing for hardware, such as floppy disk drives, that are no longer common on computers, especially netbooks. The firmware also contributes to security by verifying each step in the boot process and incorporating system recovery. The system-level software includes the Linux kernel that has been patched to improve boot performance. The userland software has been trimmed to essentials, with management by Upstart, which can launch services in parallel, re-spawn crashed jobs, and defer services in the interest of faster booting. The Chrome OS user guide is described in the Samsung Electronics Co., Ltd. presentation entitled: “Google™ Chrome OS USER GUIDE” published 2011, which is incorporated in its entirety for all purposes as if fully set forth herein.

Multicast. In computer networking, multicast is group communication where data transmission is addressed to a group of destination computers simultaneously. Multicast can be one-to-many or many-to-many distribution. Group communication may either be application layer multicast or network assisted multicast, where the latter makes it possible for the source to efficiently send to the group in a single transmission. Copies are automatically created in other network elements, such as routers, switches, and cellular network base stations, but only to network segments that currently contain members of the group. Network assisted multicast may be implemented at the data link layer using one-to-many addressing and switching such as Ethernet multicast addressing, Asynchronous Transfer Mode (ATM), point-to-multipoint virtual circuits (P2MP) or Infiniband multicast. Network assisted multicast may also be implemented at the Internet layer using IP multicast. In IP multicast the implementation of the multicast concept occurs at the IP routing level, where routers create optimal distribution paths for datagrams sent to a multicast destination address. Multicast is often employed in Internet Protocol (IP) applications of streaming media, such as IPTV and multipoint videoconferencing.

IP multicast is a method of sending Internet Protocol (IP) datagrams to a group of interested receivers in a single transmission. It is a form of point-to-multipoint communication employed for streaming media and other applications on the Internet and private networks. IP multicast is the IP-specific version of the general concept of multicast networking. It uses specially reserved multicast address blocks in IPv4 and IPv6. Protocols associated with IP multicast include Internet Group Management Protocol, Protocol Independent Multicast and Multicast VLAN Registration. IGMP snooping is used to manage IP multicast traffic on layer-2 networks, and IP multicast is described in IETF RFC 1112, and its specifications have been augmented in IETF RFC 4604 to include group management and in IETF RFC 5771 to include administratively scoped addresses.

Broadcast. A broadcast address is a logical address at which all devices connected to a multiple-access communications network are enabled to receive datagrams. A message sent to a broadcast address may be received by all network-attached hosts. In Internet Protocol version 4 (IPv4) networks, broadcast addresses are special values in the host-identification part of an IP address. The all-ones value was established in IETF RFC 919 as the standard broadcast address for networks that support broadcast. The broadcast address for an IPv4 host can be obtained by performing a bitwise OR operation between the bit complement of the subnet mask and the host's IP address. In other words, take the host's IP address, and set to ‘1’ any bit positions which hold a ‘0’ in the subnet mask. For broadcasting a packet to an entire IPv4 subnet using the private IP address space 172.16.0.0/12, which has the subnet mask 255.240.0.0, the broadcast address is 172.16.0.0|0.15.255.255=172.31.255.255. A special definition exists for the IP broadcast address 255.255.255.255. It is the broadcast address of the zero network or 0.0.0.0, which in Internet Protocol standards stands for this network, i.e. the local network. Transmission to this address is limited by definition, in that it is never forwarded by the routers connecting the local network to other networks. IP broadcasts are used by BOOTP and DHCP clients to find and send requests to their respective servers. Internet Protocol version 6 (IPv6) does not implement the method of broadcast, and therefore does not define broadcast addresses. Instead, IPv6 uses multicast addressing to the all-hosts multicast group. No IPv6 protocols are defined to use the all-hosts address, though; instead, they send and receive on particular link-local multicast addresses. This results in higher efficiency, because network hosts which are not listening for the particular multicast protocol(s) in use are not disturbed or interrupted, as they would be by broadcasts.

Broadcast is possible also on the underlying Data Link Layer in Ethernet networks. Frames are addressed to reach every computer on a given LAN segment if they are addressed to MAC address FF:FF:FF:FF:FF:FF. Ethernet frames that contain IP broadcast packages are usually sent to this address. Ethernet broadcasts are used by Address Resolution Protocol and Neighbor Discovery Protocol to translate IP addresses to MAC addresses.

Smartphone. A mobile phone (also known as a cellular phone, cell phone, smartphone, or hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones are typically hand-held and may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi, and mobile broadband access. In addition to telephony, the Smartphones may support a wide variety of other services such as text messaging, MMS, email, Internet access, short-range wireless communications (infrared, Bluetooth), business applications, gaming and photography.

An example of a contemporary smartphone is model iPhone 6 available from Apple Inc., headquartered in Cupertino, Calif., U.S.A. and described in iPhone 6 technical specification (retrieved October 2015 from www.apple.com/iphone-6/specs/), and in a User Guide dated 2015 (019-00155/2015-06) by Apple Inc. entitled: “iPhone User Guide For iOS 8.4 Software”, which are both incorporated in their entirety for all purposes as if fully set forth herein. Another example of a smartphone is Samsung Galaxy S6 available from Samsung Electronics headquartered in Suwon, South-Korea, described in the user manual numbered English (EU), March 2015 (Rev. 1.0) entitled: “SM-G925F SM-G925FQ SM-G925I User Manual” and having features and specification described in “Galaxy S6 Edge—Technical Specification” (retrieved October 2015 from www.samsung.com/us/explore/galaxy-s-6-features-and-specs), which are both incorporated in their entirety for all purposes as if fully set forth herein.

Android is an open source and Linux-based mobile operating system (OS) based on the Linux kernel that is currently offered by Google. With a user interface based on direct manipulation, Android is designed primarily for touchscreen mobile devices such as smartphones and tablet computers, with specialized user interfaces for televisions (Android TV), cars (Android Auto), and wrist watches (Android Wear). The OS uses touch inputs that loosely correspond to real-world actions, such as swiping, tapping, pinching, and reverse pinching to manipulate on-screen objects, and a virtual keyboard. Despite being primarily designed for touchscreen input, it also has been used in game consoles, digital cameras, and other electronics. The response to user input is designed to be immediate and provides a fluid touch interface, often using the vibration capabilities of the device to provide haptic feedback to the user. Internal hardware such as accelerometers, gyroscopes and proximity sensors are used by some applications to respond to additional user actions, for example, adjusting the screen from portrait to landscape depending on how the device is oriented, or allowing the user to steer a vehicle in a racing game by rotating the device by simulating control of a steering wheel.

Android devices boot to the homescreen, the primary navigation and information point on the device, which is similar to the desktop found on PCs. Android homescreens are typically made up of app icons and widgets; app icons launch the associated app, whereas widgets display live, auto-updating content such as the weather forecast, the user's email inbox, or a news ticker directly on the homescreen. A homescreen may be made up of several pages that the user can swipe back and forth between, though Android's homescreen interface is heavily customizable, allowing the user to adjust the look and feel of the device to their tastes. Third-party apps available on Google Play and other app stores can extensively re-theme the homescreen, and even mimic the look of other operating systems, such as Windows Phone. The Android OS is described in a publication entitled: “Android Tutorial”, downloaded from tutorialspoint.com on July 2014, which is incorporated in its entirety for all purposes as if fully set forth herein.

iOS (previously iPhone OS) from Apple Inc. (headquartered in Cupertino, Calif., U.S.A.) is a mobile operating system distributed exclusively for Apple hardware. The user interface of the iOS is based on the concept of direct manipulation, using multi-touch gestures. Interface control elements consist of sliders, switches, and buttons. Interaction with the OS includes gestures such as swipe, tap, pinch, and reverse pinch, all of which have specific definitions within the context of the iOS operating system and its multi-touch interface. Internal accelerometers are used by some applications to respond to shaking the device (one common result is the undo command) or rotating it in three dimensions (one common result is switching from portrait to landscape mode). The iOS OS is described in a publication entitled: “IOS Tutorial”, downloaded from tutorialspoint.com on July 2014, which is incorporated in its entirety for all purposes as if fully set forth herein.

Physical layer. The Open Systems Interconnection (OSI) model, which is defined by the International Organization for Standardization (ISO) and is maintained by the identification ISO/IEC 7498-1, includes seven-layers. The physical layer or layer 1 is the first and lowest layer. The physical layer consists of the basic networking hardware for transmission technologies of a network. It is a fundamental layer underlying the logical data structures of the higher level functions in a network. The physical layer defines the electrical and physical specifications of the data connection. It defines the relationship between a device and a physical transmission medium (e.g., a copper or fiber optical cable and radio frequency). This includes the layout of pins, voltages, line impedance, cable specifications, signal timing and similar characteristics for connected devices and frequency (5 GHz or 2.4 GHz etc.) for wireless devices. It is responsible for transmission and reception of unstructured raw data in a physical medium. It may define transmission mode as simplex, half-duplex, and full duplex. It further defines the network topology as bus, mesh, or ring being some of the most common.

The physical layer defines the means of transmitting raw bits rather than logical data packets over a physical link connecting network nodes. The bit stream may be grouped into code words or symbols and converted to a physical signal that is transmitted over a hardware transmission medium. The physical layer provides an electrical, mechanical, and procedural interface to the transmission medium. The major functions and services performed by the physical layer are bit-by-bit or symbol-by-symbol delivery, providing a standardized interface to physical transmission media, including mechanical specification of electrical connectors and cables, for example maximum cable length, electrical specification of transmission line signal level and impedance, radio interface, including electromagnetic spectrum frequency allocation and specification of signal strength, analog bandwidth, modulation, line coding, bit synchronization in synchronous serial communication, start-stop signaling and flow control in asynchronous serial communication, circuit switching, multiplexing, establishment and termination of circuit switched connections, carrier sense and collision detection (utilized by some level 2 multiple access protocols), equalization filtering, training sequences, pulse shaping and other signal processing of physical signals, forward error correction, bit-interleaving and other channel coding. The physical layer is also concerned with bit rate, point-to-point, multipoint or point-to-multipoint line configuration, physical network topology, for example bus, ring, mesh or star network, serial or parallel communication, simplex, half duplex or full duplex transmission mode, and auto-negotiation.

Medium. In a communication network, multiple devices or stations that implement some part of the communication protocol are communicating over a transmission medium, which is a transmission path along which a signal propagates, such as a wire pair, coaxial cable, waveguide, optical fiber, or radio path. Such a medium may include any material substance, such as fiber-optic cable, twisted-wire pair, coaxial cable, dielectric-slab waveguide, water, and air, which can be used for the propagation of signals, usually in the form of modulated radio, light, or acoustic waves, from one point to another. A free space is typically also considered as a transmission medium for electromagnetic waves, although it is not a material medium. A medium that consists of a specialized cable or other structure designed to carry alternating current of radio frequency, that is, currents with a frequency high enough that their wave nature must be taken into account, is referred to as a transmission line. Transmission lines are commonly used for purposes such as connecting radio transmitters and receivers with their antennas.

The transfer of information such as the digital data between two nodes in a network commonly makes use of a line driver for transmitting the signal to the conductors serving as the transmission medium connecting the two nodes, and a line receiver for receiving the transmitted signal from the transmission medium. The communication may use a proprietary interface or preferably an industry standard, which typically defines the electrical signal characteristics such as voltage level, signaling rate, timing and slew rate of signals, voltage withstanding levels, short-circuit behavior, and maximum load capacitance. Further, the industry standard may define the interface mechanical characteristics such as the pluggable connectors and pin identification and pin-out. In one example, the module circuit can use an industry or other standard used for interfacing serial binary data signals. Preferably, the line drivers, the line receivers, and their associated circuitry will be protected against Electro-Static Discharge (ESD), electromagnetic interference (EMI/EMC) and against faults (fault-protected), and employs proper termination, failsafe scheme and supports live insertion. Preferably, a point-to-point connection scheme is used, wherein a single line driver is communicating with a single line receiver. However, multi-drop or multi-point configurations may as well be used. Further, the line driver and the line receiver may be integrated into a single IC (Integrated Circuit), commonly known as transceiver IC. A device that transmits data to a medium typically uses a line driver, which commonly includes an electronic amplifier as part of a circuit designed for a load such as a transmission line, and preferably optimized to the medium used. The output impedance of the amplifier typically matches the characteristic impedance of the transmission line. The line driver typically converts the logic levels used by the module internal digital logic circuits (e.g., CMOS, TTL, LSTTL and HCMOS) to a signal to be transmitted over the medium. At the receiving device, a line receiver is used which typically converts the received signal to the logic levels used by the module internal digital logic circuits (e.g., CMOS, TTL, LSTTL and HCMOS). A set of a line driver and a line receiver is commonly referred to as, or is part of, a transceiver (transmitter+receiver), and is used in nodes that both transmits digital data to the medium and receives digital data from the medium. In the case where the signal over the medium is modulated, a modem (a MOdulator-DEModulator) device is used, which encodes digital information onto an analog carrier signal by varying their amplitude, frequency, or phase of that carrier. The demodulator extracts digital information from a similarly modified carrier. A modem transforms digital signals into a form suitable for transmission over an analog medium.

Wire. An electrical wire is a single, usually cylindrical, flexible strand or rod of metal, typically for carrying electricity and telecommunications signals. Wire is commonly formed by drawing the metal through a hole in a die or draw plate, and wire gauges come in various standard sizes, as expressed in terms of a gauge number. Wire comes in solid core, stranded, or braided forms. Although usually circular in cross-section, wire can be made in square, hexagonal, flattened rectangular, or other cross-sections, either for decorative purposes, or for technical purposes such as high-efficiency voice coils in loudspeakers. A wire pair consists of two like conductors employed to form or serve an electric circuit.

Cable. An electrical cable is an assembly of one or more insulated conductors, or optical fibers, or a combination of both, within an enveloping jacket, where the conductors or fibers may be used singly or in groups. A typical electrical cable is made of two or more wires running side by side and bonded, twisted, or braided together to form a single assembly, the ends of which can be connected to two devices, enabling the transfer of electrical signals from one device to the other.

Wireline. Wireline or wired network uses conductors, typically metallic wire conductors, as the transmission medium. The transmission mediums used in common wirelines include twisted-pair, coaxial cable, stripline, and microstrip. Microstrip is a type of electrical transmission line, which can be fabricated using printed circuit board technology, and is used to convey microwave-frequency signals. It consists of a conducting strip separated from a ground plane by a dielectric layer known as the substrate. Microwave components such as antennas, couplers, filters, power dividers etc. can be formed from microstrip, with the entire device existing as the pattern of metallization on the substrate. A stripline circuit uses a flat strip of metal, which is sandwiched between two parallel ground planes, where the insulating material of the substrate forms a dielectric. The width of the strip, the thickness of the substrate and the relative permittivity of the substrate determine the characteristic impedance of the strip, which is a transmission line. Various cables are described in “Technical Handbook & Catalog” Twelfth Edition published 2006 by Standard Wire & Cable Co., which is incorporated in its entirety for all purposes as if fully set forth herein.

Topology. A wired network is defined by the specific physical arrangement of the elements (nodes) connected to a network, although the networks may differ in physical interconnections, distances between nodes, transmission rates, and/or signal types. Network topology is the arrangement of the various elements (links, nodes, etc.) of a computer network. Essentially, it is the topological structure of a network and may be depicted physically or logically. Physical topology is the placement of the various components of a network, including device location and cable installation, while logical topology illustrates how data flows within a network, regardless of its physical design. Distances between nodes, physical interconnections, transmission rates, or signal types may differ between two networks, yet their topologies may be identical. Traditionally, eight basic topologies are identified: point-to-point, bus, star, ring or circular, mesh, tree, hybrid, and daisy chain.

A point-to-point topology is a configuration where there are only nodes connected over a dedicated medium. In a bus topology (also known as linear topology), all nodes, i.e., stations, are connected together by a single medium. A fully connected topology (also known as fully connected mesh network), there is a direct path between any two nodes, so that with n nodes, there are n(n−1)/2 direct paths. In a ring topology, every node has exactly two branches connected to it. A ring topology is actually a bus topology in a closed loop, where data travels around the ring in one direction. When one node sends data to another, the data passes through each intermediate node on the ring until it reaches its destination. The intermediate nodes repeat (retransmit) the data to keep the signal strong. Every node is a peer; there is no hierarchical relationship of clients and servers. If one node is unable to retransmit data, it severs communication between the nodes before and after it in the bus.

A combination of any two or more network topologies is known as hybrid topology. A network topology in which peripheral nodes are connected to a central node, which rebroadcasts all transmissions received from any peripheral node to all peripheral nodes on the network, including the originating node, is referred to as star topology. All peripheral nodes may thus communicate with all others by transmitting to, and receiving from, the central node only. If the star central node is passive, the originating node must be able to tolerate the reception of an echo of its own transmission, delayed by the two-way transmission time, i.e., to and from the central node, plus any delay generated in the central node. An active star network has an active central node that usually has the means to prevent echo-related problems.

In local area networks where bus topology is used, each node is connected to a single cable, by the help of interface connectors. This central cable is the backbone of the network and is known as the bus. A signal from the source travels in both directions to all nodes connected on the bus cable until it finds the intended recipient. If the node address does not match the intended address for the data, the machine ignores the data. Alternatively, if the data matches the node address, the data is accepted. Because the bus topology consists of only one or two wire, it is rather inexpensive to implement when compared to other topologies. In a linear bus, all of the nodes of the network are connected to a common transmission medium which has exactly two endpoints (this is the ‘bus’, which is also commonly referred to as the backbone, or trunk)—all data that is transmitted between nodes in the network is transmitted over this common transmission medium and is able to be received by all nodes in the network simultaneously. In a star topology network, each network node is connected to a central hub with a point-to-point connection, so effectively every node is indirectly connected to every other node with the help of the hub. In star topology, every node is connected to a central node called hub, router or switch. The switch is the server and the peripherals are the clients. The network does not necessarily have to resemble a star to be classified as a star network, but all of the nodes on the network must be connected to one central device. All traffic that traverses the network passes through the central hub. The hub acts as a signal repeater. The star topology is considered the easiest topology to design and implement. An advantage of the star topology is the simplicity of adding additional nodes. The primary disadvantage of the star topology is that the hub represents a single point of failure.

Duplexing. In a wired network using point-to-point topology, the communication may be unidirectional (also known as simplex), where the transmission is in one direction only. Alternatively, a duplex (bi-directional) communication may be employed, such as half-duplex or full-duplex. A duplex communication channel requires two simplex channels operating in opposite directions. In half-duplex operation, a transmission over a medium may be in either direction, but only one direction at a time, while in full-duplex configuration, each end can simultaneously transmit and receive.

Frame. A frame is a digital data transmission unit in computer networking and telecommunication. A frame typically includes frame synchronization features consisting of a sequence of bits or symbols that indicate to the receiver the beginning and end of the payload data within the stream of symbols or bits it receives. If a receiver is connected to the system in the middle of a frame transmission, it ignores the data until it detects a new frame synchronization sequence.

In the OSI model of computer networking, a frame is the protocol data unit at the data link layer. Frames are the result of the final layer of encapsulation before the data is transmitted over the physical layer. Each frame is separated from the next by an interframe gap. A frame is a series of bits generally composed of framing bits, the packet payload, and a frame check sequence. In telecommunications, specifically in time-division multiplex (TDM) and time-division multiple access (TDMA) variants, a frame is a cyclically repeated data block that consists of a fixed number of time slots, one for each logical TDM channel or TDMA transmitter. In this context, a frame is typically an entity at the physical layer. The frame is also an entity for time-division duplex, where the mobile terminal may transmit during some timeslots and receive during others. Often, frames of several different sizes are nested inside each other. For example, when using Point-to-Point Protocol (PPP) over asynchronous serial communication, the eight bits of each individual byte are framed by start and stop bits, the payload data bytes in a network packet are framed by the header and footer, and several packets can be framed with frame boundary octets.

Packet. A packet is the unit of data passed across the interface between the internet layer and the link layer. It typically includes an IP header and data, and a packet may be a complete IP datagram or a fragment of an IP datagram. A packet is typically a formatted unit of data carried by a packet-switched network. When data is formatted into packets, packet switching is possible and the bandwidth of the communication medium can be better shared among users than with circuit switching.

A packet consists of control information and user data, which is also known as the payload. Control information provides data for delivering the payload, for example: source and destination network addresses, error detection codes, and sequencing information. Typically, control information is found in packet headers and trailers. In the seven-layer OSI model of computer networking, packet strictly refers to a data unit at layer 3, the Network Layer. The correct term for a data unit at Layer 2, the Data Link Layer, is a frame, and at Layer 4, the Transport Layer, the correct term is a segment or datagram. For the case of TCP/IP communication over Ethernet, a TCP segment is carried in one or more IP packets, which are each carried in one or more Ethernet frames. Different communications protocols use different conventions for distinguishing between the elements and for formatting the data. For example, in Point-to-Point Protocol, the packet is formatted in 8-bit bytes, and special characters are used to delimit the different elements. Other protocols like Ethernet, establish the start of the header and data elements by their location relative to the start of the packet. Some protocols format the information at a bit level instead of a byte level. A network design can achieve two major results by using packets: error detection and multiple host addressing. A packet typically includes various fields such as addresses, Error detection and correction, hop counts, priority, length, and payload.

The addresses fields commonly relating to the routing of network packets requires two network addresses, the source address of the sending host, and the destination address of the receiving host. Error detection and correction is performed at various layers in the protocol stack. Network packets may contain a checksum, parity bits or cyclic redundancy checks to detect errors that occur during transmission. At the transmitter, the calculation is performed before the packet is sent. When received at the destination, the checksum is recalculated, and compared with the one in the packet. If discrepancies are found, the packet may be corrected or discarded. Any packet loss is dealt with by the network protocol. Under fault conditions packets can end up traversing a closed circuit. If nothing was done, eventually the number of packets circulating would build up until the network was congested to the point of failure. A time-to-live is a field that is decreased by one each time a packet goes through a network node. If the field reaches zero, routing has failed, and the packet is discarded. Ethernet packets have no time-to-live field and so are subject to broadcast radiation in the presence of a switch loop. There may be a field to identify the overall packet length. However, in some types of networks, the length is implied by the duration of transmission. Some networks implement quality of service, which can prioritize some types of packets above others. This field indicates which packet queue should be used; a high priority queue is emptied more quickly than lower priority queues at points in the network where congestion is occurring. In general, payload is the data that is carried on behalf of an application. It is usually of variable length, up to a maximum that is set by the network protocol and sometimes the equipment on the route. Some networks can break a larger packet into smaller packets when necessary.

Tunnel. Tunneling is a protocol that allows for the secure movement of data over a network, or between networks. In one example, tunneling involves allowing private network communications to be sent across a public network, such as the Internet, through a process called encapsulation. The encapsulation process allows for data packets to appear as though they are of a public nature to a public network when they are actually private data packets, allowing them to pass through unnoticed. In one example, a tunneling protocol allows a network user to access or provide a network service that the underlying network does not support or provide directly. One important use of a tunneling protocol is to allow a foreign protocol to run over a network that does not support that particular protocol; for example, running IPv6 over IPv4. Another important use is to provide services that are impractical or unsafe to be offered using only the underlying network services; for example, providing a corporate network address to a remote user whose physical network address is not part of the corporate network. Because tunneling involves repackaging the traffic data into a different form, perhaps with encryption as standard, a third use is to hide the nature of the traffic that is run through the tunnels. The tunneling protocol works by using the data portion of a packet or frame (the payload) to carry the packets or frames that actually provide the service. Tunneling uses a layered protocol model such as those of the OSI or TCP/IP protocol suite, but usually violates the layering when using the payload to carry a service not normally provided by the network. Typically, the delivery protocol operates at an equal or higher level in the layered model than the payload protocol.

VPN. Computer networks may use a tunneling protocol where one network protocol (the delivery protocol) encapsulates a different payload protocol. Tunneling enables the encapsulation of a packet from one type of protocol within the datagram of a different protocol. For example, VPN uses PPTP to encapsulate IP packets over a public network, such as the Internet. A VPN solution based on Point-to-Point Tunneling Protocol (PPTP), Layer Two Tunneling Protocol (L2TP), or Secure Socket Tunneling Protocol (SSTP) can be configured. By using tunneling a payload may be carried over an incompatible delivery-network, or provide a secure path through an untrusted network. VPN is further described in chapter 18 entitled: “Virtual Private Networks” of The Internetworking Technology Overview by Cisco Systems, Inc. [published June 1999, Document No. 1-58705-001-3], which is incorporated in its entirety for all purposes as if fully set forth herein.

Typically, the delivery protocol operates at an equal or higher OSI layer than does the payload protocol. In one example of a network layer over a network layer, Generic Routing Encapsulation (GRE), a protocol running over IP (IP Protocol Number 47), often serves to carry IP packets, with RFC 1918 private addresses, over the Internet using delivery packets with public IP addresses. In this case, the delivery and payload protocols are compatible, but the payload addresses are incompatible with those of the delivery network. In contrast, an IP payload might believe it sees a data link layer delivery when it is carried inside the Layer 2 Tunneling Protocol (L2TP), which appears to the payload mechanism as a protocol of the data link layer. L2TP, however, actually runs over the transport layer using User Datagram Protocol (UDP) over IP. The IP in the delivery protocol could run over any data-link protocol from IEEE 802.2 over IEEE 802.3 (i.e., standards-based Ethernet) to the Point-to-Point Protocol (PPP) over a dialup modem link.

Tunneling protocols may use data encryption to transport insecure payload protocols over a public network (such as the Internet), thereby providing VPN functionality. IPsec has an end-to-end Transport Mode, but can also operate in a tunneling mode through a trusted security gateway. HTTP tunneling is a technique by which communications performed using various network protocols are encapsulated using the HTTP protocol, the network protocols in question usually belonging to the TCP/IP family of protocols. The HTTP protocol therefore acts as a wrapper for a channel that the network protocol being tunneled uses to communicate. The HTTP stream with its covert channel is termed an HTTP tunnel. HTTP tunnel software consists of client-server HTTP tunneling applications that integrate with existing application software, permitting them to be used in conditions of restricted network connectivity including firewalled networks, networks behind proxy servers, and network address translation.

Virtual Private Networks (VPNs) are point-to-point connections across a private or public network, such as the Internet. A VPN client typically uses special TCP/IP-based protocols, called tunneling protocols, to make a virtual call to a virtual port on a VPN server. In a typical VPN deployment, a client initiates a virtual point-to-point connection to a remote access server over the Internet, and then the remote access server answers the call, authenticates the caller, and transfers data between the VPN client and the organization's private network. To emulate a point-to-point link, data is encapsulated, or wrapped, with a header. The header provides routing information that enables the data to traverse the shared or public network to reach its endpoint. To emulate a private link, the data being sent is encrypted for confidentiality. Packets that are intercepted on the shared or public network are indecipherable without the encryption keys. The link in which the private data is encapsulated and encrypted is known as a VPN connection.

Commonly there are two types of VPN connections, referred to as Remote Access VPN and Site-to-Site VPN. Popular VPN connections use PPTP, L2TP/IPsec, or SSTP protocols. PPTP is described in IETF RFC 2637 entitled: “Point-to-Point Tunneling Protocol (PPTP)”, L2TP is described in IETF RFC 2661 entitled: “Layer Two Tunneling Protocol “L2TP””, which are both incorporated in their entirety for all purposes as if fully set forth herein. VPN and VPN uses are described in Cisco Systems, Inc. 2001 publication entitled: “IP Tunneling and VPNs”, and in Cisco Systems, Inc. 2001 handbook ‘Internetworking Technologies Handbook’ [No. 1-58705-001-3] chapter 18 entitled: “Virtual Private Networks”, and in IBM Corporation Redbook series publications entitled: “A Comprehensive Guide to Virtual Private Networks” including “Vol. I: IBM Firewall, Server and Client Solutions” [SG24-5201-00, June 1998], “Vol II: IBM Nways Router Solutions” [SG24-5234-01, November 1999], and “Vol III: Cross-Platform Key and Policy Management” [SG24-5309-00, November 1999], which are all incorporated in their entirety for all purposes as if fully set forth herein.

VPN and its uses are further described in the IETF RFC 4026 entitled: “Provider Provisioned Virtual Private Network (VPN) Terminology” that describes provider provisioned Virtual Private Network (VPN), in the IETF RFC 2764 entitled: “A Framework for IP Based Virtual Private Networks” that describes a framework for Virtual Private Networks (VPNs) running across IP backbones, in the IETF RFC 3931 entitled: “Layer Two Tunneling Protocol—Version 3 (L2TPv3)”, and in the IETF RFC 2547 entitled: “BGP/MPLS VPNs” that provides a VPN method based on MPLS (Multiprotocol Label Switching) and BGP (Border Gateway Protocol), which are all incorporated in their entirety for all purposes as if fully set forth herein.

Remote access VPN connections enable users working at home or on the road to access a server on a private network using the infrastructure provided by a public network, such as the Internet. From the user's perspective, the VPN is a point-to-point connection between the computer (the VPN client) and an organization's server. The exact infrastructure of the shared or public network is irrelevant because it appears logically as if the data is sent over a dedicated private link.

Site-to-site VPN connections (also known as router-to-router VPN connections) enable organizations to have routed connections between separate offices, or with other organizations over a public network while helping to maintain secure communications. A routed VPN connection across the Internet logically operates as a dedicated Wide Area Network (WAN) link. When networks are connected over the Internet, a router forwards packets to another router across a VPN connection. To the routers, the VPN connection operates as a data-link layer link. A site-to-site VPN connection connects two portions of a private network. The VPN server provides a routed connection to the network to which the VPN server is attached. The calling router (the VPN client) authenticates itself to the answering router (the VPN server), and for mutual authentication, the answering router authenticates itself to the calling router. In the site-to site VPN connection, the packets sent from either router across the VPN connection typically do not originate at the routers.

Negotiating encryption keys may involve performing Internet Key Exchange (IKE or IKEv2) as part of establishing a session under the Security Protocol for the Internet (IPSec), as described in IETF RFC 2409 entitled: “The Internet Key Exchange (IKE)”, and in RFC 4306 entitled: “Internet Key Exchange (IKEv2) Protocol”, which are both incorporated in their entirety for all purposes as if fully set forth herein. Alternatively or in addition, negotiating encryption keys may involve performing RSA Key Exchange or Diffie-Helman Key Exchange described in IETF RFC 2631 entitled: “Diffie-Hellman Key Agreement Method”, which is incorporated in its entirety for all purposes as if fully set forth herein, as part of establishing a session under the Secure Socket Layer (SSL) or Transport Layer Security (TLS) protocol.

L2TP. Layer 2 Tunneling Protocol (L2TP) is a tunneling protocol that is used to support Virtual Private Networks (VPNs) or as part of the delivery of services by ISPs, and it does not provide any encryption or confidentiality by itself. Rather, it relies on an encryption protocol that it passes within the tunnel to provide privacy. The L2TPv3 is described in RFC 3931 published March 2005 and entitled: “Layer Two Tunneling Protocol—Version 3 (L2TPv3)”, which is incorporated in its entirety for all purposes as if fully set forth herein, provides additional security features, improved encapsulation, and the ability to carry data links other than simply Point-to-Point Protocol (PPP) over an IP network, such as Frame Relay, Ethernet, or ATM.

The entire L2TP packet, including payload and L2TP header, is sent within a User Datagram Protocol (UDP) datagram. It is common to carry PPP sessions within an L2TP tunnel. L2TP does not provide confidentiality or strong authentication by itself. IPsec is often used to secure L2TP packets by providing confidentiality, authentication and integrity. The combination of these two protocols is generally known as L2TP/IPsec. The two endpoints of an L2TP tunnel are called the LAC (L2TP Access Concentrator) and the LNS (L2TP Network Server). The LNS waits for new tunnels. Once a tunnel is established, the network traffic between the peers is bidirectional. To be useful for networking, higher-level protocols are then run through the L2TP tunnel. To facilitate this, an L2TP session (or ‘call’) is established within the tunnel for each higher-level protocol such as PPP. Either the LAC or LNS may initiate sessions. The traffic for each session is isolated by L2TP, so it is possible to set up multiple virtual networks across a single tunnel. MTU should be considered when implementing L2TP. The packets exchanged within an L2TP tunnel are categorized as either control packets or data packets. L2TP provides reliability features for the control packets, but no reliability for data packets. Reliability, if desired, must be provided by the nested protocols running within each session of the L2TP tunnel. L2TP allows the creation of a Virtual Private Dialup Network (VPDN) to connect a remote client to its corporate network by using a shared infrastructure, which could be the Internet or a service provider's network.

IPsec. Internet Protocol Security (IPsec) is a network protocol suite that authenticates and encrypts the packets of data sent over a network. IPsec includes protocols for establishing mutual authentication between agents at the beginning of the session and negotiation of cryptographic keys to use during the session. IPsec can protect data flows between a pair of hosts (host-to-host), between a pair of security gateways (network-to-network), or between a security gateway and a host (network-to-host). Internet Protocol security (IPsec) uses cryptographic security services to protect communications over Internet Protocol (IP) networks, and supports network-level peer authentication, data-origin authentication, data integrity, data confidentiality (encryption), and replay protection. IPsec is described in IETF RFC 4301 entitled: “Security Architecture for the Internet Protocol” and in IETF RFC 4309 entitled: “Using Advanced Encryption Standard (AES) CCM Mode with IPsec Encapsulating Security Payload (ESP)”, both published on December 2005 and which are both incorporated in their entirety for all purposes as if fully set forth herein.

IPsec is an end-to-end security scheme operating in the Internet Layer of the Internet Protocol Suite, while some other Internet security systems in widespread use, such as Transport Layer Security (TLS) and Secure Shell (SSH), operate in the upper layers at the Transport Layer (TLS) and the Application layer (SSH), and can automatically secure applications at the IP layer.

The IPsec suite is an open standard. IPsec uses the following protocols to perform various functions: Authentication Headers (AH) provides connectionless data integrity and data origin authentication for IP datagrams and provides protection against replay attacks; Encapsulating Security Payloads (ESP) provides confidentiality, data-origin authentication, connectionless integrity, an anti-replay service (a form of partial sequence integrity), and limited traffic-flow confidentiality; Security Associations (SA) provides the bundle of algorithms and data that provide the parameters necessary for AH and/or ESP operations. The Internet Security Association and Key Management Protocol (ISAKMP) provides a framework for authentication and key exchange, with actual authenticated keying material provided either by manual configuration with pre-shared keys, Internet Key Exchange (IKE and IKEv2), Kerberized Internet Negotiation of Keys (KINK), or IPSECKEY DNS records.

VLAN. A virtual LAN (VLAN) is any broadcast domain that is partitioned and isolated in a computer network at the data link layer (OSI layer 2). VLANs work by applying tags to network packets and handling these tags in networking systems—creating the appearance and functionality of network traffic that is physically on a single network but acts as if it is split between separate networks. In this way, VLANs can keep network applications separate despite being connected to the same physical network, and without requiring multiple sets of cabling and networking devices to be deployed. VLAN is described in IEEE Standard IEEE Std. 802.1Q™-2005 entitled: “Virtual Bridged Local Area Networks” published May 2006, which is incorporated in its entirety for all purposes as if fully set forth herein. VLAN technology is further described in chapter 26 entitled: “LAN Switching and VLANs” of The Internetworking Technology Overview by Cisco Systems, Inc. [published June 1999, Document No. 1-58705-001-3], which is incorporated in its entirety for all purposes as if fully set forth herein.

VLANs allow to group hosts together even if the hosts are not directly connected to the same network switch, and because VLAN membership can be configured through software, this can greatly simplify network design and deployment. VLANs allow networks and devices that must be kept separate to share the same physical cabling without interacting improving simplicity, security, traffic management, or economy. For example, a VLAN could be used to separate traffic within a business due to users, and due to network administrators, or between types of traffic, so that users or low priority traffic cannot directly affect the rest of the network's functioning. Many Internet hosting services use VLANs to separate their customers' private zones from each other, allowing each customer's servers to be grouped together in a single network segment while being located anywhere in their datacenter. Some precautions are needed to prevent traffic “escaping” from a given VLAN, an exploit known as VLAN hopping. To subdivide a network into VLANs, one configures network equipment. Simpler equipment can partition only per physical port (if at all), in which case each VLAN is connected with a dedicated network cable. More sophisticated devices can mark frames through VLAN tagging, so that a single interconnect (trunk) may be used to transport data for multiple VLANs. Since VLANs share bandwidth, a VLAN trunk can use link aggregation, quality-of-service prioritization, or both to route data efficiently. VLANs address issues such as scalability, security, and network management. Network architects set up VLANs to provide network segmentation. Routers between VLANs filter broadcast traffic, enhance network security, perform address summarization, and mitigate network congestion.

In a network utilizing broadcasts for service discovery, address assignment and resolution and other services, as the number of peers on a network grows, the frequency of broadcasts also increases. VLANs can help manage broadcast traffic by forming multiple broadcast domains. Breaking up a large network into smaller independent segments reduces the amount of broadcast traffic each network device and network segment has to bear. Switches may not bridge network traffic between VLANs, as doing so would violate the integrity of the VLAN broadcast domain. VLANs can also help create multiple layer 3 networks on a single physical infrastructure. VLANs are data link layer (OSI layer 2) constructs, analogous to Internet Protocol (IP) subnets, which are network layer (OSI layer 3) constructs. In an environment employing VLANs, a one-to-one relationship often exists between VLANs and IP subnets, although it is possible to have multiple subnets on one VLAN.

VLANs operate at Layer 2 (the data link layer) of the OSI model. Administrators often configure a VLAN to map directly to an IP network, or subnet, which gives the appearance of involving Layer 3 (the network layer). In the context of VLANs, the term “trunk” denotes a network link carrying multiple VLANs, which are identified by labels (or “tags”) inserted into their packets. Such trunks must run between “tagged ports” of VLAN-aware devices, so they are often switch-to-switch or switch-to-router links rather than links to hosts. A router (Layer 3 device) serves as the backbone for network traffic going across different VLANs. A basic switch not configured for VLANs has VLAN functionality disabled or permanently enabled with a default VLAN that contains all ports on the device as members. The default VLAN typically has an ID of 1. Every device connected to one of its ports can send packets to any of the others. Separating ports by VLAN groups separates their traffic very much like connecting each group using a distinct switch for each group. It is only when the VLAN port group is to extend to another device that tagging is used. Since communications between ports on two different switches travel via the uplink ports of each switch involved, every VLAN containing such ports must also contain the uplink port of each switch involved, and traffic through these ports must be tagged. Management of the switch requires that the administrative functions be associated with one or more of the configured VLANs. If the default VLAN were deleted or renumbered without first moving the management connection to a different VLAN, it is possible for the administrator to be locked out of the switch configuration, normally requiring physical access to the switch to regain management by either a forced clearing of the device configuration (possibly to the factory default), or by connecting through a console port or similar means of direct management.

MPLS. Multiprotocol Label Switching (MPLS) is a type of data-carrying technique for high-performance telecommunications networks. MPLS directs data from one network node to the next based on short path labels rather than long network addresses, avoiding complex lookups in a routing table. The labels identify virtual links (paths) between distant nodes rather than endpoints. MPLS can encapsulate packets of various network protocols, hence its name “multiprotocol”. MPLS is described in IETF RFC 3031 dated January 2001 entitled: “Multiprotocol Label Switching Architecture”, and in IETF RFC 5036 dated October 2007 entitled: “LDP Specification”, which are both incorporated in their entirety for all purposes as if fully set forth herein. MPLS is further described in chapter 28 entitled: “MPLS/Tag Switching” of The Internetworking Technology Overview by Cisco Systems, Inc. [published June 1999, Document No. 1-58705-001-3], which is incorporated in its entirety for all purposes as if fully set forth herein.

MPLS is a scalable, protocol-independent transport, where data packets are assigned labels. Packet-forwarding decisions are made solely on the contents of this label, without the need to examine the packet itself. This allows one to create end-to-end circuits across any type of transport medium, using any protocol. Multiprotocol label switching belongs to the family of packet-switched networks, and operates at a layer that is generally considered to lie between traditional definitions of OSI Layer 2 (data link layer) and Layer 3 (network layer), and thus is often referred to as a layer 2.5 protocol. It was designed to provide a unified data-carrying service for both circuit-based clients and packet-switching clients which provide a datagram service model. It can be used to carry many different kinds of traffic, including IP packets, as well as native ATM, SONET, and Ethernet frames. A Label-Switched Path (LSP) is a path through an MPLS network, set up by a signaling protocol such as LDP, RSVP-TE, BGP or CR-LDP. The path is set up based on criteria in the FEC.

The path begins at a Label Edge Router (LER), which makes a decision on which label to prefix to a packet, based on the appropriate FEC. It then forwards the packet along to the next router in the path, which swaps the packet's outer label for another label, and forwards it to the next router. The last router in the path removes the label from the packet and forwards the packet based on the header of its next layer, for example IPv4. Due to the forwarding of packets through an LSP being opaque to higher network layers, an LSP is also sometimes referred to as an MPLS tunnel. The router which first prefixes the MPLS header to a packet is called an ingress router. The last router in an LSP, which pops the label from the packet, is called an egress router. Routers in between, which need only swap labels, are called transit routers or Label Switch Routers (LSRs).

Note that LSPs are unidirectional; they enable a packet to be label switched through the MPLS network from one endpoint to another. Since bidirectional communication is typically desired, the aforementioned dynamic signaling protocols can set up an LSP in the other direction to compensate for this. When protection is considered, LSPs could be categorized as primary (working), secondary (backup) and tertiary (LSP of last resort). As described above, LSPs are normally P2P (point to point). A new concept of LSPs, which are known as P2MP (point to multi-point), was introduced recently. These are mainly used for multicasting purposes.

ERPS. Ethernet Ring Protection Switching (ERPS), is an effort at ITU-T under G.8032 Recommendation to provide sub-50 ms protection and recovery switching for Ethernet traffic in a ring topology and at the same time ensuring that there are no loops formed at the Ethernet layer. G.8032v1 supported a single ring topology and G.8032v2 supports multiple rings/ladder topology. ERPS is described in International Telecommunication Union (ITU) TELECOMMUNICATION STANDARDIZATION SECTOR standard (published August 2015) ITU-T G.8032/Y.1344 entitled: “Ethernet ring protection switching”, which is incorporated in its entirety for all purposes as if fully set forth herein. ERPS specifies protection switching mechanisms and a protocol for Ethernet layer network (ETH) rings. Ethernet Rings can provide wide-area multipoint connectivity more economically due to their reduced number of links. The mechanisms and protocol defined in this Recommendation achieve highly reliable and stable protection; and never form loops, which would fatally affect network operation and service availability. Each Ethernet Ring Node is connected to adjacent Ethernet Ring Nodes participating in the same Ethernet Ring, using two independent links. A ring link is bounded by two adjacent Ethernet Ring Nodes, and a port for a ring link is called a ring port. The minimum number of Ethernet Ring Nodes in an Ethernet Ring is three.

The fundamentals of this ring protection switching architecture are the principle of loop avoidance, and the utilization of learning, forwarding, and Filtering Database (FDB) mechanisms defined in the Ethernet flow forwarding function (ETH_FF). Loop avoidance in an Ethernet Ring is achieved by guaranteeing that, at any time, traffic may flow on all but one of the ring links. This particular link is called the Ring Protection Link (RPL), and under normal conditions this ring link is blocked, i.e. not used for service traffic. One designated Ethernet Ring Node, the RPL Owner Node, is responsible for blocking traffic at one end of the RPL. Under an Ethernet ring failure condition, the RPL Owner Node is responsible for unblocking its end of the RPL (unless the RPL has failed) allowing the RPL to be used for traffic. The other Ethernet Ring Node adjacent to the RPL, the RPL Neighbor Node, may also participate in blocking or unblocking its end of the RPL.

The event of an Ethernet Ring failure results in protection switching of the traffic. This is achieved under the control of the ETH_FF functions on all Ethernet Ring Nodes. An APS protocol is used to coordinate the protection actions over the ring. In ERPS there is a central node called RPL Owner Node which blocks one of the ports to ensure that there is no loop formed for the Ethernet traffic. The link blocked by the RPL owner node is called the Ring Protection Link or RPL. The node at the other end of the RPL is known as RPL Neighbor Node. It uses R-APS control messages to coordinate the activities of switching on/off the RPL link.

Version 2 of G.8032 introduced many additional features, such as Multi-ring/ladder network support, Revertive/Non-revertive mode after the condition that is causing the switch has been cleared, Administrative commands: Forced Switch (FS), Manual Switch (MS) for blocking a particular ring port, Flush FDB (Filtering database) Logic, which significantly reduces amount of flush FDB operations in the ring, and Support of multiple ERP instances on a single ring.

Bridge. A bridge (or ‘network bridge’) is a device that creates a single aggregate network from multiple communication networks or network segments (‘bridging’). Bridging is distinct from routing, as routing allows multiple different networks to communicate independently while remaining separate whilst bridging connects two separate networks as if they are only one network (hence the name “bridging”). In the OSI model, bridging is performed in the first two layers, below the network layer (layer 3). If one or more segments of the bridged network are wireless, the device is known as a wireless bridge and the function as wireless bridging. There are four types of network bridging technologies: simple bridging, multiport bridging, learning or transparent bridging, and source route bridging. Bridging is further described in chapter 4 entitled: “Bridging and Switching Basics”, in chapter 23 entitled: “Transparent Bridging”, and in chapter 24 entitled: “MIXED-Media Bridging”, of The Internetworking Technology Overview by Cisco Systems, Inc. [published June 1999, Document No. 1-58705-001-3], which is incorporated in its entirety for all purposes as if fully set forth herein.

A simple bridge connects two network segments, typically by operating transparently and deciding on a frame-by-frame basis whether or not to forward from one network to the other. A store and forward technique is typically used so, during forwarding, the frame integrity is verified on the source network and CSMA/CD delays are accommodated on the destination network. Contrary to repeaters that simply extend the maximum span of a segment, bridges only forward frames that are required to cross the bridge. Additionally, bridges reduce collisions by partitioning the collision domain. A multiport bridge connects multiple networks and operates transparently to decide on a frame-by-frame basis whether and where to forward traffic Like the simple bridge, a multiport bridge typically uses store and forward operation. The multiport bridge function serves as the basis for network switches. A transparent bridge uses a forwarding database to send frames across network segments. The forwarding database starts empty—entries in the database are built as the bridge receives frames. If an address entry is not found in the forwarding database, the frame is flooded to all other ports of the bridge, flooding the frame to all segments except the one from which it was received. By means of these flooded frames, the destination network will respond and a forwarding database entry will be created. In the context of a two-port bridge, one can think of the forwarding database as a filtering database. A bridge reads a frame's destination address and decides to either forward or filter. If the bridge determines that the destination node is on another segment on the network, it forwards (retransmits) the frame to that segment. If the destination address belongs to the same segment as the source address, the bridge filters (discards) the frame. As nodes transmit data through the bridge, the bridge establishes a filtering database of known MAC addresses and their locations on the network. The bridge uses its filtering database to determine whether a frame should be forwarded or filtered.

A network bridge, operating at the data link layer, may interconnect a small number of devices in a home or the office. This is a trivial case of bridging, in which the bridge learns the MAC address of each connected device. Bridges also buffer an incoming packet and adapt the transmission speed to that of the outgoing port. The CAM-table (Content Addressable Memory) stored in RAM is initially empty. For each received Ethernet frame the switch learns from the frames source MAC address and adds this together with the ingress interface to build a topology database. The switch then forwards the frame to the interface found in the CAM-table based on the frames destination MAC address. If the destination address is unknown the switch sends the frame out on all interfaces (except ingress interface)—known as ‘flooding’.

Classic bridges may also interconnect using a spanning tree protocol that disables links so that the resulting local area network is a tree without loops. In contrast to routers, spanning tree bridges must have topologies with only one active path between two points. While layer 2 switch remains more of a marketing term than a technical term, [citation needed] the products that were introduced as “switches” tended to use micro-segmentation and full duplex to prevent collisions among devices connected to Ethernet. By using an internal forwarding plane much faster than any interface, they give the impression of simultaneous paths among multiple devices. ‘Non-blocking’ devices use a forwarding plane or equivalent method fast enough to allow full duplex traffic for each port simultaneously.

Once a bridge learns the addresses of its connected nodes, it forwards data link layer frames using a layer 2 forwarding method. There are four forwarding methods a bridge can use, of which the second through fourth methods were performance-increasing methods when used on “switch” products with the same input and output port bandwidths: Store and forward—the switch buffers and verifies each frame before forwarding it; a frame is received in its entirety before it is forwarded; Cut through—the switch starts forwarding after the frame's destination address is received. There is no error checking with this method. When the outgoing port is busy at the time, the switch falls back to store-and-forward operation. Also, when the egress port is running at a faster data rate than the ingress port, store-and-forward is usually used; Fragment free—a method that attempts to retain the benefits of both store and forward and cut through. Fragment free checks the first 64 bytes of the frame, where addressing information is stored. According to Ethernet specifications, collisions should be detected during the first 64 bytes of the frame, so frames that are in error because of a collision will not be forwarded. This way the frame will always reach its intended destination. Error checking of the actual data in the packet is left for the end device; and Adaptive switching—a method of automatically selecting between the other three modes.

Switch. A network switch (also called switching hub, bridging hub, officially MAC bridge) is a networking device that connects devices together on a computer network by using packet switching to receive, process, and forward data to the destination device. A network switch is a multiport network bridge that uses hardware addresses to process and forward data at the data link layer (layer 2) of the OSI model. Some switches can also process data at the network layer (layer 3) by additionally incorporating routing functionality. Such switches are commonly known as layer-3 switches or multilayer switches. Switches for Ethernet are the most common form of network switch. LAN switching is further described in chapter 2 entitled: “Introduction to LAN Protocols” and in chapter 26 entitled: “LAN Switching and VLANs” of The Internetworking Technology Overview by Cisco Systems, Inc. [published June 1999, Document No. 1-58705-001-3], which is incorporated in its entirety for all purposes as if fully set forth herein.

A switch is a device in a computer network that connects together other devices. Multiple data cables are plugged into a switch to enable communication between different networked devices. Switches manage the flow of data across a network by transmitting a received network packet only to the one or more devices for which the packet is intended. Each networked device connected to a switch can be identified by its network address, allowing the switch to direct the flow of traffic maximizing the security and efficiency of the network. A switch is more intelligent than an Ethernet hub, which simply retransmits packets out of every port of the hub except the port on which the packet was received, unable to distinguish different recipients, and achieving an overall lower network efficiency. An Ethernet switch operates at the data link layer (layer 2) of the OSI model to create a separate collision domain for each switch port. Each device connected to a switch port can transfer data to any of the other ports at any time and the transmissions will not interfere. Because broadcasts are still being forwarded to all connected devices by the switch, the newly formed network segment continues to be a broadcast domain.

Segmentation involves the use of a switch to split a larger collision domain into smaller ones in order to reduce collision probability, and to improve overall network throughput. In the extreme case (i.e. micro-segmentation), each device is located on a dedicated switch port. In contrast to an Ethernet hub, there is a separate collision domain on each of the switch ports. This allows computers to have dedicated bandwidth on point-to-point connections to the network and also to run in full-duplex mode. Full-duplex mode has only one transmitter and one receiver per collision domain, making collisions impossible. The network switch plays an integral role in most modern Ethernet Local Area Networks (LANs).

Unmanaged switches have no configuration interface or options. They are plug and play, and are typically the least expensive switches, and therefore often used in a small office/home office environment. Unmanaged switches can be desktop or rack mounted. Managed switches have one or more methods to modify the operation of the switch. Common management methods include: a Command-Line Interface (CLI) accessed via serial console, telnet or Secure Shell, an embedded Simple Network Management Protocol (SNMP) agent allowing management from a remote console or management station, or a web interface for management from a web browser. Examples of configuration changes that one can do from a managed switch include: enabling features such as Spanning Tree Protocol or port mirroring, setting port bandwidth, creating or modifying virtual LANs (VLANs), etc. Two sub-classes of managed switches are marketed today: Smart (or intelligent) switches are managed switches with a limited set of management features. Likewise “web-managed” switches are switches which fall into a market niche between unmanaged and managed, and Enterprise managed (or fully managed) switches, which have a full set of management features, including CLI, SNMP agent, and web interface. They may have additional features to manipulate configurations, such as the ability to display, modify, backup and restore configurations. Compared with smart switches, enterprise switches have more features that can be customized or optimized, and are generally more expensive than smart switches. Enterprise switches are typically found in networks with larger number of switches and connections, where centralized management is a significant savings in administrative time and effort. A stackable switch is a version of enterprise-managed switch.

Layer 2 switching uses the media access control address (MAC address) from the host's network interface cards (NICs) to decide where to forward frames. Layer 2 switching is hardware-based, which means switches use application-specific integrated circuit (ASICs) to build and maintain filter tables (also known as MAC address tables or CAM tables). One way to think of a layer 2 switch is as multiport bridge. Layer 2 switching provides Hardware-based bridging (MAC), Wire speed/non-blocking forwarding, and Low latency. Layer 2 switching is highly efficient because there is no modification to the data packet and the frame, encapsulation of the packet changes only when the data packet is passing through dissimilar media (such as from Ethernet to FDDI). Layer 2 switching is used for work group connectivity and network segmentation (breaking up collision domains). This allows a flatter network design with more network segments than traditional networks joined by repeater hubs and routers. Layer 2 switching has helped develop new components in the network infrastructure.

Router. A router is a networking device that forwards data packets between computer networks. Routers perform the traffic directing functions on the Internet. A data packet is typically forwarded from one router to another router through the networks that constitute an internetwork until it reaches its destination node. A router is connected to two or more data lines from different networks. When a data packet comes in on one of the lines, the router reads the network address information in the packet to determine the ultimate destination. Then, using information in its routing table or routing policy, it directs the packet to the next network on its journey. The most familiar type of routers are home and small office routers that simply forward IP packets between the home computers and the Internet. An example of a router would be the owner's cable or DSL router, which connects to the Internet through an Internet Service Provider (ISP). More sophisticated routers, such as enterprise routers, connect large business or ISP networks up to the powerful core routers that forward data at high speed along the optical fiber lines of the Internet backbone. Though routers are typically dedicated hardware devices, software-based routers also exist. Router functionality is further described in chapter 5 entitled: “Routing Basics” of The Internetworking Technology Overview by Cisco Systems, Inc. [published June 1999, Document No. 1-58705-001-3], which is incorporated in its entirety for all purposes as if fully set forth herein.

When multiple routers are used in interconnected networks, the routers can exchange information about destination addresses using a routing protocol. Each router builds up a routing table listing the preferred routes between any two systems on the interconnected networks. A router has two types of network element components organized onto separate planes: Control plane—A router maintains a routing table that lists which route should be used to forward a data packet, and through which physical interface connection. It does this using internal preconfigured directives, called static routes, or by learning routes dynamically using a routing protocol. Static and dynamic routes are stored in the routing table. The control-plane logic then strips non-essential directives from the table and builds a forwarding information base (FIB) to be used by the forwarding plane; and Forwarding plane—The router forwards data packets between incoming and outgoing interface connections. It forwards them to the correct network type using information that the packet header contains matched to entries in the FIB supplied by the control plane.

The main purpose of a router is to connect multiple networks and forward packets destined either for its own networks or other networks. A router is considered a layer-3 device because its primary forwarding decision is based on the information in the layer-3 IP packet, specifically the destination IP address. When a router receives a packet, it searches its routing table to find the best match between the destination IP address of the packet and one of the addresses in the routing table. Once a match is found, the packet is encapsulated in the layer-2 data link frame for the outgoing interface indicated in the table entry. A router typically does not look into the packet payload but only at the layer-3 addresses to make a forwarding decision, plus optionally other information in the header for hints on, for example, quality of service (QoS). For pure IP forwarding, a router is designed to minimize the state information associated with individual packets. Once a packet is forwarded, the router does not retain any historical information about the packet.

The routing table itself can contain information derived from a variety of sources, such as a default or static routes that are configured manually, or dynamic routing protocols where the router learns routes from other routers. A default route is one that is used to route all traffic whose destination does not otherwise appear in the routing table; this is common—even necessary—in small networks, such as a home or small business where the default route simply sends all non-local traffic to the Internet service provider. The default route can be manually configured (as a static route), or learned by dynamic routing protocols, or be obtained by DHCP. A router can run more than one routing protocol at a time, particularly if it serves as an autonomous system border router between parts of a network that run different routing protocols; if it does so, then redistribution may be used (usually selectively) to share information between the different protocols running on the same router.

Besides making a decision as to which interface a packet is forwarded to, which is handled primarily via the routing table, a router also has to manage congestion when packets arrive at a rate higher than the router can process. Three policies commonly used in the Internet are tail drop, Random Early Detection (RED), and weighted random early detection (WRED). Tail drop is the simplest and most easily implemented; the router simply drops new incoming packets once the length of the queue exceeds the size of the buffers in the router. RED probabilistically drops datagrams early when the queue exceeds a pre-configured portion of the buffer, until a pre-determined max, when it becomes tail drop. WRED requires a weight on the average queue size to act upon when the traffic is about to exceed the pre-configured size, so that short bursts will not trigger random drops. Another function a router performs is to decide which packet should be processed first when multiple queues exist. This is managed through QoS, which is critical when Voice over IP is deployed, so as not to introduce excessive latency. Yet another function a router performs is called policy-based routing where special rules are constructed to override the rules derived from the routing table when a packet forwarding decision is made.

Router functions may be performed through the same internal paths that the packets travel inside the router. Some of the functions may be performed through an application-specific integrated circuit (ASIC) to avoid overhead of scheduling CPU time to process the packets. Others may have to be performed through the CPU as these packets need special attention that cannot be handled by an ASIC.

Gateway. A gateway is a network node equipped for interfacing with another network that uses different protocols. A gateway may contain devices such as protocol translators, impedance matching devices, rate converters, fault isolators, or signal translators as necessary to provide system interoperability. It also requires the establishment of mutually acceptable administrative procedures between both networks. A protocol translation/mapping gateway interconnects networks with different network protocol technologies by performing the required protocol conversions. Gateways, also called protocol converters, can operate at any network layer. The activities of a gateway are more complex than that of the router or switch as it communicates using more than one protocol. Both the computers of Internet users and the computers that serve pages to users are host nodes, while the nodes that connect the networks in between are gateways. For example, the computers that control traffic between company networks or the computers used by internet service providers (ISPs) to connect users to the internet are gateway nodes.

In the network for an enterprise, a computer server acting as a gateway node is often also acting as a proxy server and a firewall server. A gateway is often associated with both a router, which knows where to direct a given packet of data that arrives at the gateway, and a switch, which furnishes the actual path in and out of the gateway for a given packet. On an Internet Protocol (IP) network, clients should automatically send IP packets with a destination outside a given subnet mask to a network gateway. A subnet mask defines the IP range of a private network. For example, if a private network has a base IP address of 192.168.0.0 and has a subnet mask of 255.255.255.0, then any data going to an IP address outside of 192.168.0.X will be sent to that network's gateway. While forwarding an IP packet to another network, the gateway might or might not perform Network Address Translation (NAT).

SDN. Software-Defined Networking (SDN) technology is an approach to networking that facilitates network management and enables programmatically efficient network configuration in order to improve network performance and monitoring. SDN is meant to address the fact that the static architecture of traditional networks is decentralized and complex while current networks require more flexibility and easy troubleshooting. SDN suggests to centralize network intelligence in one network component by disassociating the forwarding process of network packets (Data Plane) from the routing process (Control plane). The control plane consists of one or more controllers which are considered as the brain of SDN network where the whole intelligence is incorporated. However, the intelligence centralization has its own drawbacks when it comes to security, scalability, and elasticity and this is the main issue of SDN. Software-defined networking (SDN) is an architecture purporting to be dynamic, manageable, cost-effective, and adaptable, seeking to be suitable for the high-bandwidth, dynamic nature of today's applications. SDN architectures decouple network control and forwarding functions, enabling network control to become directly programmable and the underlying infrastructure to be abstracted from applications and network services.

The SDN architecture is Directly programmable—Network control is directly programmable because it is decoupled from forwarding functions; Agile—Abstracting control from forwarding lets administrators dynamically adjust network-wide traffic flow to meet changing needs; Centrally managed—Network intelligence is (logically) centralized in software-based SDN controllers that maintain a global view of the network, which appears to applications and policy engines as a single, logical switch; Programmatically configured—SDN lets network managers configure, manage, secure, and optimize network resources very quickly via dynamic, automated SDN programs, which they can write themselves because the programs do not depend on proprietary software; and Open standards-based and vendor-neutral—When implemented through open standards, SDN simplifies network design and operation because instructions are provided by SDN controllers instead of multiple, vendor-specific devices and protocols. The SDN architectural components include SDN Application, SDN Controller, SDN Datapath, SDN Control to Data-Plane Interface (CDPI), and SDN Northbound Interfaces (NBI).

SDN Applications are programs that explicitly, directly, and programmatically communicate their network requirements and desired network behavior to the SDN Controller via a northbound interface (NBI). In addition they may consume an abstracted view of the network for their internal decision-making purposes. An SDN Application consists of one SDN Application Logic and one or more NBI Drivers. SDN Applications may themselves expose another layer of abstracted network control, thus offering one or more higher-level NBIs through respective NBI agents.

The SDN Controller is a logically centralized entity in charge of (i) translating the requirements from the SDN Application layer down to the SDN Datapaths and (ii) providing the SDN Applications with an abstract view of the network (which may include statistics and events). An SDN Controller consists of one or more NBI Agents, the SDN Control Logic, and the Control to Data-Plane Interface (CDPI) driver. Definition as a logically centralized entity neither prescribes nor precludes implementation details such as the federation of multiple controllers, the hierarchical connection of controllers, communication interfaces between controllers, nor virtualization or slicing of network resources.

The SDN Datapath is a logical network device that exposes visibility and uncontested control over its advertised forwarding and data processing capabilities. The logical representation may encompass all or a subset of the physical substrate resources. An SDN Datapath comprises a CDPI agent and a set of one or more traffic forwarding engines and zero or more traffic processing functions. These engines and functions may include simple forwarding between the datapath's external interfaces or internal traffic processing or termination functions. One or more SDN Datapaths may be contained in a single (physical) network element—an integrated physical combination of communications resources, managed as a unit. An SDN Datapath may also be defined across multiple physical network elements. This logical definition neither prescribes nor precludes implementation details such as the logical to physical mapping, management of shared physical resources, virtualization or slicing of the SDN Datapath, interoperability with non-SDN networking, nor the data processing functionality, which can include OSI layer 4-7 functions.

The SDN CDPI is the interface defined between an SDN Controller and an SDN Datapath, which provides at least (i) programmatic control of all forwarding operations, (ii) capabilities advertisement, (iii) statistics reporting, and (iv) event notification. One value of SDN lies in the expectation that the CDPI is implemented in an open, vendor-neutral and interoperable way.

SDN NBIs are interfaces between SDN Applications and SDN Controllers and typically provide abstract network views and enable direct expression of network behavior and requirements. This may occur at any level of abstraction (latitude) and across different sets of functionality (longitude). One value of SDN lies in the expectation that these interfaces are implemented in an open, vendor-neutral and interoperable way.

A high-level view of the Software-Defined Network (SDN) architecture as seen by the ONF along with key architectural principles of SDN is described in an Open Networking Foundation publication (Version 1.0—draft v08) published Dec. 12, 2013 entitled: “SDN Architecture Overview”, which is incorporated in its entirety for all purposes as if fully set forth herein. Precise implementation details allowed within this SDN architecture are provided in more detailed ONF architecture documents. The aim of SDN is to provide open interfaces enabling development of software that can control the connectivity provided by a set of network resources and the flow of network traffic though them, along with possible inspection and modification of traffic that may be performed in the network.

SDN related issues, from both protocol and architecture perspectives, are described in a paper authored by Kamal Benzekki of the Ismail University, Meknes, Morocco, and Abdeslam El Fergougui and Abdelbaki Elbelrhiti Elalaoui, of the Laboratory of Computer Networks and Systems, Department of Mathematics and Computer Science, Faculty of Sciences, Moulay, published in SECURITY AND COMMUNICATION NETWORKS (Security Comm. Networks 2016; 9:5803-5833) and online 7 Feb. 2017 in Wiley Online Library [DOI: 10.1002/sec.1737], entitled: “Software-defined networking (SDN): a survey”, which is incorporated in its entirety for all purposes as if fully set forth herein. The paper presents different existing solutions and mitigation techniques that address SDN scalability, elasticity, dependability, reliability, high availability, resiliency, security, and performance concerns. With the advent of cloud computing, many new networking concepts have been introduced to simplify network management and bring innovation through network programmability. The emergence of the software-defined networking (SDN) paradigm is one of these adopted concepts in the cloud model so as to eliminate the network infrastructure maintenance processes and guarantee easy management. In this fashion, SDN offers real-time performance and responds to high availability requirements. However, this new emerging paradigm has been facing many technological hurdles; some of them are inherent, while others are inherited from existing adopted technologies. In this paper, our purpose is to shed light on and give insight into the challenges facing the future of this revolutionary network model,

OpenFlow. OpenFlow is a communications protocol that provides access to the forwarding plane of a network switch or router over the network. OpenFlow enables network controllers to determine the path of network packets across a network of switches. The controllers are distinct from the switches. This separation of the control from the forwarding allows for more sophisticated traffic management than is feasible using Access Control Lists (ACLs) and routing protocols. Also, OpenFlow allows switches from different vendors—often each with their own proprietary interfaces and scripting languages—to be managed remotely using a single, open protocol. The protocol's inventors consider OpenFlow an enabler of software defined networking (SDN). The requirements of an OpenFlow Logical Switch are described in The Open Networking Foundation “OpenFlow Switch Specification” Version 1.5.1 (Protocol version 0x06) Document #ONF TS-025 published Mar. 26, 2015, which is incorporated in its entirety for all purposes as if fully set forth herein. The standard further provide additional information describing OpenFlow and Software Defined Networking is available on the Open Networking Foundation web site (https://www.opennetworking.org/). This specification covers the components and the basic functions of the switch, and the OpenFlow switch protocol to manage an OpenFlow switch from a remote OpenFlow controller.

OpenFlow allows remote administration of a layer 3 switch packet forwarding tables, by adding, modifying and removing packet matching rules and actions. This way, routing decisions can be made periodically or ad hoc by the controller and translated into rules and actions with a configurable lifespan, which are then deployed to a switch's flow table, leaving the actual forwarding of matched packets to the switch at wire speed for the duration of those rules. Packets which are unmatched by the switch can be forwarded to the controller. The controller can then decide to modify existing flow table rules on one or more switches or to deploy new rules, to prevent a structural flow of traffic between switch and controller. It could even decide to forward the traffic itself, provided that it has told the switch to forward entire packets instead of just their header. The OpenFlow protocol is layered on top of the Transmission Control Protocol (TCP) and prescribes the use of Transport Layer Security (TLS). Controllers should listen on TCP port 6653 for switches that want to set up a connection. Earlier versions of the OpenFlow protocol unofficially used port 6633.

Virtualization. The term virtualization typically refers to the technology that allows for the creation of software-based virtual machines that can run multiple operating systems from a single physical machine. In one example, virtual machines can be used to consolidate the workloads of several under-utilized servers to fewer machines, perhaps a single machine (server consolidation), providing benefits (perceived or real, but often cited by vendors) such as savings on hardware, environmental costs, management, and administration of the server infrastructure. Virtualization scheme allows for the creation of substitutes for real resources, that is, substitutes that have the same functions and external interfaces as their counterparts, but that differ in attributes, such as size, performance, and cost. These substitutes are called virtual resources, and their users are typically unaware of the substitution.

Virtualization is commonly applied to physical hardware resources by combining multiple physical resources into shared pools from which users receive virtual resources. With virtualization, you can make one physical resource look like multiple virtual resources. Virtual resources can have functions or features that are not available in their underlying physical resources. Virtualization can provide the benefits of consolidation to reduce hardware cost, such as to efficiently access and manage resources to reduce operations and systems management costs while maintaining needed capacity, and to have a single server function as multiple virtual servers. In addition, virtualization can provide optimization of workloads, such as to respond dynamically to the application needs of its users, and to increase the use of existing resources by enabling dynamic sharing of resource pools. Further, virtualization may be used for IT flexibility and responsiveness, such as by having a single, consolidated view of, and easy access to, all available resources in the network, regardless of location, and reducing the management of your environment by providing emulation for compatibility and improved interoperability.

Virtual machine (VM). Virtual machine is a representation of a real machine using software that provides an operating environment which can run or host a guest operating system. In one example, a virtual machine may include a self-contained software emulation of a machine, which does not physically exist, but shares resources of an underlying physical machine. Like a physical computer, a virtual machine runs an operating system and applications. Multiple virtual machines can operate concurrently on a single host system. There are different kinds of virtual machines, each with different functions: System virtual machines (also termed full virtualization VMs) provide a substitute for a real machine. They provide functionality needed to execute entire operating systems. A hypervisor uses native execution to share and manage hardware, allowing for multiple environments which are isolated from one another, yet exist on the same physical machine. Modern hypervisors use hardware-assisted virtualization, virtualization-specific hardware, primarily from the host CPUs. Process virtual machines are designed to execute computer programs in a platform-independent environment. Some virtual machines, such as QEMU, are designed to also emulate different architectures and allow execution of software applications and operating systems written for another CPU or architecture. Operating-system-level virtualization allows the resources of a computer to be partitioned via the kernel's support for multiple isolated user space instances, which are usually called containers and may look and feel like real machines to the end users.

Guest Operating System. A guest operating system is an operating system running in a virtual machine environment that would otherwise run directly on a separate physical system. Operating-system-level virtualization, also known as containerization, refers to an operating system feature in which the kernel allows the existence of multiple isolated user-space instances. Such instances, called containers, partitions, Virtualization Engines (VEs) or jails (FreeBSD jail or chroot jail), may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container. In addition to isolation mechanisms, the kernel often provides resource-management features to limit the impact of one container's activities on other containers. With operating-system-virtualization, or containerization, it is possible to run programs within containers, to which only parts of these resources are allocated. A program expecting to see the whole computer, once run inside a container, can only see the allocated resources and believes them to be all that is available. Several containers can be created on each operating system, to each of which a subset of the computer's resources is allocated. Each container may contain any number of computer programs. These programs may run concurrently or separately, even interact with each other.

Hypervisor. Hypervisor commonly refers to a thin layer of software that generally provides virtual partitioning capabilities which runs directly on hardware, but underneath higher-level virtualization services. The hypervisor typically manages virtual machines, allowing them to interact directly with the underlying hardware. System virtualization creates many virtual systems within a single physical system. Virtual systems are independent operating environments that use virtual resources. System virtualization can be approached through hardware partitioning or hypervisor technology. Hardware partitioning subdivides a physical server into fractions, each of which can run an operating system. These fractions are typically created with coarse units of allocation, such as whole processors or physical boards. This type of virtualization allows for hardware consolidation, but does not have the full benefits of resource sharing and emulation offered by hypervisors. Hypervisors use a thin layer of code in software or firmware to achieve fine-grained, dynamic resource sharing. Because hypervisors provide the greatest level of flexibility in how virtual resources are defined and managed, they are the primary technology for system virtualization.

Virtual Machine Monitor. A Virtual Machine Monitor (VMM) is computer software, firmware or hardware that creates and runs virtual machines. A computer on which a hypervisor runs one or more virtual machines is called a host machine, and each virtual machine is called a guest machine. The hypervisor presents the guest operating systems with a virtual operating platform and manages the execution of the guest operating systems. Multiple instances of a variety of operating systems may share the virtualized hardware resources: for example, Linux, Windows, and macOS instances can all run on a single physical x86 machine. This contrasts with operating-system-level virtualization, where all instances (usually called containers) must share a single kernel, though the guest operating systems can differ in user space, such as different Linux distributions with the same kernel. Typically, a VMM refers to a software that runs in a layer between a hypervisor or host operating system and one or more virtual machines that provides the virtual machines abstraction to the guest operating systems. With full virtualization, the VMM exports a virtual machine abstraction identical to the physical machine, so the standard operating system can run just as they would on physical hardware.

Hardware virtualization or platform virtualization refers to the creation of a virtual machine that acts like a real computer with an operating system. Software executed on these virtual machines is separated from the underlying hardware resources. In hardware virtualization, the host machine is the actual machine on which the virtualization takes place, and the guest machine is the virtual machine. The words host and guest are used to distinguish the software that runs on the physical machine from the software that runs on the virtual machine. The software or firmware that creates a virtual machine on the host hardware is called a hypervisor or Virtual Machine Manager. Different types of hardware virtualization include full-virtualization, where almost complete simulation of the actual hardware to allow software, which typically consists of a guest operating system, to run unmodified, and Para-virtualization, where a hardware environment is not simulated; however, the guest programs are executed in their own isolated domains, as if they are running on a separate system. Guest programs need to be specifically modified to run in this environment.

Hardware-assisted virtualization is a way of improving overall efficiency of virtualization. It involves CPUs that provide support for virtualization in hardware, and other hardware components that help improve the performance of a guest environment. Hardware virtualization can be viewed as part of an overall trend in enterprise IT that includes autonomic computing, a scenario in which the IT environment will be able to manage itself based on perceived activity, and utility computing, in which computer processing power is seen as a utility that clients can pay for only as needed. The usual goal of virtualization is to centralize administrative tasks while improving scalability and overall hardware-resource utilization. With virtualization, several operating systems can be run in parallel on a single central processing unit (CPU). This parallelism tends to reduce overhead costs and differs from multitasking, which involves running several programs on the same OS. Using virtualization, an enterprise can better manage updates and rapid changes to the operating system and applications without disrupting the user.

Server Virtualization. Server virtualization is a virtualization technique that involves partitioning a physical server into a number of small, virtual servers with the help of virtualization software. In server virtualization, each virtual server runs multiple operating system instances at the same time. A Virtual Private Server (VPS) is a virtual machine sold as a service by an Internet hosting service, that runs its own copy of an Operating System (OS), and customers may have superuser-level access to that operating system instance, so they can install almost any software that runs on that OS. For many purposes they are functionally equivalent to a dedicated physical server, and being software-defined, are able to be much more easily created and configured. They are typically priced much lower than an equivalent physical server. However, as they share the underlying physical hardware with other VPS's, performance may be lower, depending on the workload of any other executing virtual machines. Dedicated Servers may also be more efficient with CPU dependent processes such as hashing algorithms.

Application Virtualization. Application virtualization is software technology that encapsulates computer programs from the underlying operating system on which it is executed. A fully virtualized application is not installed in the traditional sense, although it is still executed as if it were. The application behaves at runtime like it is directly interfacing with the original operating system and all the resources managed by it, but can be isolated or sandboxed to varying degrees. Application virtualization is layered on top of other virtualization technologies, allowing computing resources to be distributed dynamically in real-time. In this context, the term “virtualization” commonly refers to the artifact being encapsulated (application), which is quite different from its meaning in hardware virtualization, where it refers to the artifact being abstracted (physical hardware).

Network Virtualization. Network Virtualization refers to the process of combining hardware and software network resources to create a single pool of resources that make up a virtual network that can be accessed without regard to the physical component. Network virtualization typically involves combining hardware and software network resources and network functionality into a single, software-based administrative entity, a virtual network. Network virtualization involves platform virtualization, often combined with resource virtualization. Network virtualization is categorized as either external virtualization, combining many networks or parts of networks into a virtual unit, or internal virtualization, providing network-like functionality to software containers on a single network server.

Storage Virtualization. Storage virtualization refers to the process of consolidating the physical storage from multiple network storage devices so that it appears to be a single storage unit. Within the context of a storage system, there are two primary types of virtualization that can occur: Block virtualization used in this context refers to the abstraction (separation) of logical storage (partition) from physical storage so that it may be accessed without regard to physical storage or heterogeneous structure. This separation allows the administrators of the storage system greater flexibility in how they manage storage for end users. File virtualization addresses the NAS challenges by eliminating the dependencies between the data accessed at the file level and the location where the files are physically stored. This provides opportunities to optimize storage use and server consolidation and to perform non-disruptive file migrations.

Desktop Virtualization. Desktop virtualization refers to the process of virtualizing desktop computers using virtualization software, such that the desktop computer and the associated operating system and applications are separated from the physical client device that is used to access it. Desktop virtualization is software technology that separates the desktop environment and associated application software from the physical client device that is used to access it.

Desktop virtualization can be used in conjunction with application virtualization and user profile management systems, now termed “user virtualization,” to provide a comprehensive desktop environment management system. In this mode, all the components of the desktop are virtualized, which allows for a highly flexible and much more secure desktop delivery model. In addition, this approach supports a more complete desktop disaster recovery strategy as all components are essentially saved in the data center and backed up through traditional redundant maintenance systems. If a user's device or hardware is lost, the restore is straightforward and simple, because the components will be present at login from another device. In addition, because no data is saved to the user's device, if that device is lost, there is much less chance that any critical data can be retrieved and compromised. Virtual Desktop Infrastructure (VDI)—The practice of hosting a desktop environment within a virtual machine that runs on a centralized or remote server.

An example of a virtualization architecture 500 is shown in FIG. 1b, where three virtual machines are exemplified. A Virtual Machine (VM) #1 510a provides virtualization for the application 501a that uses the guest OS 502a, which in turn interfaces with the virtual hardware 503a that emulates the actual hardware. Similarly, a Virtual Machine (VM) #2 510b provides virtualization for the application 501b that uses the guest OS 502b, which in turn interfaces with the virtual hardware 503b that emulates the associated actual hardware, and a Virtual Machine (VM) #3 510c provides virtualization for the application 501c that uses the guest OS 502c, which in turn interfaces with the virtual hardware 503c that emulates the associated actual hardware. The abstraction layer is provided by VMM 504, allowing of hardware-independence of operating system and applications, provisioning on any single physical system, and managing the applications and the OSs as a single encapsulated unit.

A hosted architecture 500a for virtualization is shown in FIG. 1c, where a wide range of actual host hardware 506 may be used by implementing a host operating system 505 layer between the actual hardware 506 and the VMM 504. Such configuration relies on the host OS 505 for device support and physical resource management. In contrast, a bare-metal architecture 500b is shown in FIG. 1d, where a hypervisor layer (in addition to, or as part of, the VMM 504) is used as the first layer, allowing the VMM 504 to have direct access to the hardware resources, hence providing more efficient, and greater scalability, robustness, and performance.

Cloud computing and virtualization is described in a book entitled “Cloud Computing and Virtualization” authored by Dac-Nhuong Le (Faculty of Information Technology, Haiphong University, Haiphong, Vietnam), Raghvendra Kumar (Department of Computer Science and Engineering, LNCT, Jabalpur, India), Gia Nhu Nguyen (Graduate School, Duy Tan University, Da Nang, Vietnam), and Jyotir Moy Chatterjee (Department of Computer Science and Engineering at GD-RCET, Bhilai, India), and published 2018 by John Wiley & Sons, Inc. [ISBN 978-1-119-48790-6], which is incorporated in its entirety for all purposes as if fully set forth herein. The book describes the adoption of virtualization in data centers creates the need for a new class of networks designed to support elasticity of resource allocation, increasing mobile workloads and the shift to production of virtual workloads, requiring maximum availability. Building a network that spans both physical servers and virtual machines with consistent capabilities demands a new architectural approach to designing and building the IT infrastructure. Performance, elasticity, and logical addressing structures must be considered as well as the management of the physical and virtual networking infrastructure. Once deployed, a network that is virtualization-ready can offer many revolutionary services over a common shared infrastructure. Virtualization technologies from VMware, Citrix and Microsoft encapsulate existing applications and extract them from the physical hardware. Unlike physical machines, virtual machines are represented by a portable software image, which can be instantiated on physical hardware at a moment's notice. With virtualization, comes elasticity where computer capacity can be scaled up or down on demand by adjusting the number of virtual machines actively executing on a given physical server. Additionally, virtual machines can be migrated while in service from one physical server to another.

Extending this further, virtualization creates “location freedom” enabling virtual machines to become portable across an ever-increasing geographical distance. As cloud architectures and multi-tenancy capabilities continue to develop and mature, there is an economy of scale that can be realized by aggregating resources across applications, business units, and separate corporations to a common shared, yet segmented, infrastructure. Elasticity, mobility, automation, and density of virtual machines demand new network architectures focusing on high performance, addressing portability, and the innate understanding of the virtual machine as the new building block of the data center. Consistent network-supported and virtualization-driven policy and controls are necessary for visibility to virtual machines' state and location as they are created and moved across a virtualized infrastructure.

Virtualization technologies in data center environments are described in a eBook authored by Gustavo Alessandro Andrade Santana and published 2014 by Cisco Systems, Inc. (Cisco Press) [ISBN-13: 978-1-58714-324-3] entitled: “Data Center Virtualization Fundamentals”, which is incorporated in its entirety for all purposes as if fully set forth herein. PowerVM technology for virtualization is described in IBM RedBook entitled: “IBM PowerVM Virtualization—Introduction and Configuration” published by IBM Corporation June 2013, and virtualization basics is described in a paper by IBM Corporation published 2009 entitled: “Power Systems—Introduction to virtualization”, which are both incorporated in their entirety for all purposes as if fully set forth herein.

Vehicle. A vehicle is a mobile machine that transports people or cargo. Most often, vehicles are manufactured, such as wagons, bicycles, motor vehicles (motorcycles, cars, trucks, buses), railed vehicles (trains, trams), watercraft (ships, boats), aircraft and spacecraft. The vehicle may be designed for use on land, in fluids, or be airborne, such as bicycle, car, automobile, motorcycle, train, ship, boat, submarine, airplane, scooter, bus, subway, train, or spacecraft. A vehicle may consist of, or may comprise, a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane. Further, a vehicle may be a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane.

A vehicle may be a land vehicle typically moving on the ground, using wheels, tracks, rails, or skies. The vehicle may be locomotion-based where the vehicle is towed by another vehicle or an animal. Propellers (as well as screws, fans, nozzles, or rotors) are used to move on or through a fluid or air, such as in watercrafts and aircrafts. The system described herein may be used to control, monitor or otherwise be part of, or communicate with, the vehicle motion system. Similarly, the system described herein may be used to control, monitor or otherwise be part of, or communicate with, the vehicle steering system. Commonly, wheeled vehicles steer by angling their front or rear (or both) wheels, while ships, boats, submarines, dirigibles, airplanes and other vehicles moving in or on fluid or air usually have a rudder for steering. The vehicle may be an automobile, defined as a wheeled passenger vehicle that carries its own motor, and primarily designed to run on roads, and have seating for one to six people. Typically, automobiles have four wheels, and are constructed to principally transport of people.

Human power may be used as a source of energy for the vehicle, such as in non-motorized bicycles. Further, energy may be extracted from the surrounding environment, such as solar powered car or aircraft, a street car, as well as by sailboats and land yachts using the wind energy. Alternatively or in addition, the vehicle may include energy storage, and the energy is converted to generate the vehicle motion. A common type of energy source is a fuel, and external or internal combustion engines are used to burn the fuel (such as gasoline, diesel, or ethanol) and create a pressure that is converted to a motion. Another common medium for storing energy are batteries or fuel cells, which store chemical energy used to power an electric motor, such as in motor vehicles, electric bicycles, electric scooters, small boats, subways, trains, trolleybuses, and trams.

Aircraft. An aircraft is a machine that is able to fly by gaining support from the air. It counters the force of gravity by using either static lift or by using the dynamic lift of an airfoil, or in a few cases, the downward thrust from jet engines. The human activity that surrounds aircraft is called aviation. Crewed aircraft are flown by an onboard pilot, but unmanned aerial vehicles may be remotely controlled or self-controlled by onboard computers. Aircraft may be classified by different criteria, such as lift type, aircraft propulsion, usage and others.

Aerostats are lighter than air aircrafts that use buoyancy to float in the air in much the same way that ships float on the water. They are characterized by one or more large gasbags or canopies filled with a relatively low-density gas such as helium, hydrogen, or hot air, which is less dense than the surrounding air. When the weight of this is added to the weight of the aircraft structure, it adds up to the same weight as the air that the craft displaces. Heavier-than-air aircraft, such as airplanes, must find some way to push air or gas downwards, so that a reaction occurs (by Newton's laws of motion) to push the aircraft upwards. This dynamic movement through the air is the origin of the term aerodyne. There are two ways to produce dynamic upthrust: aerodynamic lift and powered lift in the form of engine thrust.

Aerodynamic lift involving wings is the most common, with fixed-wing aircraft being kept in the air by the forward movement of wings, and rotorcraft by spinning wing-shaped rotors sometimes called rotary wings. A wing is a flat, horizontal surface, usually shaped in cross-section as an aerofoil. To fly, air must flow over the wing and generate lift. A flexible wing is a wing made of fabric or thin sheet material, often stretched over a rigid frame. A kite is tethered to the ground and relies on the speed of the wind over its wings, which may be flexible or rigid, fixed, or rotary.

Gliders are heavier-than-air aircraft that do not employ propulsion once airborne. Take-off may be by launching forward and downward from a high location, or by pulling into the air on a tow-line, either by a ground-based winch or vehicle, or by a powered “tug” aircraft. For a glider to maintain its forward air speed and lift, it must descend in relation to the air (but not necessarily in relation to the ground). Many gliders can ‘soar’—gain height from updrafts such as thermal currents. Common examples of gliders are sailplanes, hang gliders and paragliders. Powered aircraft have one or more onboard sources of mechanical power, typically aircraft engines although rubber and manpower have also been used. Most aircraft engines are either lightweight piston engines or gas turbines. Engine fuel is stored in tanks, usually in the wings but larger aircraft also have additional fuel tanks in the fuselage.

A propeller aircraft use one or more propellers (airscrews) to create thrust in a forward direction. The propeller is usually mounted in front of the power source in tractor configuration but can be mounted behind in pusher configuration. Variations of propeller layout include contra-rotating propellers and ducted fans. A Jet aircraft use airbreathing jet engines, which take in air, burn fuel with it in a combustion chamber, and accelerate the exhaust rearwards to provide thrust. Turbojet and turbofan engines use a spinning turbine to drive one or more fans, which provide additional thrust. An afterburner may be used to inject extra fuel into the hot exhaust, especially on military “fast jets”. Use of a turbine is not absolutely necessary: other designs include the pulse jet and ramjet. These mechanically simple designs cannot work when stationary, so the aircraft must be launched to flying speed by some other method. Some rotorcrafts, such as helicopters, have a powered rotary wing or rotor, where the rotor disc can be angled slightly forward so that a proportion of its lift is directed forwards. The rotor may, similar to a propeller, be powered by a variety of methods such as a piston engine or turbine. Experiments have also used jet nozzles at the rotor blade tips.

A vehicle may include a hood (a.k.a. bonnet), which is the hinged cover over the engine of motor vehicles that allows access to the engine compartment (or trunk on rear-engine and some mid-engine vehicles) for maintenance and repair. A vehicle may include a bumper, which is a structure attached, or integrated to, the front and rear of an automobile to absorb impact in a minor collision, ideally minimizing repair costs. Bumpers also have two safety functions: minimizing height mismatches between vehicles and protecting pedestrians from injury. A vehicle may include a cowling, which is the covering of a vehicle's engine, most often found on automobiles and aircraft. A vehicle may include a dashboard (also called dash, instrument panel, or fascia), which is a control panel placed in front of the driver of an automobile, housing instrumentation and controls for operation of the vehicle. A vehicle may include a fender that frames a wheel well (the fender underside). Its primary purpose is to prevent sand, mud, rocks, liquids, and other road spray from being thrown into the air by the rotating tire. Fenders are typically rigid and can be damaged by contact with the road surface. Instead, flexible mud flaps are used close to the ground where contact may be possible. A vehicle may include a quarter panel (a.k.a. rear wing), which is the body panel (exterior surface) of an automobile between a rear door (or only door on each side for two-door models) and the trunk (boot) and typically wraps around the wheel well. Quarter panels are typically made of sheet metal, but are sometimes made of fiberglass, carbon fiber, or fiber-reinforced plastic. A vehicle may include a rocker, which is the body section below the base of the door openings. A vehicle may include a spoiler, which is an automotive aerodynamic device whose intended design function is to ‘spoil’ unfavorable air movement across a body of a vehicle in motion, usually described as turbulence or drag. Spoilers on the front of a vehicle are often called air dams. Spoilers are often fitted to race and high-performance sports cars, although they have become common on passenger vehicles as well. Some spoilers are added to cars primarily for styling purposes and have either little aerodynamic benefit or even make the aerodynamics worse. The trunk (a.k.a. boot) of a car is the vehicle's main storage compartment. A vehicle door is a type of door, typically hinged, but sometimes attached by other mechanisms such as tracks, in front of an opening, which is used for entering and exiting a vehicle. A vehicle door can be opened to provide access to the opening, or closed to secure it. These doors can be opened manually, or powered electronically. Powered doors are usually found on minivans, high-end cars, or modified cars. Car glass includes windscreens, side and rear windows, and glass panel roofs on a vehicle. Side windows can be either fixed or be raised and lowered by depressing a button (power window) or switch or using a hand-turned crank.

Autonomous car. An autonomous car (also known as a driverless car, self-driving car, or robotic car) is a vehicle that is capable of sensing its environment and navigating without human input. Autonomous cars use a variety of techniques to detect their surroundings, such as radar, laser light, GPS, odometry, and computer vision. Advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination. Among the potential benefits of autonomous cars is a significant reduction in traffic collisions; the resulting injuries; and related costs, including a lower need for insurance. Autonomous cars are also predicted to offer major increases in traffic flow; enhanced mobility for children, the elderly, disabled and poor people; the relief of travelers from driving and navigation chores; lower fuel consumption; significantly reduced needs for parking space in cities; a reduction in crime; and the facilitation of different business models for mobility as a service, especially those involved in the sharing economy.

Modern self-driving cars generally use Bayesian Simultaneous Localization And Mapping (SLAM) algorithms, which fuse data from multiple sensors and an off-line map into current location estimates and map updates. SLAM with Detection and Tracking of other Moving Objects (DATMO), which also handles things such as cars and pedestrians, is a variant being developed by research at Google. Simpler systems may use roadside Real-Time Locating System (RTLS) beacon systems to aid localization. Typical sensors include LIDAR and stereo vision, GPS and IMU. Visual object recognition uses machine vision including neural networks.

The term ‘Dynamic driving task’ includes the operational (steering, braking, accelerating, monitoring the vehicle and roadway) and tactical (responding to events, determining when to change lanes, turn, use signals, etc.) aspects of the driving task, but not the strategic (determining destinations and waypoints) aspect of the driving task. The term ‘Driving mode’ refers to a type of driving scenario with characteristic dynamic driving task requirements (e.g., expressway merging, high speed, cruising, low speed traffic jam, closed-campus operations, etc.). The term ‘Request to intervene’ refers to notification by the automated driving system to a human driver that s/he should promptly begin or resume performance of the dynamic driving task.

The SAE International standard J3016, entitled: “Taxonomy and Definitions for Terms Related to On-Road Motor Vehicle Automated Driving Systems” [Revised 2016 September], which is incorporated in its entirety for all purposes as if fully set forth herein, describes six different levels (ranging from none to fully automated systems), based on the amount of driver intervention and attentiveness required, rather than the vehicle capabilities. The levels are further described in a table 20a in FIG. 2a. Level 0 refers to automated system issues warnings but has no vehicle control, while Level 1 (also referred to as “hands on”) refers to driver and automated system that shares control over the vehicle. An example would be Adaptive Cruise Control (ACC) where the driver controls steering and the automated system controls speed. Using Parking Assistance, steering is automated while speed is manual. The driver must be ready to retake full control at any time. Lane Keeping Assistance (LKA) Type II is a further example of level 1 self-driving.

In Level 2 (also referred to as “hands off”), the automated system takes full control of the vehicle (accelerating, braking, and steering). The driver must monitor the driving and be prepared to immediately intervene at any time if the automated system fails to respond properly. In Level 3 (also referred to as “eyes off”), the driver can safely turn their attention away from the driving tasks, e.g. the driver can text or watch a movie. The vehicle will handle situations that call for an immediate response, like emergency braking. The driver must still be prepared to intervene within some limited time, specified by the manufacturer, when called upon by the vehicle to do so. A key distinction is between level 2, where the human driver performs part of the dynamic driving task, and level 3, where the automated driving system performs the entire dynamic driving task. Level 4 (also referred to as “mind off”) is similar to level 3, but no driver attention is ever required for safety, i.e., the driver may safely go to sleep or leave the driver's seat. Self-driving is supported only in limited areas (geofenced) or under special circumstances, such as traffic jams. Outside of these areas or circumstances, the vehicle must be able to safely abort the trip, i.e., park the car, if the driver does not retake control. In Level 5 (also referred to as “wheel optional”), no human intervention is required. An example would be a robotic taxi.

An autonomous vehicle and systems having an interface for payloads that allows integration of various payloads with relative ease are disclosed in U.S. Patent Application Publication No. 2007/0198144 to Norris et al. entitled: “Networked multi-role robotic vehicle”, which is incorporated in its entirety for all purposes as if fully set forth herein. There is a vehicle control system for controlling an autonomous vehicle, receiving data, and transmitting a control signal on at least one network. A payload is adapted to detachably connect to the autonomous vehicle, the payload comprising a network interface configured to receive the control signal from the vehicle control system over the at least one network. The vehicle control system may encapsulate payload data and transmit the payload data over the at least one network, including Ethernet or CAN networks. The payload may be a laser scanner, a radio, a chemical detection system, or a Global Positioning System unit. In certain embodiments, the payload is a camera mast unit, where the camera communicates with the autonomous vehicle control system to detect and avoid obstacles. The camera mast unit may be interchangeable, and may include structures for receiving additional payload components.

Automotive electronics. Automotive electronics involves any electrically-generated systems used in vehicles, such as ground vehicles. Automotive electronics commonly involves multiple modular ECUs (Electronic Control Unit) connected over a network such as Engine Control Modules (ECM) or Transmission Control Modules (TCM). Automotive electronics or automotive embedded systems are distributed systems, and according to different domains in the automotive field, they can be classified into Engine electronics, Transmission electronics, Chassis electronics, Active safety, Driver assistance, Passenger comfort, and Entertainment (or infotainment) systems.

One of the most demanding electronic parts of an automobile is the Engine Control Unit. Engine controls demand one of the highest real time deadlines, as the engine itself is a very fast and complex part of the automobile. The computing power of the engine control unit is commonly the highest, typically a 32-bit processor, that typically controls in real-time in a diesel engine the Fuel injection rate, Emission control, NOx control, Regeneration of oxidation catalytic converter, Turbocharger control, Throttle control, and Cooling system control. In a gasoline engine, the engine control typically involves Lambda control, OBD (On-Board Diagnostics), Cooling system control, Ignition system control, Lubrication system control, Fuel injection rate control, and Throttle control.

An engine ECU typically connects to, or includes, sensors that actively monitor in real-time engine parameters such as pressure, temperature, flow, engine speed, oxygen level and NOx level, plus other parameters at different points within the engine. All these sensor signals are analyzed by the ECU, which has the logic circuits to do the actual controlling. The ECU output is commonly connected to different actuators for the throttle valve, EGR valve, rack (in VGTs), fuel injector (using a pulse-width modulated signal), dosing injector, and more.

Transmission electronics involves control of the transmission system, mainly the shifting of the gears for better shift comfort and to lower torque interrupt while shifting. Automatic transmissions use controls for their operation, and many semi-automatic transmissions having a fully automatic clutch or a semi-auto clutch (declutching only). The engine control unit and the transmission control typically exchange messages, sensor signals and control signals for their operation. Chassis electronics typically includes many sub-systems that monitor various parameters and are actively controlled, such as ABS—Anti-lock Braking System, TCS—Traction Control System, EBD—Electronic Brake Distribution, and ESP—Electronic Stability Program. Active safety systems involve modules that are ready-to-act when there is a collision in progress, or used to prevent it when it senses a dangerous situation, such as Air bags, Hill descent control, and Emergency brake assist system. Passenger comfort systems involve, for example, Automatic climate control, Electronic seat adjustment with memory, Automatic wipers, Automatic headlamps—adjusts beam automatically, and Automatic cooling—temperature adjustment. Infotainment systems include systems such as Navigation system, Vehicle audio, and Information access. Automotive electric and electronic technologies and systems are described in a book published by Robert Bosch GmbH (5^{th} Edition, July 2007) entitled: “Bosch Automotive Electric and Automotive Electronics” [ISBN—978-3-658-01783-5], which is incorporated in its entirety for all purposes as if fully set forth herein.

The automotive electronics is typically segmented to sub-systems (domains), such as powertrain, chassis, body and comfort, driver assistance/pedestrian safety, and Human-Machine Interface/Multimedia/Telematics, that may have full independent controls (whether mechanical, electrical, or computerized), or partial independence such as by having some control interaction.

The powertrain sub-system typically includes the group of components that generates the energy to power the vehicle on road. The system commonly includes the engine, transmission, shafts and wheels, but typically also includes many sensors, such as for measuring flow, pressure, speed, torque, angle, volume, position, and stability, for improving the ride, reduce pollution, increase efficiency, and improve safety. For example, the powertrain sub-system may control the right amount of fuel that is injected into the engine by using pressure sensors for measuring the fuel pressure to effect the timing of the ignition. Further, the engine timing may be optimized by the adjusting of the valve timing by using inputs from many sensors, such as the air mass in the intake manifold, fuel temperature, engine speed, accelerator pedal position, and engine torque. The powertrain sub-system typically involves low latencies (typically in microseconds) to get accurate results and fast control.

The chassis sub-system includes the internal framework that supports the powertrain, as well as components required for driving other than the engine-related parts, including brakes, steering, and suspension. The chassis sub-system typically involves exact timing requirements and controlled maximum latencies.

The body and comfort sub-system includes heating, air-conditioning, seat controls, windows controls, lights, etc. Such functionalities typically requires low-bandwidth and some latencies (typically in milliseconds). The driver assistance sub-system involves helping the driver in the driving process, and include in-vehicle navigation (such as by using GPS), cruise control, automatic parking, and ADAS. The driver/pedestrian safety involves increasing the safety for the driver, passengers, and pedestrians, and includes lane departure warning system, collision avoidance system, intelligent speed adaptation, driver drowsiness detection, and blind spot detection. These sub-systems typically include their own sensors and devices, which often interact with the other sub-systems in the vehicle. While these sub-systems may handle latencies of hundreds of microseconds, they typically require high bandwidth and large computing power.

The Human-Machine Interface (HMI) is used to facilitate interaction between humans in the vehicle and the vehicle electronics and subsystems. The information gathered from all other sub-systems is intuitively, and safely presented in a friendly, appealing, and usable fashion, and allows the driver and passengers to control the vehicle operation and infotainment systems. The HMI sub-system also connects to external devices via wireless (e.g., Bluetooth) or wired (USB) connections.

Vehicle bus. A vehicle bus is a specialized internal (in-vehicle) communications network that interconnects components inside a vehicle (e.g., automobile, bus, train, industrial or agricultural vehicle, ship, or aircraft). Special requirements for vehicle control such as assurance of message delivery, of non-conflicting messages, of minimum time of delivery, of low cost, and of EMF noise resilience, as well as redundant routing and other characteristics mandate the use of less common networking protocols. A vehicle bus typically connects the various ECUs in the vehicle. Common protocols include Controller Area Network (CAN), Local Interconnect Network (LIN) and others. Conventional computer networking technologies (such as Ethernet and TCP/IP) may as well be used.

Any in-vehicle internal network that interconnects the various devices and components inside the vehicle may use any of the technologies and protocols described herein. Common protocols used by vehicle buses include a Control Area Network (CAN), FlexRay, and a Local Interconnect Network (LIN). Other protocols used for in-vehicle are optimized for multimedia networking such as MOST (Media Oriented Systems Transport). The CAN is described in the Texas Instrument Application Report No. SLOA101A entitled: “Introduction to the Controller Area Network (CAN)”, and may be based on, may be compatible with, or may be according to, ISO 11898 standards, ISO 11992-1 standard, SAE J1939 or SAE J2411 standards, which are all incorporated in their entirety for all purposes as if fully set forth herein. The LIN communication may be based on, may be compatible with, or according to, ISO 9141, and is described in “LIN Specification Package—Revision 2.2A” by the LIN Consortium, which are all incorporated in their entirety for all purposes as if fully set forth herein. In one example, the DC power lines in the vehicle may also be used as the communication medium, as described for example in U.S. Pat. No. 7,010,050 to Maryanka, entitled: “Signaling over Noisy Channels”, which is incorporated in its entirety for all purposes as if fully set forth herein.

CAN. A controller area network (CAN bus) is a vehicle bus standard designed to allow microcontrollers and devices to communicate with each other in applications without a host computer. It is a message-based protocol, designed originally for multiplex electrical wiring within automobiles, but is also used in many other contexts. CAN bus is one of five protocols used in the on-board diagnostics (OBD)-II vehicle diagnostics standard. CAN is a multi-master serial bus standard for connecting Electronic Control Units [ECUs] also known as nodes. Two or more nodes are required on the CAN network to communicate. The complexity of the node can range from a simple I/O device up to an embedded computer with a CAN interface and sophisticated software. The node may also be a gateway allowing a standard computer to communicate over a USB or Ethernet port to the devices on a CAN network. All nodes are connected to each other through a two-wire bus. The wires are 120Ω nominal twisted pair. Implementing CAN is described in an Application Note (AN10035-0-2/12(0) Rev. 0) published 2012 by Analog Devices, Inc. entitled: “Controller Area Network (CAN) Implementation Guide—by Dr. Conal Watterson”, which is incorporated in its entirety for all purposes as if fully set forth herein.

CAN transceiver is defined by ISO 11898-2/3 Medium Access Unit [MAU] standards, and in receiving, converts the levels of the data stream received from the CAN bus to levels that the CAN controller uses. It usually has protective circuitry to protect the CAN controller, and in transmitting state converts the data stream from the CAN controller to CAN bus compliant levels. An example of a CAN transceiver is Model No. TJA1055 or Model No. TJA1044 both available from NXP Semiconductors N.V. headquartered in Eindhoven, Netherlands, respectively described in Product data sheets (document Identifier TJA1055, date of release: 6 Dec. 2013) entitled: “TJA1055 Enhanced fault-tolerant CAN transceiver—Rev. 5-6 December 2013—Product data sheet”, and Product data sheets (document Identifier TJA1055, date of release: 6 Dec. 2013) entitled: “TJA1044 High-speed CAN transceiver with Standby mode—Rev. 4-10 July 2015—Product data sheet”, which are both incorporated in their entirety for all purposes as if fully set forth herein.

Another example of a CAN Transceiver is Model No. SN65HVD234D available from Texas Instruments Incorporated (Headquartered in Dallas, Tex., U.S.A.), described in Datasheet SLLS557G (NOVEMBER 2002—REVISED JANUARY 2015), entitled: “SN65HVD23x 3.3-V CAN Bus Transceivers”, which is incorporated in its entirety for all purposes as if fully set forth herein. An example of a CAN controller is Model No. STM32F105Vc available from STMicroelectronics NV described in Datasheet Doc1D15724 Rev. 9, published September 2015 and entitled: “STM32F105xx STM32F107xx”, which is incorporated in its entirety for all purposes as if fully set forth herein, which is part of the STM32F105xx connectivity line family that incorporates the high-performance ARM®Cortex®-M3 32-bit RISC core operating at a 72 MHz frequency, high-speed embedded memories (Flash memory up to 256 Kbytes and SRAM 64 Kbytes), and an extensive range of enhanced I/Os and peripherals connected to two APB buses. All devices offer two 12-bit ADCs, four general-purpose 16-bit timers plus a PWM timer, as well as standard and advanced communication interfaces: up to two I2Cs, three SPIs, two I2Ss, five USARTs, an USB OTG FS and two CANs.

A Controller Area Network (CAN) transceiver is disclosed in U.S. Pat. No. 9,471,528 to Muth entitled: “Controller area network (CAN) transceiver and method for operating a CAN transceiver”, which is incorporated in its entirety for all purposes as if fully set forth herein. The CAN transceiver includes a CAN bus interface, a TXD interface, an RXD interface, a transmitter connected between the TXD interface and the CAN bus interface, a receiver connected between the RXD interface and the CAN bus interface, a traffic control system connected between the CAN bus interface, the TXD interface, and the RXD interface. The traffic control system detects the presence of CAN Flexible Data-rate (FD) traffic on the CAN bus interface and if the traffic control system detects the presence of CAN FD traffic on the CAN bus interface, the traffic controls system changes an operating state of the transceiver.

Embodiments of a device and method are disclosed in U.S. Pat. No. 9,330,045 to Muth et al. entitled: “Controller area network (CAN) device and method for controlling CAN traffic”, which is incorporated in its entirety for all purposes as if fully set forth herein. In an embodiment, a CAN device is disclosed. The CAN device includes a TXD input interface, a TXD output interface, an RXD input interface, an RXD output interface, and a traffic control system connected between the TXD input and output interfaces and between the RXD input and output interfaces. The traffic control system is configured to detect the presence of CAN Flexible Data-rate (FD) traffic on the RXD input interface and if the traffic control system detects the presence of CAN FD traffic on the RXD input interface, disconnect the RXD input interface from the RXD output interface and disconnect the TXD input interface from the TXD output interface.

A network node is disclosed in U.S. Pat. No. 9,280,501 to Hopfner entitled: “Compatible network node, in particular, for can bus systems”, which is incorporated in its entirety for all purposes as if fully set forth herein. The node including a device, in particular, an error detection logic, which is deactivated if it is detected that a signal according to a first protocol or a first version of a first protocol is received, and which is not deactivated if it is detected that a signal according to a second, different protocol or a second, different version of the first protocol is received.

Controller Area Network (CAN) communications apparatus and methods are presented in U.S. Pat. No. 9,652,423 to Monroe et al. entitled: “CAN and flexible data rate CAN node apparatus and methods for mixed bus CAN FD communications”, which is incorporated in its entirety for all purposes as if fully set forth herein. The apparatus and methods are for CAN flexible data rate (CAN FD) communications in a mixed CAN network with CAN FD nodes and one or more non-FD CAN nodes, in which a CAN FD node wishing to transmit CAN FD frames sends a first predefined message requesting the non-FD CAN nodes to disable their transmitters before transmitting the CAN FD frames, and thereafter sends a second predefined message or a predefined signal to return the non-FD CAN nodes to normal operation.

Each node is able to send and receive messages, but not simultaneously. A message or Frame consists primarily of the ID (identifier), which represents the priority of the message, and up to eight data bytes. A CRC, acknowledge slot [ACK] and other overhead are also part of the message. The improved CAN FD extends the length of the data section to up to 64 bytes per frame. The message is transmitted serially onto the bus using a non-return-to-zero (NRZ) format and may be received by all nodes. The devices that are connected by a CAN network are typically sensors, actuators, and other control devices. These devices are connected to the bus through a host processor, a CAN controller, and a CAN transceiver. A terminating bias circuit is power and ground provided together with the data signaling in order to provide electrical bias and termination at each end of each bus segment to suppress reflections.

CAN data transmission uses a lossless bit-wise arbitration method of contention resolution. This arbitration method requires all nodes on the CAN network to be synchronized to sample every bit on the CAN network at the same time. While some call CAN synchronous, the data is transmitted without a clock signal in an asynchronous format. The CAN specifications use the terms “dominant” bits and “recessive” bits where dominant is a logical ‘0’ (actively driven to a voltage by the transmitter) and recessive is a logical ‘1’ (passively returned to a voltage by a resistor). The idle state is represented by the recessive level (Logical 1). If one node transmits a dominant bit and another node transmits a recessive bit, then there is a collision and the dominant bit “wins”. This means there is no delay to the higher-priority message, and the node transmitting the lower priority message automatically attempts to re-transmit six bit clocks after the end of the dominant message. This makes CAN very suitable as a real time prioritized communications system.

The exact voltages for a logical level ‘0’ or ‘1’ depend on the physical layer used, but the basic principle of CAN requires that each node listen to the data on the CAN network including the data that the transmitting node is transmitting. If a logical 1 is transmitted by all transmitting nodes at the same time, then a logical 1 is seen by all of the nodes, including both the transmitting node(s) and receiving node(s). If a logical 0 is transmitted by all transmitting node(s) at the same time, then a logical 0 is seen by all nodes. If a logical 0 is being transmitted by one or more nodes, and a logical 1 is being transmitted by one or more nodes, then a logical 0 is seen by all nodes including the node(s) transmitting the logical 1. When a node transmits a logical 1 but sees a logical 0, it realizes that there is a contention and it quits transmitting. By using this process, any node that transmits a logical 1 when another node transmits a logical 0 “drops out” or loses the arbitration. A node that loses arbitration re-queues its message for later transmission and the CAN frame bit-stream continues without error until only one node is left transmitting. This means that the node that transmits the first 1, loses arbitration. Since the 11 (or 29 for CAN 2.0B) bit identifier is transmitted by all nodes at the start of the CAN frame, the node with the lowest identifier transmits more zeros at the start of the frame, and that is the node that wins the arbitration or has the highest priority.

The CAN protocol, like many networking protocols, can be decomposed into the following abstraction layers—Application layer, Object layer (including Message filtering and Message and status handling), and Transfer layer.

Most of the CAN standard applies to the transfer layer. The transfer layer receives messages from the physical layer and transmits those messages to the object layer. The transfer layer is responsible for bit timing and synchronization, message framing, arbitration, acknowledgement, error detection and signaling, and fault confinement. It performs Fault Confinement, Error Detection, Message Validation, Acknowledgement, Arbitration, Message Framing, Transfer Rate and Timing, and Information Routing.

The mechanical aspects of the physical layer (connector type and number, colors, labels, pin-outs) are not specified. As a result, an automotive ECU will typically have a particular—often custom—connector with various sorts of cables, of which two are the CAN bus lines. Nonetheless, several de facto standards for mechanical implementation have emerged, the most common being the 9-pin D-sub type male connector with the following pin-out: pin 2: CAN-Low (CAN−); pin 3: GND (Ground); pin 7: CAN-High (CAN+); and pin 9: CAN V+ (Power). This de facto mechanical standard for CAN could be implemented with the node having both male and female 9-pin D-sub connectors electrically wired to each other in parallel within the node. Bus power is fed to a node's male connector and the bus draws power from the node's female connector. This follows the electrical engineering convention that power sources are terminated at female connectors. Adoption of this standard avoids the need to fabricate custom splitters to connect two sets of bus wires to a single D connector at each node. Such nonstandard (custom) wire harnesses (splitters) that join conductors outside the node, reduce bus reliability, eliminate cable interchangeability, reduce compatibility of wiring harnesses, and increase cost.

Noise immunity on ISO 11898-2:2003 is achieved by maintaining the differential impedance of the bus at a low level with low-value resistors (120 ohms) at each end of the bus. However, when dormant, a low-impedance bus such as CAN draws more current (and power) than other voltage-based signaling buses. On CAN bus systems, balanced line operation, where current in one signal line is exactly balanced by current in the opposite direction in the other signal provides an independent, stable 0 V reference for the receivers. Best practice determines that CAN bus balanced pair signals be carried in twisted pair wires in a shielded cable to minimize RF emission and reduce interference susceptibility in the already noisy RF environment of an automobile. ISO 11898-2 provides some immunity to common mode voltage between transmitter and receiver by having a ‘0’ V rail running along the bus to maintain a high degree of voltage association between the nodes. Also, in the de facto mechanical configuration mentioned above, a supply rail is included to distribute power to each of the transceiver nodes. The design provides a common supply for all the transceivers. The actual voltage to be applied by the bus and which nodes apply to it are application-specific and not formally specified. Common practice node design provides each node with transceivers which are optically isolated from their node host and derive a 5 V linearly regulated supply voltage for the transceivers from the universal supply rail provided by the bus. This usually allows operating margin on the supply rail sufficient to allow interoperability across many node types. Typical values of supply voltage on such networks are 7 to 30 V. However, the lack of a formal standard means that system designers are responsible for supply rail compatibility.

ISO 11898-2 describes the electrical implementation formed from a multi-dropped single-ended balanced line configuration with resistor termination at each end of the bus. In this configuration, a dominant state is asserted by one or more transmitters switching the CAN− to supply 0 V and (simultaneously) switching CAN+ to the +5 V bus voltage thereby forming a current path through the resistors that terminate the bus. As such, the terminating resistors form an essential component of the signaling system and are included not just to limit wave reflection at high frequency. During a recessive state, the signal lines and resistor(s) remain in a high impedances state with respect to both rails. Voltages on both CAN+ and CAN− tend (weakly) towards ½ rail voltage. A recessive state is only present on the bus when none of the transmitters on the bus is asserting a dominant state. During a dominant state the signal lines and resistor(s) move to a low impedance state with respect to the rails so that current flows through the resistor. CAN+ voltage tends to +5 V and CAN− tends to 0 V. Irrespective of signal state the signal lines are always in low impedance state with respect to one another by virtue of the terminating resistors at the end of the bus. Multiple access on CAN bus is achieved by the electrical logic of the system supporting just two states that are conceptually analogous to a ‘wired OR’ network.

The CAN is standardized in a standards set ISO 11898 entitled: “Road vehicles—Controller area network (CAN)” that specifies physical and datalink layer (levels 1 and 2 of the ISO/OSI model) of serial communication technology called Controller Area Network that supports distributed real-time control and multiplexing for use within road vehicles

The standard ISO 11898-1:2015 entitled: “Part 1: Data link layer and physical signalling” specifies the characteristics of setting up an interchange of digital information between modules implementing the CAN data link layer. Controller area network is a serial communication protocol, which supports distributed real-time control and multiplexing for use within road vehicles and other control applications. The ISO 11898-1:2015 specifies the Classical CAN frame format and the newly introduced CAN Flexible Data Rate Frame format. The Classical CAN frame format allows bit rates up to 1 Mbit/s and payloads up to 8 byte per frame. The Flexible Data Rate frame format allows bit rates higher than 1 Mbit/s and payloads longer than 8 byte per frame. ISO 11898-1:2015 describes the general architecture of CAN in terms of hierarchical layers according to the ISO reference model for open systems interconnection (OSI) according to ISO/IEC 7498-1. The CAN data link layer is specified according to ISO/IEC 8802-2 and ISO/IEC 8802-3. ISO 11898-1:2015 contains detailed specifications of the following: logical link control sub-layer; medium access control sub-layer; and physical coding sub-layer.

The standard ISO 11898-2:2003 entitled: “Part 2: High-speed medium access unit” specifies the high-speed (transmission rates of up to 1 Mbit/s) medium access unit (MAU), and some medium dependent interface (MDI) features (according to ISO 8802-3), which comprise the physical layer of the controller area network (CAN): a serial communication protocol that supports distributed real-time control and multiplexing for use within road vehicles.

The standard ISO 11898-3:2006 entitled: “Part 3: Low-speed, fault-tolerant, medium-dependent interface” specifies characteristics of setting up an interchange of digital information between electronic control units of road vehicles equipped with the controller area network (CAN) at transmission rates above 40 kBit/s up to 125 kBit/s.

The standard ISO 11898-4:2004 entitled: “Part 4: Time-triggered communication” specifies time-triggered communication in the controller area network (CAN): a serial communication protocol that supports distributed real-time control and multiplexing for use within road vehicles. It is applicable to setting up a time-triggered interchange of digital information between electronic control units (ECU) of road vehicles equipped with CAN, and specifies the frame synchronization entity that coordinates the operation of both logical link and media access controls in accordance with ISO 11898-1, to provide the time-triggered communication schedule.

The standard ISO 11898-5:2007 entitled: “Part 5: High-speed medium access unit with low-power mode” specifies the CAN physical layer for transmission rates up to 1 Mbit/s for use within road vehicles. It describes the medium access unit functions as well as some medium dependent interface features according to ISO 8802-2. ISO 11898-5:2007 represents an extension of ISO 11898-2, dealing with new functionality for systems requiring low-power consumption features while there is no active bus communication. Physical layer implementations according to ISO 11898-5:2007 are compliant with all parameters of ISO 11898-2, but are defined differently within ISO 11898-5:2007. Implementations according to ISO 11898-5:2007 and ISO 11898-2 are interoperable and can be used at the same time within one network.

The standard ISO 11898-6:2013 entitled: “Part 6: High-speed medium access unit with selective wake-up functionality” specifies the controller area network (CAN) physical layer for transmission rates up to 1 Mbit/s. It describes the medium access unit (MAU) functions. ISO 11898-6:2013 represents an extension of ISO 11898-2 and ISO 11898-5, specifying a selective wake-up mechanism using configurable CAN frames. Physical layer implementations according to ISO 11898-6:2013 are compliant with all parameters of ISO 11898-2 and ISO 11898-5. Implementations according to ISO 11898-6:2013, ISO 11898-2 and ISO 11898-5 are interoperable and can be used at the same time within one network.

The standard ISO 11992-1:2003 entitled: “Road vehicles—Interchange of digital information on electrical connections between towing and towed vehicles—Part 1: Physical and data-link layers” specifies the interchange of digital information between road vehicles with a maximum authorized total mass greater than 3 500 kg, and towed vehicles, including communication between towed vehicles in terms of parameters and requirements of the physical and data link layer of the electrical connection used to connect the electrical and electronic systems. It also includes conformance tests of the physical layer.

The standard ISO 11783-2:2012 entitled: “Tractors and machinery for agriculture and forestry—Serial control and communications data network—Part 2: Physical layer” specifies a serial data network for control and communications on forestry or agricultural tractors and mounted, semi-mounted, towed or self-propelled implements. Its purpose is to standardize the method and format of transfer of data between sensors, actuators, control elements and information storage and display units, whether mounted on, or part of, the tractor or implement, and to provide an open interconnect system for electronic systems used by agricultural and forestry equipment. ISO 11783-2:2012 defines and describes the network 250 kbit/s, twisted, non-shielded, quad-cable physical layer. ISO 11783-2 uses four unshielded twisted wires; two for CAN and two for terminating bias circuit (TBC) power and ground. This bus is used on agricultural tractors. It is intended to provide interconnectivity between the tractor and any agricultural implement adhering to the standard.

The standard J1939/11_201209 entitled: “Physical Layer, 250 Kbps, Twisted Shielded Pair” defines a physical layer having a robust immunity to EMI and physical properties suitable for harsh environments. These SAE Recommended Practices are intended for light- and heavy-duty vehicles on- or off-road as well as appropriate stationary applications which use vehicle derived components (e.g., generator sets). Vehicles of interest include but are not limited to: on- and off-highway trucks and their trailers; construction equipment; and agricultural equipment and implements.

The standard SAE J1939/15_201508 entitled: “Physical Layer, 250 Kbps, Un-Shielded Twisted Pair (UTP)” describes a physical layer utilizing Unshielded Twisted Pair (UTP) cable with extended stub lengths for flexibility in ECU placement and network topology. CAN controllers are now available which support the newly introduced CAN Flexible Data Rate Frame format (known as “CAN FD”). These controllers, when used on SAE J1939-15 networks, must be restricted to use only the Classical Frame format compliant to ISO 11898-1 (2003).

The standard SAE J2411_200002 entitled: “Single Wire Can Network for Vehicle Applications” defines the Physical Layer and portions of the Data Link Layer of the OSI model for data communications. In particular, this document specifies the physical layer requirements for any Carrier Sense Multiple Access/Collision Resolution (CSMA/CR) data link which operates on a single wire medium to communicate among Electronic Control Units (ECU) on road vehicles. Requirements stated in this document will provide a minimum standard level of performance to which all compatible ECUs and media shall be designed. This will assure full serial data communication among all connected devices regardless of the supplier. This document is to be referenced by the particular vehicle OEM Component Technical Specification which describes any given ECU, in which the single wire data link controller and physical layer interface is located. Primarily, the performance of the physical layer is specified in this document.

A specification for CAN FD (CAN with Flexible Data-Rate) version 1.0 was released on Apr. 17, 2012 by Robert Bosch GmbH entitled: “CAN with Flexible Data-Rate Specification Version 1.0)”, and is incorporated in its entirety for all purposes as if fully set forth herein. This specification uses a different frame format that allows a different data length as well as optionally switching to a faster bit rate after the arbitration is decided. CAN FD is compatible with existing CAN 2.0 networks so new CAN FD devices can coexist on the same network with existing CAN devices. CAN FD is further described in iCC 2013 CAN in Automation articles by Florian Hatwich entitled: “Bit Time Requirements for CAN FD” and “Can with Flexible Data-Rate”, and in National Instruments article published Aug. 1, 2014 entitled: “Understanding CAN with Flexible Data-Rate (CAN FD)”, which are all incorporated in their entirety for all purposes as if fully set forth herein. In one example, the CAN FD interface is based on, compatible with, or uses, the SPC57EM80 controller device available from STMicroelectronics described in an Application Note AN4389 (document number DocD025493 Rev 2) published 2014 entitled: “SPC57472/SPC57EM80 Getting Started”, which is incorporated in its entirety for all purposes as if fully set forth herein. Further, a CAN FD transceiver may be based on, compatible with, or use, transceiver model MCP2561/2FD available from Microchip Technology Inc., described in a data sheet DS20005284A published 2014 [ISBN—978-1-63276-020-3] entitled: “MCP2561/2FD—High-Speed CAN Flexible Data Rate Transceiver”, which is incorporated in its entirety for all purposes as if fully set forth herein.

LIN. LIN (Local Interconnect Network) is a serial network protocol used for communication between components in vehicles. The LIN communication may be based on, compatible with, or is according to, ISO 9141, and is described in “LIN Specification Package—Revision 2.2A” by the LIN Consortium (dated Dec. 31, 2010), which is incorporated in its entirety for all purposes as if fully set forth herein. The LIN standard is further standardized as part of ISO 17987-1 to 17987-7 standards. LIN may be used also over the vehicle's battery power-line with a special DC-LIN transceiver. LIN is a broadcast serial network comprising 16 nodes (one master and typically up to 15 slaves). All messages are initiated by the master with at most one slave replying to a given message identifier. The master node can also act as a slave by replying to its own messages, and since all communications are initiated by the master it is not necessary to implement a collision detection. The master and slaves are typically microcontrollers, but may be implemented in specialized hardware or ASICs in order to save cost, space, or power. Current uses combine the low-cost efficiency of LIN and simple sensors to create small networks that can be connected by a backbone network. (i.e., CAN in cars).

The LIN bus is an inexpensive serial communications protocol, which effectively supports remote application within a car's network, and is particularly intended for mechatronic nodes in distributed automotive applications, but is equally suited to industrial applications. The protocol's main features are single master, up to 16 slaves (i.e. no bus arbitration), Slave Node Position Detection (SNPD) that allows node address assignment after power-up, Single wire communications up to 19.2 kbit/s @ 40 meter bus length (in the LIN specification 2.2 the speed up to 20 kbit/s), Guaranteed latency times, Variable length of data frame (2, 4 and 8 byte), Configuration flexibility, Multi-cast reception with time synchronization, without crystals or ceramic resonators, Data checksum and error detection, Detection of defective nodes, Low cost silicon implementation based on standard UART/SCI hardware, Enabler for hierarchical networks, and Operating voltage of 12 V. LIN is further described in U.S. Pat. No. 7,091,876 to Steger entitled: “Method for Addressing the Users of a Bus System by Means of Identification Flows”, which is incorporated in its entirety for all purposes as if fully set forth herein.

Data is transferred across the bus in fixed form messages of selectable lengths. The master task transmits a header that consists of a break signal followed by synchronization and identifier fields. The slaves respond with a data frame that consists of between 2, 4 and 8 data bytes plus 3 bytes of control information. The LIN uses Unconditional Frames, Event-triggered Frames, Sporadic Frames, Diagnostic Frames, User-Defined Frames, and Reserved Frames.

Unconditional Frames always carry signals and their identifiers are in the range 0 to 59 (0x00 to 0x3b) and all subscribers of the unconditional frame shall receive the frame and make it available to the application (assuming no errors were detected), and Event-triggered Frame, to increase the responsiveness of the LIN cluster without assigning too much of the bus bandwidth to the polling of multiple slave nodes with seldom occurring events. The first data byte of the carried unconditional frame shall be equal to a protected identifier assigned to an event-triggered frame. A slave shall reply with an associated unconditional frame only if its data value has changed. If none of the slave tasks responds to the header, the rest of the frame slot is silent and the header is ignored. If more than one slave task responds to the header in the same frame slot a collision will occur, and the master has to resolve the collision by requesting all associated unconditional frames before requesting the event-triggered frame again. Sporadic Frame is transmitted by the master as required, so a collision cannot occur. The header of a sporadic frame shall only be sent in its associated frame slot when the master task knows that a signal carried in the frame has been updated. The publisher of the sporadic frame shall always provide the response to the header. A Diagnostic Frame always carries diagnostic or configuration data and they always contain eight data bytes. The identifier is either 60 (0x3C), called master request frame, or 61 (0x3D), called slave response frame. Before generating the header of a diagnostic frame, the master task asks its diagnostic module if it shall be sent or if the bus shall be silent. The slave tasks publish and subscribe to the response according to their diagnostic module. User-Defined Frame carry any kind of information. Their identifier is 62 (0x3E). The header of a user-defined frame is usually transmitted when a frame slot allocated to the frame is processed. Reserved Frame are not be used in a LIN 2.0 cluster, and their identifier is 63 (0x3F).

The LIN specification was designed to allow very cheap hardware-nodes being used within a network. The LIN specification is based on ISO 9141:1989 standard entitled: “Road vehicles—Diagnostic systems—Requirements for interchange of digital information” that Specifies the requirements for setting up the interchange of digital information between on-board Electronic Control Units (ECUs) of road vehicles and suitable diagnostic testers. This communication is established in order to facilitate inspection, test diagnosis and adjustment of vehicles, systems and ECUs. It does not apply when system-specific diagnostic test equipment is used. The LIN specification is further based on ISO 9141-2:1994 standard entitled: “Road vehicles—Diagnostic systems—Part 2: GARB requirements for interchange of digital information” that involves vehicles with nominal 12 V supply voltage, describes a subset of ISO 9141:1989, and specifies the requirements for setting-up the interchange of digital information between on-board emission-related electronic control units of road vehicles and the SAE OBD II scan tool as specified in SAE J1978. It is a low-cost, single-wire network, where microcontrollers with either UART capability or dedicated LIN hardware are used. The microcontroller generates all needed LIN data by software and is connected to the LIN network via a LIN transceiver (simply speaking, a level shifter with some add-ons). Working as a LIN node is only part of the possible functionality. The LIN hardware may include this transceiver and works as a pure LIN node without added functionality. As LIN Slave nodes should be as cheap as possible, they may generate their internal clocks by using RC oscillators instead of crystal oscillators (quartz or a ceramic). To ensure the baud rate-stability within one LIN frame, the SYNC field within the header is used. An example of a LIN transceiver is IC Model No. 33689D available from Freescale Semiconductor, Inc. described in a data-sheet Document Number MC33689 Rev. 8.0 (dated September 2012) entitled: “System Basis Chip with LIN Transceiver”, which is incorporated in its entirety for all purposes as if fully set forth herein.

The LIN-Master uses one or more predefined scheduling tables to start the sending and receiving to the LIN bus. These scheduling tables contain at least the relative timing, where the message sending is initiated. One LIN Frame consists of the two parts header and response. The header is always sent by the LIN Master, while the response is sent by either one dedicated LIN-Slave or the LIN master itself. Transmitted data within the LIN is transmitted serially as eight-bit data bytes with one start & stop-bit and no parity. Bit rates vary within the range of 1 kbit/s to 20 kbit/s. Data on the bus is divided into recessive (logical HIGH) and dominant (logical LOW). The time normal is considered by the LIN Masters stable clock source, the smallest entity is one bit time (52 μs @ 19.2 kbit/s).

Two bus states—Sleep-mode and active—are used within the LIN protocol. While data is on the bus, all LIN-nodes are requested to be in active state. After a specified timeout, the nodes enter Sleep mode and will be released back to active state by a WAKEUP frame. This frame may be sent by any node requesting activity on the bus, either the LIN Master following its internal schedule, or one of the attached LIN Slaves being activated by its internal software application. After all nodes are awakened, the Master continues to schedule the next Identifier.

MOST. MOST (Media Oriented Systems Transport) is a high-speed multimedia network technology optimized for use in automotive applications, and may be used for applications inside or outside the car. The serial MOST bus uses a ring topology and synchronous data communication to transport audio, video, voice and data signals via plastic optical fiber (POF) (MOST25, MOST150) or electrical conductor (MOST50, MOST150) physical layers. The MOST specification defines the physical and the data link layer as well as all seven layers of the ISO/OSI-Model of data communication. Standardized interfaces simplify the MOST protocol integration in multimedia devices. For the system developer, MOST is primarily a protocol definition. It provides the user with a standardized interface (API) to access device functionality, and the communication functionality is provided by driver software known as MOST Network Services. MOST Network Services include Basic Layer System Services (Layer 3, 4, 5) and Application Socket Services (Layer 6). They process the MOST protocol between a MOST Network Interface Controller (NIC), which is based on the physical layer, and the API (Layer 7).

A MOST network is able to manage up to 64 MOST devices in a ring configuration. Plug and play functionality allows MOST devices to be easily attached and removed. MOST networks can also be set up in virtual star network or other topologies. Safety critical applications use redundant double ring configurations. In a MOST network, one device is designated the timing master, used to continuously supply the ring with MOST frames. A preamble is sent at the beginning of the frame transfer. The other devices, known as timing followers, use the preamble for synchronization. Encoding based on synchronous transfer allows constant post-sync for the timing followers.

MOST25 provides a bandwidth of approximately 23 megabaud for streaming (synchronous) as well as package (asynchronous) data transfer over an optical physical layer. It is separated into 60 physical channels. The user can select and configure the channels into groups of four bytes each. MOST25 provides many services and methods for the allocation (and deallocation) of physical channels. MOST25 supports up to 15 uncompressed stereo audio channels with CD-quality sound or up to 15 MPEG-1 channels for audio/video transfer, each of which uses four Bytes (four physical channels). MOST also provides a channel for transferring control information. The system frequency of 44.1 kHz allows a bandwidth of 705.6 kbit/s, enabling 2670 control messages per second to be transferred. Control messages are used to configure MOST devices and configure synchronous and asynchronous data transfer. The system frequency closely follows the CD standard. Reference data can also be transferred via the control channel. Some limitations restrict MOST25's effective data transfer rate to about 10 kB/s. Because of the protocol overhead, the application can use only 11 of 32 bytes at segmented transfer and a MOST node can only use one third of the control channel bandwidth at any time.

MOST50 doubles the bandwidth of a MOST25 system and increases the frame length to 1024 bits. The three established channels (control message channel, streaming data channel, packet data channel) of MOST25 remain the same, but the length of the control channel and the sectioning between the synchronous and asynchronous channels are flexible. Although MOST50 is specified to support both optical and electrical physical layers, the available MOST50 Intelligent Network Interface Controllers (INICs) only support electrical data transfer via Unshielded Twisted Pair (UTP).

MOST150 was introduced in October 2007 and provides a physical layer to implement Ethernet in automobiles. It increases the frame length up to 3072 bits, which is about 6 times the bandwidth of MOST25. It also integrates an Ethernet channel with adjustable bandwidth in addition to the three established channels (control message channel, streaming data channel, packet data channel) of the other grades of MOST. MOST150 also permits isochronous transfer on the synchronous channel. Although the transfer of synchronous data requires a frequency other than the one specified by the MOST frame rate, it is also possible with MOST150. MOST150's advanced functions and enhanced bandwidth will enable a multiplex network infrastructure capable of transmitting all forms of infotainment data, including video, throughout an automobile. The optical transmission layer uses Plastic Optical Fibers (POF) with a core diameter of 1 mm as transmission medium, in combination with light emitting diodes (LEDs) in the red wavelength range as transmitters. MOST25 only uses an optical Physical Layer. MOST50 and MOST150 support both optical and electrical Physical Layers.

The MOST protocol is described in a book published 2011 by Franzis Verlag Gmbh [ISBN—978-3-645-65061-8] edited by Prof. Dr. Ing. Andreas Grzemba entitled: “MOST—The Automotive Multimedia Network—From MOST25 to MOST 150”, in MOST Dynamic Specification by MOST Cooperation Rev. 3.0.2 dated October 2012 entitled: “MOST—Multimedia and Control Networking Technology”, and in MOST Specification Rev. 3.0 E2 dated July 2010 by MOST Cooperation, which are all incorporated in their entirety for all purposes as if fully set forth herein.

MOST Interfacing may use a MOST transceiver, such as IC model No. OS81118 available from Microchip Technology Incorporated (headquartered in Chandler, Ariz., U.S.A.) and described in a data sheet DS00001935A published 2015 by Microchip Technology Incorporated entitled: “MOST150 INIC with USB 2.0 Device Port”, or IC model No. OS8104A also available from Microchip Technology Incorporated and described in a data sheet PFL_OS8104A_V01_00_XX-4.fm published August 2007 by Microchip Technology Incorporated entitled: “MOST Network Interface Controller”, which are both incorporated in their entirety for all purposes as if fully set forth herein.

FlexRay. FlexRay™ is an automotive network communications protocol developed by the FlexRay Consortium to govern on-board automotive computing. The FlexRay consortium disbanded in 2009, but the FlexRay standard is described in a set of ISO standards, ISO 17458 entitled: “Road vehicles—FlexRay communications system”, including ISO 17458-1:2013 standard entitled: “Part 1: General information and use case definition”, ISO 17458-2:2013 standard entitled: “Part 2: Data link layer specification”, ISO 17458-3:2013 standard entitled: “Part 3: Data link layer conformance test specification”, ISO 17458-4:2013 standard entitled: “Part 4: Electrical physical layer specification”, and ISO 17458-5:2013 standard entitled: “Part 5: Electrical physical layer conformance test specification”.

FlexRay supports high data rates, up to 10 Mbit/s, explicitly supports both star and “party line” bus topologies, and can have two independent data channels for fault-tolerance (communication can continue with reduced bandwidth if one channel is inoperative). The bus operates on a time cycle, divided into two parts: the static segment and the dynamic segment. The static segment is pre-allocated into slices for individual communication types, providing a stronger real-time guarantee than its predecessor CAN. The dynamic segment operates more like CAN, with nodes taking control of the bus as available, allowing event-triggered behavior. FlexRay specification Version 3.0.1 is described in FlexRay consortium October 2010 publication entitled: “FlexRay Communications System—Protocol Specification—Version 3.0.1”, which is incorporated in its entirety for all purposes as if fully set forth herein. The FlexRay physical layer is described in Carl Hanser Verlag Gmbh 2010 publication (Automotive 2010) by Lorenz, Steffen entitled: “The FlexRay Electrical Physical Layer Evolution”, and in National Instruments Corporation Technical Overview Publication (Aug. 21, 2009) entitled: “FlexRay Automotive Communication Bus Overview”, which are both incorporated in their entirety for all purposes as if fully set forth herein.

FlexRay system consists of a bus and processors (Electronic control unit, or ECUs), where each ECU has an independent clock. The clock drift must be not more than 0.15% from the reference clock, so the difference between the slowest and the fastest clock in the system is no greater than 0.3%. At each time, only one ECU writes to the bus, and each bit to be sent is held on the bus for 8 sample clock cycles. The receiver keeps a buffer of the last 5 samples, and uses the majority of the last 5 samples as the input signal. Single-cycle transmission errors may affect results near the boundary of the bits, but will not affect cycles in the middle of the 8-cycle region. The value of the bit is sampled in the middle of the 8-bit region. The errors are moved to the extreme cycles, and the clock is synchronized frequently enough for the drift to be small (Drift is smaller than 1 cycle per 300 cycles, and during transmission the clock is synchronized more than once every 300 cycles). An example of a FlexRay transceiver is model TJA1080A available from NXP Semiconductors N.V. headquartered in Eindhoven, Netherlands, described in Product data sheet (document Identifier TJA1080A, date of release: 28 Nov. 2012) entitled: “TJA1080A FlexRay Transceiver—Rev. 6-28 November 2012—Product data sheet”, which is incorporated in its entirety for all purposes as if fully set forth herein.

Further, the vehicular communication system employed may be used so that vehicles may communicate and exchange information with other vehicles and with roadside units, may allow for cooperation and may be effective in increasing safety such as sharing safety information, safety warnings, as well as traffic information, such as to avoid traffic congestion. In safety applications, vehicles that discover an imminent danger or obstacle in the road may inform other vehicles directly, via other vehicles serving as repeaters, or via roadside units. Further, the system may help in deciding right to pass first at intersections, and may provide alerts or warning about entering intersections, departing highways, discovery of obstacles, and lane change warnings, as well as reporting accidents and other activities in the road. The system may be used for traffic management, allowing for easy and optimal traffic flow control, in particular in the case of specific situations such as hot pursuits and bad weather. The traffic management may be in the form of variable speed limits, adaptable traffic lights, traffic intersection control, and accommodating emergency vehicles such as ambulances, fire trucks and police cars.

The vehicular communication system may further be used to assist the drivers, such as helping with parking a vehicle, cruise control, lane keeping, and road sign recognition. Similarly, better policing and enforcement may be obtained by using the system for surveillance, speed limit warning, restricted entries, and pull-over commands. The system may be integrated with pricing and payment systems such as toll collection, pricing management, and parking payments. The system may further be used for navigation and route optimization, as well as providing travel-related information such as maps, business location, gas stations, and car service locations. Similarly, the system may be used for emergency warning system for vehicles, cooperative adaptive cruise control, cooperative forward collision warning, intersection collision avoidance, approaching emergency vehicle warning (Blue Waves), vehicle safety inspection, transit or emergency vehicle signal priority, electronic parking payments, commercial vehicle clearance and safety inspections, in-vehicle signing, rollover warning, probe data collection, highway-rail intersection warning, and electronic toll collection.

OBD. On-Board Diagnostics (OBD) refers to a vehicle's self-diagnostic and reporting capability. OBD systems give the vehicle owner or repair technician access to the status of the various vehicle subsystems. Modern OBD implementations use a standardized digital communications port to provide real-time data in addition to a standardized series of diagnostic trouble codes, or DTCs, which allow one to rapidly identify and remedy malfunctions within the vehicle. Keyword Protocol 2000, abbreviated KWP2000, is a communications protocol used for on-board vehicle diagnostics systems (OBD). This protocol covers the application layer in the OSI model of computer networking. KWP2000 also covers the session layer in the OSI model, in terms of starting, maintaining and terminating a communications session, and the protocol is standardized by International Organization for Standardization as ISO 14230.

One underlying physical layer used for KWP2000 is identical to ISO 9141, with bidirectional serial communication on a single line called the K-line. In addition, there is an optional L-line for wakeup. The data rate is between 1.2 and 10.4 kilobaud, and a message may contain up to 255 bytes in the data field. When implemented on a K-line physical layer, KWP2000 requires special wakeup sequences: 5-baud wakeup and fast-initialization. Both of these wakeup methods require timing critical manipulation of the K-line signal, and are therefore not easy to reproduce without custom software. KWP2000 is also compatible on ISO 11898 (Controller Area Network) supporting higher data rates of up to 1 Mbit/s. CAN is becoming an increasingly popular alternative to K-line because the CAN bus is usually present in modern-day vehicles and thus removing the need to install an additional physical cable. Using KWP2000 on CAN with ISO 15765 Transport/Network layers is most common. Also using KWP2000 on CAN does not require the special wakeup functionality.

KWP2000 can be implemented on CAN using just the service layer and session layer (no header specifying length, source and target addresses is used and no checksum is used); or using all layers (header and checksum are encapsulated within a CAN frame). However using all layers is overkill, as ISO 15765 provides its own Transport/Network layers.

ISO 14230-1:2012 entitled: “Road vehicles—Diagnostic communication over K-Line (DoK-Line)—Part 1: Physical layer”, which is incorporated in its entirety for all purposes as if fully set forth herein, specifies the physical layer, based on ISO 9141, on which the diagnostic services will be implemented. It is based on the physical layer described in ISO 9141-2, but expanded to allow for road vehicles with either 12 V DC or 24 V DC voltage supply.

ISO 14230-2:2013 entitled: “Road vehicles—Diagnostic communication over K-Line (DoK-Line)—Part 2: Data link layer”, which is incorporated in its entirety for all purposes as if fully set forth herein, specifies data link layer services tailored to meet the requirements of UART-based vehicle communication systems on K-Line as specified in ISO 14230-1. It has been defined in accordance with the diagnostic services established in ISO 14229-1 and ISO 15031-5, but is not limited to use with them, and is also compatible with most other communication needs for in-vehicle networks. The protocol specifies an unconfirmed communication. The diagnostic communication over K-Line (DoK-Line) protocol supports the standardized service primitive interface as specified in ISO 14229-2. ISO 14230-2:2013 provides the data link layer services to support different application layer implementations like: enhanced vehicle diagnostics (emissions-related system diagnostics beyond legislated functionality, non-emissions-related system diagnostics); emissions-related OBD as specified in ISO 15031, SAE J1979-DA, and SAE J2012-DA. In addition, ISO 14230-2:2013 clarifies the differences in initialization for K-line protocols defined in ISO 9141 and ISO 14230. This is important since a server supports only one of the protocols mentioned above and the client has to handle the coexistence of all protocols during the protocol-determination procedure.

The application layer is described in ISO 14230-3:1999 entitled: “Road vehicles—Diagnostic systems—Keyword Protocol 2000—Part 3: Application layer”, and the requirements for emission-related systems are described in ISO 14230-4:2000 entitled: “Road vehicles—Diagnostic systems—Keyword Protocol 2000—Part 4: Requirements for emission-related systems”, which are both incorporated in their entirety for all purposes as if fully set forth herein.

Avionics bus. A vehicle bus may consist of, or may comprise, an avionics bus, used as a data bus in military, commercial and advanced models of civilian aircraft. Common avionics data bus protocols, with their primary application, include Aircraft Data Network (ADN) that is an Ethernet derivative for Commercial Aircraft, Avionics Full-Duplex Switched Ethernet (AFDX) that is a specific implementation of ARINC 664 (ADN) for Commercial Aircraft, ARINC 429: “Generic Medium-Speed Data Sharing for Private and Commercial Aircraft”, ARINC 664, ARINC 629 used in Commercial Aircraft (such as Boeing 777), ARINC 708: “Weather Radar for Commercial Aircraft”, ARINC 717: “Flight Data Recorder for Commercial Aircraft”, ARINC 825 that is a CAN bus for commercial aircraft (for example Boeing 787 and Airbus A350), IEEE 1394b used in some Military Aircraft, MIL-STD-1553 and MIL-STD-1760 for Military Aircraft, and Time-Triggered Protocol (TTP): Boeing 787 Dreamliner, Airbus A380, Fly-By-Wire Actuation Platforms from Parker Aerospace.

MIL-STD-1553. MIL-STD-1553 is a military standard published by the United States Department of Defense that defines the mechanical, electrical, and functional characteristics of a serial data bus. It was originally designed as an avionic data bus for use with military avionics, but has also become commonly used in spacecraft on-board data handling (OBDH) subsystems, both military and civil. It features multiple (commonly dual) redundant balanced line physical layers, a (differential) network interface, time division multiplexing, half-duplex command/response protocol, and can handle up to 30 Remote Terminals (devices). The MIL-STD-1553 is standardized as a Military standard MIL-STD-1553B dated 21 Sep. 1978 by the Department of Defense of U.S.A. entitled: “Aircraft Internal Time Division Command/Response Multiplex Data Bus”, and is described in AIM Gmbh tutorial v2.3 dated November 2010 entitled: “MIL-STD-1553 Tutorial”, which are both incorporated in their entirety for all purposes as if fully set forth herein.

A single bus consists of a wire pair with 70-85Ω impedance at 1 MHz. Where a circular connector is used, its center pin is used for the high (positive) Manchester bi-phase signal. Transmitters and receivers couple to the bus via isolation transformers, and stub connections branch off using a pair of isolation resistors and, optionally, a coupling transformer, for reducing the impact of a short circuit and assures that the bus does not conduct current through the aircraft. A Manchester code is used to present both clock and data on the same wire pair and to eliminate any DC component in the signal (which cannot pass the transformers). The bit rate is 1.0 megabit per second (1 bit per μs). The combined accuracy and long-term stability of the bit rate is only specified to be within ±0.1%; the short-term clock stability must be within ±0.01%. The peak-to-peak output voltage of a transmitter is 18-27 V. The bus can be made dual or triply redundant by using several independent wire pairs, and then all devices are connected to all buses. There is provision to designate a new bus control computer in the event of a failure by the current master controller. Usually, the auxiliary flight control computer(s) monitor the master computer and aircraft sensors via the main data bus. A different version of the bus uses optical fiber, which weighs less and has better resistance to electromagnetic interference, including EMP.

A MIL-STD-1553 multiplex data bus system consists of a Bus Controller (BC) controlling multiple Remote Terminals (RT) all connected together by a data bus providing a single data path between the Bus Controller and all the associated Remote Terminals. There may also be one or more Bus Monitors (BM); however, Bus Monitors are specifically not allowed to take part in data transfers, and are only used to capture or record data for analysis, etc. In redundant bus implementations, several data buses are used to provide more than one data path, i.e. dual redundant data bus, tri-redundant data bus, etc. All transmissions onto the data bus are accessible to the BC and all connected RTs. Messages consist of one or more 16-bit words (command, data, or status). The 16 bits comprising each word are transmitted using Manchester code, where each bit is transmitted as a 0.5 μs high and 0.5 μs low for a logical 1 or a low-high sequence for a logical 0. Each word is preceded by a 3 μs sync pulse (1.5 μs low plus 1.5 μs high for data words and the opposite for command and status words, which cannot occur in the Manchester code) and followed by an odd parity bit. Practically each word could be considered as a 20-bit word: 3 bit for sync, 16 bit for payload and 1 bit for odd parity control. The words within a message are transmitted contiguously and there has to be a minimum of a 4 μs gap between messages. However, this inter-message gap can be, and often is, much larger than 4 μs, even up to 1 ms with some older Bus Controllers. Devices have to start transmitting their response to a valid command within 4-12 μs and are considered to not have received a command or message if no response has started within 14 μs.

ARINC 429. ARINC 429, also known as “Mark33 Digital Information Transfer System (DITS)” and as Aeronautical Radio INC. (ARINC), is the technical standard for the predominant avionics data bus used on most higher-end commercial and transport aircraft. It defines the physical and electrical interfaces of a two-wire data bus and a data protocol to support an aircraft's avionics local area network. ARINC 429 is a data transfer standard for aircraft avionics, and uses a self-clocking, self-synchronizing data bus protocol (Tx and Rx are on separate ports). The physical connection wires are twisted pairs carrying balanced differential signaling. Data words are 32 bits in length and most messages consist of a single data word. Messages are transmitted at either 12.5 or 100 kbit/s to other system elements that are monitoring the bus messages. The transmitter constantly transmits either 32-bit data words or the NULL state. A single wire pair is limited to one transmitter and no more than 20 receivers. The protocol allows for self-clocking at the receiver end, thus eliminating the need to transmit clocking data. The ARINC 429 unit of transmission is a fixed-length 32-bit frame, which the standard refers to as a ‘word’. The bits within an ARINC 429 word are serially identified from Bit Number 1 to Bit Number 32 or simply Bit 1 to Bit 32. The fields and data structures of the ARINC 429 word are defined in terms of this numbering. The ARINC 429 is described in Avionics Interface Technologies Doc. No. 40100001 (downloaded from the Internet on November 2016) entitled: “ARINC 429 Protocol Tutorial”, and in an ARINC Specification 429 prepared by Airlines Electronic Engineering Committee and published May 17, 2004 by Aeronautical Radio, Inc. entitled: “Mark 33 Digital Information Transfer System (DITS)—Part 1—Functional Description, Electrical Interface, Label Assignments and Word Formats”, which are both incorporated in their entirety for all purposes as if fully set forth herein. ARINC 429 interface may use ‘ARINC 429 Bus Interface—DirectCore’ v5.0 available from Actel Corporation (headquartered in Mountain-View, Calif., USA) described in Document No. 51700055-5/9.06 published September 2006, which is incorporated in its entirety for all purposes as if fully set forth herein.

GPS. The Global Positioning System (GPS) is a space-based radio navigation system owned by the United States government and operated by the United States Air Force. It is a global navigation satellite system that provides geolocation and time information to a GPS receiver anywhere on or near the Earth where there is an unobstructed line of sight to four or more GPS satellites. The GPS system does not require the user to transmit any data, and it operates independently of any telephonic or Internet reception, though these technologies can enhance the usefulness of the GPS positioning information. The GPS system provides critical positioning capabilities to military, civil, and commercial users around the world. The United States government created the system, maintains it, and makes it freely accessible to anyone with a GPS receiver. In addition to GPS, other systems are in use or under development, mainly because of a potential denial of access by the US government. The Russian Global Navigation Satellite System (GLONASS) was developed contemporaneously with GPS, but suffered from incomplete coverage of the globe until the mid-2000s. GLONASS can be added to GPS devices, making more satellites available and enabling positions to be fixed more quickly and accurately, to within two meters. There are also the European Union Galileo positioning system, China's BeiDou Navigation Satellite System and India's NAVIC.

Automotive Ethernet. Automotive Ethernet refers to the use of an Ethernet-based network for connections between in-vehicle electronic systems, and typically defines a physical network that is used to connect components within a car using a wired network. Ethernet is a family of computer networking technologies commonly used in Local Area Networks (LAN), Metropolitan Area Networks (MAN) and Wide Area Networks (WAN). It was commercially introduced in 1980 and first standardized in 1983 as IEEE 802.3, and has since been refined to support higher bit rates and longer link distances. The Ethernet standards comprise several wiring and signaling variants of the OSI physical layer in use with Ethernet. Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Since its commercial release, Ethernet has retained a good degree of backward compatibility. Features such as the 48-bit MAC address and Ethernet frame format have influenced other networking protocols. Simple switched Ethernet networks, while a great improvement over repeater-based Ethernet, suffer from single points of failure, attacks that trick switches or hosts into sending data to a machine even if it is not intended for it, scalability and security issues with regard to switching loops, broadcast radiation and multicast traffic, and bandwidth choke points where a lot of traffic is forced down a single link.

Advanced networking features in switches use shortest path bridging (SPB) or the spanning-tree protocol (STP) to maintain a loop-free, meshed network, allowing physical loops for redundancy (STP) or load-balancing (SPB). Advanced networking features also ensure port security, provide protection features such as MAC lockdown and broadcast radiation filtering, use virtual LANs to keep different classes of users separate while using the same physical infrastructure, employ multilayer switching to route between different classes, and use link aggregation to add bandwidth to overloaded links and to provide some redundancy. IEEE 802.1aq (shortest path bridging) includes the use of the link-state routing protocol IS-IS to allow larger networks with shortest path routes between devices.

A data packet on an Ethernet link is called an Ethernet packet, which transports an Ethernet frame as its payload. An Ethernet frame is preceded by a preamble and Start Frame Delimiter (SFD), which are both part of the Ethernet packet at the physical layer. Each Ethernet frame starts with an Ethernet header, which contains destination and source MAC addresses as its first two fields. The middle section of the frame is payload data including any headers for other protocols (for example, Internet Protocol) carried in the frame. The frame ends with a frame check sequence (FCS), which is a 32-bit cyclic redundancy check used to detect any in-transit corruption of data. Automotive Ethernet is described in a book by Charles M. Kozierok, Colt Correa, Robert B. Boatright, and Jeffrey Quesnelle entitled: “Automotive Ethernet: The Definitive Guide”, published 2014 by Interpid Control Systems [ISBN-13: 978-0-9905388-0-6], and in a white paper document No. 915-3510-01 Rev. A published May 2014 by Ixia entitled: “Automotive Ethernet: An Overview”, which are both incorporated in their entirety for all purposes as if fully set forth herein.

100BaseT1. 100BASE-T1 (and upcoming 1000Base-T1) is an Ethernet automotive standard, standardized in IEEE 802.3bw-2015 Clause 96 and entitled: “802.3bw-2015—IEEE Standard for Ethernet Amendment 1: Physical Layer Specifications and Management Parameters for 100 Mb/s Operation over a Single Balanced Twisted Pair Cable (100BASE-T1)”. The data is transmitted over a single copper pair, 3 bits per symbol (PAM3), and it supports only full-duplex, transmitting in both directions simultaneously. The twisted-pair cable is required to support 66 MHz, with a maximum length of 15 m. The standard is intended for automotive applications or when Fast Ethernet is to be integrated into another application. Changes to IEEE Std 802.3-2015 that adds Clause 96 are described in IEEE Std 802.3bw™-2015 Amendment 1 entitled: “Amendment 1: Physical Layer Specifications and Management Parameters for 100 Mb/s Operation over a Single Balanced Twisted Pair Cable (100BASE-T1)” approved 26 Oct. 2015 [ISBN 978-1-5044-0137-1], which is incorporated in its entirety for all purposes as if fully set forth herein. This amendment adds 100 Mb/s Physical Layer (PHY) specifications and management parameters for operation on a single balanced twisted-pair copper cable.

BroadR-Reach®. BroadR-Reach® technology is an Ethernet physical layer standard designed for use in automotive connectivity applications. BroadR-Reach® technology allows multiple in-vehicle systems to simultaneously access information over unshielded single twisted pair cable, intended for reduced connectivity costs and cabling weight. Using BroadR-Reach® technology in automotive enables the migration from multiple closed applications to a single open, scalable Ethernet-based network within the automobile. This allows automotive manufacturers to incorporate multiple electronic systems and devices, such as advanced safety features (i.e. 360-degree surround view parking assistance, rear-view cameras and collision avoidance systems) and comfort and infotainment features. The automotive-qualified BroadR-Reach® Ethernet physical layer standard can be combined with IEEE 802.3 compliant switch technology to deliver 100 Mbit/s over unshielded single twisted pair cable.

The BroadR-Reach automotive Ethernet standard realizes simultaneous transmit and receive (i.e., full-duplex) operations on a single-pair cable instead of the half-duplex operation in 100BASE-TX, which uses one pair for transmit and one for receive to achieve the same data rate. In order to better de-correlate the signal, the digital signal processor (DSP) uses a highly optimized scrambler when compared to the scrambler used in 100BASE-TX. This provides a robust and efficient signaling scheme required by automotive applications. The BroadR-Reach automotive Ethernet standard uses a signaling scheme with higher spectral efficiency than that of 100BASE-TX. This limits the signal bandwidth of Automotive Ethernet to 33.3 MHz, which is about half the bandwidth of 100BASE-TX. A lower signal bandwidth improves return loss, reduces crosstalk, and ensures that BroadR-Reach® automotive Ethernet standard passes the stringent automotive electromagnetic emission requirements. The physical layer of BroadR-Reach® is described in a specification authored by Dr. Bernd Korber and published Nov. 28, 2014 by the OPEN Alliance, entitled: “BroadR-Reach® Definitions for Communication Channel—Version 2.0”, which is incorporated in its entirety for all purposes as if fully set forth herein.

A method and a device for recording data or for transmitting stimulation data, which are transmitted in Ethernet-based networks of vehicles, are described in U.S. Patent Application No. 2015/0071115 to Neff et al. entitled: “Data Logging or Stimulation in Automotive Ethernet Networks Using the Vehicle Infrastructure”, which is incorporated in its entirety for all purposes as if fully set forth herein. A method for recording data is described, wherein the data are transmitted from a transmitting control unit to a receiving control unit of a vehicle via a communication system of the vehicle. The communication system comprises an Ethernet network, wherein the data are conducted from a transmission component to a reception component of the Ethernet network via a transmission path, and wherein the data are to be recorded at a logging component of the Ethernet network, which does not lie on the transmission path. The method comprises the configuration of an intermediate component of the Ethernet network, which lies on the transmission path, to transmit a copy of the data as logging data to the logging component; and the recording of the logging data at the logging component.

A system and method of regulating data communications between a vehicle electronics system and a computing device is described in U.S. Pat. No. 9,912,754 to WIDEMAN et al. entitled: “Vehicular data isolation device”, which is incorporated in its entirety for all purposes as if fully set forth herein. The method includes: communicatively linking a first data port of an isolation device with the vehicle electronics system; communicatively linking a second data port of the isolation device with the computing device; receiving data at the isolation device sent between the computing device and the vehicle electronics system; and permitting the data to pass through the isolation device based on the identity of the computing device, the rate at which the data passes through the isolation device, or the content of the data.

A backbone network system for a vehicle enables high-speed and large-capacity data transmission between integrated control modules mounted in the vehicle, such that communication can be maintained through another alternative communication line when an error occurs in a specific communication line, is described in U.S. Pat. No. 9,172,635 to Kim et al. entitled: “Ethernet backbone network system for vehicle and method for controlling fail safe of the ethernet backbone network system”, which is incorporated in its entirety for all purposes as if fully set forth herein. The backbone network system enables various kinds of integrated control modules mounted in the vehicle to perform large-capacity and high-speed communications, based on Ethernet communication, by connecting domain gateways of the integrated control modules through an Ethernet backbone network, and provides a fast fail-safe function so that domain gateways can perform communications through another communication line when an error occurs in a communication line between the domain gateways.

A packet-switched, fault-tolerant, vehicle communication internetwork (100, 400, 500) comprising port-based VLANs is disclosed in U.S. Pat. No. 9,735,980 to Koch et al. entitled: “Fault-tolerant, frame-based communication system”, which is incorporated in its entirety for all purposes as if fully set forth herein. Two or more VLANs are embodied where a source node (110, 410, 510,610) comprises two or more network interface circuits (130,140, 415,425, 515,525, 630,640), and where looping is precluded via specific VLAN tagging and switch ports (131-134, 200, 300, 420, 430, 435, 445, 455, 465, 535, 540, 545, 560, 575, 585, associated with at least one specific VLAN. A destination node (120, 440, 450, 460, 570, 580, 590, 620) may feedback packets to the source node via a general VLAN tag along pathways associated with the two or more specific outgoing VLAN tags.

Vehicle internetworks provide for communications among diverse electronic devices within a vehicle, and for communications among these devices and networks external to the vehicle, as described in U.S. Pat. No. 7,484,008 to Gelvin et al. entitled: “Apparatus for vehicle internetworks”, which is incorporated in its entirety for all purposes as if fully set forth herein. The vehicle internetwork comprises specific devices, software, and protocols, and provides for security for essential vehicle functions and data communications, ease of integration of new devices and services to the vehicle internetwork, and ease of addition of services linking the vehicle to external networks such as the Internet.

A system and method for managing a vehicle Ethernet communication network are disclosed in U.S. Pat. No. 9,450,911 to CHA et al. entitled: “System and method for managing ethernet communication network for use in vehicle”, which is incorporated in its entirety for all purposes as if fully set forth herein. More specifically, each unit in a vehicle Ethernet communication network is configured to initially enter a power-on (PowerOn) mode when is applied to each unit of the vehicle to initialize operational programs. Once powered on, each unit enters a normal mode in which a node for each unit participates in a network to request the network. Subsequently, each unit enters a sleep indication (SleepInd) mode where other nodes are not requested even though the network has already been requested by the other nodes. A communication mode is then terminated at each unit and each unit enters a wait bus sleep (WaitBusSleep) mode in which all nodes connected to the network are no longer in communication and are waiting to switch to sleep mode. Finally, each unit is powered off to prevent communication between units in the network.

A system that includes an on-board unit (OBU) in communication with an internal subsystem in a vehicle on at least one Ethernet network and a node on a wireless network, is disclosed in U.S. Patent Application Publication No. 2014/0215491 to Addepalli et al. entitled: “System and method for internal networking, data optimization and dynamic frequency selection in a vehicular environment”, which is incorporated in its entirety for all purposes as if fully set forth herein. A method in one embodiment includes receiving a message on the Ethernet network in the vehicle, encapsulating the message to facilitate translation to Ethernet protocol if the message is not in Ethernet protocol, and transmitting the message in Ethernet protocol to its destination. Certain embodiments include optimizing data transmission over the wireless network using redundancy caches, dictionaries, object contexts databases, speech templates and protocol header templates, and cross layer optimization of data flow from a receiver to a sender over a TCP connection. Certain embodiments also include dynamically identifying and selecting an operating frequency with least interference for data transmission over the wireless network.

An example of an electronics architecture in a vehicle 21 is illustrated in a schematic block diagram 20 shown in FIG. 2. The vehicle 21 comprises five ECUs: A Telematics ECU 22b, a Communication ECU 22a, an ECU #1 22c, an ECU #2 22d, and an ECU #3 22e. While five ECUs are shown, any number of ECUs may be employed. Each of the ECUs may comprises, may consists of, or may be part of, Electronic/engine Control Module (ECM), Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed Control Unit (SCU), Telematic Control Unit (TCU), Transmission Control Unit (TCU), Brake Control Module (BCM; ABS or ESC), Battery management system, control unit, and a control module. The ECUs communicates with each other over a vehicle bus 23, which may consists of, comprises, or may be based on, Controller Area Network (CAN) standard (such as Flexible Data-Rate (CAN FD) protocol), Local Interconnect Network (LIN), FlexRay protocol, or Media Oriented Systems Transport (MOST) (such as MOST25, MOST50, or MOST150). In one example, the vehicle bus may consists of, comprises, or may be based on, automotive Ethernet, may use only a single twisted pair, and may consist of, employ, use, may be based on, or may be compatible with, IEEE802.3 100BaseT1, IEEE802.3 1000BaseT1, BroadR-Reach®, IEEE 802.3bw-2015, IEEE Std 802.3bv-2017, or IEEE Std 802.3 bp-2016 standards.

An ECU may connect to, or include, a sensor for sensing a phenomenon in the vehicle or in the vehicle environment. In the exemplary vehicle 21 shown in the arrangement 20, a sensor 24b is connected to the ECU #1 22c, and an additional sensor 24a is connected to the ECU #3 22e. Further, an ECU may connect to, or include, an actuator for affecting, generating, or controlling a phenomenon in the vehicle or in the vehicle environment. In the exemplary vehicle 21 shown in the arrangement 20, an actuator 25b is connected to the ECU #2 22d, and an additional actuator 25a is connected to the ECU #3 22e.

The vehicle 21 may communicate over a wireless network 39 with other vehicles or with stationary devices, directly or via the Internet. The communication with the wireless network 39 uses an antenna 29 and a wireless transceiver 28, which may part of the Communication ECU 22a. The wireless network 39 may be a Wireless Wide Area Network (WWAN), such as WiMAX network or a cellular telephone network (such as Third Generation (3G) or Fourth Generation (4G) network). Alternatively or in addition, the wireless network 39 may be a Wireless Personal Area Network (WPAN) that may be according to, may be compatible with, or may be based on, Bluetooth™ or IEEE 802.15.1-2005 standards, or may be according to, or may be based on, ZigBee™, IEEE 802.15.4-2003, or Z-Wave™ standard. Alternatively or in addition, the wireless network 39 may be a Wireless Local Area Network (WLAN) that may be according to, may be compatible with, or may be based on, IEEE 802.11-2012, IEEE 802.11a, IEEE 802.11b, IEEE 802.11g, IEEE 802.11n, or IEEE 802.11ac.

Alternatively or in addition, the wireless network 39 may use a Dedicated Short-Range Communication (DSRC), that may be according to, compatible with, or based on, European Committee for Standardization (CEN) EN 12253:2004, EN 12795:2002, EN 12834:2002, EN 13372:2004, or EN ISO 14906:2004 standard, or may be according to, compatible with, or based on, IEEE 802.11p, IEEE 1609.1-2006, IEEE 1609.2, IEEE 1609.3, IEEE 1609.4, or IEEE1609.5.

The vehicle 21 may include a GPS receiver for a localization, navigation, or tracking of the vehicle 21. In the exemplary vehicle 21 shown in the arrangement 20, a GPS receiver 27 receives RF signals from the GPS satellites 38a and 38b, and is part of, or connected to, the Telematics ECU 22b. The Telematics ECU 22b may further include, or connect to, a dashboard display 26, (also known as instrument panel (IP), or fascia) that is a control panel located directly ahead, or in plain view, of a vehicle's driver or passenger, displaying instrumentation, infotainment, and controls for the vehicle's operation.

ECU. In automotive electronics, an Electronic Control Unit (ECU) is a generic term for any embedded system that controls one or more of the electrical system or subsystems in a vehicle such as a motor vehicle. Types of ECU include Electronic/engine Control Module (ECM) (sometimes referred to as Engine Control Unit—ECU, which is distinct from the generic ECU—Electronic Control Unit), Airbag Control Unit (ACU), Powertrain Control Module (PCM), Transmission Control Module (TCM), Central Control Module (CCM), Central Timing Module (CTM), Convenience Control Unit (CCU), General Electronic Module (GEM), Body Control Module (BCM), Suspension Control Module (SCM), Door Control Unit (DCU), Powertrain Control Module (PCM), Electric Power Steering Control Unit (PSCU), Seat Control Unit, Speed Control Unit (SCU), Suspension Control Module (SCM), Telematic Control Unit (TCU), Telephone Control Unit (TCU), Transmission Control Unit (TCU), Brake Control Module (BCM or EBCM; such as ABS or ESC), Battery management system, control unit, or control module.

A microprocessor or a microcontroller serves as a core of an ECU, and uses a memory such as SRAM, EEPROM, and Flash. An ECU is power fed by a supply voltage, and includes or connects to sensors using analog and digital inputs. In addition to a communication interface, an ECU typically includes a relay, H-Bridge, injector, or logic drivers, or outputs for connecting to various actuators.

ECU technology and applications is described in the M. Tech. Project first stage report (EE696) by Vineet P. Aras of the Department of Electrical Engineering, Indian Institute of Technology Bombay, dated July 2004, entitled: “Design of Electronic Control Unit (ECU) for Automobiles—Electronic Engine Management system”, and in National Instruments paper published Nov. 7, 2009 entitled: “ECU Designing and Testing using National Instruments Products”, which are both incorporated in their entirety for all purposes as if fully set forth herein. ECU examples are described in a brochure by Sensor-Technik Wiedemann Gmbh (headquartered in Kaufbeuren, Germany) dated 20110304 GB entitled “Control System Electronics”, which is incorporated in its entirety for all purposes as if fully set forth herein. An ECU or an interface to a vehicle bus may use a processor such as the MPC5748G controller available from Freescale Semiconductor, Inc. (headquartered in Tokyo, Japan, and described in a data sheet Document Number MPC5748G Rev. 2, May 2014 entitled: “MPC5748 Microcontroller Datasheet”, which is incorporated in its entirety for all purposes as if fully set forth herein.

OSEK/VDX. OSEK/VDX, formerly known as OSEK (Offene Systeme und deren Schnittstellen für die Elektronik in Kraftfahrzeugen; in English: “Open Systems and their Interfaces for the Electronics in Motor Vehicles”) OSEK is an open standard, published by a consortium founded by the automobile industry for an embedded operating system, a communications stack, and a network management protocol for automotive embedded systems. OSEK was designed to provide a standard software architecture for the various electronic control units (ECUs) throughout a car.

The OSEK standard specifies interfaces to multitasking functions—generic I/O and peripheral access—and thus remains architecture dependent. OSEK systems are expected to run on chips without memory protection. Features of an OSEK implementation can be usually configured at compile-time. The number of application tasks, stacks, mutexes, etc., is statically configured; it is not possible to create more at run time. OSEK recognizes two types of tasks/threads/compliance levels: basic tasks and enhanced tasks. Basic tasks never block; they “run to completion” (coroutine). Enhanced tasks can sleep and block on event objects. The events can be triggered by other tasks (basic and enhanced) or interrupt routines. Only static priorities are allowed for tasks, and First-In-First-Out (FIFO) scheduling is used for tasks with equal priority. Deadlocks and priority inversion are prevented by priority ceiling (i.e. no priority inheritance). The specification uses ISO/ANSI-C-like syntax; however, the implementation language of the system services is not specified. OSEK/VDX Network Management functionality is described in a document by OSEK/VDX NM Concept & API 2.5.2 (Version 2.5.3, 26 Jul. 2004) entitled: “Open Systems and the Corresponding Interfaces for Automotive Electronics—Network Management—Concept and Application Programming Interface”, which is incorporated in its entirety for all purposes as if fully set forth herein. Some parts of the OSEK are standardized as part of ISO 17356 standard series entitled: “Road vehicles—Open interface for embedded automotive applications”, such as ISO 17356-1 standard (First edition, 2005 Jan. 15) entitled: “Part 1: General structure and terms, definitions and abbreviated terms”, ISO 17356-2 standard (First edition, 2005 May 1) entitled: “Part 2: OSEK/VDX specifications for binding OS, COM and NM”, ISO 17356-3 standard (First edition, 2005 Nov. 1) entitled: “Part 3: OSEK/VDX Operating System (OS)”, and ISO 17356-4 standard (First edition, 2005 Nov. 1) entitled: “Part 4: OSEK/VDX Communication (COM)”, which are all incorporated in their entirety for all purposes as if fully set forth herein.

AUTOSAR. AUTOSAR (Automotive Open System Architecture) is a worldwide development partnership of automotive interested parties founded in 2003. It pursues the objective of creating and establishing an open and standardized software architecture for automotive electronic control units excluding infotainment. Goals include the scalability to different vehicle and platform variants, transferability of software, the consideration of availability and safety requirements, a collaboration between various partners, sustainable utilization of natural resources, maintainability throughout the whole “Product Life Cycle”.

AUTOSAR provides a set of specifications that describe basic software modules, defines application interfaces, and builds a common development methodology based on standardized exchange format. Basic software modules made available by the AUTOSAR layered software architecture can be used in vehicles of different manufacturers and electronic components of different suppliers, thereby reducing expenditures for research and development, and mastering the growing complexity of automotive electronic and software architectures. Based on this guiding principle, AUTOSAR has been devised to pave the way for innovative electronic systems that further improve performance, safety and environmental friendliness and to facilitate the exchange and update of software and hardware over the service life of the vehicle. It aims to be prepared for the upcoming technologies and to improve cost-efficiency without making any compromise with respect to quality.

AUTOSAR uses a three-layered architecture: Basic Software—standardized software modules (mostly) without any functional job itself that offers services necessary to run the functional part of the upper software layer; Runtime environment—Middleware which abstracts from the network topology for the inter- and intra-ECU information exchange between the application software components and between the Basic Software and the applications; and Application Layer—application software components that interact with the runtime environment. System Configuration Description includes all system information and the information that must be agreed between different ECUs (e.g. definition of bus signals). ECU extract is the information from the System Configuration Description needed for a specific ECU (e.g. those signals where a specific ECU has access to). ECU Configuration Description contains all basic software configuration information that is local to a specific ECU. The executable software can be built from this information, the code of the basic software modules and the code of the software components. The AUTOSAR specifications are described in Release 4.2.2 released 31 Jan. 2015 by the AUTOSAR consortium entitled: “Release 4.2 Overview and Revision History”, which is incorporated in its entirety for all purposes as if fully set forth herein.

SOME/IP. Scalable service-Oriented MiddlewarE over IP (SOME/IP) is an AUTOSAR automotive/embedded middleware solution for communication Protocol which supports remote procedure calls, event notifications and the underlying serialization/wire format. SOME/IP may be implemented on different operating system (i.e. AUTOSAR, GENIVI, and OSEK) and even embedded devices without operating system. SOME/IP shall be used for inter-ECU Client/Server Serialization. An implementation of SOME/IP allows AUTOSAR to parse the RPC PDUs and transport the signals to the application, and can be used for control messages. SOME/IP supports a wide range of middleware features such as serialization—transforming into and from on-wire representation; Remote Procedure Call (RPC)—implementing remote invocation of functions; Service Discovery (SD)—dynamically finding and functionality and configuring its access; Publish/Subscribe (Pub/Sub)—dynamically configuring which data is needed and shall be sent to the client; and Segmentation of UDP messages—allowing the transport of large SOME/IP messages over UDP without the need of fragmentation. SOME/IP is described in AUTOSAR Document ID 696 Release 1.0.0 published 2016 Nov. 30 entitled: “SOME/IP Protocol Specification”, in AUTOSAR Document ID 637 Release 4.2.1 (downloaded December 2017) entitled: “Example for a Serialization Protocol (SOME/IP)”, SOME/IP Protocol Specification”, and in AUTOSAR Document ID 616 Release 4.3.1 (downloaded December 2017) entitled: “Specification of Service Discovery”, which are all incorporated in their entirety for all purposes as if fully set forth herein.

A method for processing a SOME/IP stream through interworking with Audio Video Bridging (AVB) in a server is disclosed in U.S. Pat. No. 9,755,968 to Kim et al. entitled: “Method and apparatus for processing a SOME/IP stream through interworking with AVB technology”, which is incorporated in its entirety for all purposes as if fully set forth herein. The method includes determining a transmission scheme for the SOME/IP stream through a SOME/IP service discovery procedure and generating an InitialEvent message and transmitting the generated InitialEvent message to a client according to the determined transmission scheme. If the determined transmission scheme is L2-Frame, the SOME/IP stream is transmitted through a layer 2 of AVB. Therefore, a SOME/IP stream, the QoS of which is guaranteed through interworking with AVB, may be provided.

XCP. The Association for Standardization of Automation and Measuring Systems (ASAM) MCD-1 XCP (Universal Measurement and Calibration Protocol) standard defines a bus-independent, master-slave communication protocol to connect ECUs with calibration systems. The primary purpose of XCP is to adjust internal parameters and acquire the current values of internal variables of an ECU. The standard consists of a base standard, which describes memory-oriented protocol services without direct dependencies on specific bus systems. Several associate standards contain the transport layer definitions for CAN, FlexRay, Ethernet (UDP/IP and TCP/IP), serial links (SPI and SCI) and USB. The ASAM MCD-1 XCP standard defines the access to parameters and measurement variables using memory addresses. The properties and memory addresses of this data are described in the A2L-file format, which is standardized through the ASAM MCD-2 MC standard. The A2L-file contains all the information necessary to access and correctly interpret the data that is transmitted via the XCP protocol. This A2L file therefore provides access to a specific parameter or variable, without the need to have hardcoded access in the ECU application software. In other words, the ECU contains only a generic XCP-protocol stack, which responds to memory access requests from the calibration system. Different calibration and measurement tasks can be performed by different configurations of the calibration system without recompiling and reprogramming the ECU application code.

ASAM MCD-1 XCP was designed with two main objectives. First, to reduce the high requirements on ECU resources, such as CPU load, RAM consumption and flash memory, for the XCP slave. Second, to achieve a maximal data transmission rate over the communication link and to reduce the impact on bus communication as much as possible. The standard also describes the organization of the ECU memory segments used by the ECU software. This description allows memory-type specific access. XCP additionally describes the ECU interface for data read and write access. Overview of XCP is described in ASAM standard (dated 2003 Apr. 8) entitled: “XCP—Version 1.0—“The Universal Measurement and Calibration Protocol Family”—Part 1—Overview”, and the XCP protocol layer is described in ASAM standard (dated 2003 Apr. 8) entitled: “XCP—Version 1.0—“The Universal Measurement and Calibration Protocol Family”—Part 2—Protocol Layer Specification”, which are both incorporated in their entirety for all purposes as if fully set forth herein.

DoIP. Diagnostic over Internet Protocol (DoIP) refers to a standardized vehicle interface which separates in-vehicle network technology from the external test equipment vehicle interface requirements to allow for a long-term stable external vehicle communication interface, utilizes existing industry standards to define a long-term stable state-of-the-art communication standard usable for legislated diagnostic communication as well as for manufacturer-specific use cases, and can easily be adapted to new physical and data link layers, including wired and wireless connections, by using existing adaptation layers. DoIP encourages diagnostics related correspondence between outer test types of gear and car control units (ECU) utilizing IP, TCP and UDP. DoIP is described in the International Organization for Standardization (ISO) standard set ISO 13400, which parts are based on the Open Systems Interconnection (OSI) Basic Reference Model specified in ISO/IEC 7498-1 and ISO/IEC 10731, which structures communication systems into seven layers. ISO 13400 consists of the following parts, under the general title Road vehicles—Diagnostic communication over Internet Protocol (DoIP): Part 1: General information and use case definition; Part 2: Transport protocol and network layer services; and Part 3: Wired vehicle interface based on IEEE 802.3 standard.

An arrangement 30 shown in FIG. 3 describes an exemplary block diagram of the ECU #3 22e shown as part of the vehicle 21 that is described in the arrangement 20 shown in FIG. 2. The ECU #3 22e connects to the vehicle bus 23 via two conductors or wires 39a and 39b using a connector 38. A transceiver and a controller are used for respectively handling the physical layer and the higher layers of the vehicle bus 23 interface and protocol. In an example where the vehicle bus 23 is a CAN bus, the physical layer is supported by a CAN transceiver 36 that includes a bus driver (or transmitter) 37a for transmitting data to the vehicle bus 23, and a bus receiver 37b for receiving data from the vehicle bus 23. A CAN controller 33, which may include a processor for controlling and supporting the functionalities and features of the ECU #3 22e. The software (or firmware) 35 to be executed by the controller (or processor) 33 is stored in a memory 34, which is typically a non-volatile memory. In a case where the sensor 24a is an analog sensor having an analog signal output, an Analog-to-Digital converter (A/D) 32a is used for digitization of the output, providing digital samples that can be read by the controller (or processor) 33. Similarly, in a case where the actuator 25a is an analog actuator controlled or activated through an analog signal input, a Digital-to-Analog converter (D/A) 32b is used for converting digital values from the controller (or processor) 33 and providing analog signal that can affect the actuator 25a operation.

The signal received from the analog sensor 24a, or transmitted to the analog actuator 25a, may be respectively conditioned by signal conditioners 31a and 31b. The signal conditioners 31a and 31b may involve time, frequency, or magnitude related manipulations, typically adapted to optimally operate, activate, or interface the Analog-to-Digital (A/D) converter 32a or Digital-to-Analog converter (D/A) 32b. Each of the signal conditioners 31a and 31b may be linear or non-linear, and may include an operation or an instrument amplifier, a multiplexer, a frequency converter, a frequency-to-voltage converter, a voltage-to-frequency converter, a current-to-voltage converter, a current loop converter, a charge converter, an attenuator, a sample-and-hold circuit, a peak-detector, a voltage or current limiter, a delay line or circuit, a level translator, a galvanic isolator, an impedance transformer, a linearization circuit, a calibrator, a passive or active (or adaptive) filter, an integrator, a deviator, an equalizer, a spectrum analyzer, a compressor or a de-compressor, a coder (or decoder), a modulator (or demodulator), a pattern recognizer, a smoother, a noise remover, an average or RMS circuit, or any combination thereof. Each of the signal conditioners 31a and 31b may use any one of the schemes, components, circuits, interfaces, or manipulations described in a handbook published 2004-2012 by Measurement Computing Corporation entitled: “Data Acquisition Handbook—A Reference For DAQ And Analog & Digital Signal Conditioning”, which is incorporated in its entirety for all purposes as if fully set forth herein. Further, the conditioning may be based on the book entitled: “Practical Design Techniques for Sensor Signal Conditioning”, by Analog Devices, Inc., 1999 (ISBN-0-916550-20-6), which is incorporated in its entirety for all purposes as if fully set forth herein.

The controller (or processor) 33 may be based on a discrete logic or an integrated device, such as a processor, microprocessor or microcomputer, and may include a general-purpose device or may be a special purpose processing device, such as an ASIC, PAL, PLA, PLD, Field Programmable Gate Array (FPGA), Gate Array, or other customized or programmable device. In the case of a programmable device as well as in other implementations, a memory is required. The processor 33 commonly includes a memory, which may comprise, may be part of, or may consist of, the memory 34 that may include a static RAM (random Access Memory), dynamic RAM, flash memory, ROM (Read Only Memory), or any other data storage medium. The memory may include data, programs, and/or instructions and any other software or firmware executable by the processor. Control logic can be implemented in hardware or in software, such as a firmware stored in the memory. The processor 33 controls and monitors the ECU #3 22e operation, such as initialization, configuration, interface, analysis, notification, communication, and commands.

ADAS. Advanced Driver Assistance Systems, or ADAS, are automotive electronic systems to help the driver in the driving process, such as to increase car safety and more generally, road safety using a safe Human-Machine Interface (HMI). Advanced driver assistance systems (ADAS) are developed to automate/adapt/enhance vehicle systems for safety and better driving. Safety features are designed to avoid collisions and accidents by offering technologies that alert the driver to potential problems, or to avoid collisions by implementing safeguards and taking over control of the vehicle. Adaptive features may automate lighting, provide adaptive cruise control, automate braking, incorporate GPS/traffic warnings, connect to smartphones, alert driver to other cars or dangers, keep the driver in the correct lane, or show what is in blind spots.

There are many forms of ADAS available; some features are built into cars or are available as an add-on package. ADAS technology can be based upon, or use, vision/camera systems, sensor technology, car data networks, Vehicle-to-vehicle (V2V), or Vehicle-to-Infrastructure systems (V2I), and leverage wireless network connectivity to offer improved value by using car-to-car and car-to-infrastructure data. ADAS technologies or applications comprise: Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system (such as Precrash system), Collision Imminent Braking (CM), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), or Wrong-way driving warning.

ADAS is further described in Intel Corporation 2015 Technical White Paper (0115/MW/HBD/PDF 331817-001US) by Meiyuan Zhao of Security & Privacy Research, Intel Labs entitled: “Advanced Driver Assistant System—Threats, Requirements, Security Solutions”, and in a PhD Thesis by Alexandre Dugarry submitted on June 2004 to the Cranfield University, School of Engineering, Applied Mathematics and Computing Group, entitled: “Advanced Driver Assistance Systems—Information Management and Presentation”, which are both incorporated in their entirety for all purposes as if fully set forth herein.

ACC. Autonomous cruise control (ACC; also referred to as ‘adaptive cruise control’ or ‘radar cruise control’) is an optional cruise control system for road vehicles that automatically adjusts the vehicle speed to maintain a safe distance from vehicles ahead. It makes no use of satellite or roadside infrastructures or of any cooperative support from other vehicles. The vehicle control is imposed based on sensor information from on-board sensors only. Cooperative Adaptive Cruise Control (CACC) further extends the automation of navigation by using information gathered from fixed infrastructure such as satellites and roadside beacons, or mobile infrastructure such as reflectors or transmitters on the back of other vehicles. These systems use either a radar or laser sensor setup allowing the vehicle to slow when approaching another vehicle ahead and accelerate again to the preset speed when traffic allows. ACC technology is widely regarded as a key component of any future generations of intelligent cars. The impact is equally on driver safety as on economizing capacity of roads by adjusting the distance between vehicles according to the conditions. Radar-based ACC often feature a pre-crash system, which warns the driver and/or provides brake support if there is a high risk of a collision. In certain cars it is incorporated with a lane maintaining system which provides power steering assist to reduce steering input burden in corners when the cruise control system is activated.

Adaptive High Beam. Adaptive High Beam Assist is Mercedes-Benz' marketing name for a headlight control strategy that continuously automatically tailors the headlamp range so the beam just reaches other vehicles ahead, thus always ensuring maximum possible seeing range without glaring other road users. It provides a continuous range of beam reach from a low-aimed low beam to a high-aimed high beam, rather than the traditional binary choice between low and high beams. The range of the beam can vary between 65 and 300 meters, depending on traffic conditions. In traffic, the low beam cutoff position is adjusted vertically to maximize seeing range while keeping glare out of leading and oncoming drivers' eyes. When no traffic is close enough for glare to be a problem, the system provides full high beam. Headlamps are adjusted every 40 milliseconds by a camera on the inside of the front windscreen which can determine distance to other vehicles. The adaptive high beam may be realized with LED headlamps.

Automatic parking. Automatic parking is an autonomous car-maneuvering system that moves a vehicle from a traffic lane into a parking spot to perform parallel, perpendicular or angle parking. The automatic parking system aims to enhance the comfort and safety of driving in constrained environments where much attention and experience is required to steer the car. The parking maneuver is achieved by means of coordinated control of the steering angle and speed, which takes into account the actual situation in the environment to ensure collision-free motion within the available space. The car is an example of a non-holonomic system where the number of control commands available is less than the number of coordinates that represent its position and orientation.

Automotive night vision. An automotive night vision system uses a thermographic camera to increase a driver's perception and seeing distance in darkness or poor weather beyond the reach of the vehicle's headlights. Active systems use an infrared light source built into the car to illuminate the road ahead with light that is invisible to humans. There are two kinds of active systems: gated and non-gated. The gated system uses a pulsed light source and a synchronized camera that enable long ranges (250 m) and high performance in rain and snow. Passive infrared systems do not use an infrared light source, instead they capture thermal radiation already emitted by the objects, using a thermographic camera.

Blind spot monitor. The blind spot monitor is a vehicle-based sensor device that detects other vehicles located to the driver's side and rear. Warnings can be visual, audible, vibrating or tactile. Blind spot monitors may include more than monitoring the sides of the vehicle, such as ‘Cross Traffic Alert’, which alerts drivers backing out of a parking space when traffic is approaching from the sides. BLIS is an acronym for Blind Spot Information System, a system of protection developed by Volvo, and produced a visible alert when a car entered the blind spot while a driver was switching lanes, using two door mounted lenses to check the blind spot area for an impending collision.

Collision avoidance system. A collision avoidance system (a.k.a. Precrash system) is an automobile safety system designed to reduce the severity of an accident. Such forward collision warning system or collision mitigating system typically uses radar (all-weather) and sometimes laser and camera (both sensor types are ineffective during bad weather) to detect an imminent crash. Once the detection is done, these systems either provide a warning to the driver when there is an imminent collision or take action autonomously without any driver input (by braking or steering or both). Collision avoidance by braking is appropriate at low vehicle speeds (e.g. below 50 km/h), while collision avoidance by steering is appropriate at higher vehicle speeds. Cars with collision avoidance may also be equipped with adaptive cruise control, and use the same forward-looking sensors.

Intersection assistant. Intersection assistant is an advanced driver assistance system for city junctions that are a major accident blackspot. The collisions here can mostly be put down to driver distraction or mis-judgement. While humans often react too slowly, assistance systems are immune to that brief moment of shock. The system monitors cross traffic in an intersection/road junction. If this anticipatory system detects a hazardous situation of this type, it prompts the driver to start emergency braking by activating visual and acoustic warnings and automatically engaging brakes.

Lane Departure Warning system. A lane departure warning system is a mechanism designed to warn the driver when the vehicle begins to move out of its lane (unless a turn signal is on in that direction) on freeways and arterial roads. These systems are designed to minimize accidents by addressing the main causes of collisions: driver error, distractions, and drowsiness. There are two main types of systems: Systems which warn the driver (lane departure warning, LDW) if the vehicle is leaving its lane (visual, audible, and/or vibration warnings), and systems which warn the driver and, if no action is taken, automatically take steps to ensure the vehicle stays in its lane (Lane Keeping System, LKS). Lane warning/keeping systems are based on video sensors in the visual domain (mounted behind the windshield, typically integrated beside the rear mirror), laser sensors (mounted on the front of the vehicle), or Infrared sensors (mounted either behind the windshield or under the vehicle).

ADASIS. The Advanced Driver Assistance System Interface Specification (ADASIS) forum was established in May 2001 by a group of car manufacturers, in-vehicle system developers and map data companies with the primary goal of developing a standardized map data interface between stored map data and ADAS applications. Main objectives of the ADASIS Forum are to define an open standardized data model and structure to represent map data in the vicinity of the vehicle position (i.e. the ADAS Horizon), in which map data is delivered by a navigation system or a general map data server, and to define an open standardized interface specification to provide ADAS horizon data (especially on a vehicle CAN bus) and enable ADAS applications to access the ADAS Horizon and position-related data of the vehicle. Using ADASIS, the available map data may not only be used for routing purposes but also to enable advanced in-vehicle applications. The area of potential features reaches from headlight control up to active safety applications (ADAS). With the ongoing development of navigation based ADAS features the interface to access the so-called ADAS Horizon is of rising importance. The ADASIS protocol is described in ADASIS Forum publication 200v2.0.3-D2.2-ADASIS_v2_Specification.0 dated December 2013 and entitled: “ADASIS v2 Protocol—Version 2.0.3.0”, which is incorporated in its entirety for all purposes as if fully set forth herein. Built-in vehicle sensors may be used to capture the vehicle's environment are limited to a relatively short range. However, the available digital map data can be used as a virtual sensor to look more forward on the path of the vehicle. The digital map contains attributes attached to the road segments, such as road geometry, functional road class, number of lanes, speed limits, traffic signs, etc. The “road ahead” concept is basically called Most Probable Path (or Most Likely Path) derived from the ADAS Horizon. For each street segment, the probability of driving through this segment is assigned and given by the ADASIS protocol.

ECU. In automotive electronics, an Electronic Control Unit (ECU) is a generic term for any embedded system that controls one or more of the electrical system or subsystems in a vehicle such as a motor vehicle. Types of ECU include Electronic/engine Control Module (ECM) (sometimes referred to as Engine Control Unit—ECU, which is distinct from the generic ECU—Electronic Control Unit), Airbag Control Unit (ACU), Powertrain Control Module (PCM), Transmission Control Module (TCM), Central Control Module (CCM), Central Timing Module (CTM), Convenience Control Unit (CCU), General Electronic Module (GEM), Body Control Module (BCM), Suspension Control Module (SCM), Door Control Unit (DCU), Powertrain Control Module (PCM), Electric Power Steering Control Unit (PSCU), Seat Control Unit, Speed Control Unit (SCU), Suspension Control Module (SCM), Telematic Control Unit (TCU), Telephone Control Unit (TCU), Transmission Control Unit (TCU), Brake Control Module (BCM or EBCM; such as ABS or ESC), Battery management system, control unit, or control module.

A microprocessor or a microcontroller serves as a core of an ECU, and uses a memory such as SRAM, EEPROM, and Flash. An ECU is power fed by a supply voltage, and includes or connects to sensors using analog and digital inputs. In addition to a communication interface, an ECU typically includes a relay, H-Bridge, injector, or logic drivers, or outputs for connecting to various actuators.

ECU technology and applications is described in the M. Tech. Project first stage report (EE696) by Vineet P. Aras of the Department of Electrical Engineering, Indian Institute of Technology Bombay, dated July 2004, entitled: “Design of Electronic Control Unit (ECU) for Automobiles—Electronic Engine Management system”, and in National Instruments paper published Nov. 7, 2009 entitled: “ECU Designing and Testing using National Instruments Products”, which are both incorporated in their entirety for all purposes as if fully set forth herein. ECU examples are described in a brochure by Sensor-Technik Wiedemann Gmbh (headquartered in Kaufbeuren, Germany) dated 20110304 GB entitled “Control System Electronics”, which is incorporated in its entirety for all purposes as if fully set forth herein. An ECU or an interface to a vehicle bus may use a processor such as the MPC5748G controller available from Freescale Semiconductor, Inc. (headquartered in Tokyo, Japan, and described in a data sheet Document Number MPC5748G Rev. 2, May 2014 entitled: “MPC5748 Microcontroller Datasheet”, which is incorporated in its entirety for all purposes as if fully set forth herein.

The main aspects of the IP technology are IP addressing and routing. Addressing refers to how IP addresses are assigned to end hosts, and how sub-networks of IP host addresses are divided and grouped together. IP routing is performed by all hosts, but most importantly, by internetwork routers, which typically use either Interior Gateway Protocols (IGPs) or External Gateway Protocols (EGPs) to help make IP datagram forwarding decisions across IP connected networks. Core routers serving in the Internet backbone commonly use the Border Gateway Protocol (BGP) as per RFC 4098 or Multi-Protocol Label Switching (MPLS). Other prior art publications relating to Internet related protocols and routing include the following chapters of the publication number 1-587005-001-3 by Cisco Systems, Inc. (July 1999) entitled: “Internetworking Technologies Handbook”, which are all incorporated in their entirety for all purposes as if fully set forth herein: Chapter 5: “Routing Basics” (pages 5-1 to 5-10), Chapter 30: “Internet Protocols” (pages 30-1 to 30-16), Chapter 32: “IPv6” (pages 32-1 to 32-6), Chapter 45: “OSI Routing” (pages 45-1 to 45-8) and Chapter 51: “Security” (pages 51-1 to 51-12), as well as in a IBM Corporation, International Technical Support Organization Redbook Documents No. GG24-4756-00 entitled: “Local Area Network Concepts and Products: LAN Operation Systems and Management”, 1^{st} Edition May 1996, Redbook Document No. GG24-4338-00, entitled: “Introduction to Networking Technologies”, 1^{st} Edition April 1994, Redbook Document No. GG24-2580-01 “IP Network Design Guide”, 2^{nd} Edition June 1999, and Redbook Document No. GG24-3376-07 “TCP/IP Tutorial and Technical Overview”, ISBN 0738494682 8^{th} Edition December 2006, which are incorporated in their entirety for all purposes as if fully set forth herein. Programming, designing, and using the Internet is described in a book by Paul S. Wang and Sanda Katila entitled: “An Introduction to Web Design+Programming” (Brooks/Cole book/Dec. 24, 2003), which is incorporated in its entirety for all purposes as if fully set forth herein.

Instant Messaging. Instant Messaging (IM) is a type of online chat, which offers real-time text transmission over the Internet. Short messages are typically transmitted bi-directionally between two parties, when each user chooses to complete a thought and select “send”. Some IM applications can use push technology to provide real-time text, which transmits messages character by character, as they are composed. More advanced instant messaging can add file transfer, clickable hyperlinks, Voice over IP, or video chat. Instant messaging systems typically facilitate connections between specified known users (often using a contact list also known as a “buddy list” or “friend list”). Depending on the IM protocol, the technical architecture can be peer-to-peer (direct point-to-point transmission) or client-server (a central server retransmits messages from the sender to the communication device).

Instant messaging is a set of communication technologies used for text-based communication between two or more participants over the Internet or other types of networks. IM-chat happens in real-time. Of importance is that online chat and instant messaging differ from other technologies such as email due to the perceived quasi-synchrony of the communications by the users. Some systems permit messages to be sent to users not then ‘logged on’ (offline messages), thus removing some differences between IM and email (often done by sending the message to the associated email account). Various IP technologies are described in a thesis by Tim van Lokven (Jan. 23, 2011) entitled: “Review and Comparison of Instant Messaging Protocols”, which is incorporated in its entirety for all purposes as if fully set forth herein.

Text Messaging. Text messaging, or texting, is the act of composing and sending brief, electronic messages between two or more mobile phones, or fixed or portable devices over a phone network. The term commonly refers to messages sent using the Short Message Service (SMS), but may include messages containing image, video, and sound content (known as MMS messages). The sender of a text message is known as a texter, while the service itself has different colloquialisms depending on the region. Text messages can be used to interact with automated systems, for example, to order products or services, or to participate in contests. Advertisers and service providers use direct text marketing to message mobile phone users about promotions, payment due dates, et cetera instead of using mail, e-mail or voicemail. In a straight and concise definition for the purposes of this English language article, text messaging by phones or mobile phones should include all 26 letters of the alphabet and 10 numerals, i.e., alpha-numeric messages, or text, to be sent by texter or received by the textee. SMS messaging gateway providers can provide gateway-to-mobile (Mobile Terminated—MT) services. Some suppliers can also supply mobile-to-gateway (text-in or Mobile Originated/MO services).

SMS. Short Message Service (SMS) is a text messaging service component of phone, Web, or mobile communication systems. It uses standardized communications protocols to allow fixed line or mobile phone devices to exchange short text messages. SMS as used on modern handsets as part of the Global System for Mobile Communications (GSM) series of standards as a means of sending messages of up to 160 characters to and from GSM mobile handsets. Though most SMS messages are mobile-to-mobile text messages, support for the service has expanded to include other mobile technologies, such as ANSI CDMA networks and Digital AMPS, as well as satellite and landline networks. The Short Message Service-Point to Point (SMS-PP) is standardized by the 3GPP as TS 23.040 and 3GPP TS 23.041, which define the Short Message Service-Cell Broadcast (SMS-CB), which allows messages (advertising, public information, etc.) to be broadcast to all mobile users in a specified geographical area.

Messages are sent to a Short Message Service Center (SMSC), which provides a “store and forward” mechanism. It attempts to send messages to the SMSC recipients, and if a recipient is not reachable, the SMSC queues the message for later retry. Some SMSCs also provide a “forward and forget” option where transmission is tried only once. Both Mobile Terminated (MT, for messages sent to a mobile handset) and Mobile Originating (MO, for those sent from the mobile handset) operations are supported, and the message delivery is “best effort” scheme, so there are no guarantees that a message will actually be delivered to its recipient, but delay or complete loss of a message is uncommon. SMS is a stateless communication protocol in which every SMS message is considered entirely independent of other messages. Enterprise applications using SMS as a communication channel for stateful dialogue (where an MO reply message is paired to a specific MT message) requires that session management be maintained external to the protocol through proprietary methods as Dynamic Dialogue Matrix (DDM).

The Short Message Service is realized by the use of the Mobile Application Part (MAP) of the SS#7 protocol, with Short Message protocol elements being transported across the network as fields within the MAP messages. These MAP messages may be transported using ‘traditional’ TDM based signaling, or over IP using SIGTRAN and an appropriate adaptation layer. The Short Message protocol itself is defined by 3GPP TS 23.040 for the Short Message Service-Point to Point (SMS-PP), and 3GPP TS 23.041 for the Cell Broadcast Service (CBS). SMS is further described in a 3GPP Technical Specification 3GPP TS 22.011 (v143.0.0, 2015 September) entitled: “3rd Generation Partnership Project; Technical Specification Group Services and System Aspects; Service accessibility (Release 14)”, which is incorporated in its entirety for all purposes as if fully set forth herein.

MMS. Multimedia Messaging Service (MMS) is an Open Mobile Alliance (OMA) standard way to send messages that include multimedia content to and from mobile phones over a cellular network. It extends the core SMS (Short Message Service) capability that allowed exchange of text messages only up to 160 characters in length. The most popular use is to send photographs from camera-equipped handsets, and is also used on a commercial basis by media companies as a method of delivering news and entertainment content and by retail brands as a tool for delivering scannable coupon codes, product images, videos and other information. Unlike text only SMS, commercial MMS can deliver a variety of media including up to forty seconds of video, one image, multiple images via slideshow, or audio plus unlimited characters.

MMS messages are delivered differently from SMS. The first step is for the sending device to encode the multimedia content in a fashion similar to sending a MIME e-mail (MIME content formats are defined in the MMS Message Encapsulation specification). The message is then forwarded to the carrier MMS store and forward server, known as the MMSC (Multimedia Messaging Service Centre). If the receiver is on another carrier, then the MMSC acts as a relay, and forwards the message to the MMSC of the recipient's carrier using the Internet.

Once the recipient MMSC has received a message, it first determines whether the receiver's handset is “MMS capable”, that it supports the standards for receiving MMS. If so, the content is extracted and sent to a temporary storage server with an HTTP front-end. An SMS “control message” (ping) containing the URL of the content is then sent to the recipient's handset to trigger the receiver's WAP browser to open and receive the content from the embedded URL. Several other messages are exchanged to indicate status of the delivery attempt. Before delivering content, some MMSCs also include a conversion service known as “content adaptation” that will attempt to modify the multimedia content into a format suitable for the receiver. E-mail and web-based gateways to the MMS (and SMS) system are common. On the reception side, the content servers can typically receive service requests from both WAPs and normal HTTP browsers, so delivery via the web is simple. For sending from external sources to handsets, most carriers allow MIME encoded message to be sent to the receiver's phone number with a special domain. MMS is described in a 3GPP technical specification 3GPP TS 23.140 V6.16.0 (2009 March) entitled: “3rd Generation Partnership Project; Technical Specification Group Core Network and Terminals; Multimedia Messaging Service (MMS); Functional description; Stage 2 (Release 6)”, which is incorporated in its entirety for all purposes as if fully set forth herein.

Facebook. Facebook Messenger is an instant messaging service and software application which provides text and voice communication. Integrated with Facebook web-based Chat feature and built on the open MQTT protocol, Messenger lets Facebook users chat with friends both on mobile and on the main website. Facebook is described in a guide by American Majority organization (retrieved October 2015 from http://cmrw.org/) entitled: “facebook—A Beginner's Guide”, which is incorporated in its entirety for all purposes as if fully set forth herein.

Twitter. Twitter is an online social networking service by Twitter Inc. (headquartered in San Francisco) that enables users to send and read short 140-character messages called “tweets”. Registered users can read and post tweets, but unregistered users can only read them. Users access Twitter through the website interface, SMS, or mobile device applications. Tweets are publicly visible by default, but senders can restrict message delivery to just their followers. Users can tweet via the Twitter website, compatible external applications (such as for smartphones), or by Short Message Service (SMS) available in certain countries. Retweeting is when users forward a tweet via Twitter. Both tweets and retweets can be tracked to see which ones are most popular. Users may subscribe to other users tweets—this is known as “following” and subscribers are known as “followers” or “tweeps”, a portmanteau of Twitter and peeps. Users can check the people who are unsubscribing them on Twitter (“unfollowing”) via various services. In addition, users can block those who have followed them.

As a social network, Twitter revolves around the principle of followers. When you choose to follow another Twitter user, that user's tweets appear in reverse chronological order on your main Twitter page. Individual tweets are registered under unique IDs using software called snowflake, and geolocation data is added using ‘Rockdove’. The URL t.co then checks for a spam link and shortens the URL. Next, the tweets are stored in a MySQL database using Gizzard, and the user receives acknowledgement that the tweets were sent. Tweets are then sent to search engines via the Firehose API. The process itself is managed by FlockDB and takes an average of 350 ms, and the service's Application Programming Interface (API) allows other web services and applications to integrate with Twitter. Twitter is described in a guide (retrieved October 2015 from https://g.twimg.com/business/pdfs/Twitter_Smallbiz_Guide.pdf) by Twitter, Inc., entitled: “Twitter for Small Business—A GUIDE TO GET STARTED”, which is incorporated in its entirety for all purposes as if fully set forth herein.

WhatsApp. WhatsApp is an instant messaging app developed by WhatsApp Inc. (headquartered in Mountain View, Calif.) for smartphones that operates under a subscription business model. The proprietary, cross-platform app uses the Internet to send text messages, images, video, user location and audio media messages. WhatsApp uses a customized version of the open standard Extensible Messaging and Presence Protocol (XMPP). Upon installation, it creates a user account using one's phone number as the username (Jabber ID: [phone number]@s.whatsapp.net) WhatsApp software automatically compares all the phone numbers from the device's address book with its central database of WhatsApp users to automatically add contacts to the user's WhatsApp contact list.

Multimedia messages are sent by uploading the image, audio or video to be sent to an HTTP server and then sending a link to the content along with its Base64 encoded thumbnail (if applicable). WhatsApp follows a ‘store and forward’ mechanism for exchanging messages between two users. When a user sends a message, it first travels to the WhatsApp server where it is stored. Then the server repeatedly requests the receiver acknowledge receipt of the message. As soon as the message is acknowledged, the server drops the message; it is no longer available in database of server. The WhatsApp service is described in an article published (Aug. 30, 2013) on MOBILE HCI 2013—COLLABORATION AND COMMUNICATION by Karen Church and Rodrigo de Oliveira (both of Telefonica Research) entitled: “What's up with WhatsApp? Comparing Mobile Instant—Messaging Behaviors with Traditional SMS”, which is incorporated in its entirety for all purposes as if fully set forth herein.

Viber. Viber is an instant messaging and Voice over IP (VoIP) app for smartphones developed by Viber Media, where in addition to instant messaging, users can exchange images, video and audio media messages. Viber works on both 3G/4G and Wi-Fi networks. Viber includes text, picture and video messaging across all platforms, with voice calling available only to iPhone, Android and Microsoft's Windows Phone. The application user interface includes tab bar on the bottom, giving access to messages, recent calls, contact, the keypad and a button for accessing more options. Upon installation, it creates a user account using one's phone number as username. Viber synchronizes with the phone's address book, so users do not need to add contacts in a separate book. Since all users are registered with their phone number, the software returns all Viber users among the user contacts.

Mail Server. Mail server (a.k.a. Email server, Electronic Mail server, Mail Exchanger—MX) refer to a server operating as an electronic post office for email exchanging across networks, commonly performing the server-side of an MTA function. A Message Transfer Agent (or Mail Transfer Agent—MTA), or mail relay is a software that transfers electronic mail messages from one computer to another using a client-server application architecture. An MTA typically implements both the client (sending) and server (receiving) portions of the Simple Mail Transfer Protocol (SMTP). The Internet mail architecture is described in IETF RFC 5598 entitled: “Internet Mail Architecture”, and the SMTP protocol is described in IETF RFC 5321 entitled: “Simple Mail Transfer Protocol” and in IETF RFC 7504 entitled: “SMTP 521 and 556 Reply Codes”, which are all incorporated in their entirety for all purposes as if fully set forth herein.

The Domain Name System (DNS) typically associates a mail server to a domain with mail exchanger (MX) resource records, containing the domain name of a host providing MTA services. A message transfer agent receives mail either from another MTA, a Mail Submission Agent (MSA), or a Mail User Agent (MUA). The transmission details are specified by the Simple Mail Transfer Protocol (SMTP). When a recipient mailbox of a message is not hosted locally, the message is relayed, that is, forwarded to another MTA. Every time an MTA receives an email message, it adds a ‘Received’ trace header field to the top of the header of the message, thereby building a sequential record of MTAs handling the message. The process of choosing a target MTA for the next hop is also described in SMTP, but can usually be overridden by configuring the MTA software with specific routes. Internet mail schemes are described in IEEE Annals of the History of Computing paper published 2008 by the IEEE Computer Society [1058-6180/08], authored by Craig Partridge of BBN Technologies entitled: “The technical Development of Internet Mail”, which is incorporated in its entirety for all purposes as if fully set forth herein.

A mail server infrastructure consists of several components that work together to send, relay, receive, store, and deliver email, and typically uses various Internet standard protocols for sending and retrieving email, such as the Internet standard protocol Simple Mail Transfer Protocol (SMTP) for sending email, the Internet standard protocols for retrieving email Post Office Protocol (POP), and Internet Message Access Protocol version 4 (IMAPv4). An example of a mail server software is ‘Microsoft Exchange Server 2013’ (available from Microsoft Corporation, headquartered in Redmond, Wash., U.S.A.), described in ‘Pocket Consultant’ book [ISBN: 978-0-7356-8168-2] published 2013 by Microsoft Press and entitled: “Microsoft Exchange Server 2013—Configuration & Clients”, which is incorporated in its entirety for all purposes as if fully set forth herein.

The POP is specified in IETF RFC 1939 entitled: “Post Office Protocol”, and updated specification with an extension mechanism is described in IETF RFC 2449 entitled: “POP3 Extension Mechanism”, and an authentication mechanism is described in IETF RFC 1734 entitled: “POP3 AUTHentication command”, which are all incorporated in their entirety for all purposes as if fully set forth herein. IMAP4 clients can create, rename, and/or delete mailboxes (usually presented to the user as folders) on the mail server, and copy messages between mailboxes, and this multiple mailbox support also allows servers to access shared and public folders. IMAP4 is described in IETF RFC 3501 entitled: “INTERNET MESSAGE ACCESS PROTOCOL—VERSION 4rev1”, and the IMAP4 Access Control List (ACL) Extension may be used to regulate access rights, and is described in IETF RFC 4314 entitled: “IMAP4 Access Control List (ACL) Extension”, which are both incorporated in their entirety for all purposes as if fully set forth herein.

Mail servers may be operated, or used by mailbox providers, and mail servers are described in U.S. Pat. No. 5,832,218 to Gibbs et al. entitled: “Client/server Electronic Mail System for Providing Off-Line Client Utilization and Seamless Server Resynchronization”, in U.S. Pat. No. 6,081,832 to Gilchrist et al. entitled: “Object Oriented Mail Server Framework Mechanism”, in U.S. Pat. No. 7,136,901 to Chung et al. entitled: “Electronic Mail Server”, and in U.S. Pat. No. 7,818,383 to Kodama entitled: “E-Mail Server”, which are all incorporated in their entirety for all purposes as if fully set forth herein.

XMPP. Extensible Messaging and Presence Protocol (XMPP) is an open standard communications protocol for message-oriented middleware based on XML (Extensible Markup Language) that enables the near-real-time exchange of structured yet extensible data between any two or more network entities. Designed to be extensible, the protocol has also been used for publish-subscribe systems, signaling for VoIP, video, file transfer, gaming, Internet of Things (IoT) applications such as the smart grid, and social networking services. The XMPP network uses a client-server architecture where clients do not talk directly to one another. The model is decentralized and anyone can run a server. By design, there is no central authoritative. Every user on the network has a unique XMPP address, called JID (for historical reasons, XMPP addresses are often called Jabber IDs). The JID is structured like an email address with a username and a domain name (or IP address) for the server where that user resides, separated by an ‘at’ sign (@), such as username@example.com. Since a user may wish to log in from multiple locations, they may specify a resource. A resource identifies a particular client belonging to the user (for example home, work, or mobile). This may be included in the JID by appending a slash followed by the name of the resource. For example, the full JID of a user's mobile account could be username@example.com/mobile. Each resource may have specified a numerical value called priority. Messages simply sent to username@example.com will go to the client with highest priority, but those sent to username@example.com/mobile will go only to the mobile client. The highest priority is the one with largest numerical value. JIDs without a username part are also valid, and may be used for system messages and control of special features on the server. A resource remains optional for these JIDs as well. XMPP is described in IETF RFC 6120 entitled: “Extensible Messaging and Presence Protocol (XMPP): Core”, which describes client-server messaging using two open-ended XML streams, in IETF RFC 6121 entitled: “Extensible Messaging and Presence Protocol (XMPP): Instant Messaging and Presence”, which describes instant messaging (IM), the most common application of XMPP, and in IETF RFC 6122 entitled: “Extensible Messaging and Presence Protocol (XMPP): Address Format”, which describes the rules for XMPP addresses, also called JabberIDs or JIDs.

SIMPLE. The Session Initiation Protocol (SIP) for Instant Messaging and Presence Leveraging Extensions (SIMPLE) is an open standard Instant Messaging (IM) and presence protocol suite based on Session Initiation Protocol (SIP) managed by the Internet Engineering Task Force. The SIMPLE presence use the core protocol machinery that provides the actual SIP extensions for subscriptions, notifications and publications. IETF RFC 6665 defines the SUBSCRIBE and NOTIFY methods, where SUBSCRIBE allows to subscribe to an event on a server, and the server responds with NOTIFY whenever the event come up. IETF RFC 3856 defines how to make use of SUBSCRIBE/NOTIFY for presence. Two models are defined: an end-to-end model in which each User Agent handles presence subscriptions itself, and a centralized model. The message PUBLISH (IETF RFC 3903) allows User Agents to inform the presence server about their subscription states.

SIP defines two modes of instant messaging: The Page Mode makes use of the SIP method MESSAGE, as defined in IETF RFC 3428. This mode establishes no sessions, and the Session Mode. The Message Session Relay Protocol (RFC 4975, RFC 4976) is a text-based protocol for exchanging arbitrarily-sized content between users, at any time. An MSRP session is set up by exchanging certain information, such as an MSRP URI, within SIP and SDP signaling. SIMPLE is described in IETF RFC 6914 entitled: “SIMPLE Made Simple: An Overview of the IETF Specifications for Instant Messaging and Presence Using the Session Initiation Protocol (SIP)”, which is incorporated in its entirety for all purposes as if fully set forth herein.

Any message herein may comprise the time of the message and the controlled switch status, and may be sent over the Internet via the wireless network to a client device using a peer-to-peer scheme. Alternatively or in addition, any message herein may be sent over the Internet via the wireless network to an Instant Messaging (IM) server for being sent to a client device as part of an IM service. The message or the communication with the IM server may use, or may be based on, SMTP (Simple Mail Transfer Protocol), SIP (Session Initiation Protocol), SIMPLE (SIP for Instant Messaging and Presence Leveraging Extensions), APEX (Application Exchange), Prim (Presence and Instance Messaging Protocol), XMPP (Extensible Messaging and Presence Protocol), IMPS (Instant Messaging and Presence Service), RTMP (Real Time Messaging Protocol), STM (Simple TCP/IP Messaging) protocol, Azureus Extended Messaging Protocol, Apple Push Notification Service (APNs), or Hypertext Transfer Protocol (HTTP). The message may be a text-based message and the IM service may be a text messaging service, and may be according to, or may be based on, a Short Message Service (SMS) message and the IM service may be a SMS service, the message may be according to, or based on, an electronic-mail (e-mail) message and the IM service may be an e-mail service, the message may be according to, or based on, WhatsApp message and the IM service may be a WhatsApp service, the message may be according to, or based on, an Twitter message and the IM service may be a Twitter service, or the message may be according to, or based on, a Viber message and the IM service may be a Viber service. Alternatively or in addition, the message may be a Multimedia Messaging Service (MMS) or an Enhanced Messaging Service (EMS) message that includes an audio or video data, and the IM service may respectively be a MMS or EMS service.

IP. The Internet Protocol (IP) is the principal communications protocol used for relaying datagrams (packets) across a network using the Internet Protocol Suite. It is considered as the primary protocol that establishes the Internet, and is responsible for routing packets across the network boundaries. IP is the primary protocol in the Internet Layer of the Internet Protocol Suite, and is responsible for delivering datagrams from the source host to the destination host based on their addresses. For this purpose, IP defines addressing methods and structures for datagram encapsulation. Internet Protocol Version 4 (IPv4) is the dominant protocol of the Internet. IPv4 is described in Internet Engineering Task Force (IETF) Request for Comments (RFC) 791 and RFC 1349, and the successor, Internet Protocol Version 6 (IPv6), is currently active and in growing deployment worldwide. IPv4 uses 32-bit addresses (providing 4 billion: 4.3×10⁹ addresses), while IPv6 uses 128-bit addresses (providing 340 undecillion or 3.4×10³⁸ addresses), as described in RFC 2460.

The Internet Protocol is responsible for addressing hosts and routing datagrams (packets) from a source host to the destination host across one or more IP networks. For this purpose, the Internet Protocol defines an addressing system that has two functions. Addresses identify hosts, and provide a logical location service. Each packet is tagged with a header that contains the meta-data for the purpose of delivery. This process of tagging is also called encapsulation. IP is a connectionless protocol for use in a packet-switched Link Layer network, and does not need circuit setup prior to transmission. The aspects of guaranteeing delivery, proper sequencing, avoidance of duplicate delivery, and data integrity are addressed by an upper transport layer protocol (e.g., TCP—Transmission Control Protocol and UDP—User Datagram Protocol).

The main aspects of the IP technology are IP addressing and routing. Addressing refers to how IP addresses are assigned to end hosts, and how sub-networks of IP host addresses are divided and grouped together. IP routing is performed by all hosts, but most importantly, by internetwork routers, which typically use either Interior Gateway Protocols (IGPs) or External Gateway Protocols (EGPs) to help make IP datagram forwarding decisions across IP connected networks. Core routers serving in the Internet backbone commonly use the Border Gateway Protocol (BGP) as per RFC 4098 or Multi-Protocol Label Switching (MPLS). Other prior art publications relating to Internet related protocols and routing include the following chapters of the publication number 1-587005-001-3 by Cisco Systems, Inc. (July 1999) entitled: “Internetworking Technologies Handbook”, which are all incorporated in their entirety for all purposes as if fully set forth herein: Chapter 5: “Routing Basics” (pages 5-1 to 5-10), Chapter 30: “Internet Protocols” (pages 30-1 to 30-16), Chapter 32: “IPv6” (pages 32-1 to 32-6), Chapter 45: “OSI Routing” (pages 45-1 to 45-8) and Chapter 51: “Security” (pages 51-1 to 51-12), as well as in a IBM Corporation, International Technical Support Organization Redbook Documents No. GG24-4756-00 entitled: “Local Area Network Concepts and Products: LAN Operation Systems and Management”, 1^{st} Edition May 1996, Redbook Document No. GG24-4338-00, entitled: “Introduction to Networking Technologies”, 1^{st} Edition April 1994, Redbook Document No. GG24-2580-01 “IP Network Design Guide”, 2^{nd} Edition June 1999, and Redbook Document No. GG24-3376-07 “TCP/IP Tutorial and Technical Overview”, ISBN 0738494682 8^{th} Edition December 2006, which are incorporated in their entirety for all purposes as if fully set forth herein. Programming, designing, and using the Internet is described in a book by Paul S. Wang and Sanda Katila entitled: “An Introduction to Web Design+Programming” (Brooks/Cole book/Dec. 24, 2003), which is incorporated in its entirety for all purposes as if fully set forth herein.

Memory. The terms “memory” and “storage” are used interchangeably herein and refer to any physical component that can retain or store information (that can be later retrieved) such as digital data on a temporary or permanent basis, typically for use in a computer or other digital electronic device. A memory can store computer programs or any other sequence of instructions, or data such as files, text, numbers, audio and video, as well as any other form of information represented as a string of bits or bytes. The physical means of storing information may be electrostatic, ferroelectric, magnetic, acoustic, optical, chemical, electronic, electrical, or mechanical. A memory may be in a form of Integrated Circuit (IC, a.k.a. chip or microchip). Alternatively or in addition, the memory may be in the form of a packaged functional assembly of electronic components (module). Such module may be based on a PCB (Printed Circuit Board) such as PC Card according to Personal Computer Memory Card International Association (PCMCIA) PCMCIA 2.0 standard, or a Single In-line Memory Module (SIMM) (or DIMM) which is standardized under the JEDEC JESD-21C standard. Further, a memory may be in the form of a separately rigidly enclosed box such as a hard-disk drive.

Semiconductor memory may be based on Silicon-On-Insulator (SOI) technology, where a layered silicon-insulator-silicon substrate is used in place of conventional silicon substrates in semiconductor manufacturing, especially microelectronics, to reduce parasitic device capacitance and thereby improving performance. SOI-based devices differ from conventional silicon-built devices in that the silicon junction is above an electrical insulator, typically silicon dioxide or sapphire (these types of devices are called silicon on sapphire, or SOS, and are less common). SOI-Based memories include Twin Transistor RAM (TTRAM) and Zero-capacitor RAM (Z-RAM).

A memory may be a volatile memory, where a continuous power is required to maintain the stored information such as RAM (Random Access Memory), including DRAM (Dynamic RAM) or SRAM (Static RAM), or alternatively be a non-volatile memory which does not require a maintained power supply, such as Flash memory, EPROM, EEPROM and ROM (Read-Only Memory). Volatile memories are commonly used where long-term storage is required, while non-volatile memories are more suitable where fast memory access is required. Volatile memory may be dynamic, where the stored information is required to be periodically refreshed (such as re-read and then re-written) such as DRAM, or alternatively may be static, where there is no need to refresh as long as power is applied, such as RAM. In some cases, a small battery is connected to a low-power consuming volatile memory, allowing its use as a non-volatile memory.

A memory may be read/write (or mutable storage) memory where data may be overwritten more than once and typically at any time, such as RAM and Hard Disk Drive (HDD). Alternatively, a memory may be an immutable storage where the information is retained after being written once. Once written, the information can only be read and typically cannot be modified, sometimes referred to as Write Once Read Many (WORM). The data may be written at the time of manufacture of the memory, such as mask-programmable ROM (Read Only Memory) where the data is written into the memory a part of the IC fabrication, CD-ROM (CD—Compact Disc) and DVD-ROM (DVD—Digital Versatile Disk, or Digital Video Disk). Alternately, the data may be once written to the “write once storage” at some point after manufacturing, such as Programmable Read-Only Memory (PROM) or CD-R (Compact Disc-Recordable).

A memory may be accessed using “random access” scheme, where any location in the storage can be accessed at any moment in typically the same time, such as RAM, ROM or most semiconductor-based memories. Alternatively, a memory may be of “sequential access” type, where the pieces of information are gathered or stored in a serial order, and therefore the time to access a particular piece of information or a particular address depends upon which piece of information was last accessed, such as magnetic tape-based storage. Common memory devices are location-addressable, where each individually accessible unit of data in storage is selected using its numerical memory address. Alternatively, a memory may be file-addressable, where the information is divided into files of variable length, and a file is selected by using a directory or file name (typically a human readable name), or may be content-addressable, where each accessible unit of information is selected based on the stored content (or part of). File addressability and content addressability commonly involves additional software (firmware), hardware, or both.

Various storage technologies are used for the medium (or media) that actually holds the data in the memory. Commonly in use are semiconductor, magnetic, and optical mediums. Semiconductor based medium is based on transistors, capacitors or other electronic components in an IC, such as RAM, ROM and Solid-State Drives (SSDs). A currently popular non-volatile semiconductor technology is based on a flash memory, and can be electrically erased and reprogrammed. The flash memory is based on NOR- or NAND-based single-level cells (SLC) or multi-level cells (MLC), made from floating-gate transistors. Non-limiting examples of applications of flash memory include personal and laptop computers, PDAs, digital audio players (MP3 players), digital cameras, mobile phones, synthesizers, video games consoles, scientific instrumentation, industrial robotics and medical electronics. The magnetic storage uses different types of magnetization on a magnetic or a ferromagnetic coated surface as a medium for storing the information. The information is accessed by read/write heads or other transducers. Non-limiting examples of magnetic-based memory are Floppy disk, magnetic tape data storage and HDD.

In optical storage, typically an optical disc is used that stores information in deformities on the surface of a circular disc, and the information is read by illuminating the surface with a laser diode and observing the reflection. The deformities may be permanent (read only media), formed once (write once media) or reversible (recordable or read/write media). Non-limiting examples of read-only storage, commonly used for mass distribution of digital information such as music, audio, video or computer programs, include CD-ROM, BD-ROM (BD—Blu-ray Disc) and DVD-ROM. Non-limiting examples of write-once storage are CD-R, DVD-R, DVD+R, and BD-R, and non-limiting examples of recordable storage are CD-RW (Compact Disc-ReWritable), DVD-RW, DVD+RW, DVD-RAM, and BD-RE (Blu-ray Disc Recordable Erasable). Another non-limiting example is magneto-optical disc storage, where the magnetic state of a ferromagnetic surface stores the information, which can be read optically. 3D optical data storage is an optical data storage, in which information can be recorded and/or read, with three-dimensional resolution.

A storage medium may be removable, designed to be easily removed from, and easily installed or inserted into the computer by a person, typically without the need for any tool, and without needing to power off the computer or the associated drive. Such a capability allows for archiving, transporting data between computers, and buying and selling software. The medium may be read using a reader or player that reads the data from the medium, may be written by a burner or writer, or may be used for writing and reading by a writer/reader commonly referred to as a drive. Commonly in the case of magnetic or optical based mediums, the medium has the form factor of a disk, which is typically a round plate on which the data is encoded, respectively known as magnetic disc and optical disk. The machine that is associated with reading data from and writing data onto a disk is known as a disk drive. Disk drives may be internal (integrated within the computer enclosure) or may be external (housed in a separate box that connects to the computer). Floppy disks, that can be read from or written on by a floppy drive, are a non-limiting example of removable magnetic storage medium, and CD-RW (Compact Disc-ReWritable) is a non-limiting example of a removable optical disk. A commonly-used non-volatile removable semiconductor based storage medium is referred to as a memory card. A memory card is a small storage device, commonly based on flash memory, and can be read by a suitable card reader.

A memory may be accessed via a parallel connection or bus (wherein each data word is carried in parallel on multiple electrical conductors or wires), such as PATA, PCMCIA or EISA, or via serial bus (such as bit-serial connections) such as USB or Ethernet based on IEEE802.3 standard, or a combination of both. The connection may further be wired in various topologies such as multi-drop (electrical parallel), point-to-point, or daisy-chain. A memory may be powered via a dedicated port or connector, or may be powered via a power signal carried over the bus, such as SATA or USB.

An attack or intrusion of a wired network may include connecting of non-legitimate or unauthorized device to the network, or disconnecting (or removal) of a legitimate or authorized device from the network. In one example, the network is compromised by the connecting of an unauthorized device as an additional network node for eavesdropping to the traffic carried over the network. Alternatively or in addition, the added unauthorized device may use malware for transmitting harmful or non-legitimate information to the network, to be used or analyzed for a harmful purpose by the legitimately connected nodes. If not detected, the unauthorized device may harmfully participate in the wired network. Such an intrusion in a wired network typically takes the form of wire-tapping to the wired network medium, allowing for monitoring or recording the data over the network by a non-authorized third party. Passive wiretapping monitors or records the traffic, while active wiretapping alters or otherwise affects it. Protection against active wire-tapping in which the attacker attempts to seize control of a communication association, e.g. packet injection or modifying, hijacking sessions, TCP sequence number attacks, piggyback attacks, man-in-the-middle attacks, spoofing etc.

An approach of outsourcing the management and operation of home networks to a third party that has both operations expertise and a broader view of network activity (rather than having individual networks managed independently) is described in a paper by Nick Feamster (of School of Computer Science, Georgia Tech) Published in HomeNets 2010 Sep. 3, 2010, New Delhi, India [2010 ACM 9781450301982/10/09..$10.00] entitled: “Outsourcing Home Network Security”, which is incorporated in its entirety for all purposes as if fully set forth herein. The growth of home and small enterprise networks brings with it a large number of devices and networks that are either managed poorly or not at all. Hosts on these networks may become compromised and become sources of spam, denial of-service traffic, or the site of a scam or phishing attack site. Although a typical user now knows how to apply software updates and run anti-virus software, these techniques still require user vigilance, and they offer no recourse when a machine ultimately becomes compromised. The approach harnesses two trends: (1) the advent of programmable network switches, which offer flexibility and the possibility for remote management; and (2) the increasing application of distributed network monitoring and inference algorithms to network security problems (an appealing technique because of its ability to reveal coordinated behavior that may represent an attack).

The inventive methodology of an integrated plug and play solution designed to protect home networks against spam, phishing emails, viruses, spyware as well as other similar threats is described in U.S. Pat. No. 7,904,518 to Marino et al. entitled: “Apparatus and method for analyzing and filtering email and for providing web related services”, which is incorporated in its entirety for all purposes as if fully set forth herein. The described content filtering appliance can be used for processing of web and email traffic implemented and can be deployed as a stand-alone appliance. In one implementation, the content processing appliance utilizes backend content filtering provided by a remote scanning service accessed via a network. The system employs network level analysis and translation of content and executes various procedures to handle the network traffic. In an embodiment of the invention, the appliance is provided with an automatic remote updating capability, wherein the software and data used by the appliance can be updated remotely via a network. Finally, the appliance may also implement parental controls.

According to one embodiment, in response to receiving a plurality of uniform resource locator (URL) links for malicious determination, any known URL links are removed from the URL links based on a list of known link signatures, as described in U.S. Pat. No. 9,300,686 to Pidathala et al. entitled: “System and method for detecting malicious links in electronic messages”, which is incorporated in its entirety for all purposes as if fully set forth herein. For each of remaining URL links that are unknown, a link analysis is performed on the URL link based on link heuristics to determine whether the URL link is suspicious. For each of the suspicious URL links, a dynamic analysis is performed on a resource of the suspicious URL link. It is classified whether the suspicious URL link is a malicious link based on a behavior of the resource during the dynamic analysis.

Methods, apparatus and computer program products that protect networks from malware and botnet activity are disclosed in U.S. Patent Application Publication No. 2010/0162399 to Sheleheda et al. entitled: “Methods, apparatus, and computer program products that monitor and protect home and small office networks from botnet and malware activity”, which is incorporated in its entirety for all purposes as if fully set forth herein. The methods, the apparatus, and the computer program include collecting xFlow data associated with a network, analyzing the collected xFlow data to detect anomalous traffic on the network, investigating the presence of malware on the network in response to detecting anomalous traffic on the network, and taking remedial action to eradicate and/or isolate malware detected on the network. Collecting xFlow data includes capturing xFlow data at a router that connects the network and a communications network, and sending the captured xFlow data to a local or remote xFlow collector. Analyzing collected xFlow data, locally or remotely, to detect anomalous traffic includes applying one or more activity profiling algorithms to the xFlow data.

Malware. Malware, short for ‘malicious software’, is a general term used to refer to a variety of forms of hostile or intrusive software. Typically, a malware is software or program that is inserted into a system, usually covertly, with the intent of compromising the confidentiality, integrity, or availability of the victim's data, applications, or operating system or of otherwise annoying or disrupting the victim. Malware is commonly used or programmed by attackers to disrupt computer operation, gather sensitive information, or gain access to private computer systems. It can appear in the form of code, scripts, active content, firmware, and other software. Malware may be used to steal sensitive information of personal, financial, or business importance by black hat hackers with harmful intentions. Malware is sometimes used broadly against governments or corporations to gather guarded information, or to disrupt their operation in general. However, malware is often used against individuals to gain personal information such as social security numbers, bank or credit card numbers, and so on. Left unguarded, personal and networked computers can be at considerable risk of these threats. Malware includes computer viruses, ransomware, worms, Trojan horses, rootkits, backdoors, keyloggers, dialers, spyware, adware, malicious BHOs, rogue security software and other malicious programs. Some malware is disguised as genuine software, and may come from an official company website, or otherwise in the form of a useful or attractive program that has the harmful malware embedded in it along with additional tracking software. Further, as used herein, a malware will include any non-authentic software or firmware, such as software/firmware (or changes in such software) in a device that was not originally installed by the device manufacturer. Various security technologies are described in chapter 51 entitled: “Security Technologies” of The Internetworking Technology Overview by Cisco Systems, Inc. [published June 1999, Document No. 1-58705-001-3], which is incorporated in its entirety for all purposes as if fully set forth herein.

A computer virus is a form of malware that is designed to self-replicate, make copies of itself, and distribute the copies to other files, programs, or computers, without the user's consent. When executed, the virus replicates by inserting copies of itself (possibly modified) into other computer programs, data files, or the boot sector of the hard drive. Once this replication succeeds, the affected areas are then said to be “infected”. Viruses often perform some type of harmful activity on infected hosts, such as stealing hard disk space or CPU time, accessing private information, corrupting data, displaying political or humorous messages on the user's screen, spamming their contacts, or logging their keystrokes. Virus writers commonly use social engineering, and exploit detailed knowledge of security vulnerabilities to gain access to their hosts' computing resources. Motives for creating viruses can include seeking profit, desire to send a political message, personal amusement, to demonstrate that a vulnerability exists in the software, for sabotage and denial of service, or simply because they wish to explore artificial life and evolutionary algorithms.

Ransomware (which when carried out correctly is called cryptoviral extortion, but is sometimes also called scareware) comprises a class of malware which restricts access to the computer system that it infects, and demands a ransom paid to the creator of the malware in order for the restriction to be removed. Some forms of ransomware encrypt files on the system's hard drive, while some may simply lock the system and display messages intended to coax the user into paying. Ransomware typically propagates like a conventional computer worm, entering a system through, for example, a downloaded file or vulnerability in a network service. The program will then run a payload: such as one that will begin to encrypt personal files on the hard drive. Ransomware payloads, especially ones that do not encrypt files, utilize elements of scareware to coax the user into paying for its removal. The payload may, for example, display notices purportedly issued by companies or law enforcement agencies which falsely claim that the user's system had been used for illegal activities, or contains illegal content such as pornography, and unlawfully obtained software. In any case, the ransomware will attempt to extort money from the system's user by forcing them to purchase either a program to decrypt the files it had encrypted, or an unlock code which will remove the locks it had applied.

A computer worm is a standalone malware computer program that is completely self-contained and self-propagating, and replicates itself in order to spread to other computers. Often, it uses a computer network to spread itself, relying on security failures on the target computer to access it. Unlike a computer virus, it does not need to attach itself to an existing program. Worms usually cause at least some harm to the network, even if only by consuming bandwidth, whereas viruses usually corrupt or modify files on a targeted computer. Many worms that have been created are designed only to spread, and do not attempt to change the systems they pass through. However, even these “payload free” worms can cause major disruption by increasing network traffic and other unintended effects. A “payload” code in the worm is designed to do more than spread the worm—it might delete files on a host system (e.g., the ExploreZip worm), encrypt files in a cryptoviral extortion attack, or send documents via e-mail. A very common payload for worms is to install a backdoor on the infected computer to allow the creation of a “zombie” computer under control of the worm author. Networks of such machines are often referred to as botnets and are very commonly used by spam senders for sending junk email or to cloak their website's address. Backdoors can be exploited by other malware, including worms.

A ‘Trojan horse’, or ‘Trojan’, is a non-self-replicating type of malware program that appears to be benign but actually has a hidden malicious purpose, which commonly gains privileged access to the operating system while appearing to perform a desirable function but instead, drops a malicious payload, often including a backdoor allowing unauthorized access to the target's computer. These backdoors tend to be invisible to average users, but may cause the computer to run slow. Trojans do not attempt to inject themselves into other files like a computer virus, but may steal information, or harm their host computer systems. Trojans may use drive-by downloads or install via online games or Internet-driven applications in order to reach target computers.

A rootkit is a collection of files that is installed on a system to alter the standard functionality of the system in a malicious and stealthy way. Often malicious, the rootkit is designed to hide the existence of certain processes or programs from the normal methods of detection, and enable continued privileged access to a computer. Rootkit installation can be automated, or an attacker can install it once they've obtained root or Administrator access. Obtaining this access is a result of a direct attack on a system, such as by exploiting a known vulnerability or password (either by cracking, privilege escalation, or social engineering). Once installed, it becomes possible to hide the intrusion as well as to maintain privileged access. Full control over a system means that existing software can be modified, including software that might otherwise be used to detect or circumvent it. Rootkit detection is difficult because a rootkit may be able to subvert the software that is intended to find it. Detection methods include using an alternative and trusted operating system, behavioral-based methods, signature scanning, difference scanning, and memory dump analysis. Removal can be complicated or practically impossible, especially in cases where the rootkit resides in the kernel; reinstallation of the operating system may be the only available solution to the problem. When dealing with firmware rootkits, removal may require hardware replacement, or specialized equipment.

Keystroke logging, often referred to as ‘keylogging’ or ‘Keyboard Capturing’, is the action of recording (or logging) or monitoring the keys struck on a keyboard, typically in a covert manner so that the person using the keyboard is unaware that their actions are being monitored. It also has very legitimate uses in studies of human-computer interaction. There are numerous keylogging methods, ranging from hardware and software-based approaches to acoustic analysis.

Spyware is a malware that is intended to violate a user's privacy, typically by gathering information about a person or organization without their knowledge, and that may send such information to another entity without the user's consent, or that asserts control over a computer without the consumer's knowledge. These programs may be designed to monitor users' web browsing, display unsolicited advertisements, or redirect affiliate marketing revenues to the spyware creator. “Spyware” is mostly classified into four types: system monitors, Trojans, adware, and tracking cookies. Spyware is mostly used for the purposes such as tracking and storing internet users' movements on the web, and serving up pop-up ads to internet users. Whenever spyware is used for malicious purposes, its presence is typically hidden from the user, and can be difficult to detect. Some spyware, such as keyloggers, may be installed by the owner of a shared, corporate, or public computer intentionally in order to monitor users. The functions of spyware can extend beyond simple monitoring. Spyware can collect almost any type of data, including personal information like Internet surfing habits, user logins, and bank or credit account information. Spyware can also interfere with user control of a computer by installing additional software, or redirecting Web browsers. Some spyware can change computer settings, which can result in slow Internet connection speeds, un-authorized changes in browser settings, or changes to software settings. Sometimes, spyware is included along with genuine software, and may come from a malicious website.

Spyware does not necessarily spread in the same way as a virus or worm because infected systems generally do not attempt to transmit, or copy the software to other computers. Instead, spyware installs itself on a system by deceiving the user, or by exploiting software vulnerabilities. Most spyware is installed without users' knowledge, or by using deceptive tactics. Spyware may try to deceive users by bundling itself with desirable software. Other common tactics are using a Trojan horse. Some spyware authors infect a system through security holes in the Web browser or in other software, so that when the user navigates to a Web page controlled by the spyware author, the page contains code that attacks the browser and forces the download and installation of the spyware.

A backdoor is a method of bypassing normal authentication procedures, securing illegal remote access to a computer, obtaining access to plaintext, and so on, while attempting to remain undetected. Commonly a backdoor is a malicious program that listens for commands on a certain Transmission Control Protocol (TCP) or User Datagram Protocol (UDP) port. Once a system has been compromised, one or more backdoors may be installed in order to allow easier unauthorized access in the future. Backdoors may also be installed prior to other malicious software, to allow attackers entry. A backdoor in a login system might take the form of a hard-coded user and password combination that gives access to the system. The backdoor may take the form of an installed program (e.g., Back Orifice) or may subvert the system through a rootkit.

Firewall. As used herein, the term ‘firewall’ is a device that inspects network traffic passing through it, and may perform actions, such as denying or permitting passage of the traffic based on a set of rules. Firewalls may be implemented as stand-alone network devices or, in some cases, integrated in a single network device, such as a router or switch that performs other functions. For instance, a network switch may perform firewall related functions as well as switching functions. A firewall may be implemented using a hardware and/or software-based, and may include all necessary subsystems that may control incoming and outgoing network traffic based on an applied rule set. A firewall may be used to establish a barrier between a trusted, secure internal network and another network, such as the Internet, that may not be secure and trusted. Firewalls exist both as software to run on general purpose hardware and as a hardware appliance. Many hardware-based firewall environments also offer other functionalities to the internal network that the firewall environments protect.

Apparatus and methods prevent malicious data in Universal Serial Bus (USB) configurations by providing a hardware firewall, is described in U.S. Pat. No. 8,646,082 to Lomont et al. entitled: “USB Firewall Apparatus and Method”, which is incorporated in its entirety for all purposes as if fully set forth herein. A hardware device interconnected between a host and the USB monitors communication packets and blocks packets having unwanted or malicious intent. The device may act as a hub, enabling multiple devices to connect to a single host. The device may only allow mass storage packets from a device recognized as a mass storage device. The device may block enumeration of unwanted devices by not forwarding packets between the device and the host. The device may be operative to assign a bogus address to a malicious device so as not to transfer communications from the device further up the chain to the host. The device may provide shallow or deep packet inspection to determine when a trusted device is sending possible malicious data, or provide packet validation to block packets that are malformed.

An example of using a firewall for protecting a network is described as an arrangement 40 shown in FIG. 4. A network 41 connects the data server #3 23c, the data server #4 23d, the client device #3 24c, and the client device #4 24d. For example, the network 41 may be a private network that is owned, operated, and used by a single entity, such as a business or an enterprise, and may be in a single location, such as a campus, a building, or a floor, such as a LAN. The firewall device (or functionality) 50 is connected between the External Network I 42, which is an untrusted network, and may be a public network such as the Internet, and the network 41. Thus the firewall 50 is protecting the protected network 41 from any malware that may arrive from the public or external network I 42, by forming a non-protected side or zone 43a, which is separated from a protected side or zone 43a.

One disadvantage of using the firewall 50 as shown in the arrangement 40 is that the firewall 50 serves a single point of connection and checking point between the protected network 41 and the external network I 42. Hence, in a case where the protected network 41 is to be connected to two external networks, which may be connected in different locations or edges of the network 41, two firewall devices may be required. Such an arrangement 40a where the network 41 is connected to two external networks, the External Network I 42 and the External Network II 42a is shown in FIG. 4a. In order to protect the network 41 from malware arriving from (or to) the additional External Network II 42a, which may connect to the network 41 at a distinct and separate point, an additional firewall device 50a is added between the External Network II 42a and the protected network 41.

One disadvantage of using the firewall 50 as shown in the arrangement 40 is that the protection fails to detect or avoid any malware that is internal to the network 41 or to the protected side or zone 43b. In an arrangement 40b shown in FIG. 4b, the client device 24c is replaced (either by mistake or as part of an attack) with another client device #3 24′c, which includes a memory 45 that stores a malware 46. Alternatively or in addition, the user of the client #3 24c may unintentionally or by mistake download the malware 46 to the memory 45, rendering it an infected computer 24′c. Upon operation, the malware 46 may infect or damage the network 41 operation. Since the firewall device 50 only checks the traffic flowing between the External Network I 42 and the protected network 41, such malware 46 cannot be detected by the firewall 50.

A schematic functional block diagram 50 of a firewall is shown as part of an arrangement 55 shown in FIG. 5. The firewall device 50 comprises a physical layer handling PHY2 51b for interfacing with the External Network I 42. Such a physical layer interface 51b may comprise a transceiver and a port (such as a connector for connecting to a wired medium or an antenna for communicating over the air in case of a RF-based wireless network) for physical connecting to the External Network I 42. Similarly, the firewall device 50 comprises a physical layer handling PHY1 51a for interfacing with the Protected Network 41. Such a physical layer interface 51a may comprise a transceiver and a port (such as a connector for connecting to a wired medium or an antenna for communicating over the air in case of a RF-based wireless network) for physical connecting to the Protected Network 41. Adapting between layers that are above the physical layer is handled by an adapter 52. For example, the adapter 52 may include Layer-2 handling, such as switching functionality, for handling at the Ethernet frame level. Alternatively or in addition, the adapter 52 may include Layer-3 handling, such as IP routing functionality, for handling at the IP packet level. Further, the adapter 52 may be used for converting between different protocols or rates of the two connected networks. The firewall dedicated functionality is handled by an analyzer functionality 53, which analyzes messages received from the External Network I 42, and makes a decisions according to pre-set criteria, such as whether to block or pass the received messages. Hence, messages (e.g., frames, packets, TCP sessions, or any data stream) that are received from the External Network I 42 via the PHY2 51b, are processed and analyzed according to pre-set rules by the adapter 52, and then are either blocked or forwarded to the Protected Network 41 via the PHY1 51a, where the adapter 52 may be used for general interfacing between the two connected networks. Similarly, messages (e.g., frames, packets, TCP sessions, or any data stream) that are received from the Protected Network 41 via the PHY1 51a, are processed and analyzed according to pre-set rules by the adapter 52, and then are either blocked or forwarded to the External Network I 42 via the PHY2 51b, where the adapter 52 may be used for general interfacing between the two connected networks.

An example of using a vehicular firewall 50b that is based on the firewall 50 shown in FIG. 5 as part of a vehicle system 21a, is described in an arrangement 60 shown in FIG. 6, which is based on the vehicle 21 in the arrangement 20 shown in FIG. 2. The firewall 50b may be part of, integrated with, or may include, an ECU, such as the communication ECU 22a. The PHY2 51b for connecting to the wireless network 39 (corresponding to the External Network I 42) may include the antenna 29 and the wireless transceiver 28. Similarly, the PHY1 51a for connecting to the vehicle bus 23 (corresponding to the Protected Network 41) may include the CAN controller 33 and the CAN transceiver 36. The adapter 52 serves for adapting between the networks, and the firewall functionality is based on the analyzer functionality 53.

In one example, the protected network 41 consists of, comprises, or is based on, a wired (wireline) network, using a conductive medium. In such a case, the PHY1 51a of the adapter device 70 is a connector suitable for connecting to the medium, and the adapter 70 further comprises a wired transceiver connected to the connector for transmitting to, and receiving from, the medium of the protected network 41. In one example, the external network I 42 consists of, comprises, or is based on, a wired (wireline) network, using a conductive medium that may be identical to, similar to, or different from, the medium of the protected network 41. In such a case, the PHY2 51b of the adapter device 70 is a connector suitable for connecting to the medium of the external network I 42, and the adapter 70 further comprises a wired transceiver connected to the connector of PHY2 51b for transmitting to, and receiving from, the medium of the external network I 42.

For example, in response to detecting a match between a received identifier and a stored identifier, the CAN node can be configured to immediately send an error signal such as an error flag onto the CAN bus to prevent the malicious CAN message from being successfully and completely received by any CAN nodes on the CAN bus, e.g., to invalidate, destroy, and/or kill the CAN message. Applying such a technique, only the original CAN node that uses a particular identifier can send CAN messages with that identifier without the CAN messages being invalidated, destroyed, and/or killed.

A Cyclic Redundancy Check (CRC) is an error-detecting code commonly used in digital networks and storage devices to detect accidental changes to raw data. Blocks of data entering these systems get a short check value attached, based on the remainder of a polynomial division of their contents. On retrieval, the calculation is repeated and, in the event the check values do not match, corrective action can be taken against data corruption. CRCs can be used for error correction. The check (data verification) value is a redundancy (it expands the message without adding information) and the algorithm is based on cyclic codes, and because the check value has a fixed length, the function that generates it is occasionally used as a hash function. CRCs are commonly based on the theory of cyclic error-correcting codes. Specification of a CRC code requires definition of a generator polynomial, where this polynomial becomes the divisor in a polynomial long division, which takes the message as the dividend and in which the quotient is discarded and the remainder becomes the result. The important caveat is that the polynomial coefficients are calculated according to the arithmetic of a finite field, so the addition operation can always be performed bitwise-parallel (there is no carry between digits). The length of the remainder is always less than the length of the generator polynomial, which therefore determines how long the result can be.

In practice, all commonly used CRCs employ the Galois field of two elements, GF(2). The two elements are usually called 0 and 1, comfortably matching computer architecture. A CRC is called an n-bit CRC when its check value is n bits long. For a given n, multiple CRCs are possible, each with a different polynomial. Such a polynomial has highest degree n, which means it has n+1 terms. In other words, the polynomial has a length of n+1; its encoding requires n+1 bits. Note that most polynomial specifications either drop the MSB or LSB, since they are always 1. The simplest error-detection system, the parity bit, is in fact a trivial 1-bit CRC: it uses the generator polynomial x+1 (two terms), and has the name CRC-1. A CRC-enabled device calculates a short, fixed-length binary sequence, known as the check value or CRC, for each block of data to be sent or stored and appends it to the data, forming a codeword. When a codeword is received or read, the device either compares its check value with one freshly calculated from the data block, or equivalently, performs a CRC on the whole codeword and compares the resulting check value with an expected residue constant. If the CRC values do not match, then the block contains a data error. The device may take corrective action, such as rereading the block or requesting that it be sent again. Otherwise, the data is assumed to be error-free (though, with some small probability, it may contain undetected errors; this is the fundamental nature of error-checking).

In one example, the corruption is achieved by transmitting a signal that changes the value of a single bit in the message. This single bit change renders a CRC error, which may be used by the receiving devices as an indicator of an invalidated or corrupted message that needs to be ignored. Alternatively or in addition, multiple bits, which may be carried sequentially or non-sequentially in the message (frame or packet), are changed by the transmitted corrupting signal. Alternatively or in addition, the corrupting signal may change a value in one or more fields in the frame (or packet), rendering this field non-legitimate according to the agreed upon or used communication protocol. In one example, such as in a CAN protocol, the corrupting signal may generate a sequence of six or more consecutive identical bits when received by the devices over the bus, known to be a standard CAN error frame. Further, one or more defined flags in the message, such as error flag may be set by the corrupting signal. When the message uses recessive (‘1’) and dominant (‘0’) (non-recessive) bits, the corrupting signal may convert a recessive bit (or multiple bits) to a dominant one, or may convert a dominant bit (or multiple bits) to a recessive one.

A vehicle network with a monitoring-purpose onboard control apparatus that detects illicit data through monitoring the data communication format predetermined in order to operate a communication protocol that is used in the vehicle network is disclosed in U.S. Patent Application Publication No. 2015/0066239 to Mabuchi entitled: “Vehicle network monitoring method and apparatus”, which is incorporated in its entirety for all purposes as if fully set forth herein. Upon detecting illicit data whose communication format is different from the prescribed communication format, the monitoring-purpose onboard control apparatus performs a process of transmitting alarm information to onboard control apparatuses, and also performs a process of prohibiting gateways from routing the illicit data.

A method of real-time data security of a communications bus is disclosed in International Patent application Publication WO 2017/013622 to LITICHEVER et al. entitled: “Vehicle communications bus data security”, which is incorporated in its entirety for all purposes as if fully set forth herein. The method comprising the steps of: reading at least an early portion of a message being transmitted over a communications bus, determining whether the message is suspicious, according to at least one rule applied on the read early portion of the message, and upon determining that the message is suspicious, corrupting at least a part of the message.

A system for providing security to an in-vehicle communication network is disclosed in U.S. Pat. No. 9,616,828 to BEN NOON et al. entitled: “Global automotive safety system”, which is incorporated in its entirety for all purposes as if fully set forth herein. The system comprising: a data monitoring and processing hub; and at least one module configured to monitor messages in communication traffic propagating in a vehicle's in-vehicle network, the network having a bus and at least one node connected to the bus, the module comprising: a communication interface configured to support communication with the hub; a memory having software comprising data characterizing messages that the at least one node transmits and receives during normal operation of the node; at least one communication port via which the module receives and transmits messages configured to be connected to a portion of the in-vehicle network; a processor that processes messages received via the port from the portion of the in-vehicle network responsive to the software in the memory to: identify an anomalous message in the received messages indicative of exposure of the in-vehicle network to damage from a cyber attack; determine an action to be taken by the module that affects the anomalous message; and transmit data responsive to the anomalous message to the hub for processing by the hub via the communication interface.

A method for serial data transmission in a bus system having at least two bus subscribers is disclosed in U.S. Pat. No. 9,361,178 to Hartwich et al. entitled: “Method and device for improving the data transmission security in a serial data transmission having flexible message size”, which is incorporated in its entirety for all purposes as if fully set forth herein. The method exchange messages via the bus, the send access to the bus for each message being assigned to a bus subscriber by the arbitration method according to CAN Standard ISO 11898-1; it being decided as a function of a suitable identification (EDL) which result from one of the CRC calculations started in parallel is used for checking the correct data transmission; for at least one value of the identification an additional condition being checked, and in response to its presence, fixed stuff bit sequences from one or more bits are inserted into the message by the sender, at least into parts of the message.

A system and method for determining when to reset a controller in response to a bus off state are disclosed in U.S. Pat. No. 9,600,372 to Jiang et al. entitled: “Approach for controller area network bus off handling”, which is incorporated in its entirety for all purposes as if fully set forth herein. The method includes determining that the controller has entered a first bus off state and immediately resetting the controller. The method further includes setting a reset timer in response to the controller being reset, determining whether the controller has entered a subsequent bus off state, and determining whether a reset time. The method immediately resets the controller in response to the subsequent bus off state if the reset time is greater than the first predetermined time interval, and resets the controller in response to the subsequent bus off state after a second predetermined time interval has elapsed if the reset time is less than the first predetermined time interval.

A communication apparatus for preventing the broadcasting of unauthorized messages on a broadcast bus network is disclosed in U.S. Patent Application Publication No. 2016/0149934 to Frank et al. entitled: “Illegal message destroyer”, which is incorporated in its entirety for all purposes as if fully set forth herein. The communication apparatus comprising a first memory adapted to store first information; a second memory adapted to store second information; a monitoring unit adapted to monitor the bus for processing messages being broadcasted on the bus, and output a third information and fourth information, a comparing unit adapted to compare the first information with the third information and the second information with the fourth information; and a message destroyer adapted to when the first information matches with the third information, and the second information does not match with the fourth information, causing the body of the current message to be altered while the current message is being broadcasted on the bus.

Embodiments of a device and method are disclosed are disclosed in U.S. Patent Application Publication No. 2017/0093659 to Elend et al. entitled: “Controller area network (can) device and method for controlling can traffic”, which is incorporated in its entirety for all purposes as if fully set forth herein. A controller area network (CAN) device includes a compare module configured to interface with a CAN transceiver, the compare module having a receive data (RXD) interface configured to receive data from the CAN transceiver, a CAN decoder configured to decode an identifier of a CAN message received from the RXD interface, and an identifier memory configured to store an entry that corresponds to at least one identifier, and compare logic configured to compare a received identifier from a CAN message to the entry that is stored in the identifier memory and to output a match signal when the comparison indicates that the received identifier of the CAN message matches the entry that is stored at the CAN device. The CAN device also includes a signal generator configured to output, in response to the match signal, a signal to invalidate the CAN message.

A method and system monitor a communications network, e.g., a controller area network (CAN), and more specifically, an in-vehicle communications network, are disclosed in U.S. Pat. No. 8,213,321 to Butts et al. entitled: “Controller area network condition monitoring and bus health on in-vehicle communications networks”, which is incorporated in its entirety for all purposes as if fully set forth herein. The monitoring is performed by maintaining a count of each type of error code and a histogram of all network messages seen by each of the controllers during a measurement period; and by determining a bus health index of the communication bus based upon a percentage of a given type of error to the total count of all errors during a measurement period. An individual controller or controller area network bus segment can be indicated as having a communications problem as a result of the health index.

A system for providing network security on a vehicle information system and methods for manufacturing and using same is disclosed in U.S. Patent Application Publication No. 2010/0318794 to Dierickx entitled: “System and Method for Providing Security Aboard a Moving Platform”, which is incorporated in its entirety for all purposes as if fully set forth herein. The security system comprises an all-in-one security system that facilitates security system functions for the vehicle information system. Exemplary security system functions include secure storage of keys used to encrypt and/or decrypt system data, security-related application programming interfaces, a security log file, and/or private data. The security system likewise can utilize antivirus software, anti-spyware software, an application firewall, and/or a network firewall. As desired, the security system can include an intrusion prevention system and/or an intrusion detection system. If the information system includes a wireless distribution system, the security system can include an intrusion prevention (and/or detection) system that is suitable for use with wireless network systems. Thereby, the security system advantageously can provide a defense in depth approach by adding multiple layers of security to the information system.

Methods and systems for mitigating cyber-attacks on components of an automotive communication system are disclosed in U.S. Pat. No. 9,661,006 to Kantor et al. entitled: “Method for protection of automotive components in intravehicle communication system”, which is incorporated in its entirety for all purposes as if fully set forth herein. These methods and systems comprise elements of hardware and software for receiving a frame; determining whether the frame potentially affects correct operation of an automotive component; and, taking protective action.

A project to find out if it is possible to select a set of metrics available from networking equipment, which could be used to detect known physical layer attacks on Ethernet networks, is described in a Thesis by Alexey Petrenko entitled: “Detecting physical layer attacks on Ethernet networks” that was presented by the Helsinki Metropolia University of Applied Sciences, Degree Programme in Information Technology dated 8 Oct. 2015, which is incorporated in its entirety for all purposes as if fully set forth herein. Known physical layer attacks on Ethernet networks were described in detail, and a set of metrics which might be used for attack detection was suggested. All metric values were gathered on each link in a topology in a normal state and under each of the attacks. Effectiveness of the suggested metrics was analyzed. The project showed that it is possible to use metrics obtained from networking devices to detect known physical layer attacks on Ethernet networks.

A diagnostic tool that can communicate with a computing device such as smart phone is disclosed in U.S. Pat. No. 9,297,721 to Bertosa et al. entitled: “Auto ID and fingerprint system and method thereof”, which is incorporated in its entirety for all purposes as if fully set forth herein. The diagnostic tool can include a power management system that allows the dynastic tool to enter lower power state in order to prevent the power drain of vehicle battery. The diagnostic tool can also AutoID a vehicle or use a “fingerprinting” process to identify the vehicle. A crediting system is provided that can be used to credit a 3rd party for software purchased for use by the diagnostic tool or smart phone.

A system and method for securing links at the physical (PHY) layer in an IEEE 802.3 Ethernet communication system are disclosed in U.S. Pat. No. 8,375,201 to Booth entitled: “Ethernet PHY level security”, which is incorporated in its entirety for all purposes as if fully set forth herein. A local device (LD) receives an electrical waveform representing link partner security information from a network-connected link partner (LP) via unformatted message pages. The LD accesses predetermined LP reference information stored in a tangible memory medium. The LD compares the received LP security information to the LP reference information. In response to the LD matching the received LP security information to the LP reference information, a secure link to the LP is verified. Likewise, the LD may send electrical waveforms representing security information to the LP via the unformatted message pages. In response to the LP matching the LD security information to the LD reference information, a secure link to the LD is verified.

A project that examines the feasibility of machine learning based fingerprinting of CAN transceivers, for the purpose of uniquely identifying signal sources during intrusion detection, is described in a Bachelor Project Number DA-2016-06 by Roar Elias Georgsen, published May 19, 2016 by the University College of Southeast Norway (Campus Vestfold) entitled: “Machine Learning Based Intrusion Detection in Controller Area Networks”, which is incorporated in its entirety for all purposes as if fully set forth herein. A working multi-node CAN bus development environment was constructed, and an OpenCL Deep Learning Python Wrapper was ported to the platform. Multiple Machine Learning Algorithms were compared systematically, and two models fully implemented on a SoC ARM/FPGA device, with computationally intensive tasks running as Software Defined Hardware using an OpenCL FPGA interface. The implementation achieves a higher hit rate than earlier work based on least-mean squares and convolution Digital Signals Processing (DSP). Performance on learning tasks is comparable to high-end CPU devices, indicating that FPGA is a cost effective solution for utilizing machine learning in embedded systems.

An apparatus for detecting an attack on an electric circuit is disclosed in U.S. Patent Application Publication No. 2007/0182421 to Janke et al. entitled: “Apparatus for detecting an attack on an electric circuit”, which is incorporated in its entirety for all purposes as if fully set forth herein. The electric circuit includes a current consumption threshold value discriminator to determine whether current consumption of the electric circuit exceeds a predetermined threshold value or not, and to generate a binary current limitation signal depending therefrom. The apparatus includes a monitor for monitoring the binary current limitation signal over a predetermined time interval, in order to indicate a signal characterizing the current consumption of the electric circuit over the predetermined time interval, and a detector for detecting an attack on the electric circuit based on the monitoring signal.

Methods and systems in which a network induces different distortions in signals traversing different segments of the network are disclosed in U.S. Patent Application Publication No. 2011/0243214 to Wolcott et al. entitled: “Inducing response signatures in a communication network”, which is incorporated in its entirety for all purposes as if fully set forth herein. The distortions may be used to identify locations on the network of devices that transmit and receive the signals. The distortions may be reflected in equalization coefficients programmed into transmitting or receiving devices, which may be used to pre- or post-filter the signals to compensate for the distortions.

An apparatus for protecting a vehicle electronic system is disclosed in U.S. Patent Application Publication No. 2015/0020152 to Litichever et al. entitled: “Security system and method for protecting a vehicle electronic system”, which is incorporated in its entirety for all purposes as if fully set forth herein. The protecting is by selectively intervening in the communications path in order to prevent the arrival of malicious messages at ECUs, in particular at the safety critical ECUs. The security system includes a filter, which prevents illegal messages sent by any system or device communicating over a vehicle communications bus from reaching their destination. The filter may, at its discretion according to preconfigured rules, send messages as is, block messages, change the content of the messages, request authentication or limit the rate such messages can be delivered, by buffering the messages and sending them only in preconfigured intervals.

A system for providing security to an in-vehicle communication network is disclosed in U.S. Patent Application Publication No. 2015/0195297 to BEN NOON et al. entitled: “Global automotive safety system”, which is incorporated in its entirety for all purposes as if fully set forth herein. The system comprising: a data monitoring and processing hub; and at least one module configured to monitor messages in communication traffic propagating in a vehicle's in-vehicle network, the network having a bus and at least one node connected to the bus, the module comprising: a communication interface configured to support communication with the hub; a memory having software comprising data characterizing messages that the at least one node transmits and receives during normal operation of the node; at least one communication port via which the module receives and transmits messages configured to be connected to a portion of the in-vehicle network; a processor that processes messages received via the port from the portion of the in-vehicle network responsive to the software in the memory to: identify an anomalous message in the received messages indicative of exposure of the in-vehicle network to damage from a cyber attack; determine an action to be taken by the module that affects the anomalous message; and transmit data responsive to the anomalous message to the hub for processing by the hub via the communication interface.

A Controller Area Network (CAN) device is disclosed in U.S. Patent Application Publication No. 2017/0235698 to van der Maas entitled: “Controller area network (can) message filtering”, which is incorporated in its entirety for all purposes as if fully set forth herein. The CAN device includes a CAN controller and a transceiver coupled to the CAN controller. The transceiver includes a transmitter and a receiver coupled to a CAN bus interface. The CAN device also includes a security module coupled to the receiver. The security module includes an identifier table and a receiver controller. The security module is configured to receive an incoming CAN message, retrieve an identifier from the incoming CAN message, search the identifier table for the identifier and to alter the incoming message based on a result of the search.

A system and method for providing security to a network may include maintaining, by a processor, a model of an expected behavior of data communications over the in-vehicle communication network are disclosed in U.S. Patent Application Publication No. 2016/0381059 to GALULA et al. entitled: “SYSTEM AND METHOD FOR TIME BASED ANOMALY DETECTION IN AN IN-VEHICLE COMMUNICATION NETWORK”, which is incorporated in its entirety for all purposes as if fully set forth herein. The method comprises receiving, by the processor, a message sent over the network; determining, by the controller, based on the model and based on a timing attribute of the message, whether or not the message complies with the model; and if the message does not comply with the model then performing, by the processor, at least one action related to the message.

A method for automatically generating a security policy for a controller is disclosed in U.S. Patent Application Publication No. 2017/0295188 to David et al. entitled: “Automated security policy generation for controllers”, which is incorporated in its entirety for all purposes as if fully set forth herein. The method includes receiving, by a security policy generation system and from a controller development environment, code for a device controller; selecting middleware that enforces a security policy; analyzing the code for the device controller; based at least in part on the analyzing, automatically generating the security policy; and providing the selected middleware along with the generated security policy.

A system and method for providing security to a network are disclosed in U.S. Patent Application Publication No. 2016/0381055 to GALULA et al. entitled: “SYSTEM AND METHOD FOR PROVIDING SECURITY TO A COMMUNICATION NETWORK”, which is incorporated in its entirety for all purposes as if fully set forth herein. The method may include identifying a message sent over a network, the message related to a data transfer from an initiator to a target node, and transmitting, over the network, at least one disruptive message that causes the data transfer to fail.

Systems and methods for detection of attacks on a communication authentication layer of an in-vehicle network are disclosed in U.S. Patent Application Publication No. 2018/0007076 to GALULA et al. entitled: “SYSTEM AND METHOD FOR DETECTION AND PREVENTION OF ATTACKS ON IN-VEHICLE NETWORKS”, which is incorporated in its entirety for all purposes as if fully set forth herein. The systems and methods include determining, by at least one network node, at least one attack attempt on the communication authentication layer of the in-vehicle network, wherein the determination is carried out by identifying anomalies in at least one of messages, data and metadata directed to the communication authentication layer, and selecting, by the at least one network node, a response corresponding to the determined attack attempt from at least one of modification of parameter values corresponding to a security protocol, a failsafe response, and rejection of messages identified as anomalies.

A system and method for detection of at least one cyber-attack on one or more vehicles are disclosed in U.S. Patent Application Publication No. 2017/0230385 to Ruvio et al. entitled: “Vehicle correlation system for cyber attacks detection and method thereof”, which is incorporated in its entirety for all purposes as if fully set forth herein. The system and method including steps of transmitting and/or receiving by a first on-board agent module installed within one or more vehicles and/or a second on-board agent module installed within road infrastructure and in a range of communication with said first on-board agent module metadata to and/or from an on-site and/or remote cloud-based detection server including a correlation engine; detecting cyberattacks based on correlation calculation between the metadata received from one or more first agent module installed within vehicles and/or from one or more second agent modules installed within road infrastructure; indicating a probability of a cyber-attack against one or more vehicle based on correlation calculation; initiating blocking of vehicle-to-vehicle communication to present and/or stop a spread of an identified threat.

A device for detection and prevention of an attack on a vehicle via its communication channels is disclosed in U.S. Patent Application Publication No. 2015/0271201 to Ruvio et al. entitled: “Device for detection and prevention of an attack on a vehicle”, which is incorporated in its entirety for all purposes as if fully set forth herein. The device having: an input-unit configured to collect real-time and/or offline data from various sources such as sensors, network based services, navigation applications, the vehicles electronic control units, the vehicle's bus-networks, the vehicle's subsystems, and on board diagnostics; a database, for storing the data; a detection-unit in communication with the input-unit; and an action-unit, in communication with the detection unit, configured for sending an alert via the communication channels and/or prevent the attack, by breaking or changing the attacked communication channels. The detection-unit is configured to simultaneously monitor the content, the meta-data and the physical-data of the data and detect the attack.

A connection detection apparatus is disclosed in U.S. Patent Application Publication No. 2014/0380416 to Adachi entitled: “Connection detection apparatus and in-vehicle relay apparatus”, which is incorporated in its entirety for all purposes as if fully set forth herein. The apparatus includes a gateway to which communication lines are connected, and which detects whether an unauthorized communication device has been connected to the communication lines. The gateway samples a signal several times from each of the communication lines, and generates waveform information, such as an eye pattern in which the waveforms are superimposed on one another. Furthermore, the gateway has stored normal waveform information therein, such as a mask generated based on the eye pattern at normal times. The gateway compares the generated waveform information with the stored waveform information, and recognizes that the waveform information is abnormal if it does not sufficiently match the normal waveform information. If the waveform information is abnormal, it is determined that an unauthorized communication device has been connected to one or more of the communication lines.

A system and method for detecting an intrusion or a bug in a vehicle data transmission system is disclosed in U.S. Pat. No. 8,955,130 to Kalintsev et al. entitled: “Method for protecting vehicle data transmission system from intrusions”, which is incorporated in its entirety for all purposes as if fully set forth herein. A hardware-software complex (HSC) is used to find a bug or intrusion device in a vehicle electronic system. The HSC is connected to CAN-buses in the vehicle and also scans radio waves, which can be used to transmit data to a bug. This complex is a self-teaching CAN-system used to monitor and block harmful commands in the vehicle. Each vehicle (of each model, type and settings) has its own reference bus data (parameters), which is used to detect added modules and malicious data sent over the vehicle's CAN bus.

A method for detecting threats or attacks on an automobile network, is disclosed in U.S. Pat. No. 9,401,923 to Valasek et al. entitled: “Electronic system for detecting and preventing compromise of vehicle electrical and control systems”, which is incorporated in its entirety for all purposes as if fully set forth herein. The automobile network is connected to a plurality of electronic components and an attack monitoring unit including a processor, the method including: monitoring, by the processor of the attack monitoring unit, data messages transmitted on the automobile network; determining, by the processor of the attack monitoring unit, whether at least one data message among the data messages transmitted on the mobile network is a threat to one or more of the plurality of electronic components on the automobile network; and when it is determined, by the processor, that the at least one data message is a threat, performing at least one action based on the threat.

Methods and apparatus for physical layer security of a network communications link are disclosed in U.S. Pat. No. 7,752,672 to Karam et al. entitled: “Methods and apparatus for physical layer security of a network communications link”, which is incorporated in its entirety for all purposes as if fully set forth herein. A communications port of a network communications device maintains capability information indicating that under normal operating conditions a communications link is capable of operating in a secure mode in which communications signals of the communications link are unintelligible to an intruder having an unauthorized physical connection (e.g. tap) to the communications link. During operation, the port detects occurrence of a link event of a type that can invoke an automatic communications-mode control mechanism to change the operating of the communications link to a non-secure mode in which communications signals of the communications link are intelligible to such an intruder. An example is Ethernet auto-negotiation, which can change from relatively secure 1000BaseT signaling to relatively non-secure 10/100BaseT signaling. Based on the capability information, the port responds to the link event by preventing the automatic communications mode control mechanism from changing the operating of the communications link to the non-secure mode.

In consideration of the foregoing, it would be an advancement in the art to provide methods and systems for detecting, and taking action when detecting, an intrusion or an attack of a network or system, Such method or device may be used to provide an improved security, verifying authentic hardware or software, malware or attack vulnerability reduction, or an intrusion operation detection/prevention, that are simple, secure, cost-effective, reliable, easy to use or sanitize, has a minimum part count, minimum hardware, and/or uses existing and available components, protocols, programs and applications for providing better security and additional functionalities, and provides a better user experience.

### SUMMARY

A non-transitory computer readable medium may include computer executable instructions stored thereon, wherein the instructions may include any step or steps, any method, or any flow chart described herein. Any analyzer apparatus may perform any step or steps, any method, or any flow chart described herein.

A system may be used for protecting a first network from a second network, and the system may comprise a first device coupled to the first network; an adapter device coupled between the first and second networks for receiving a message or a part thereof from the second network addressed to a first device in the first network; and a first analyzer device connected to the first network for receiving the message, or the part thereof, from the adapter device via a tunnel over the first network. In response to a determining that the message or the part thereof is not satisfying the criterion, the analyzer device may be operative to send the message or the part thereof to the first device over the first network, and in response to a determining that the message or the part thereof satisfies the criterion, the analyzer device may be operative to acting. A device may comprise the adapter device and the first device in a single enclosure.

Any message herein may be a multicast message associated with a plurality of devices connected over the first network. Any device herein, such as the analyzer device, may be operative to send the multicast message or the part thereof to the plurality of devices over the first network. Alternatively or in addition, any message herein may be a broadcast message, and any device herein, such as the analyzer device, may be operative for sending of the broadcast message or the part thereof to all the devices connected to the first network. Any device herein, such as the analyzer device, may be operative to block, in response to the message satisfying the criterion, the message from being sent over a network, such as the first network.

Any message herein may comprise one or more frames or packets, one or more Ethernet frames one or more Internet Protocol (IP) packets, a Transmission Control Protocol (TCP) stream, or one or more multicast or broadcast frames or packets. The first and second networks may use, or may be based on, the same protocol. Alternatively or in addition, the first and second networks may use, or may be based on, different protocols. Any device herein, such as the adapter device, may be operative for adapting between any different protocols.

Any network herein, such as the first network, may use a topology that may be based on, or may use, a point-to-point, bus, star, ring or circular, mesh, tree, hybrid, or daisy chain topology. The second network topology may be identical to, or may be different from, the first network topology.

Any criterion herein may comprise, or may be used, for detecting a malware or a malware activity. Any malware herein may consist of, may include, or may be based on, a computer virus, spyware, DoS (Denial of Service), rootkit, ransomware, adware, backdoor, Trojan horse, or a destructive malware.

Any system herein may be use with an enclosed environment, any network herein, such as the first network, may be partly or in full within the enclosed environment. The second network may be in full or in part external to the enclosed environment. Any enclosed environment herein may consist of, or may comprise, a building, an apartment, a floor in a building, a room in a building, or a vehicle.

Any system or device herein may use a virtualization. Any system or device herein may further comprise a Virtual Machine (VM) executing a virtualized application. Any device herein, such as the analyzer device or the first device, or any part thereof, may be implemented as virtual hardware as part of the VM. At least one of any action or step herein by any device may be executed as part of the virtualized application.

Any system herein may further comprise an additional adapter device coupled between the first network and a third network. The additional adapter device may be operative for receiving an additional message from the third network destined to a second device in the first network, and for sending the additional message, or a part thereof, to the analyzer device via an additional tunnel over the first network. The analyzer device may further be operative for receiving the additional message, or the part thereof, from the additional adapter device over the additional tunnel, and may be operative for determining if the additional message, or the part thereof, satisfies the criterion. Further, the analyzer device may be operative for sending, in response to the determining that the additional message or the part thereof is not satisfying the criterion, the additional message or the part thereof to the second device over the first network, and may be further operative for acting, in response to the determining that the additional message or the part thereof is satisfying the criterion.

Any network herein, such as the first network or the second network, may be implemented as a virtualized network as part of a Virtual Machine (VM). Any system herein may comprise a host computer that implement the VM. The host computer may further be operative for executing a hypervisor or a Virtual Machine Monitor (VMM). Any virtualized network herein may use or may interface virtual hardware. Any virtualization herein may include, may be based on, or may use, full virtualization, para-virtualization, or hardware assisted virtualization.

Any device herein, such as the analyzer device, may be further operative for an additional message from one of the multiple devices addressed to a second device in the first network; may be further operative for determining if the additional message, or a part thereof, satisfies the criterion; may be further operative for sending, in response to the determining that the additional message or the part thereof is not satisfying the criterion, the additional message or the part thereof, by the analyzer device, to the second device over the first network; and may be further operative for acting, in response to the determining that the additional message or the part thereof is satisfying the criterion.

Any network herein, such as the first network, may comprise an Open Systems Interconnection (OSI) Layer-2 network for transporting Ethernet frames, an Open Systems Interconnection (OSI) Layer-3 network for transporting Internet Protocol (IP) packets, or an Open Systems Interconnection (OSI) Layer-4 network for transporting Transmission Control Protocol (TCP) streams. Any device herein, such as the adapter device, the first device, or the analyzer device, may consist of, may comprise, or may be part of, an Ethernet switch, an IP router, a bridge, a gateway, or any combination thereof.

Any tunnel herein may consist of, may use, may be compatible with, or may be based on, an Open Systems Interconnection (OSI) Layer-2 tunnel, an Open Systems Interconnection (OSI) Layer-3 tunnel, or an Open Systems Interconnection (OSI) Layer-4 or above tunnel. Further, any tunnel herein may consist of, may use, may be compatible with, or may be based on, a Virtual Local Area Network (VLAN) or Virtual Private Network (VPN). Any VPN herein may consist of, may use, may be compatible with, or may be based on, Frame-Relay (FR), Asynchronous Transfer Mode (ATM), ITU-T X.25, Open Systems Interconnection (OSI) Layer 2 Tunneling Protocol (L2TP), Generic Routing Encapsulation (GRE), Internet Protocol Security (IPsec), or Label-Switched Path (LSP). Any network herein, such as the first network, may support, or may use, Multiprotocol Label Switching (MPLS).

Any message herein, such as any message received by the adapter device or the analyzer device, may comprise encrypted data, decrypted data, or both, and any device herein, such as the adapter device or the analyzer device, may further be operative for decrypting the encrypted data. Any system herein may further be operative for authenticating, using Extensible Authentication Protocol (EAP) between a supplicant and an authenticator under control of an authentication server, based on, according to, or compatible with, IEEE 802.1X-2010 or IEEE 802.1AE-2006. Any authenticating herein may use, may be based on, may be according to, or may be compatible with, EAP over LAN (EAPOL) protocol or frames. Any device herein, such as the analyzer device or the adapter device, may further be operative for serving as the authentication server, as the supplicant, or as the authenticator.

Any system herein may comprise a second analyzer device connected to the first network, and operative for determining if a message satisfies the criterion, and the second analyzer device may be operative for load balancing, offloading, or backuping, with the first analyzer device. The second analyzer device may be identical to, may be similar to, or may be different from, the first analyzer device, and may be operative for communication with the first analyzer device, and the communicating may be over the first network or over a network other than the first network. Any system herein may comprise a redundancy scheme using the second analyzer device that may be based on, or may use, Dual Modula redundancy (DMR), Triple Modular Redundancy (TMR), Quadruple Modular Redundancy (QMR), 1:N Redundancy, ‘Cold Standby’, or ‘Hot Standby’.

Any device herein, such as the adapter device, may be operative for sending the message, or a part thereof, to the second analyzer device via a tunnel over the first network in response for detecting a failure in the first analyzer device. The second analyzer device may further be operative, in response to the detecting, for receiving the message or the part thereof and for determining if the message, or the part thereof, satisfies the criterion, and in response to the determining that the message or the part thereof is not satisfying the criterion, the second analyzer device is operative for sending the message or the part thereof by to the first device over the first network and for acting, in response to the determining that the message or the part thereof is satisfying the criterion. Any device herein, such as the adapter device, may be operative for sending the message, or a part thereof, to the second analyzer device via an additional tunnel over the first network, and the second analyzer device may be operative for receiving the message, or the part thereof, and for determining if the message, or the part thereof, satisfies the criterion. Any sending of the message, or a part thereof herein to the second analyzer device may be at least in part in parallel to the sending of the message, or a part thereof, to the first analyzer device.

Any device herein, such as the second analyzer device, may be operative for sending, in response to the determining that the message or the part thereof is not satisfying the criterion, the message or the part thereof by to the first device over the first network, and for acting, in response to the determining that the message or the part thereof is satisfying the criterion. Any system herein may further comprise an additional adapter device coupled between a third network and the first network, and the additional adapter device may be operative for receiving an additional message from the third network destined to a second device in the first network, and for sending the additional message, or a part thereof, to the second analyzer device via an additional tunnel over the first network, and wherein the second analyzer device is operative for receiving the additional message, or the part thereof, for determining, by the second analyzer device, if the additional message, or the part thereof, satisfies the criterion; for sending, in response to the determining that the additional message or the part thereof is not satisfying the criterion, the additional message or the part thereof to the second device over the first network; and for acting, in response to the determining that the additional message or the part thereof is satisfying the criterion.

Any device herein, such as the second analyzer device, may be operative for receiving an additional message from one of the multiple devices addressed to a second device in the first network, for determining if the additional message, or a part thereof, satisfies the criterion, for sending, in response to the determining that the additional message or the part thereof is not satisfying the criterion, the additional message or the part thereof, to the second device over the first network; and for acting, in response to the determining that the additional message or the part thereof is satisfying the criterion.

Any system herein may further be operative for storing, operating, or using, an operating system. Any system herein may comprise a Virtual Machine (VM) for virtualization, and the operating system may be executed as a guest operating system. Any system herein may further comprise a host computer that implements the VM, and the host computer may be operative for executing a hypervisor or a Virtual Machine Monitor (VMM), and the guest operating system may use or may interface virtual hardware. Any virtualization herein, such as any operating system virtualization, may include, may be based on, or may use, full virtualization, para-virtualization, or hardware assisted virtualization.

A method may be used for protecting a first network that may interconnect multiple devices and an analyzer device, and may further be used with a second network that may be coupled to the first network via an adapter device. The method may comprise receiving, by the adapter device, a message from the second network destined to a first device or node in the first network; sending, by the adapter device, the message to the analyzer device via a tunnel over the first network; receiving, by the analyzer device, the message; determining, by the analyzer device, if the message satisfies a criterion; sending, in response to the determining that the message is not satisfying the criterion, the message by the analyzer device to the first device or node over the first network; and acting, in response to the determining that the message is satisfying the criterion, by the analyzer device.

Any message herein may be a multicast message that may be associated with a plurality of devices connected over the first network, and the sending of the message or the part thereof by the analyzer device may comprise sending the multicast message to the plurality of devices over the first network. Alternatively or in addition, any message herein may be a broadcast message, and the sending of the message or the part thereof by the analyzer device may comprise sending the broadcast message to all devices connected to the first network. In one example, the adapter device and the first device are the same device.

The method may further comprise blocking, in response to the message satisfying the criterion, the message from being sent over the first network. Any message herein may comprise one or more frames (such as Ethernet frames) or packets (such as IP packets), that may be unicast, multicast, or broadcast. The topology of any network herein, such as the first or second network, may be based on, or may use, a point-to-point, bus, star, ring or circular, mesh, tree, hybrid, or daisy chain topology. The topology of the second network may be identical to, or different from, the first network topology. The method may further comprise, or the criterion may be defined for, detecting a malware or a malware activity, and the malware may consist of, may include, or may be based on, a computer virus, spyware, DoS (Denial of Service), rootkit, ransomware, adware, backdoor, Trojan horse, or a destructive malware.

Any method herein may further comprise receiving, by the analyzer device, an additional message from one of the multiple devices addressed to a second device or node in the first network; determining, by the analyzer device, if the additional message, or a part thereof, satisfies the criterion; sending, in response to the determining that the additional message or the part thereof is not satisfying the criterion, the additional message or the part thereof, by the analyzer device, to the second device or node over the first network; and acting, in response to the determining that the additional message or the part thereof is satisfying the criterion, by the analyzer device.

Any method herein may further be used with a third network that may be coupled to the first network via an additional adapter device, and the method may further comprise: receiving, by the additional adapter device, an additional message from the third network destined to a second device or node in the first network; sending, by the additional adapter device, the additional message, or a part thereof, to the analyzer device via an additional tunnel over the first network; receiving, by the analyzer device, the additional message, or the part thereof; determining, by the analyzer device, if the additional message, or the part thereof, satisfies the criterion; sending, in response to the determining that the additional message or the part thereof is not satisfying the criterion, the additional message or the part thereof by the analyzer device to the second device or node over the first network; and acting, in response to the determining that the additional message or the part thereof is satisfying the criterion, by the analyzer device.

Any coupled two network herein, such as the first and second networks, may use, or may be based on, the same protocol, or may use, or may be based on, different protocols. Any method herein may further comprise adapting, by a device such as the adapter device, between the different protocols. Any method herein may be used with an enclosed environment. Any network herein, such as the first network, may be within the enclosed environment. Further, any network herein, such as the second network, may be at least in part external to the enclosed environment. The enclosed environment may consist of, or may comprise, a building, an apartment, a floor in a building, a room in a building, or a vehicle.

Any tunnel herein may consist of, may use, may be compatible with, or may be based on, a Layer-2, a Layer-3, a Layer-4, or any other layer tunnel. Alternatively or in addition, any tunnel herein may consist of, may use, may be compatible with, or may be based on, a Virtual Local Area Network (VLAN) or a Virtual Private Network (VPN). Any VPN herein may consist of, may use, may be compatible with, or may be based on, Frame-Relay (FR), Asynchronous Transfer Mode (ATM), ITU-T X.25, or Layer-2 Tunneling Protocol (L2TP). Further, any VPN herein may consist of, may use, may be compatible with, or may be based on, Generic Routing Encapsulation (GRE) or Internet Protocol Security (IPsec). Alternatively or in addition, any network herein may support, or may use, Multiprotocol Label Switching (MPLS), and any tunnel herein may consist of, may use, may be compatible with, or may be based on, Label-Switched Path (LSP).

Any network herein, such as the first network, the second network, or both, may be used with a virtualization, and any network herein may be executed as a virtualized network as part of a Virtual Machine (VM). The virtualization may be implemented by a host computer that may implement the VM, and any method herein may further comprise executing, by the host computer, a hypervisor or a Virtual Machine Monitor (VMM), and the virtualized may use or interface virtual hardware. Any virtualization herein may include, may be based on, or may use, full virtualization, para-virtualization, or hardware assisted virtualization.

Any method herein, any step herein, any flow-chart herein, or any part thereof, may be used with a virtualization, and at least one of the steps or methods herein may be executed as part of a virtualized application as part of a Virtual Machine (VM). Any device herein, such as the analyzer device, the first device, or any part thereof, may be implemented as virtual hardware. Any virtualization herein may be used with an host computer that implement the VM, and may further comprising executing, by the host computer, a hypervisor or a Virtual Machine Monitor (VMM). Any virtualized application herein or any or hardware virtualization herein may use or may interface virtual hardware. Any virtualization herein may include, may be based on, or may use, full virtualization, para-virtualization, or hardware assisted virtualization.

Any message herein, such as the message received by the adapter device, may comprise encrypted data, and any method herein may further comprise decrypting, by any device herein, such as the adapter device or the analyzer device, the encrypted data, and sending, by any device herein, such as the adapter device or the analyzer device, the decrypted data. Any message received by the analyzer device may comprise encrypted data, and any method herein further comprise decrypting, by the analyzer device or the adapter device, the encrypted data, and the message sent by the analyzer device or the adapter device may comprise the decrypted data.

Any method herein may further comprise authenticating, using an authentication scheme such as the Extensible Authentication Protocol (EAP) between a supplicant and an authenticator under control of an authentication server, such as by using EAPOL. Any authentication scheme herein may be based on, may be according to, or may be compatible with, IEEE 802.1X-2010 or IEEE 802.1AE-2006. Any device herein, such as the adapter device, the analyzer device, the first device or node, any one of the multiple device, or a device or node in the second network, may serve as the authentication server, as the supplicant, or as the authenticator.

Any network herein, such as the first or second network may be a wired network where the transmission medium comprises, consists of, or may be part of, two or more conductors, which may comprise, may consist of, or may be part of, a stripline, a microstrip, two wires, or a cable. The adapter device may include a first connector for connecting to the wired medium of the first network, and a first wired transceiver connected to the first connector for transmitting to, or for receiving from, the first network. Similarly, the adapter device may include a second connector for connecting to the wired medium of the second network, and a second wired transceiver connected to the second connector for transmitting to, or for receiving from, the second network. Further, any medium herein may comprise, may consist of, or may be part of, a twisted wire pair that comprises, or consists of, two individually insulated solid or stranded conductors or wires, and the twisted wire pair may comprise, or may consist of, an Unshielded Twisted Pair (UTP) or a Shielded Twisted Pair (STP). Any twisted wire pair herein may be according to, may be based on, may be compatible with, or may use, ISO/IEC 11801:2002 or ANSI/TIA/EIA-568-B.2-2001 standard, and any STP herein be according to, may be based on, may be compatible with, or may use, F/UTP, S/UTP, or SF/UTP. Further, any twisted wire pair herein may be according to, may be part of, may be based on, may be compatible with, or may use, Category 3, Category 5, Category 5e, Category 6, Category 6A, Category 7, Category 7A, Category 8.1, or Category 8.2 cable. Alternatively or in addition, any wired network herein may comprise, may consist of, or may be part of, a coaxial cable, and the coaxial cable may comprise a dielectric materials are commonly used are foamed polyethylene (FPE), solid polyethylene (PE), polyethylene foam (PF), polytetrafluoroethylene (PTFE), or air space polyethylene (ASP). The medium of the first network may be identical to, similar to, or different from, the medium of the second network.

Any network herein, such as the first network, may consist of, or may comprise, a Personal Area Network (PAN), the first connector may be a PAN connector, and the first wired transceiver may be a PAN transceiver. The second network may consist of, or may comprise, a second Personal Area Network (PAN), and the adapter device may comprise a second connector for connecting to the second PAN and a second wired transceiver for transmitting to, or receiving from, the second PAN. Alternatively, the second network may consist of, or may comprises, a network other than Personal Area Network (PAN), and the method may further comprise adapting, by the adapter device, between the PAN and the second network.

Any network herein, such as the first network, may consist of, or may comprise, a Local Area Network (LAN), the first connector may be a LAN connector, and the first wired transceiver may be a LAN transceiver. The second network may consist of, or may comprise, a second Local Area Network (LAN), and the adapter device may comprise a second connector for connecting to the second LAN and a second wired transceiver for transmitting to, or receiving from, the second LAN. Alternatively, the second network may consist of, or may comprises, a network other than Local Area Network (LAN), and the method may further comprise adapting, by the adapter device, between the LAN and the second network. Any LAN herein may be Ethernet based, such as according to, compatible with, or based on, IEEE 802.3-2008 standard. Further, any LAN herein may be according to, may be compatible with, or may be based on, a standard selected from the group consisting of 10Base-T, 100Base-T, 100Base-TX, 100Base-T2, 100Base-T4, 1000Base-T, 1000Base-TX, 10GBase-CX4, and 10GBase-T; and the LAN connector may be an RJ-45 connector.

Any network herein, such as the first network, may consist of, or may comprise, a packet-based or switched-based Wide Area Network (WAN), the first connector may be a WAN connector, and the first wired transceiver may be a WAN transceiver. The second network may consist of, or may comprise, a second Wide Area Network (WAN), and the adapter device may comprise a second connector for connecting to the second WAN and a second wired transceiver for transmitting to, or receiving from, the second WAN. Alternatively, the second network may consist of, or may comprises, a network other than Wide Area Network (WAN), and the method may further comprise adapting, by the adapter device, between the WAN and the second network.

Any network herein, such as the first or second network, may be frame or packet based. The topology of any wired network herein, such as the first or second network, may be based on, or may use, point-to-point, bus, star, ring or circular, mesh, tree, hybrid, or daisy chain topology. Any two devices or nodes may be connected in a point-to-point topology, and any communication herein between two devices or nodes may be unidirectional, half-duplex, or full-duplex. medium herein, such as of the first or second network, may comprise, or may consist of, an unbalanced line, and any signals herein may be carried over the medium employing single-ended signaling, that may be based on, may be according to, or may be compatible with, RS-232 or RS-423 standards. Alternatively or in addition, any medium herein, such as the first or second network, may comprises, or may consist of, a balanced line, and any signals herein may be carried over the medium employing differential signaling, that may be based on, may be according to, or may be compatible with, RS-232 or RS-423 standards. Any communication over a medium herein may use serial or parallel transmission.

Any method herein may be used with a vehicle, and any network herein may be in the vehicle or external to the vehicle. The multiple devices and the first network may be in the vehicle, and the second network may be in the vehicle, external to the vehicle, or any combination thereof. Any vehicle herein may be a ground vehicle adapted to travel on land, such as a bicycle, a car, a motorcycle, a train, an electric scooter, a subway, a train, a trolleybus, and a tram. Any ground vehicle herein may consist of, or may comprise, an autonomous car, that may be according to levels 0, 1, 2, 3, 4, 5, or 6, of the Society of Automotive Engineers (SAE) J3016 standard. Alternatively or in addition, the vehicle may be a buoyant or submerged watercraft adapted to travel on or in water, and the watercraft may be a ship, a boat, a hovercraft, a sailboat, a yacht, or a submarine. Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV). Any device herein, such as the adapter device or the analyzer device, may be mounted onto, may be attached to, may be part of, or may be integrated with a rear or front view camera, chassis, lighting system, headlamp, door, car glass, windscreen, side or rear window, glass panel roof, hood, bumper, cowling, dashboard, fender, quarter panel, rocker, or a spoiler of the vehicle.

Any vehicle herein may further comprise an Advanced Driver Assistance Systems (ADAS) functionality or an Advanced Driver Assistance System Interface Specification (ADASIS) system, or scheme, and any device of network herein, such as the first network, one of the multiple devices, the adapter device, or the analyzer device, may be part of, may be integrated with, may communicate with, or may be coupled to, the ADAS or ADASIS functionality, system, or scheme. The ADAS functionality, system, or scheme may be selected from a group consisting of Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system, Pre-crash system, Collision Imminent Braking (CM), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), and Wrong-way driving warning.

Any method herein may be used with a vehicle, and any network herein, such as the first network may be in the vehicle, and any device herein, such as each of the multiple devices, the adapter device or the analyzer device, may comprise, may consist of, or may be integrated with, an Electronic Control Unit (ECU). Any ECU herein may be selected from the group consisting of Electronic/engine Control Module (ECM), Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed Control Unit (SCU), Telematic Control Unit (TCU), Transmission Control Unit (TCU), Brake Control Module (BCM; ABS or ESC), Battery management system, control unit, and a control module. F Any method herein may further comprise executing software, an operating-system, or a middleware, that may comprise, or may use OSEK/VDX, International Organization for Standardization (ISO) 17356-1, ISO 17356-2, ISO 17356-3, ISO 17356-4, ISO 17356-5, AUTOSAR standard, or Scalable service-Oriented MiddlewarE over IP (SOME/IP). Alternatively or in addition, the software may comprises, may use, or may be based on, an operating-system or a middleware, that comprises, or uses OSEK/VDX, International Organization for Standardization (ISO) 17356-1, ISO 17356-2, ISO 17356-3, ISO 17356-4, ISO 17356-5, AUTOSAR standard, or Scalable service-Oriented MiddlewarE over IP (SOME/IP).

Any network herein, such as the first network, the second network, or both, may consist of, may comprise, or may use, a vehicle network (or a vehicle bus), and any device herein, such as the adapter device, the analyzer device, or both, may comprise a first connector for connecting to the vehicle network (or vehicle bus) and a first wired transceiver coupled to the first connector for transmitting to, or receiving from, the vehicle network (or the vehicle bus). Alternatively or in addition, the second network may be other than a vehicle network or bus.

Any vehicle network or bus herein may use a data link layer or a physical layer signaling that may be according to, may be based on, may use, or may be compatible with, ISO 11898-1:2015 or standard, and the connector may be an On-Board Diagnostics (OBD) complaint connector. Any vehicle network herein may be compatible with, a multi-master, serial protocol using acknowledgement, arbitration, and error-detection schemes. Any method herein may further comprise transmitting digital data to, and for receiving digital data from, the vehicle bus or network, by a vehicle bus transceiver coupled to a vehicle network connector. The vehicle bus may employ, may use, may be based on, or may be compatible with, a synchronous and frame-based protocol, such as a Controller Area Network (CAN). The CAN may be according to, may be based on, may use, or may be compatible with, a standard selected from the group consisting of ISO 11898-3:2006, ISO 11898-2:2004, ISO 11898-5:2007, ISO 11898-6:2013, ISO 11992-1:2003, ISO 11783-2:2012, SAE J1939/11_201209, SAE J1939/15_201508, On-Board Diagnostics (OBD), and SAE J2411_200002. Alternatively or in addition, the CAN may be according to, may be based on, may use, or may be compatible with, Flexible Data-Rate (CAN FD) protocol.

Any network data link layer or any physical layer signaling herein may be according to, may be based on, may be using, or may be compatible with, ISO 11898-1:2015 or On-Board Diagnostics (OBD) standard. Any connector herein may be an On-Board Diagnostics (OBD) complaint connector, and any network medium access herein may be according to, may be based on, may be using, or may be compatible with, ISO 11898-2:2003 or On-Board Diagnostics (OBD) standard. Any network herein may be in-vehicle network such as a vehicle bus, and may employ, may use, may be based on, or may be compatible with, a multi-master, serial protocol using acknowledgement, arbitration, and error-detection schemes. Any network or vehicle bus herein may employ, may use, may be based on, or may be compatible with, a synchronous and frame-based protocol, and may further consist of, may employ, may use, may be based on, or may be compatible with, a Controller Area Network (CAN), that may be according to, may be based on, may use, or may be compatible with, ISO 11898-3:2006, ISO 11898-2:2004, ISO 11898-5:2007, ISO 11898-6:2013, ISO 11992-1:2003, ISO 11783-2:2012, SAE J1939/11_201209, SAE J1939/15_201508, On-Board Diagnostics (OBD), or SAE J2411_200002 standards. Any CAN herein may be according to, may be based on, may use, or may be compatible with, Flexible Data-Rate (CAN FD) protocol.

Alternatively or in addition, any network or vehicle bus herein may consist of, may employ, may use, may be based on, or may be compatible with, a Local Interconnect Network (LIN), which may be according to, may be based on, may use, or may be compatible with, ISO 9141-2:1994, ISO 9141:1989, ISO 17987-1, ISO 17987-2, ISO 17987-3, ISO 17987-4, ISO 17987-5, ISO 17987-6, or ISO 17987-7 standard. Alternatively or in addition, any network or vehicle bus herein may consist of, may employ, may use, may be based on, or may be compatible with, FlexRay protocol, which may be according to, may be based on, may use, or may be compatible with, ISO 17458-1:2013, ISO 17458-2:2013, ISO 17458-3:2013, ISO 17458-4:2013, or ISO 17458-5:2013 standard. Alternatively or in addition, any network or vehicle bus herein may consist of, may employ, may use, may be based on, or may be compatible with, Media Oriented Systems Transport (MOST) protocol, which may be according to, may be based on, may use, or may be compatible with, MOST25, MOST50, or MOST150.

Any vehicle network or bus herein may consist of, may comprise, or may be based on, automotive Ethernet, and may use a single twisted pair. Alternatively or in addition, any network or vehicle bus herein may consist of, may employ, may use, may be based on, or may be compatible with, IEEE802.3 100BaseT1, IEEE802.3 1000BaseT1, BroadR-Reach®, IEEE 802.3bw-2015, IEEE Std 802.3bv-2017, or IEEE Std 802.3 bp-2016 standards. Any vehicle network or bus herein may consist of, may comprise, or may be based on, an avionics data bus standard, such as Aircraft Data Network (ADN), Avionics Full-Duplex Switched Ethernet (AFDX), Aeronautical Radio INC. (ARINC) 664, ARINC 629, ARINC 708, ARINC 717, ARINC 825, MIL-STD-1553, MIL-STD-1760, or Time-Triggered Protocol (TTP).

Any network herein, such as the second network, may be a wireless network. Any device coupled to the a wireless network, such as the second device that may be coupled to a wireless network, may comprise an antenna for transmitting and receiving Radio-Frequency (RF) signals over the air; and a wireless transceiver coupled to the antenna for wirelessly transmitting digital data to, and receiving digital data from, the wireless network.

Any wireless network herein may comprise a Wireless Wide Area Network (WWAN), any wireless transceiver herein may comprise a WWAN transceiver, and any antenna herein may comprise a WWAN antenna. Any WWAN herein may be a wireless broadband network. The WWAN may be a WiMAX network, the antenna may be a WiMAX antenna and the wireless transceiver may be a WiMAX modem, and the WiMAX network may be according to, compatible with, or based on, IEEE 802.16-2009. Alternatively or in addition, the WWAN may be a cellular telephone network, the antenna may be a cellular antenna, and the wireless transceiver may be a cellular modem, where the cellular telephone network may be a Third Generation (3G) network that may use a protocol selected from the group consisting of UMTS W-CDMA, UMTS HSPA, UMTS TDD, CDMA2000 1×RTT, CDMA2000 EV-DO, and GSM EDGE-Evolution, or the cellular telephone network may use a protocol selected from the group consisting of a Fourth Generation (4G) network that use HSPA+, Mobile WiMAX, LTE, LTE-Advanced, MBWA, or may be based on IEEE 802.20-2008.

Any wireless network herein may comprise a Wireless Personal Area Network (WPAN), the wireless transceiver may comprise a WPAN transceiver, and the antenna may comprise a WPAN antenna. The WPAN may be according to, compatible with, or based on, Bluetooth™ Bluetooth Low Energy (BLE), or IEEE 802.15.1-2005 standards, or the WPAN may be a wireless control network that may be according to, or may be based on, Zigbee™, IEEE 802.15.4-2003, or Z-Wave™ standards. Any wireless network herein may comprise a Wireless Local Area Network (WLAN), the wireless transceiver may comprise a WLAN transceiver, and the antenna may comprise a WLAN antenna. The WLAN may be according to, may be compatible with, or may be based on, a standard selected from the group consisting of IEEE 802.11-2012, IEEE 802.11a, IEEE 802.11b, IEEE 802.11g, IEEE 802.11n, and IEEE 802.11ac. Any wireless network herein may be over a licensed or unlicensed radio frequency band that may be an Industrial, Scientific and Medical (ISM) radio band.

Further, any wireless network herein may be using, or may be based on, Dedicated Short-Range Communication (DSRC) that may be according to, may be compatible with, or may be based on, European Committee for Standardization (CEN) EN 12253:2004, EN 12795:2002, EN 12834:2002, EN 13372:2004, or EN ISO 14906:2004 standard. Alternatively or in addition, the DSRC may be according to, may be compatible with, or may be based on, IEEE 802.11p, IEEE 1609.1-2006, IEEE 1609.2, IEEE 1609.3, IEEE 1609.4, or IEEE1609.5.

The analyzer device or any one of the multiple devices may consist of, may comprises, or may be part of, a server device, and the method by the server device may comprise storing, operating, or using, a server operating system. The server operating system may consist or, may comprise, or may be based on, Microsoft Windows Server®, Linux, or UNIX. Alternatively or in addition, the server operating system may consist or, may comprise, or may be based on, one out of Microsoft Windows Server® 2003 R2, 2008, 2008 R2, 2012, or 2012 R2 variant, Linux™ or GNU/Linux based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, and NetBSD®. The analyzer device or any one of the multiple devices may consist of, may comprises, or may be part of, a client device, and the method by the client device may comprise storing, operating, or using, a client operating system. The client operating system may consist or, may comprise, or may be based on, one out of Microsoft Windows 7, Microsoft Windows XP, Microsoft Windows 8, Microsoft Windows 8.1, Linux, and Google Chrome OS. Alternatively or in addition, the client operating system may be a mobile operating system that may comprise Android version 2.2 (Froyo), Android version 2.3 (Gingerbread), Android version 4.0 (Ice Cream Sandwich), Android Version 4.2 (Jelly Bean), Android version 4.4 (KitKat), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

Any operating system herein may be used with a virtualization, and any operating system herein may be executed as a guest operating system as part of a Virtual Machine (VM). The virtualization may be implemented by a host computer that may implement the VM, and any method herein may further comprise executing, by the host computer, a hypervisor or a Virtual Machine Monitor (VMM), and the guest operating system may use or interface virtual hardware. Any virtualization herein may include, may be based on, or may use, full virtualization, para-virtualization, or hardware assisted virtualization.

Any device herein, such as the analyzer device, may be used with a first protocol and a second protocol that may be different from the first protocol, and any method herein may further comprises, converting, by any device such as the analyzer device, between the first and second protocols. The first and second protocols may be OSI Layer-3 or Layer-4 protocols, and the converting device, such as the analyzer device may consist of, may comprise, or may be part of, a router or a gateway. The first network may use the first protocol and the second network may use the second protocol. Alternatively or in addition, the communication with one of the multiple devices may use the first protocol and the first or second network may use the second protocol. Each of the first and second protocols may be a calibration, measurement, or diagnostic protocol, such as DoIP or XCP. Alternatively or in addition, the first and second protocols may be different versions or variants of the same protocol standard, which may use, may be according to, or may be compatible with, IEEE 802.1X. Any received message herein, such as by the adapter device, may be according to the first (or second) protocol, and any message sent herein, such as by the analyzer device, may be according to the second (or first) protocol.

Any method herein may be used with a second analyzer device that may be connected to the first network, and may be operative for determining if a message satisfies the criterion. The second analyzer device may be identical to, may be similar to, or may be different from, the first analyzer device, and the method may comprises load balancing, offloading, or backuping, the first analyzer device by the second analyzer device. Any method herein may comprise communicating, between the first and second analyzer devices, over the first network or over a network other than the first network. Any method herein may comprise implementing a redundancy scheme that uses the second analyzer device, and the redundancy scheme may be based on, or may use, Dual Modula redundancy (DMR), Triple Modular Redundancy (TMR), Quadruple Modular Redundancy (QMR), 1:N Redundancy, ‘Cold Standby’, or ‘Hot Standby’. Any method herein may further comprise detecting a failure in the first analyzer device; in response to the detecting, sending, by the adapter device, the message, or a part thereof, to the second analyzer device via a tunnel over the first network; receiving, by the second analyzer device, the message, or the part thereof; determining, by the second analyzer device, if the message, or the part thereof, satisfies the criterion; sending, in response to the determining that the message or the part thereof may not be satisfying the criterion, the message or the part thereof by the second analyzer device to the first device or node over the first network; and acting, in response to the determining that the message or the part thereof is satisfying the criterion, by the second analyzer device.

Alternatively or in addition, any method herein may further comprise sending, by the adapter device, the message, or a part thereof, to the second analyzer device via an additional tunnel over the first network; receiving, by the second analyzer device, the message, or the part thereof; and determining, by the second analyzer device, if the message, or the part thereof, satisfies the criterion, and the sending of the message, or a part thereof, to the second analyzer device may be at least in part in parallel to the sending of the message, or a part thereof, to the first analyzer device. The method may further comprise sending, in response to the determining that the message or the part thereof is not satisfying the criterion, the message or the part thereof by the second analyzer device to the first device or node over the first network; and acting, in response to the determining that the message or the part thereof is satisfying the criterion, by the second analyzer device.

Alternatively or in addition, any method herein may be used with a third network that may be coupled to the first network via an additional adapter device, and may further comprise receiving, by the additional adapter device, an additional message from the third network destined to a second device or node in the first network; sending, by the additional adapter device, the additional message, or a part thereof, to the second analyzer device via an additional tunnel over the first network; receiving, by the second analyzer device, the additional message, or the part thereof; determining, by the second analyzer device, if the additional message, or the part thereof, satisfies the criterion; sending, in response to the determining that the additional message or the part thereof is not satisfying the criterion, the additional message or the part thereof by the second analyzer device to the second device or node over the first network; and acting, in response to the determining that the additional message or the part thereof is satisfying the criterion, by the second analyzer device.

Alternatively or in addition, any method herein may further comprise receiving, by the second analyzer device, an additional message from one of the multiple devices addressed to a second device or node in the first network; determining, by the second analyzer device, if the additional message, or a part thereof, satisfies the criterion; sending, in response to the determining that the additional message or the part thereof is not satisfying the criterion, the additional message or the part thereof, by the second analyzer device, to the second device or node over the first network; and acting, in response to the determining that the additional message or the part thereof is satisfying the criterion, by the second analyzer device.

Any acting herein, such as by the analyzer device, may comprise notifying a human user using auditory, visual, or haptic stimuli by an annunciator, that may be in the analyzer device. Any device herein, such as the analyzer device, may further comprise an annunciator for notify a human user using auditory, visual, or haptic stimuli. Alternatively or in addition, the annunciator may consist of, may use, or may comprise, a visual annunciator that comprises a visual signaling component. Alternatively or in addition, the acting may comprise providing a haptic or a tactile stimuli, and the annunciator may consist of, may use, or may comprise, a vibrator.

Any annunciator herein may consist of, may use, or may comprise, an audible annunciator that comprises an audible signaling component for emitting a sound coupled to the control port for activating or controlling the audible annunciator. The audible signaling component may comprise electromechanical or piezoelectric sounder, a buzzer, a chime or a ringer. Alternatively or in addition, the audible signaling component comprises a loudspeaker and the device further comprising a digital to analog converter coupled to the loudspeaker, and may be operative to generate a single or multiple tones or a human voice talking a syllable, a word, a phrase, a sentence, a short story or a long story. Alternatively or in addition, any annunciator herein may consist of, may use, or may comprise, a visual annunciator comprising a visual signaling component, which may be a visible light emitter such as a semiconductor device, an incandescent lamp or fluorescent lamp. Alternatively or in addition, any notifier herein may consist of, may use, or may comprise, a vibrator for providing haptic or tactile stimuli, and the vibrator may consist of, may use, or may comprise, a vibration motor, a linear actuator, or an off-center motor.

Any annunciator herein may further include a visual annunciator comprising a visual signaling component that may be a visible light emitter such as a semiconductor device, an incandescent lamp or fluorescent lamp, and the taking an action may comprise activating or controlling the visual annunciator. The visible light emitter may be adapted for a steady illumination and for blinking in response to the value of the estimated angular deviation, or any other numerical value. Alternatively or in addition, the illumination level, location, type, color, or steadiness of the visible light emitter may be in response to any other numerical value. Alternatively or in addition, the visible light emitter may be a numerical or an alphanumerical display emitter that may be based on LCD (Liquid Crystal Display), TFT (Thin-Film Transistor), FED (Field Emission Display) or CRT (Cathode Ray Tube), for displaying a value.

Any acting herein may further comprise composing a notification message by any device herein, such as by the analyzer device. The notification message may comprise the time associated with the received message by the device, such as by the analyzer device, and an identity of the device that transmitted the message. Any method herein may further comprise sending the notification message either over the first network, or over a network other than the first network, or both.

Any notification message herein may be sent over the Internet via the network to a client device using a peer-to-peer scheme. Alternatively or in addition, any notification message herein may be sent over the Internet via a wireless network to an Instant Messaging (IM) server for being sent to a client device as part of an IM service. Any notification message herein, or any communication with the IM server, may use, may be based on, or may be compatible with, SMTP (Simple Mail Transfer Protocol), SIP (Session Initiation Protocol), SIMPLE (SIP for Instant Messaging and Presence Leveraging Extensions), APEX (Application Exchange), Prim (Presence and Instance Messaging Protocol), XMPP (Extensible Messaging and Presence Protocol), IMPS (Instant Messaging and Presence Service), RTMP (Real Time Messaging Protocol), STM (Simple TCP/IP Messaging) protocol, Azureus Extended Messaging Protocol, Apple Push Notification Service (APNs), or Hypertext Transfer Protocol (HTTP).

Further, any notification message herein may be a text-based message and the IM service may be a text messaging service. Furthermore, Any notification message herein may be according to, may be compatible with, or may be based on, a Short Message Service (SMS) message and the IM service is a SMS service, the message is according to, or based on, an electronic-mail (e-mail) message and the IM service is an e-mail service, the message is according to, or based on, WhatsApp message and the IM service is a WhatsApp service, the message is according to, or based on, an Twitter message and the IM service is a Twitter service, or the message is according to, or based on, a Viber message and the IM service is a Viber service. Even more, any notification message herein may be a Multimedia Messaging Service (MMS) or an Enhanced Messaging Service (EMS) message that may include an audio or video, and any IM service herein may respectively be a NMS or EMS service.

Any network herein, such as the first network, may consist of, may comprise, or may be based on, a first node that may comprise multiple ports for connecting to any other nodes or devices, such as to at least one of the multiple devices, to the analyzer device, or to the adapter device. Any node herein, such as the first node, may be coupled to pass data between the adapter device and the analyzer device, and any sending of any message, such as by the adapter device, may comprise sending the message to the first node by the adapter device, and forwarding the message, by the first node, to the analyzer device. Alternatively or in addition, Any node herein, such as the first node, may be coupled to pass data between the first device and the analyzer device, and any sending of any message, such as by the analyzer device, may comprise sending the message to the first node by the analyzer device, and forwarding the message, by the first node, to the first device.

Any node herein, such as the first node, may consists of, may comprise, may be part of, or may be integrated with, a gateway, a router, a bridge, a switch, a hub, a repeater, a multilayer switch, a protocol converter, a proxy server, a firewall, a multiplexer, or an aggregator. Any node herein, such as the first node, may comprise a first port for connecting to the analyzer device, a second node for connecting to the adapter device, and a third port for connecting to one of the multiple devices. Any node herein, such as the first node, may be an Ethernet-based or automotive-Ethernet node, and each of the ports herein may be an Ethernet port, and each of the connections herein may consist of, may employs, may use, may be based on, or may be compatible with, IEEE802.3 100BaseT1, IEEE802.3 1000BaseT1, BroadR-Reach®, IEEE 802.3bw-2015, IEEE Std 802.3bv-2017, or IEEE Std 802.3 bp-2016 standards. Any node herein, such as the first node, may comprise, may be part of, or may be integrated in part or entirely in, any other device herein, such as in the analyzer device or the adapter device. Any integration herein may involve sharing a component, such as housing in same enclosure, sharing same processor, or mounting onto same surface. Alternatively or in addition, the integration may involve sharing a same connector, which may be a power connector for connecting to a power source, and the integration may involve sharing the same connector for being powered from same power source, or the integration may involve sharing same power supply or power source. Further, any node herein, such as the first node, may be enclosed in the analyzer device or in the adapter device. Any acting herein may comprise blocking a port of the multiple ports, and the blocked port may consist of the port that may be connected to the adapter device.

Any network herein, such as the first network, may consist of, may comprise, or may be based on, multiple nodes that may include the first node, and each one of the multiple nodes may comprise multiple ports for connecting to at least one of the multiple devices, to the analyzer device, to the adapter device, or to any other device herein.

The multiple nodes may be coupled to pass data between any devices or nodes herein, such as between the adapter device and the analyzer device, and the sending of any message herein, such as by the adapter device or the analyzer device, may comprise sending the message to one of the nodes by the adapter device or the analyzer device, and forwarding the message, by one of the nodes, to the analyzer device or the adapter device. The multiple nodes may be coupled to pass data between the analyzer device and the first device, and the sending the message by the analyzer device to the first device may comprise sending the message to one of the nodes by the analyzer device, and forwarding the message, by one of the nodes, to the first device.

Each one of the multiple nodes may consist of, may comprise, may be part of, or may be integrated with, a gateway, a router, a bridge, a switch, a hub, a repeater, a multilayer switch, a protocol converter, a proxy server, a firewall, a multiplexer, or an aggregator. At least two of the nodes of the multiple nodes may be identical to, distinct from, or different from, each other. Any multiple nodes herein may comprise at least three nodes that may be arranged in a ring, linear or star topology. Alternatively or in addition, the nodes may consists of, or may comprise, Ethernet switches, and the ring may be according to, may be based on, or may employ, Ethernet Ring Protection Switching (ERPS) that may be according to, may be based on, or may be compatible with, International Telecommunication Union (ITU) Telecommunication Standardization Sector standard ITU-T G.8032v1 or ITU-T G.8032v2. Any acting herein may comprise blocking a port of a node, such as of the multiple nodes. The blocked port may consist of the port that may be connected to any device, such as the adapter device or one of the multiple devices.

Any network herein, such as the first network, may consist of, may comprise, or may be based on, multiple nodes that may comprise multiple ports for connecting to at least one of the multiple devices, to the analyzer device, or to the adapter device. Each one of the multiple nodes may store a collection of forwarding rules associated an output port, for forwarding for each received messages or for each received port. Any data path or tunnel herein may be implemented by the at least part of the forwarding rules in at least part of the multiple nodes.

Any method herein may further comprise implementing the tunnel by setting forwarding rules in one or more of the nodes. Further, any method herein may further comprise implementing sending a message from a device to another device by setting forwarding rules in one or more of the nodes, such as the sending of the message or path thereof by the analyzer device to the first device by setting forwarding rules in one or more of the nodes. Any method herein may further comprise receiving, by at least one of the multiple node, the forwarding rules, such as from the analyzer device, either over the first network or over a network that is other than the first network.

Any node herein, such as any multiple nodes, may be Virtual Local Area Network (VLAN) capable, and any path or tunnel herein may be implemented by forming a first VLAN using a first VLAN identification (VID) to the messages from the adapter device to the analyzer device, and associating the first VID with the adapter device and the analyzer device. Any sending of any message herein, such as the sending of the message or part thereof by the analyzer device to the first device, may be implemented by forming a second VLAN using a second VLAN identification (VID) to the messages from the analyzer device to the first device, and associating the second VID with the first device and the analyzer device. Any method herein may further comprise in response to the determining that the message, or part thereof, is not satisfying the criterion, combining the first and second VLANs. Alternatively or in addition, Any method herein may further comprise in response to the determining that the message, or part thereof, is not satisfying the criterion, dis-associated the analyzer device from the combined first and second VLANs, and any acting herein may comprise blocking or discarding, by at least one of the nodes, messages associated by the first VID.

Any network herein, such as the first network, may employ, may use, or may be based on, Multiprotocol Label Switching (MPLS), and any node herein may consist of, or may comprise, a Label Edge Router (LER) or a Label Switch Router (LSR), and any tunnel herein may comprises, may be implemented by, or may consist of, a Label-Switched Path (LSP).

Any network herein, such as the first network, may employ, may use, or may be based on, Software-Defined Networking (SDN) technology, and any device herein, such as the analyzer device, may serves as an SDN controller, and any multiple nodes herein may consist of, may comprise, may form, or may be part of, an SDN Datapath. The SDN technology may use, or may be based on, OpenFlow protocol, any node herein, such as each of the multiple nodes, may be OpenFlow capable, and any device herein, such as the analyzer device, may serve as an OpenFlow controller. Alternatively or in addition, any tunnel herein may be implemented by employing, using, or based on, Software-Defined Networking (SDN) technology.

Any network herein may be a vehicle network, such as a vehicle bus or any other in-vehicle network. A connected element comprises a transceiver for transmitting to, and receiving from, the network. The physical connection typically involves a connector coupled to the transceiver. The vehicle bus may consist of, may comprise, may be compatible with, may be based on, or may use a Controller Area Network (CAN) protocol, specification, network, or system. The bus medium may consist of, or comprise, a single wire, or a two-wire such as an UTP or a STP. The vehicle bus may employ, may use, may be compatible with, or may be based on, a multi-master, serial protocol using acknowledgement, arbitration, and error-detection schemes, and may further use synchronous, frame-based protocol.

Any wireless network herein may be a Wireless Personal Area Network (WPAN), any wireless transceiver may be a WPAN transceiver, and any antenna herein may be a WPAN antenna. The WPAN may be according to, may be compatible with, or may be based on, Bluetooth™ or IEEE 802.15.1-2005 standards, or the WPAN may be a wireless control network that may be according to, or may be based on, ZigBee™, IEEE 802.15.4-2003, or Z-Wave™ standard. Any wireless network herein may be a Wireless Local Area Network (WLAN), any wireless transceiver may be a WLAN transceiver, and any antenna herein may be a WLAN antenna. The WLAN may be according to, may be compatible with, or may be based on, IEEE 802.11-2012, IEEE 802.11a, IEEE 802.11b, IEEE 802.11g, IEEE 802.11n, or IEEE 802.11ac. Any wireless network herein may use a licensed or unlicensed radio frequency band, and the unlicensed radio frequency band may be an Industrial, Scientific and Medical (ISM) radio band.

Any acting herein may comprise transmitting a signal to the medium while the at least part of the frame is received, so that the frame is interfered and is corruptedly propagated on the medium so that the first frame is rendered ineligible to be properly received by any of the multiple devices. The transmitting of the signal to the medium may comprise changing a single bit in the series of bits received by each of the multiple devices, or the transmitting of the signal to the medium may comprise changing multiple consecutive or non-consecutive bits (such as 2, 4, 6, 8 bits or more) in the series of bits received by each of the multiple devices. Further, the medium may be carrying data as dominant (‘0’) or recessive (‘1’) bits, and the transmitting of the signal to the medium may comprise transmitting high voltage or high current pulse for changing one or more bits from recessive to dominant bits, so that the one or more bits in the series of bits received by each of the multiple devices is changed.

The above summary is not an exhaustive list of all aspects of the present invention. Indeed, the inventor contemplates that his invention includes all systems and methods that can be practiced from all suitable combinations and derivatives of the various aspects summarized above, as well as those disclosed in the detailed description below, and particularly pointed out in the claims filed with the application. Such combinations have particular advantages not specifically recited in the above summary.

### BRIEF DESCRIPTION OF THE DRAWINGS

The invention is herein described, by way of non-limiting examples only, with reference to the accompanying drawings, wherein like designations denote like elements. Understanding that these drawings only provide information concerning typical embodiments of the invention and are not therefore to be considered limiting in scope:

FIG. 1 illustrates schematically a block diagram of a prior-art computer connected to the Internet;

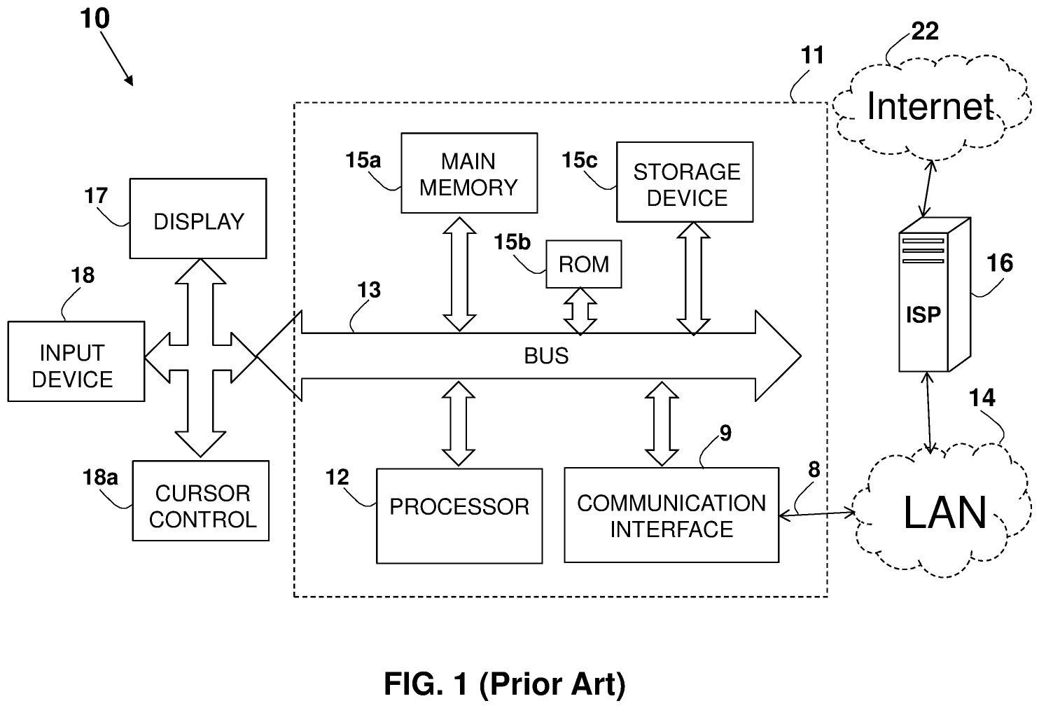

FIG. 1a illustrates schematically prior-art servers, clients, and a computer workstation connected via the Internet;

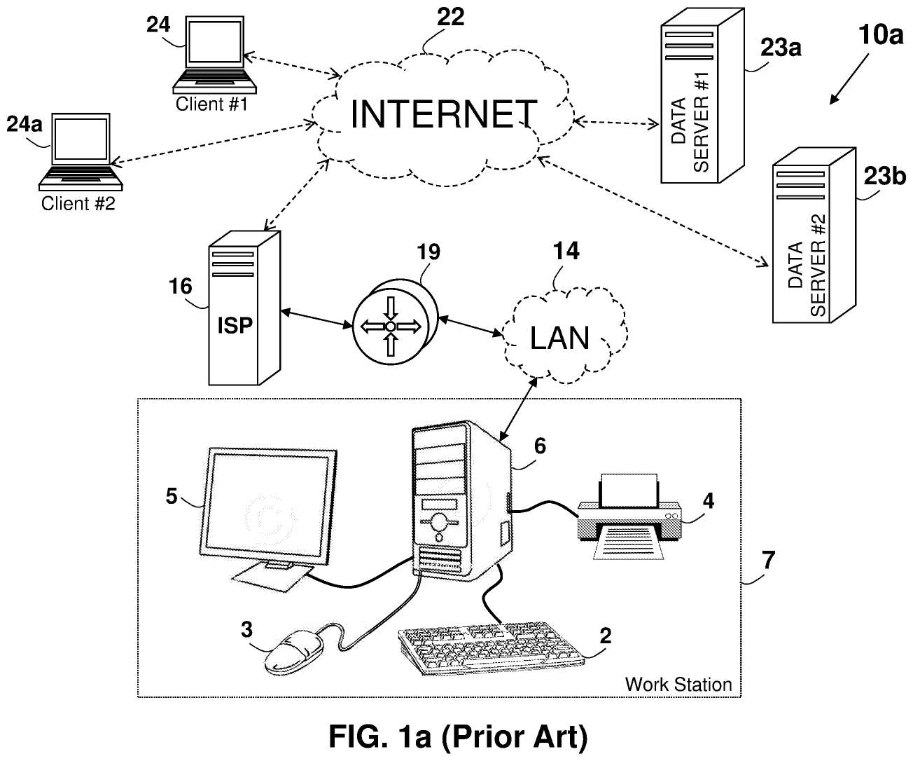

FIG. 1b illustrates schematically a prior-art arrangement of virtualization;

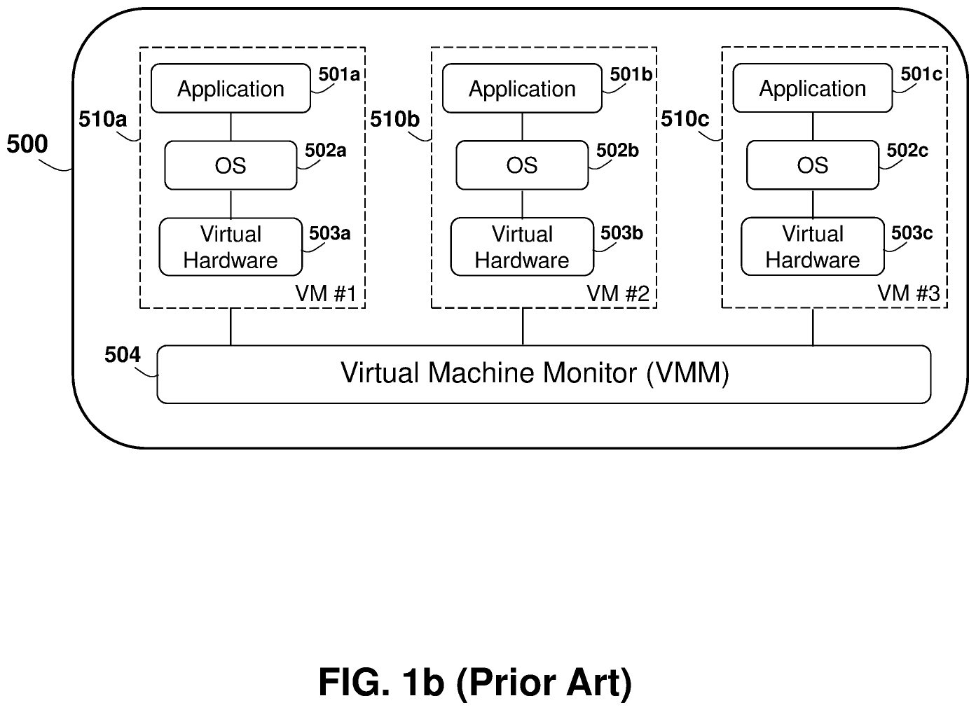

FIG. 1c illustrates schematically a prior-art arrangement of hosted architecture of virtualization;

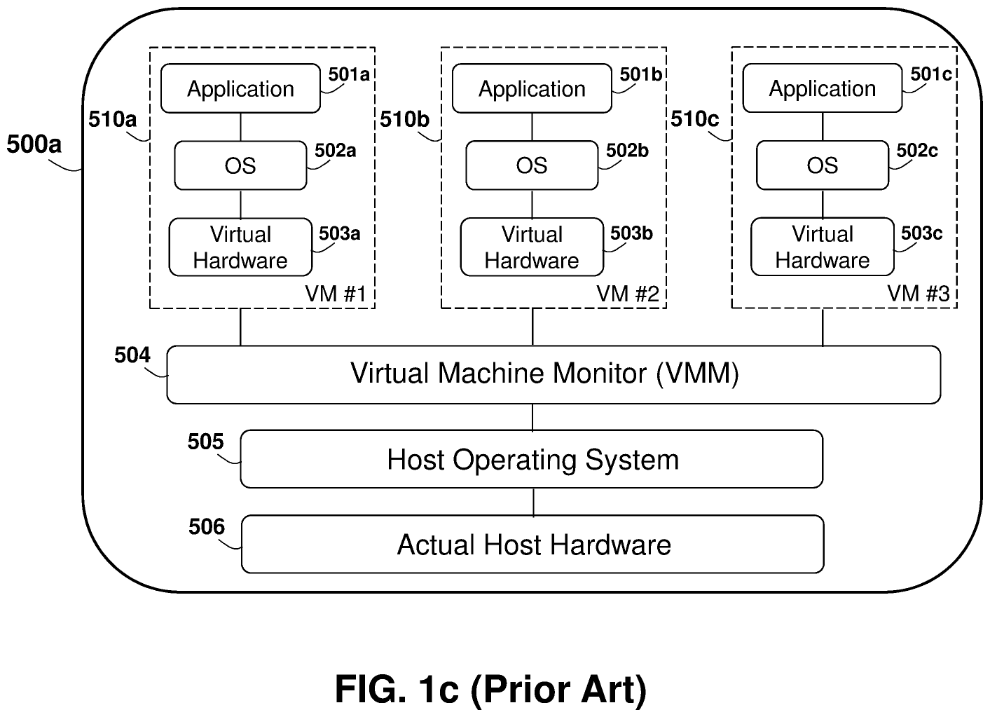

FIG. 1d illustrates schematically a prior-art arrangement of bare-metal (hypervisor) architecture of virtualization;

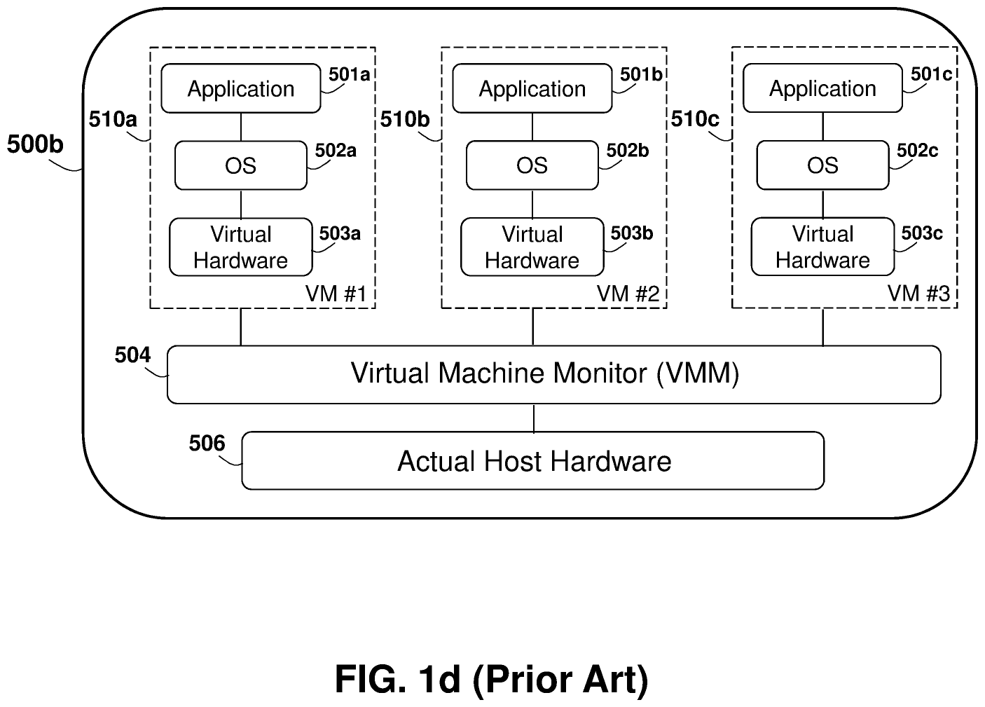

FIG. 2 illustrates a simplified schematic block diagram of a prior-art electronics architecture in a vehicle;

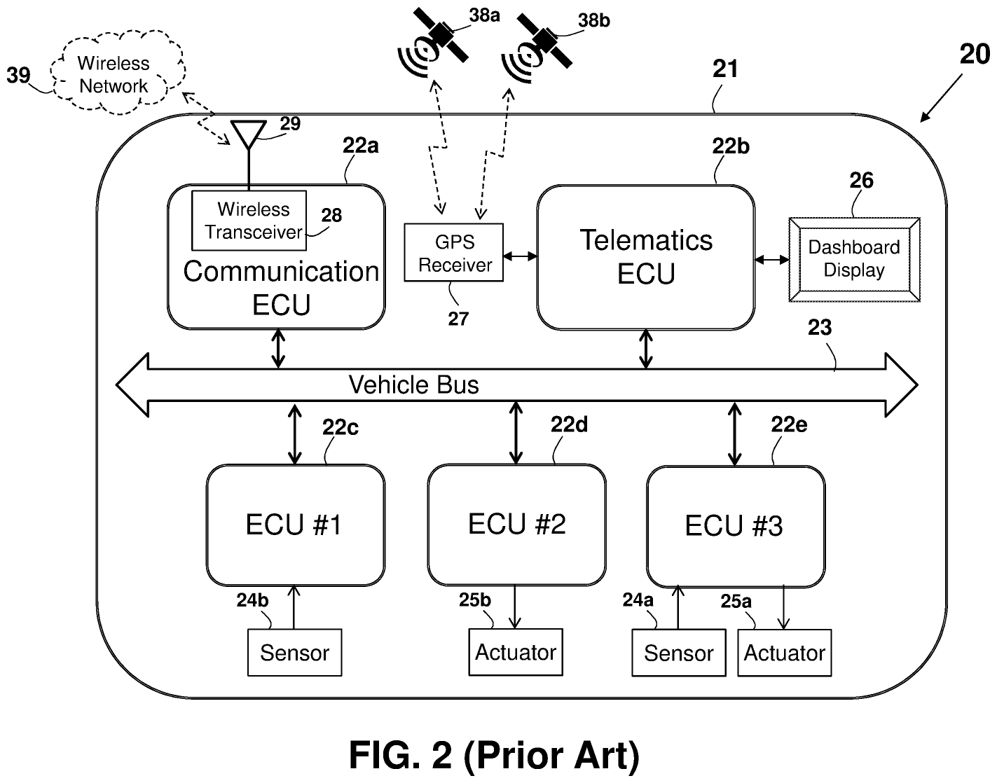

FIG. 2a illustrates a table of the various classification levels of autonomous car is according to the Society of Automotive Engineers (SAE) J3016 standard;

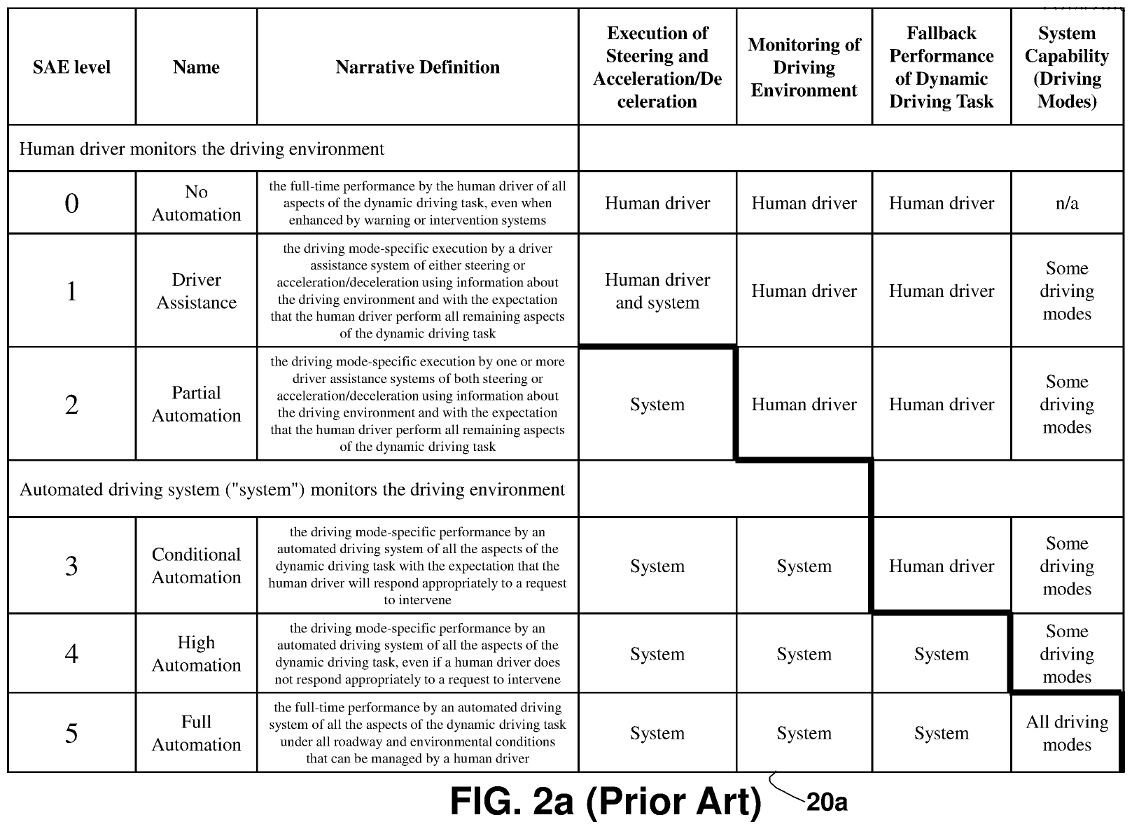

FIG. 3 illustrates a simplified schematic block diagram of a prior-art Electronic Control Unit (ECU);

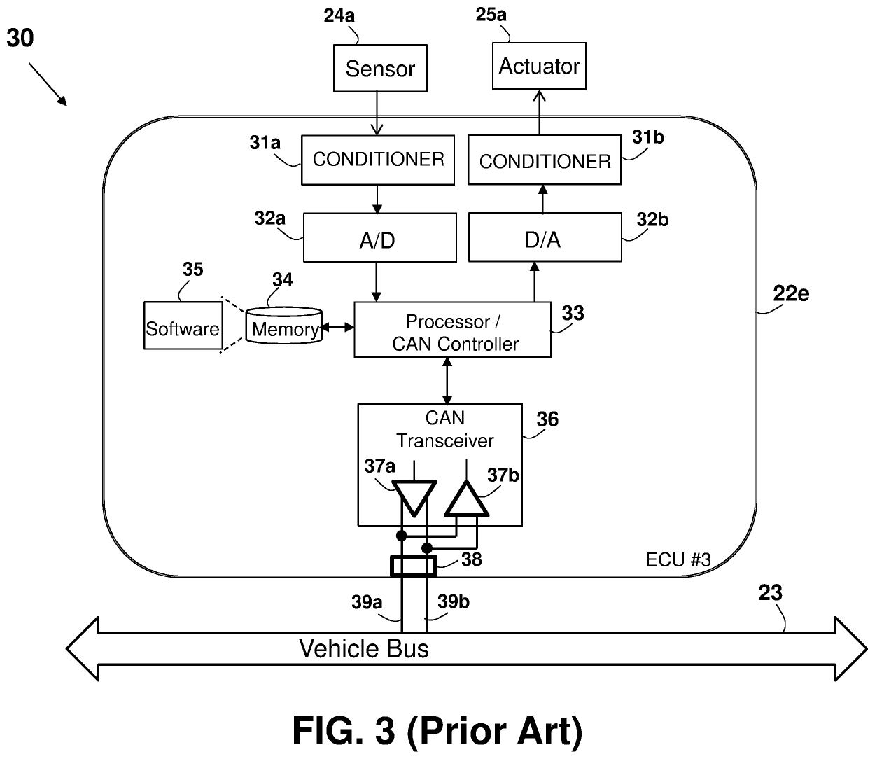

FIG. 4 illustrates a simplified schematic block diagram of a prior-art protecting of a network using a firewall;

FIG. 4a illustrates a simplified schematic block diagram of a prior-art protecting of a network using two firewalls, each connected to a different external network;

FIG. 4b illustrates a simplified schematic block diagram of a prior-art network using a firewall and a malware in the protected side;

FIG. 5 illustrates a simplified schematic block diagram of a prior-art firewall connected between two networks;

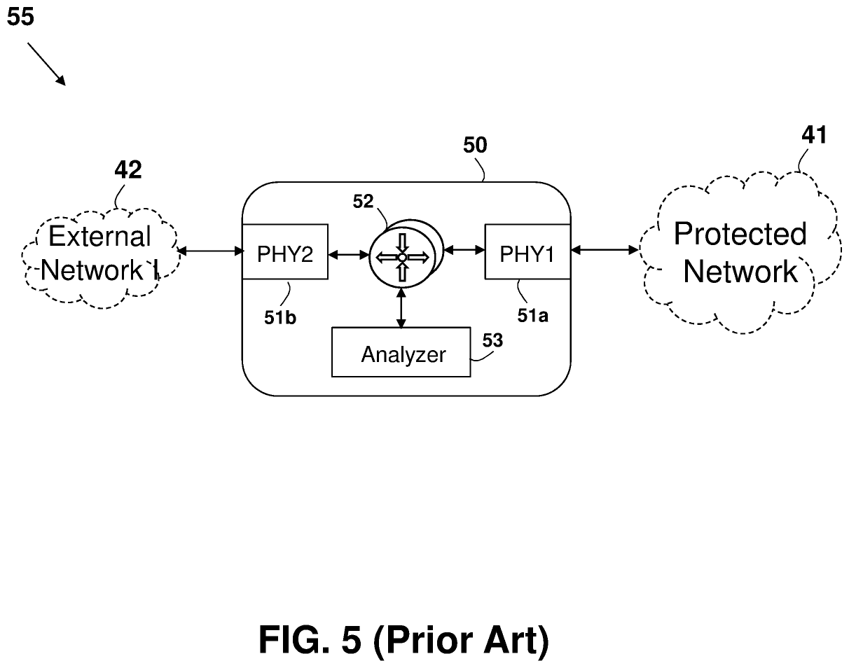

FIG. 6 illustrates a simplified schematic block diagram of a prior-art automotive networking scheme;

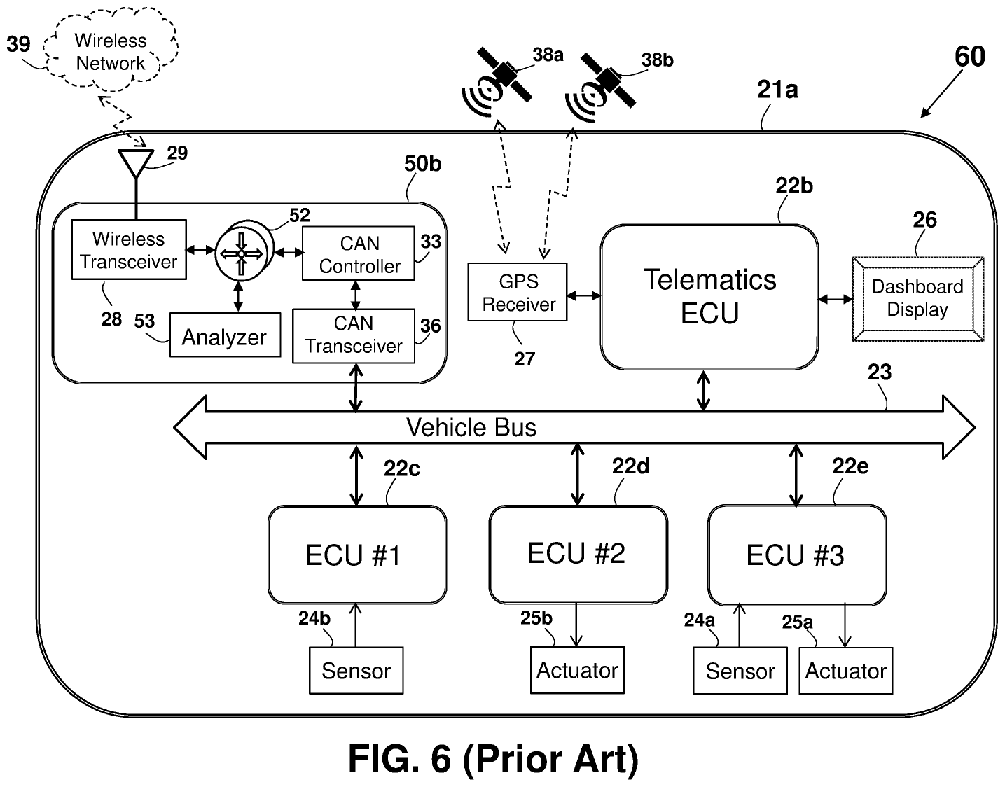

FIG. 7 illustrates a simplified schematic block diagram of a general adapter devices connected between two networks;

FIG. 8 illustrates a simplified schematic block diagram of an arrangement for protecting using an analyzer server in a location other than a network edge or protected side edge;

FIG. 8a illustrates a simplified schematic block diagram of message routing in an arrangement using an analyzer server in a location other than a network edge or protected side edge;

FIG. 8b illustrates a simplified schematic block diagram of an arrangement of protecting a network in a building using an analyzer server in a location other than a network edge or protected side edge;

FIG. 8c illustrates a simplified schematic block diagram of messages routing in an arrangement for protecting when connecting to two networks using an analyzer server in a location other than a network edge or protected side edge;

FIG. 8d illustrates a simplified schematic block diagram of an arrangement of protecting a network from external network and from internal device using an analyzer server in a location other than a network edge or protected side edge;

FIG. 8e illustrates a simplified schematic block diagram of an arrangement of protecting a network from a broadcast message received from an external network using an analyzer server in a location other than a network edge or protected side edge;

FIG. 8f illustrates a simplified schematic block diagram of an arrangement of protecting a network from a multicast message received from an internal device using an analyzer server in a location other than a network edge or protected side edge;

FIG. 8g illustrates a simplified schematic block diagram of an arrangement of protecting a network from a unicast message received from, and destined to, an internal device using an analyzer server in a location other than a network edge or protected side edge;

FIG. 9 illustrates schematically a simplified flowchart of handling a message in an arrangement using an analyzer server in a location other than a network edge or protected side edge;

FIG. 10 illustrates a simplified schematic block diagram of messages routing in an vehicular arrangement for protecting when connecting to two networks using an analyzer server in a location other than a network edge or protected side edge;

FIG. 10a illustrates a simplified schematic block diagram of messages routing in an vehicular arrangement for protecting a network from external network and from internal device using an analyzer server in a location other than a network edge or protected side edge;

FIG. 11 illustrates a simplified schematic block diagram of an analyzer server or device for use in an arrangement for use in a location other than a network edge or protected side edge;

FIG. 12 illustrates a simplified schematic block diagram of an arrangement for protecting using two analyzer servers in a location other than a network edge or protected side edge;

FIG. 12a illustrates a simplified schematic block diagram of messages routing in an arrangement using redundant two analyzer servers in a location other than a network edge or protected side edge;

FIG. 12b illustrates a simplified schematic block diagram of messages routing in an arrangement using one analyzer server for external networks and one analyzer server for internal network;

FIG. 12c illustrates a simplified schematic block diagram of an arrangement for protecting using two analyzer servers in a location other than a network edge or protected side edge, where each analyzer server handles a different external network;

FIG. 12d illustrates a simplified schematic block diagram of an arrangement for protecting using two analyzer servers in a location other than a network edge or protected side edge, where each analyzer server handles a different internal network;

FIG. 13 illustrates a simplified schematic block diagram of messages routing in an arrangement using an analyzer server in a location other than a network edge or protected side edge, where direct connection between devices is allowed after authentication;

FIG. 14 illustrates a simplified schematic block diagram of an arrangement for protecting a network formed by three serially connected nodes using an analyzer server in a location other than a network edge or protected side edge;

FIG. 14a illustrates a simplified schematic block diagram of an arrangement for protecting a network formed by a single node using an analyzer server in a location other than a network edge or protected side edge;

FIG. 14b illustrates a simplified schematic block diagram of an arrangement for protecting a network formed by star topology connected nodes using an analyzer server in a location other than a network edge or protected side edge;

FIG. 14c illustrates a simplified schematic block diagram of an arrangement for protecting a network formed by ring topology connected nodes using an analyzer server in a location other than a network edge or protected side edge;

FIG. 14d illustrates a simplified schematic block diagram of an arrangement for protecting a network using an analyzer server integrated with one of the network nodes;

FIG. 14e illustrates a simplified schematic block diagram of an arrangement for protecting a network using an analyzer functionality integrated with one of the network nodes;

FIG. 14f illustrates a simplified schematic block diagram of an arrangement for protecting a network using an adapter device integrated with one of the network nodes;

FIG. 15 illustrates a simplified schematic block diagram of messages routing in an arrangement of a network formed by three serially connected nodes using an analyzer server in a location other than a network edge or protected side edge;

FIG. 15a illustrates a simplified schematic block diagram of messages routing in an arrangement of a network formed by ring topology connected nodes using an analyzer server in a location other than a network edge or protected side edge;

FIG. 15b illustrates a simplified schematic block diagram of messages routing in an arrangement of a network formed by star topology connected nodes using an analyzer server in a location other than a network edge or protected side edge; and

FIG. 15c illustrates a simplified schematic block diagram of blocking messages in an arrangement of a network formed by star topology connected nodes using an analyzer server in a location other than a network edge or protected side edge.

### DETAILED DESCRIPTION

The principles and operation of an apparatus according to the present invention may be understood with reference to the figures and the accompanying description wherein similar components appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (even in the case of using different suffix, such as 5, 5a, 5b and 5c) refer to functions or actual devices that are either identical, substantially similar, or having similar functionality. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in the figures herein, is not intended to limit the scope of the invention, as claimed, but is merely representative of embodiments of the invention. It is to be understood that the singular forms “a,” “an,” and “the” herein include plural referents unless the context clearly dictates otherwise. Thus, for example, a reference to “a component surface” includes reference to one or more of such surfaces. The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

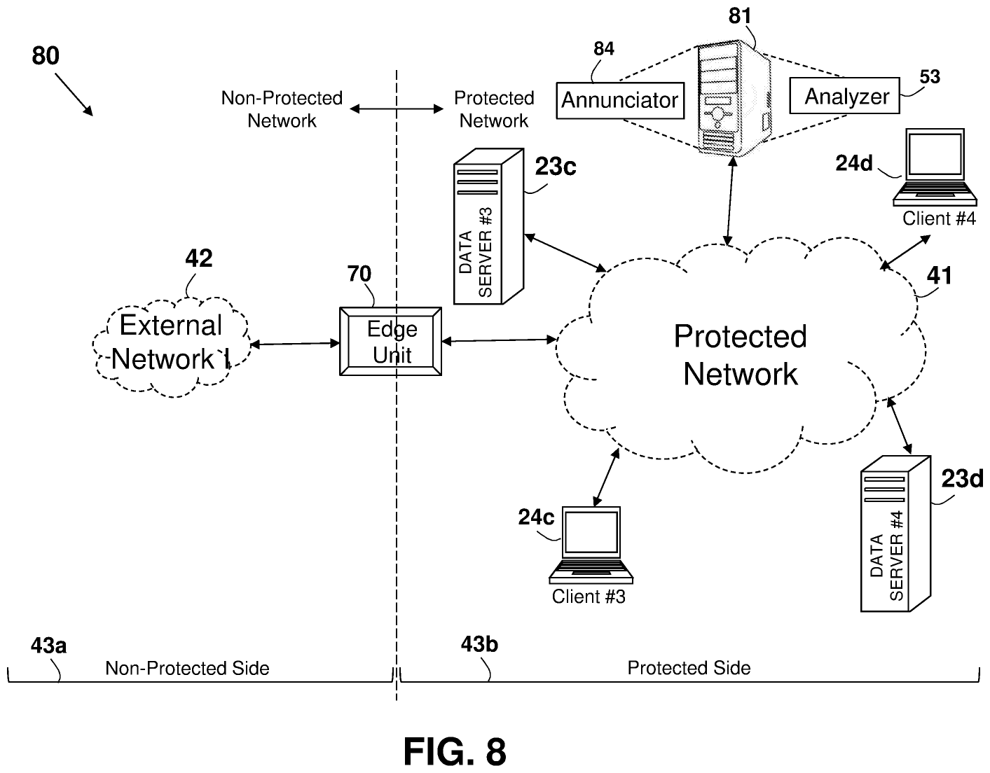

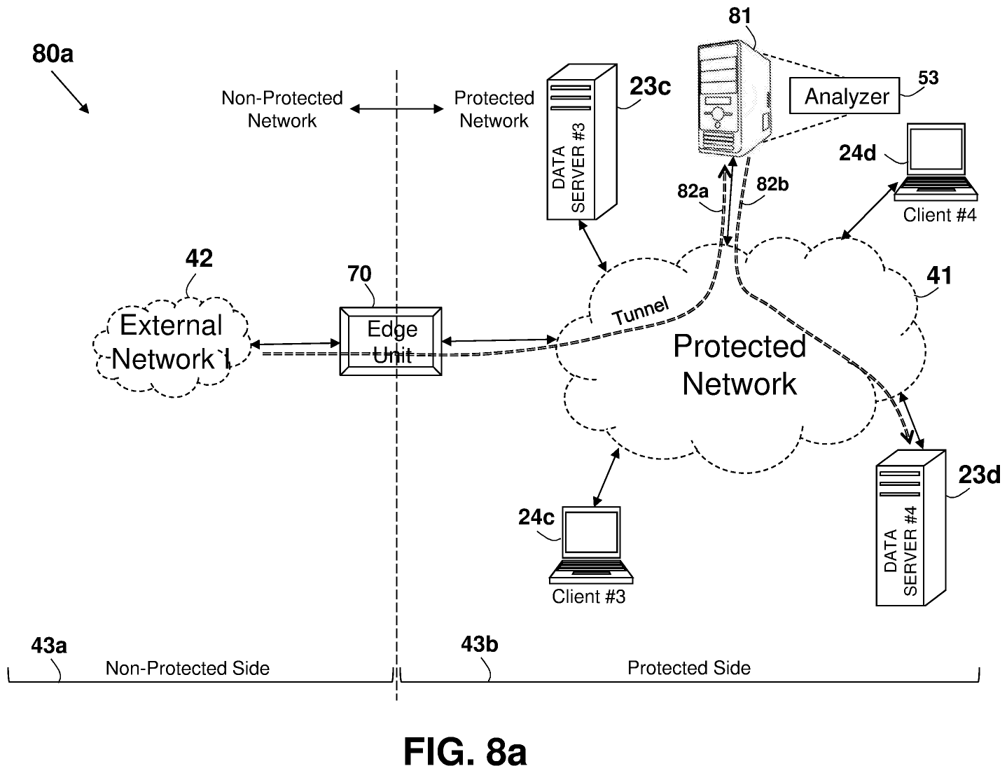

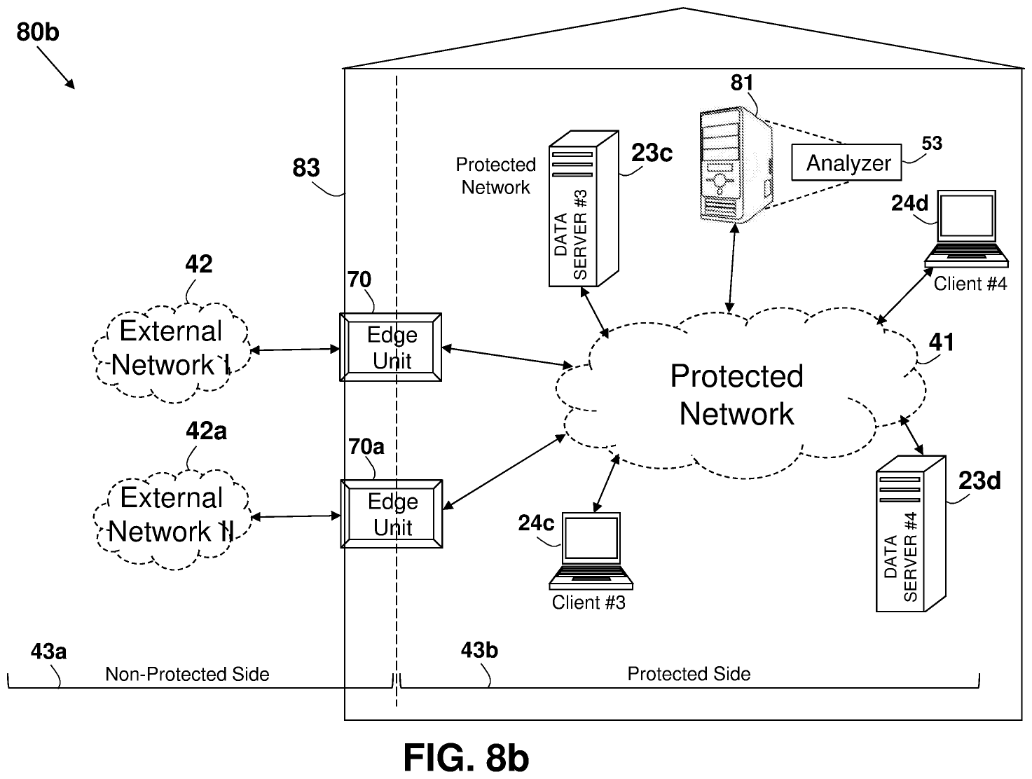

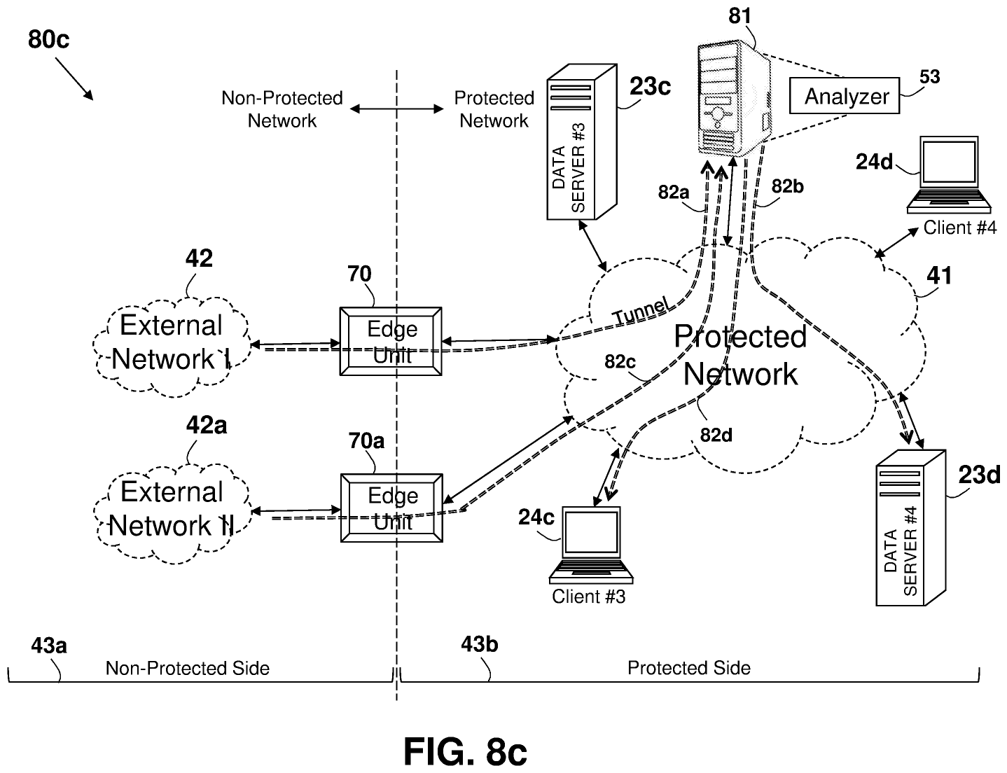

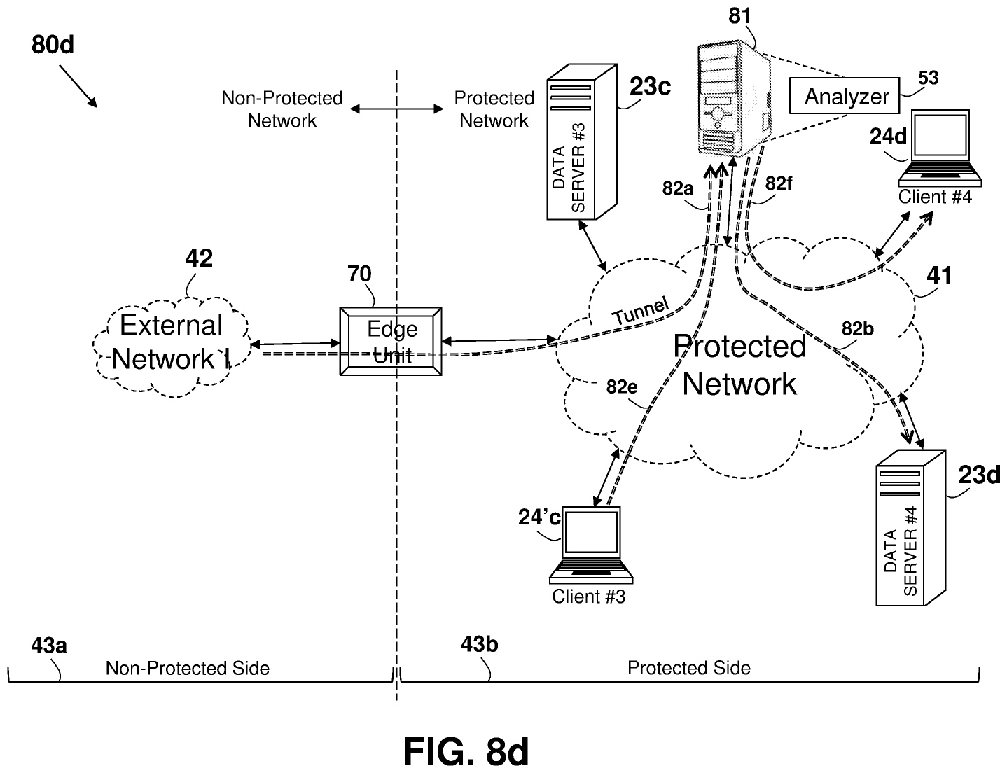

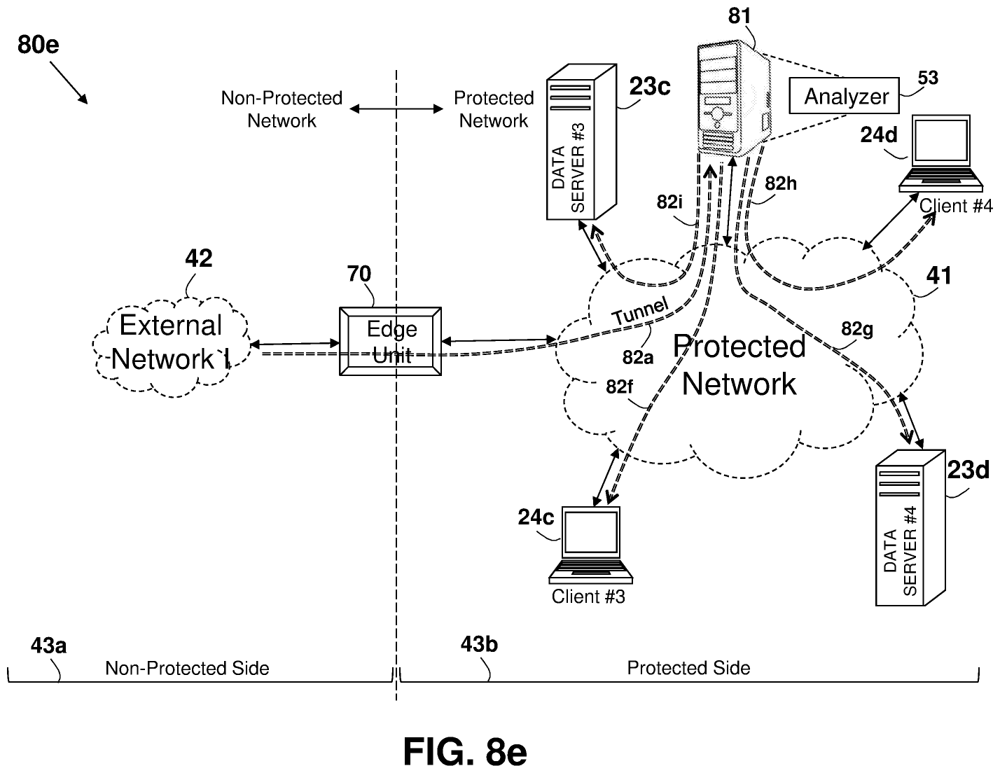

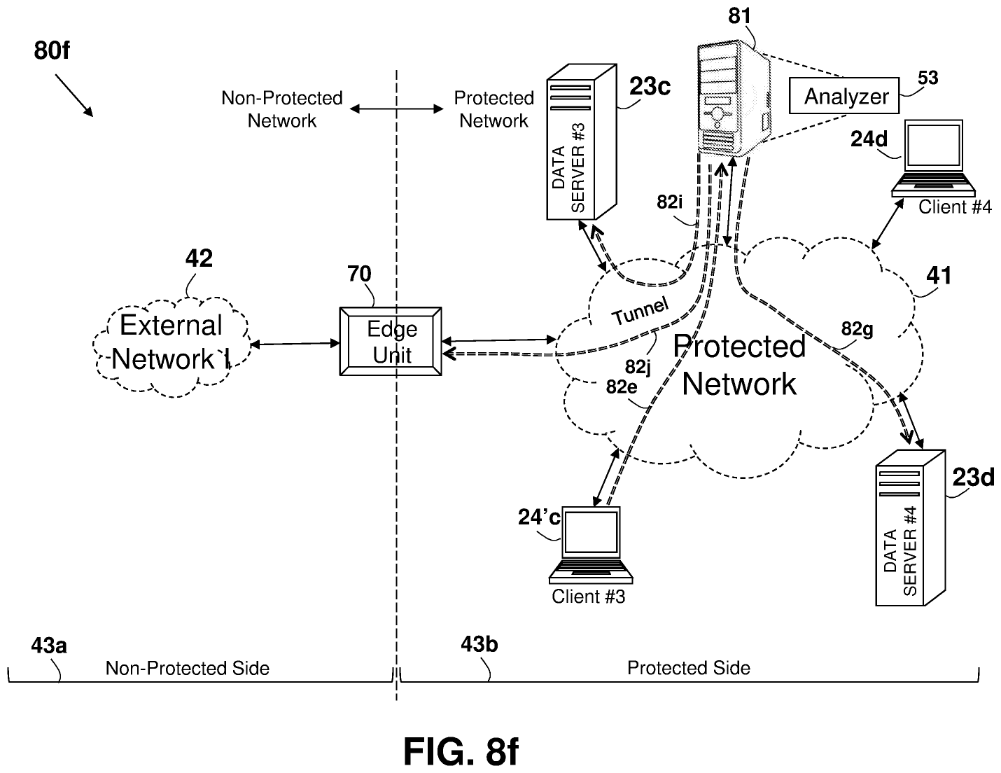

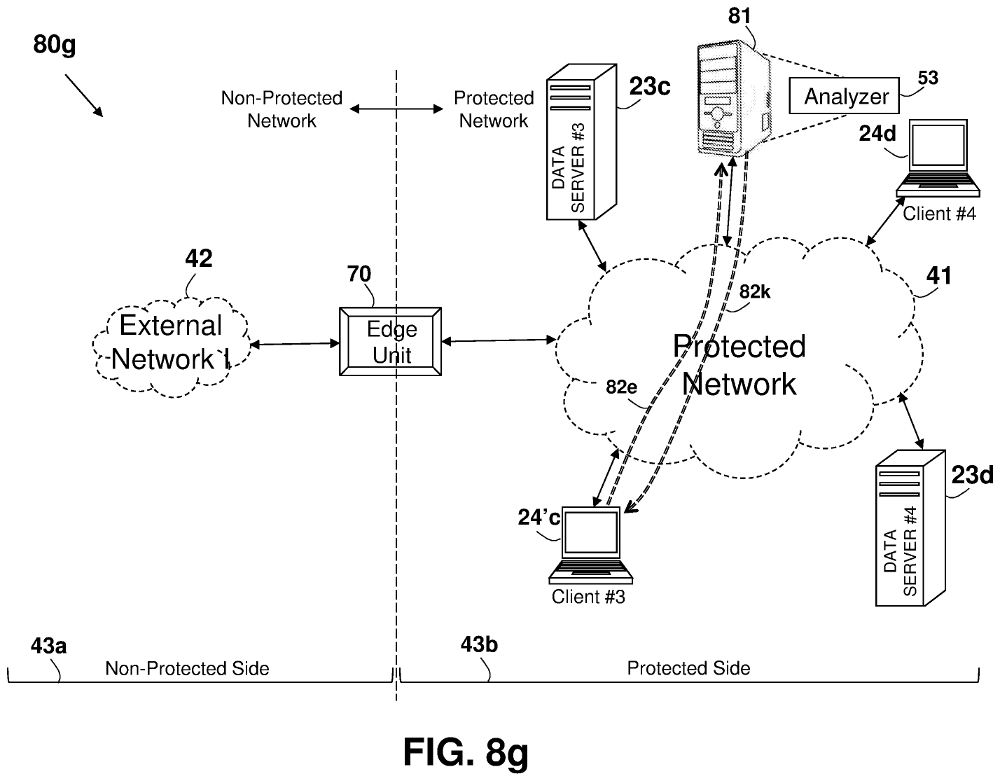

In one example, the analyzing functionality of inspecting the incoming (or outgoing) messages for detecting malware is separated from the networks interfacing or bridging functionality, and thus may be located anywhere in the protected side 43b. Such an arrangement 80 is shown in FIG. 8, where the analyzer functionality 53 is not integrated or located at the networks connection location, but is integrated or located in a server 81. The server 81 may be a dedicated unit serving only or mainly the security features relating to handling malware, in particular inspecting incoming (or outgoing) traffic for malware. Alternatively or in addition, the analyzer 53 functionality may be integrated or located within any end unit associated with the network 41, such as part of a client device (such as the client device #3 24c or the client device #4 24d). Similarly, the analyzer 53 functionality may be integrated or located within any server connected to, or part of, the network 41, such as the server device #3 23c or the server device #4 23d. Further, the analyzer 53 functionality may be integrated or located within any device or node that is part of, or associated with, the network 41, such as a Layer-2 switch, a Layer-3 router, a bridge, a concentrator, an aggregator, or an Add/Drop Multiplexer (ADM). Further, the analyzer server 81 may comprise, or may be connected to, an annunciator 84, for notifying information to a human user, such as alerting the human user when a malware is detected.

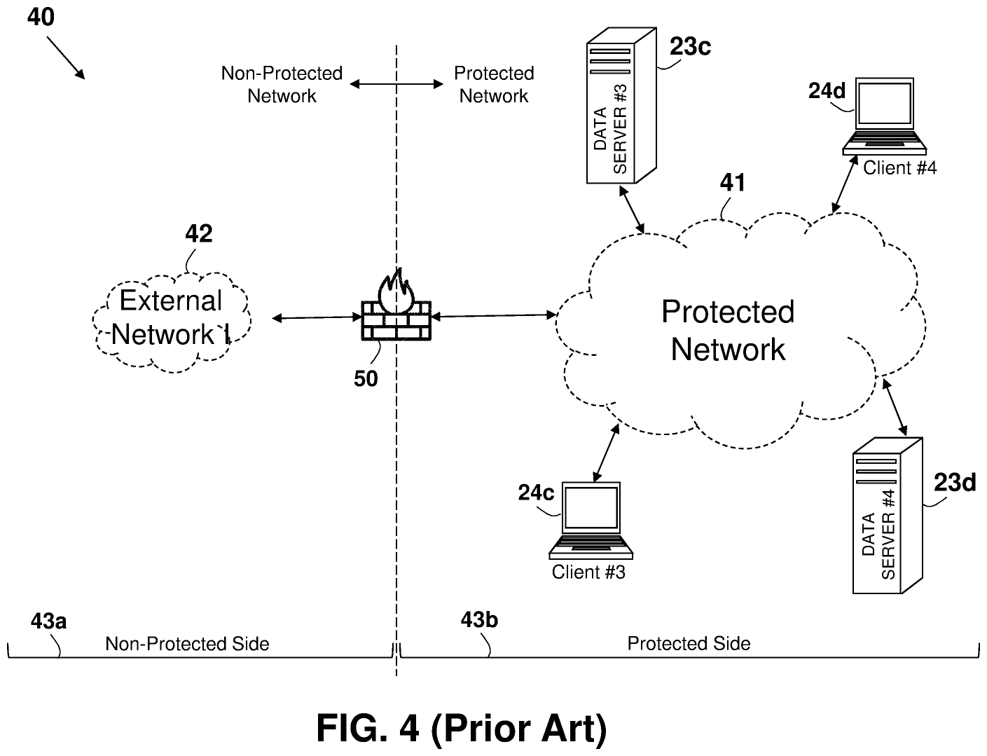

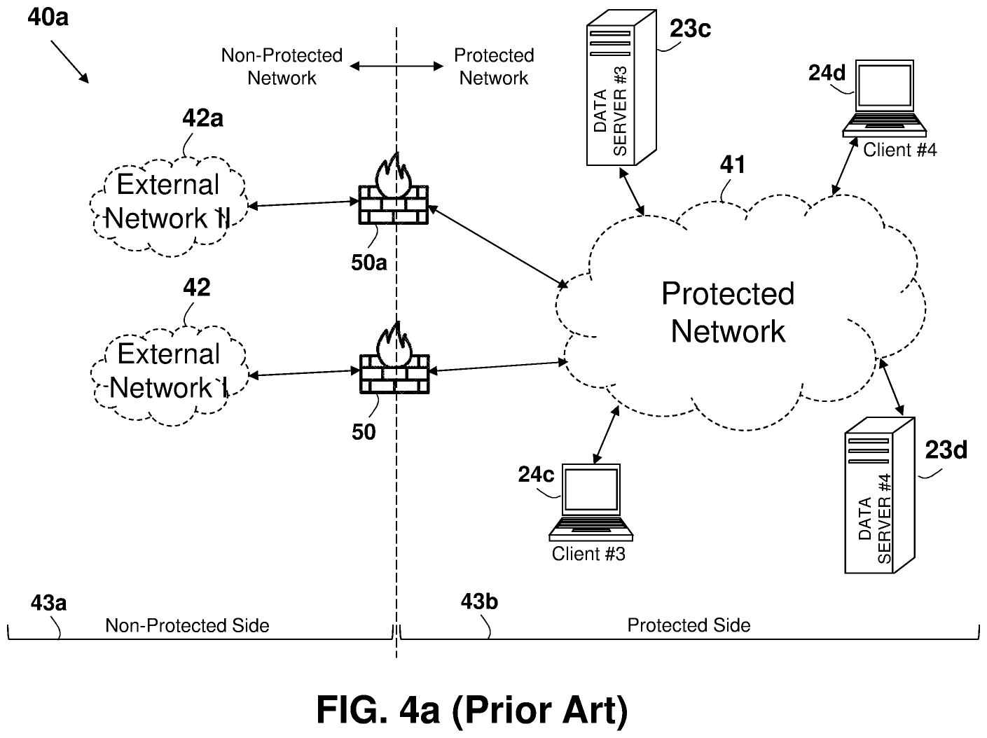

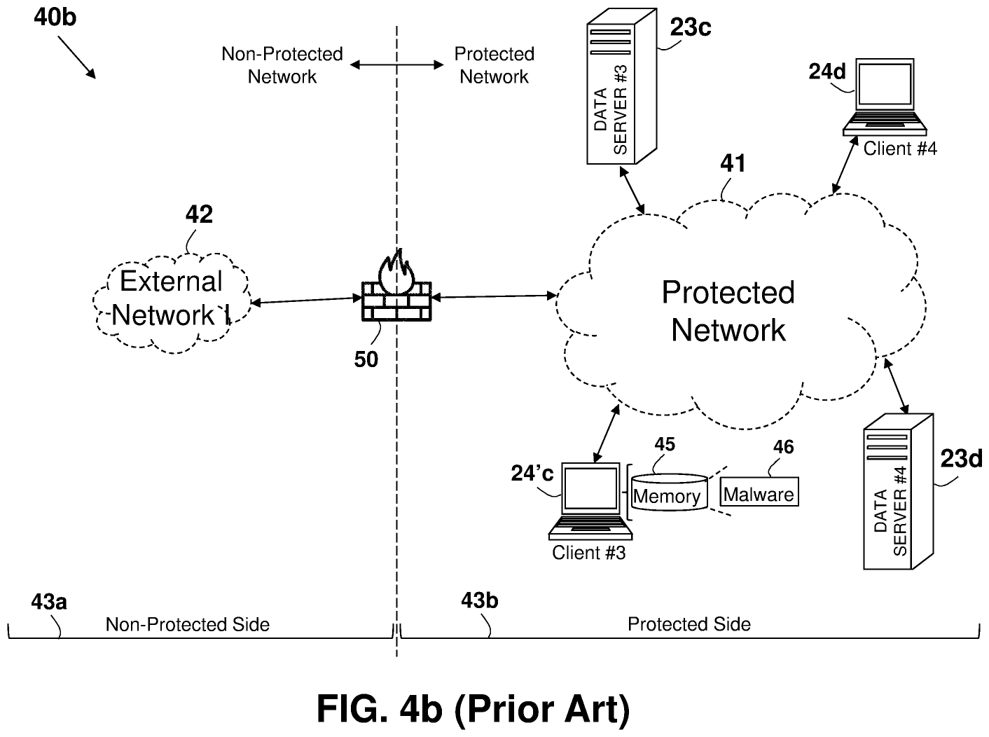

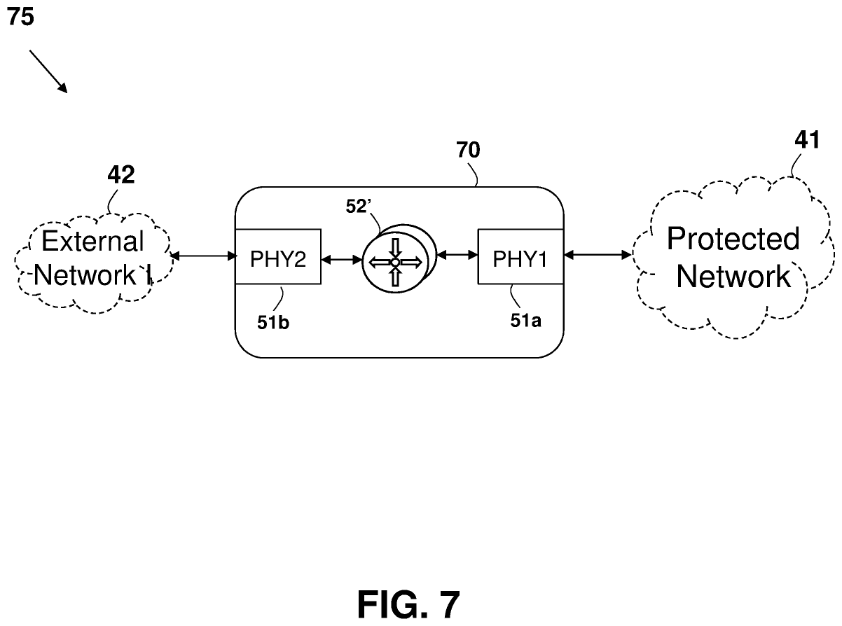

As shown in the arrangement 80 in FIG. 8, the firewall device 50 shown in the arrangement 40 in FIG. 4 is replaced with an edge device 70, which has no (or minimum) analyzer functionality 53, and mainly serves to interface and adapt between the external Network I 42 and the Protected Network 41, such as physical layer and higher layers adapting. An example of a schematic block diagram of such edge unit 70 is illustrated as part of an arrangement 75 shown in FIG. 7. Similar to the firewall device 50 shown as part of the arrangement 55 above, the edge unit 70 comprises the physical layer handling PHY1 51a for interfacing with the Protected Network 41, and the physical layer handling PHY2 51b for interfacing with the External Network I 42. Adapting between layers that are above the physical layer is handled by an adapter 52′, which may include, or may be identical, to the adapter 52, and may include Layer-2 handling, such as switching functionality, for handling at the Ethernet frame level. Alternatively or in addition, the adapter 52′ may include Layer-3 handling, such as IP routing functionality, for handling at the IP packet level. Further, the adapter 52′ may be used for converting between different protocols or rates of the two connected networks.

In order for forming the protected side or zone 43b, part or all of the messages from the External Network I 42 are checked for malware presence by the analyzer 53 in the server 81, and thus need to be routed by the network 41 from the edge unit 70 to the server 81, irrespective of the actual destination in the network 41 of the received messages. Preferably, the received messages are redirected by the adapter 52′ in the edge unit 70 to the server 81 for analyzing by the analyzer functionality 53 therein, over a path 82a. In one example, such routing over the path 82a uses a tunnel in the network 41, for isolating the suspected messages to arrive to any other device, node, or end-unit of the network 41, thus avoiding the risk of damage or infection by a malware in the received messages. For example, a message or data stream (such as a frame or a packet) received by the edge unit 70 and destined to the data server #4 23d, is redirected by the edge unit 70 over the tunnel 82a to be analyzed or checked by the analyzer functionality 53 in the server 81. Only after the message is determined not to include any malware, the message may then be sent by the server 81 to data server #4 23d, the original destination, over a path 82b in the network 41.

The path 82b of the message that has been analyzed by the analyzer 53 from the server 81 to the original destination, which is the server 23d, may be over a tunnel that is identical to, similar to, or different from, the tunnel 82a from the receiving edge unit 70 to the analyzing server 81. In one example, since the message transported over the path 82b has been already analyzed and was determined to be harmless, the path may not be a tunnel but rather a regular message transfer over the network 41 from the source—the server 81—to the original destination—the data server #4 23d. Further, the same message (being a frame or packet, for example), that was redirected to be analyzed by the analyzer functionality 53 may be transmitted to the network 41, and will be forwarded by the network 41 based on the original destination address (that may be MAC or IP address).

One advantage of using a centralized analyzer 53 is exampled in an arrangement 80b shown in FIG. 8b, which is based on the arrangement 80 shown in FIG. 8. The protected side 43b, which may be inside a building 83, for example, is connected to an additional network External Network II 42a. The need for an additional analyzer (or part thereof) for handling the additional network External Network II 42a is obviated by using the centralized analyzer 53. An additional edge unit 70a is connected between the External Network II 42a and the in-building protected network 41. The additional edge unit 70a may be identical to, similar to, or different from, the edge unit 70. As illustrated in an arrangement 80c shown in FIG. 8c, messages received from the External Network II 42a are routed over a tunnel 82c from the edge unit 70a, to be analyzed by the analyzer 53 in the server 81. For example, when a received message is destined to the Client device #3 24c, the message is first redirected by the edge unit 70a to the analyzing server 81 to be analyzed by the analyzer 53, and only after being determined as non-harmful message, the message is sent over a tunnel 82d (or over a non-tunnel routing) to the destination Client device #3 24c. The tunnel 82c may be identical to, similar to, or different from, the tunnel 82a.

Similarly, the central analyzer 53 may be used for protecting against infected or malicious end units connected in the protected side 43b. Such a protection arrangement 80d is shown in FIG. 8d. Assuming that a Client device #3 24′c is suspected as infected, substituted, compromised, or otherwise including a malware. A message from the suspected Client device #3 24′c to the Client device #4 24d is redirected by the network 41 to the server 81 for analyzing by the analyzer 53, over a tunnel 82e that may be identical to, similar to, or different from, the tunnel 82a. Only after analyzing and determining that the message is legitimate and non-harmful, the message is forwarded to the destination—the client device #4 24d over a path 82f, which may be a regular path or a tunnel in the network 41.

The FIGS. 8a-8d example the handling of a unicast message, involving a one-to-one transmission from one point in the network to another point: one sender and one receiver, each identified by a network address, where the transported message includes a destination address that uniquely identifies a single receiver endpoint. However, broadcast and multicast messages may equally be handled. Broadcast uses a one-to-all association, where a single datagram from one sender is routed to all of the possibly multiple endpoints associated with the broadcast address. The network automatically replicates datagrams as needed to reach all the recipients within the scope of the broadcast, which is generally an entire network subnet. Multicast addressing uses a one-to-many-of-many or many-to-many-of-many association, and datagrams are routed simultaneously in a single transmission to many recipients. It differs from broadcast in that the destination address designates a subset, not necessarily all, of the accessible nodes.

An arrangement 80e shown in FIG. 8e illustrates the handling of a broadcast message received from the external network I 42 via the edge unit 70. The broadcast message is tunneled over the tunnel 82a to the analyzer server 81. If found to be a valid and non-harmful message, the message is broadcasted by the analyzer server 81 to all entities in the protected network 41, such as to the data server #3 23c over a path 82i, to the client #3 24c over a path 82f, to the data server #4 23d over a path 82g, and to the client #4 24d over a path 82h. An arrangement 80f shown in FIG. 8f illustrates the handling of a multicast message received from the client #3 24′c by the analyzer server 81 over the path 82e. In the case where the analyzer server 81 decides to further distribute the message (after checking it), the message may be multicast to some of the entities connected by the internal network 41, such as to the data server #3 23c over a path 82i, to the data server #4 23d over a path 82g, and to the external network I 42 via the edge unit 70 over the path 82j.

The FIGS. 8a-8f example the handling of messages received for an entity, and destined to one or more entities different from the sending entity. However, the arrangements may equally apply to a scenario where the same entity sends a message (such as over a tunnel) to the analyzer and receives the message or a response from the analyzer. In one example, such mechanism may be used for converting protocols, authentication, or wherein an entity wishes information to be checked by the analyzer. An arrangement 80g shown in FIG. 8g illustrates the handling of receiving from, and sending to, the same device, such as the client device #3 24′c. The client device #3 24′c sends a message over the path 82e, which may be a tunnel, to the analyzer server 81, where the message is analyzed and checked, and in response the message or another response is sent back to the client device #3 24′c over a path 82k.

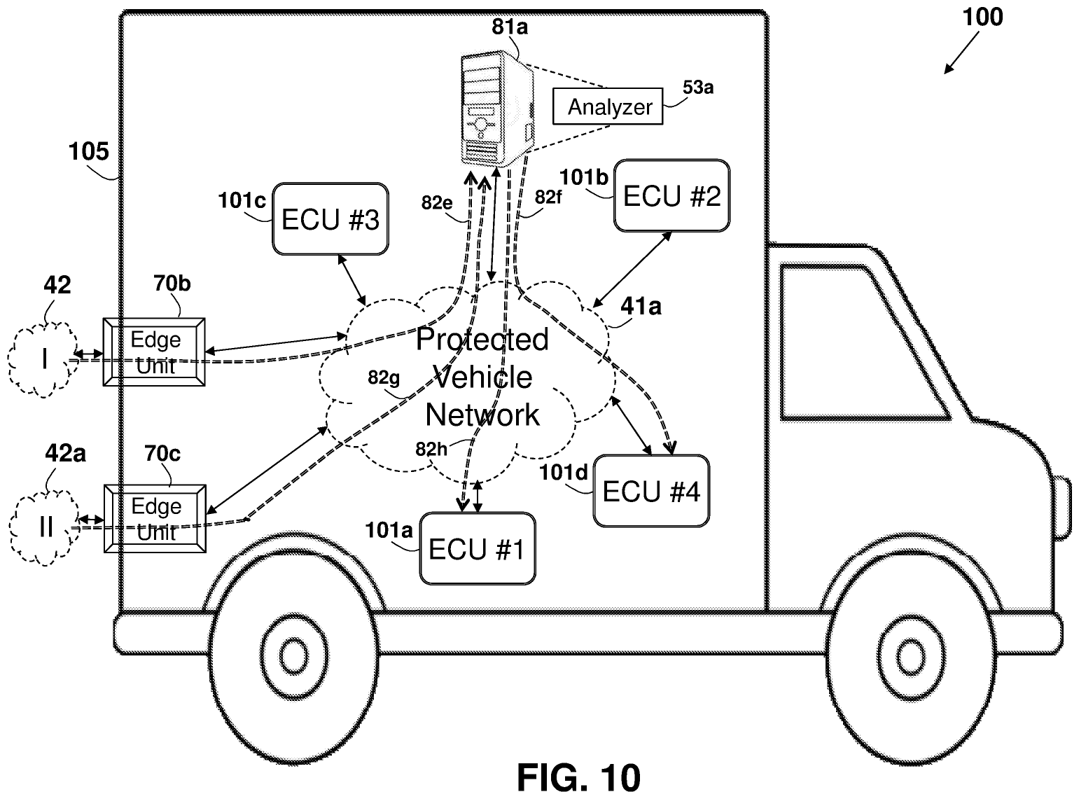

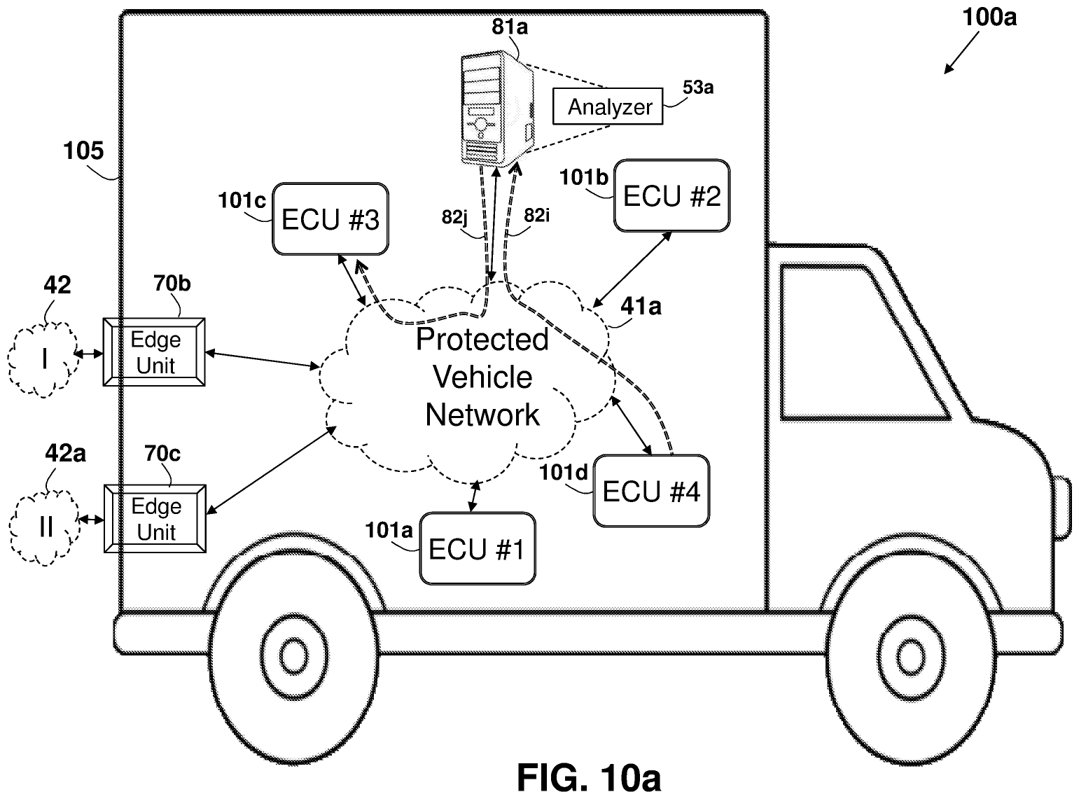

In one example, the protected side 43b consists of, or is part of, a vehicle. Such a protected truck 105 is shown as part of an arrangement 100 in FIG. 10. The truck 105 comprises a Protected Vehicle Network 41a, connecting an ECU #1 101a, an ECU #2 101b, an ECU #3 101c, and an ECU #4 101d, as well as a server 81a that is connected to, or comprises, a vehicular analyzer 53a, which may be vehicle-oriented and may be identical to, similar to, or different from, the analyzer 53. Similarly, the server 81a may be vehicle-oriented and may be identical to, similar to, or different from, the server 81. In one example, the server 81a, the analyzer 53a, or both, may be part of an ECU. Similar to the arrangement 80c shown in FIG. 8c, the truck 105 is connected to, and protected from malware from, two external networks: The External Network I 42 and the External Network II 42a, which are respectively connected to the protected vehicle network 41a via the edge unit 70b and the edge unit 70c. Each of the edge units 70b and 70c may be vehicle-oriented and may be identical to, similar to, or different from, any of the edge units 70 or 70a. Messages received from External Network I 42 and destined to the ECU #1 101a are redirected by the edge unit 70b over a tunnel 82e to the server 81a to be analyzed by the analyzer 53a, and only upon being validated as non-harmful are routed to the original destination, the ECU #1 101a, over a path 82h. Similarly, messages received from External Network II 42a and destined to the ECU #4 101d are redirected by the edge unit 70c over a tunnel 82g to the server 81a to be analyzed by the central analyzer 53a, and only upon being validated as non-harmful are routed to the original destination, the ECU #4 101d, over a path 82f.

Similar to the arrangement 80d shown in FIG. 8d, the central vehicular analyzer 53a may be used for protecting against infected or malicious ECUs connected in the truck 105. Such a protection arrangement 100a is shown in FIG. 10a. Assuming that the ECU #4 101d is suspected as infected, substituted, compromised, or otherwise including a malware. A message from the suspected ECU #4 101d to the ECU #3 101c is redirected by the vehicle network 41a to the server 81a for analyzing by the analyzer 53a, over a tunnel 82i that may be identical to, similar to, or different from, the tunnel 82a. Only after analyzing and determining that the message is legitimate and non-harmful, the message is forwarded to the destination—the ECU #3 101c over a path 82j, which may be a regular path or a tunnel in the network 41a. The vehicle 105 may further comprise an Advanced Driver Assistance Systems (ADAS) functionality or an Advanced Driver Assistance System Interface Specification (ADASIS) system, or scheme, and any device of network herein, such as the protected network 41a, one of the connected ECUs (such as the ECU #1 101a, the ECU #2 101b, the ECU #3 101c, or the ECU #4 101d), the edge unit 70b, or the analyzer server 81a, may be part of, may be integrated with, may communicate with, or may be coupled to, the ADAS or ADASIS functionality, system, or scheme. Further, any ECU, device, or network herein may be part of, or may comprise, the powertrain, chassis, body and comfort, driver assistance/pedestrian safety, or Human-Machine Interface/Multimedia/Telematics sub-system.

In one example, the edge unit 70b, the edge unit 70c, the server 81a, or any combination thereof, may comprise, may consist of, or may be integrated with, an Electronic Control Unit (such as the ECU #1 101a, the ECU #2 101b, the ECU #3 101c, or the ECU #4 101d). Further, each of the ECUs, the edge unit 70b, the edge unit 70c, the server 81a, or any combination thereof, may comprise, may use, or may be based on, an operating-system or a middleware, that comprises, or uses, OSEK/VDX, International Organization for Standardization (ISO) 17356-1, ISO 17356-2, ISO 17356-3, ISO 17356-4, ISO 17356-5, or AUTOSAR standard. Furthermore, each of the ECUs, the edge unit 70b, the edge unit 70c, the server 81a, or any combination thereof, may comprise, may use, or may be based on, an operating-system or a middleware, that comprises, or uses, Scalable service-Oriented MiddlewarE over IP (SOME/IP).

The protected vehicle network 41a may consist of, may comprise, or may use, a vehicle network (or a vehicle bus, such as the vehicle bus 23). In such a case, the PHY1 51a of the edge unit 70b (and of the edge unit 70c), and the physical layer of the analyzer server 81a, may comprise a first connector for connecting to the vehicle network (or vehicle bus) and a first vehicle network or bus transceiver (such as the CAN transceiver 36) coupled to the first connector for transmitting to, or receiving from, the vehicle network (or the vehicle bus). In one example, the external network I 42 or the external network II 42a (or both) may be a network that is not a vehicle network or a vehicle bus. Alternatively or in addition, the external network I 42 or the external network II 42a (or both) may also be comprise, or may use, a vehicle network (or a vehicle bus, such as the vehicle bus 23), which may be identical to, similar to, or different from the protected vehicle network 41a. In such a case, the PHY2 51b of the edge unit 70b (and of the edge unit 70c), may comprise a second connector for connecting to the additional vehicle network (or vehicle bus) and a second vehicle network or bus transceiver (such as the CAN transceiver 36) coupled to the second connector for transmitting to, or receiving from, the additional vehicle network (or the vehicle bus).

Any vehicle network or bus herein may use a data link layer or a physical layer signaling that may be according to, may be based on, may use, or may be compatible with, ISO 11898-1:2015 or standard, and the connector may be an On-Board Diagnostics (OBD) complaint connector. Any vehicle network herein may be compatible with, a multi-master, serial protocol using acknowledgement, arbitration, and error-detection schemes. Any method herein may further comprise transmitting digital data to, and for receiving digital data from, the vehicle bus or network, by a vehicle bus transceiver coupled to a vehicle network connector. The vehicle bus may employ, may use, may be based on, or may be compatible with, a synchronous and frame-based protocol, such as a Controller Area Network (CAN). The CAN may be according to, may be based on, may use, or may be compatible with, a standard selected from the group consisting of ISO 11898-3:2006, ISO 11898-2:2004, ISO 11898-5:2007, ISO 11898-6:2013, ISO 11992-1:2003, ISO 11783-2:2012, SAE J1939/11_201209, SAE J1939/15_201508, On-Board Diagnostics (OBD), and SAE J2411_200002. Alternatively or in addition, the CAN may be according to, may be based on, may use, or may be compatible with, Flexible Data-Rate (CAN FD) protocol.

Any network data link layer or any physical layer signaling herein may be according to, may be based on, may be using, or may be compatible with, ISO 11898-1:2015 or On-Board Diagnostics (OBD) standard. Any connector herein may be an On-Board Diagnostics (OBD) complaint connector, and any network medium access herein may be according to, may be based on, may be using, or may be compatible with, ISO 11898-2:2003 or On-Board Diagnostics (OBD) standard. Any network herein may be in-vehicle network such as a vehicle bus, and may employ, may use, may be based on, or may be compatible with, a multi-master, serial protocol using acknowledgement, arbitration, and error-detection schemes. Any network or vehicle bus herein may employ, may use, may be based on, or may be compatible with, a synchronous and frame-based protocol, and may further consist of, may employ, may use, may be based on, or may be compatible with, a Controller Area Network (CAN), that may be according to, may be based on, may use, or may be compatible with, ISO 11898-3:2006, ISO 11898-2:2004, ISO 11898-5:2007, ISO 11898-6:2013, ISO 11992-1:2003, ISO 11783-2:2012, SAE J1939/11_201209, SAE J1939/15_201508, On-Board Diagnostics (OBD), or SAE J2411_200002 standards. Any CAN herein may be according to, may be based on, may use, or may be compatible with, Flexible Data-Rate (CAN FD) protocol.

Alternatively or in addition, any network or vehicle bus herein may consist of, may employ, may use, may be based on, or may be compatible with, a Local Interconnect Network (LIN), which may be according to, may be based on, may use, or may be compatible with, ISO 9141-2:1994, ISO 9141:1989, ISO 17987-1, ISO 17987-2, ISO 17987-3, ISO 17987-4, ISO 17987-5, ISO 17987-6, or ISO 17987-7 standard. Alternatively or in addition, any network or vehicle bus herein may consist of, may employ, may use, may be based on, or may be compatible with, FlexRay protocol, which may be according to, may be based on, may use, or may be compatible with, ISO 17458-1:2013, ISO 17458-2:2013, ISO 17458-3:2013, ISO 17458-4:2013, or ISO 17458-5:2013 standard. Alternatively or in addition, any network or vehicle bus herein may consist of, may employ, may use, may be based on, or may be compatible with, Media Oriented Systems Transport (MOST) protocol, which may be according to, may be based on, may use, or may be compatible with, MOST25, MOST50, or MOST150.

Any vehicle network or bus herein may consist of, may comprise, or may be based on, automotive Ethernet, and may use a single twisted pair. Alternatively or in addition, any network or vehicle bus herein may consist of, may employ, may use, may be based on, or may be compatible with, IEEE802.3 100BaseT1, IEEE802.3 1000BaseT1, BroadR-Reach®, IEEE 802.3bw-2015, IEEE Std 802.3bv-2017, or IEEE Std 802.3 bp-2016 standards. Any vehicle network or bus herein may consist of, may comprise, or may be based on, an avionics data bus standard, such as Aircraft Data Network (ADN), Avionics Full-Duplex Switched Ethernet (AFDX), Aeronautical Radio INC. (ARINC) 664, ARINC 629, ARINC 708, ARINC 717, ARINC 825, MIL-STD-1553, MIL-STD-1760, or Time-Triggered Protocol (TTP).

The external network I 42, the external network II 42a, or both, may consists of, comprises, or may be based on, a wireless network using transmitting and receiving Radio-Frequency (RF) signals over the air. In such a case, the PHY2 51b of the respective edge unit 70 may comprise an antenna (such as the antenna 29) for coupling to the wireless network, and a wireless transceiver (such as the wireless transceiver 28) coupled to the antenna for wirelessly transmitting digital data to, and receiving digital data from, the wireless network.

The wireless network may comprise a Wireless Wide Area Network (WWAN), any wireless transceiver herein may comprise a WWAN transceiver, and any antenna herein may comprise a WWAN antenna. The WWAN may be a wireless broadband network. The WWAN may be a WiMAX network, the antenna may be a WiMAX antenna and the wireless transceiver may be a WiMAX modem, and the WiMAX network may be according to, compatible with, or based on, IEEE 802.16-2009. Alternatively or in addition, the WWAN may be a cellular telephone network, the antenna may be a cellular antenna, and the wireless transceiver may be a cellular modem, where the cellular telephone network may be a Third Generation (3G) network that may use a protocol selected from the group consisting of UMTS W-CDMA, UMTS HSPA, UMTS TDD, CDMA2000 1×RTT, CDMA2000 EV-DO, and GSM EDGE-Evolution, or the cellular telephone network may use a protocol selected from the group consisting of a Fourth Generation (4G) network that use HSPA+, Mobile WiMAX, LTE, LTE-Advanced, MBWA, or may be based on IEEE 802.20-2008.

Further, the wireless network may comprise a Wireless Personal Area Network (WPAN), the wireless transceiver may comprise a WPAN transceiver, and the antenna may comprise a WPAN antenna. The WPAN may be according to, compatible with, or based on, Bluetooth™, Bluetooth Low Energy (BLE), or IEEE 802.15.1-2005 standards, or the WPAN may be a wireless control network that may be according to, or may be based on, Zigbee™, IEEE 802.15.4-2003, or Z-Wave™ standards. The wireless network may comprise a Wireless Local Area Network (WLAN), the wireless transceiver may comprise a WLAN transceiver, and the antenna may comprise a WLAN antenna. The WLAN may be according to, may be compatible with, or may be based on, a standard selected from the group consisting of IEEE 802.11-2012, IEEE 802.11a, IEEE 802.11b, IEEE 802.11g, IEEE 802.11n, and IEEE 802.11ac. Any wireless network herein may be over a licensed or unlicensed radio frequency band that may be an Industrial, Scientific and Medical (ISM) radio band.

Further, the wireless network may be using, or may be based on, Dedicated Short-Range Communication (DSRC) that may be according to, may be compatible with, or may be based on, European Committee for Standardization (CEN) EN 12253:2004, EN 12795:2002, EN 12834:2002, EN 13372:2004, or EN ISO 14906:2004 standard. Alternatively or in addition, the DSRC may be according to, may be compatible with, or may be based on, IEEE 802.11p, IEEE 1609.1-2006, IEEE 1609.2, IEEE 1609.3, IEEE 1609.4, or IEEE1609.5.

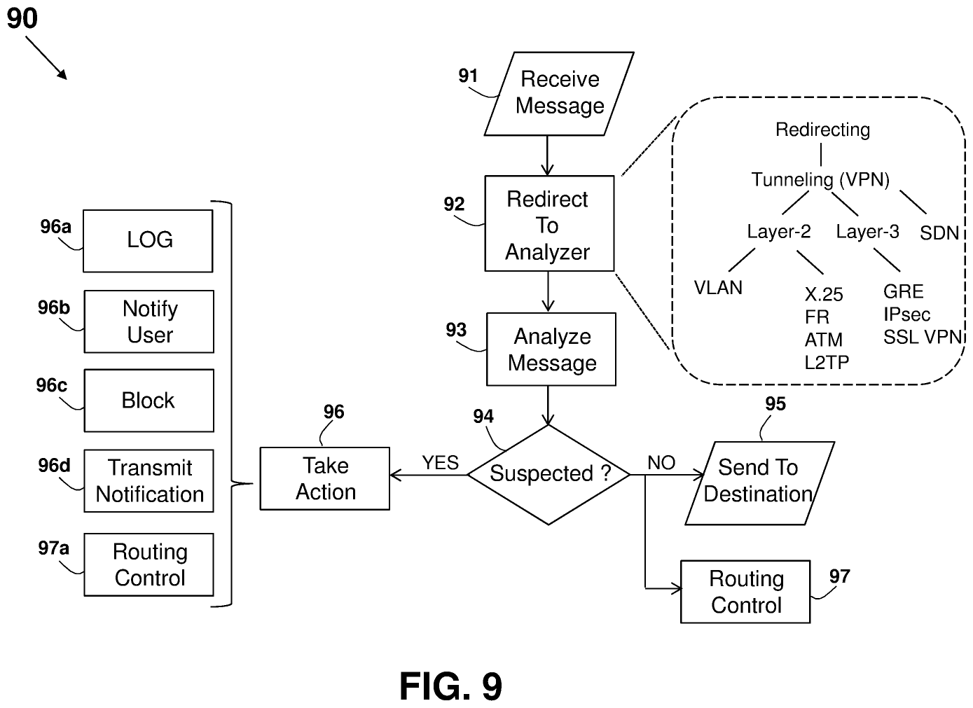

An example of a flow chart 90 for protecting by using a centralized analyzer is illustrated in FIG. 9. The method starts upon receiving a message (such a frame, a packet, or a data stream) at a “Receive Message” step 91. The message may be received from a network external to a location or to a network to be protected (such as the protected network 41 or the protected vehicle network 41a), such as the External Network I 42, which may be external to a building (such as the building 83 or the vehicle 105). In case of external network, such as the External Network I 42, the message is received by the edge unit 70. In case of receiving the message from inside the protected side 43b, the message may be received by any element that is part of, or connected to, the protected network 41. A suspected message received as part of the “Receive Message” step 91, is redirected to a central analyzer as part of a “Redirect To Analyzer” step 92, such as routing via the tunnel 82a from the edge unit 70 to the server 81 to be analyzed by the central analyzer 53.

Any tunnel herein, such as tunnel 82a, may consist of, may use, may be compatible with, or may be based on, a Layer-2, a Layer-3, a Layer-4, or any other layer tunnel. Alternatively or in addition, the tunnel may consist of, may use, may be compatible with, or may be based on, a Virtual Local Area Network (VLAN) or a Virtual Private Network (VPN). The VPN may consist of, may use, may be compatible with, or may be based on, Frame-Relay (FR), Asynchronous Transfer Mode (ATM), ITU-T X.25, or Layer 2 Tunneling Protocol (L2TP). Further, The VPN may consist of, may use, may be compatible with, or may be based on, Generic Routing Encapsulation (GRE) or Internet Protocol Security (IPsec). Further, the protected network 41 may support or use Multiprotocol Label Switching (MPLS), and any tunnel, such as tunnel 82a, may consist of, may use, may be compatible with, or may be based on, Label-Switched Path (LSP).

Upon receiving the redirected message, the analyzer 53 that is part of, or connected to, the server 81 analyzes the message as part of an “Analyze Message” step 93 using various rules and criteria. The analysis as part of “Analyze Message” step 93 may comprise any Layer-2 handling, any Layer-3 handling, or any combination thereof. As part of a “Suspected?” step 94, the analyzer 53 determines whether the redirected message is legitimate or is consists of, or related to, a malware. If according to the analysis it is determined in the “Suspected?” step 94 that the message represents a normal or authorized traffic, condition, or configuration, then the message is sent to its original destination as part of a “Send To Destination” step 95, over a tunnel or a regular path over the network, as exampled in path 82b in the arrangement 80c, thus performing the system normal routing operation of routing the message to its destination. In one example, the system may ‘approve’ the source, such as a specific external network or specific connected device, and may forward any additional message directly to the destination without any analysis or redirecting, as part of a “Routing Control” step 97.

The sending of a legitimate message to the destination as part of the “Send To Destination” step 95, may be over a tunnel that may be identical to, similar to, or different from, the tunnel used for carrying the message to the analyzer as part of the “Redirect To Analyzer” step 92. For example, such tunnel may consist of, may use, may be compatible with, or may be based on, a Layer-2, a Layer-3, a Layer-4, or any other layer tunnel. Alternatively or in addition, the tunnel may consist of, may use, may be compatible with, or may be based on, a Virtual Local Area Network (VLAN) or a Virtual Private Network (VPN). The VPN may consist of, may use, may be compatible with, or may be based on, Frame-Relay (FR), Asynchronous Transfer Mode (ATM), ITU-T X.25, or Layer 2 Tunneling Protocol (L2TP). Further, The VPN may consist of, may use, may be compatible with, or may be based on, Generic Routing Encapsulation (GRE) or Internet Protocol Security (IPsec).

In the case the criterion applied as part of the analysis in the “Analyze Message” step 93, suggests a malware presence (or any other anomaly or configuration change), suggesting possible or certain intrusion to the network as determined as part of the “Suspected?” step 94, various actions may be taken as part of a “Take Action” step 96. As part of the action taken as part of the “Take Action” step 96, a record regarding the incident may be stored in the memory, for logging the analyzer server 81 activity and results, as part of a “LOG” step 96a. Alternatively or in addition, a person or a device may be notified of the suspected attack or intrusion as part of a “Notify User” step 96b, that may include activating or controlling the annunciator 84 by the processor. In a case where a frame or packet that may be affected or generated as part of an attack, the analyzer server 81 may transmit in parallel to the receiving of the frame or packet, a signal to the medium of the protected network 41, such as a frame or packet, forming a collision on the medium, thus neutralizing the unauthorized effect or propagation of the frame or packet, causing the other devices in the network to ignore the suspected frame or packet. As part of a “Transmit Notification” step 96d, the detection of an attack may result in a transmission of a message, or blocking a transmission of a message, to the protected network 41. As part of a “Block” step 96c, any further data or message from the suspected device that transmitted the suspected message is blocked by the system, thus affectively isolating the device from the protected network 41 for avoiding or minimizing any further harm or impact.

The flow chart 90 describes making decisions based on analyzing received messages. Alternatively or in addition, the system security may be obtained by authentication of the endpoint devices or connected networks, such as the external network I 42, the client device #3 24c, or the server #4 23d, by the analyzer functionality 53 in the analyzer server 81. In one example, the analyzer server 81 initiates an authentication session with the suspected device. Such initiation may be after power-up, after a system reset, or upon human user request. In one example, such authentication session is initiated in response to receiving a message, such as in the “Redirect To Analyzer” step 92. The authentication scheme may use secret or private authentication material, such as keys, credentials, or certificates, which are stored in the analyzer sever 81 that serves as an intermediator device for forming a one-way or two-way secured link between two connected devices over the protected network 41.

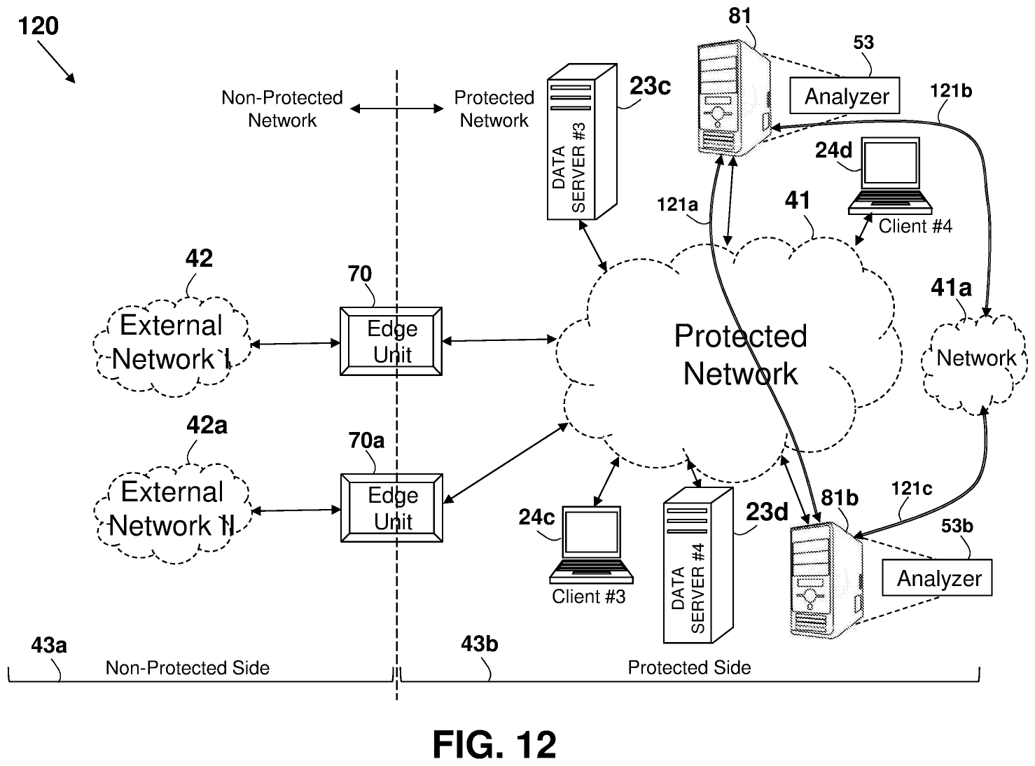

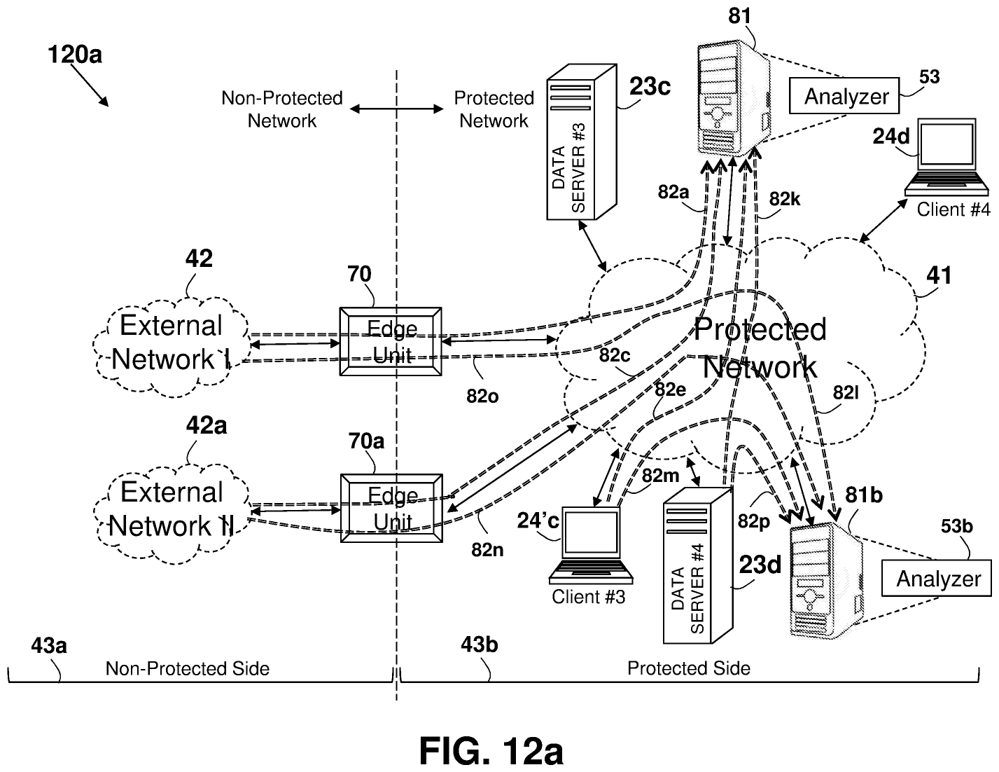

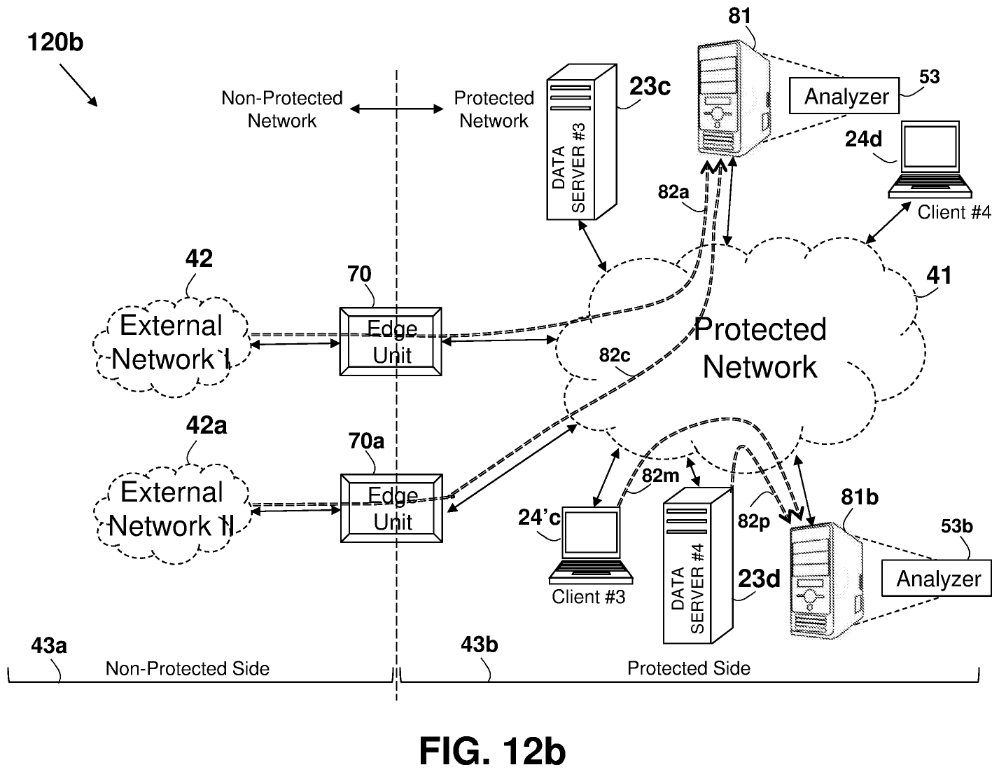

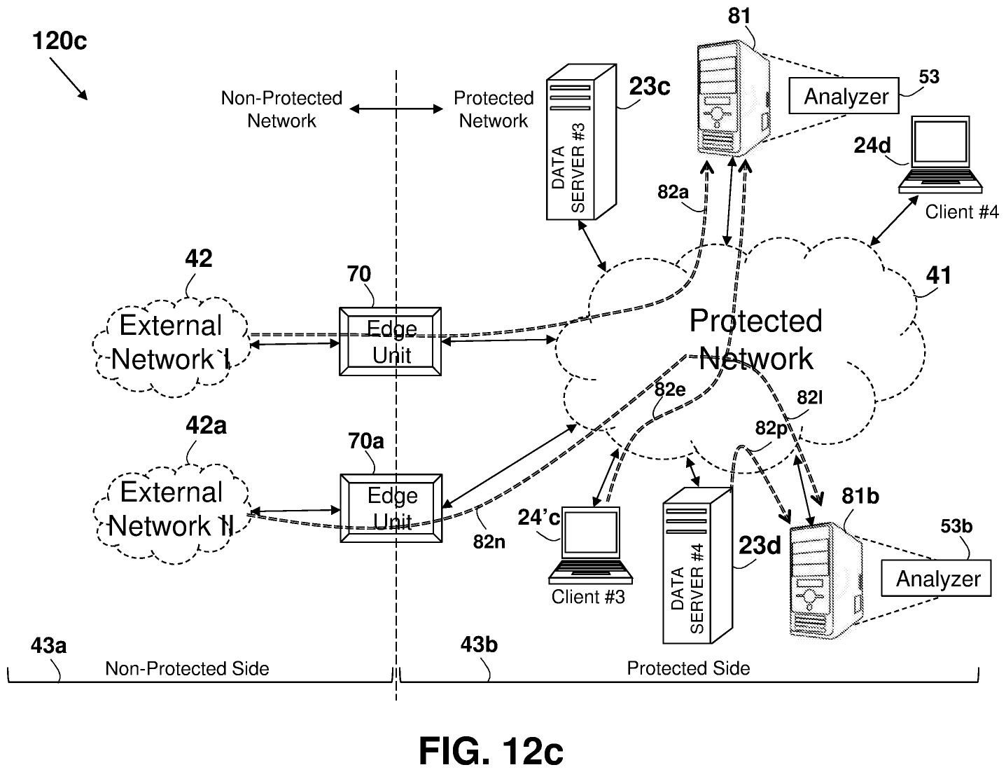

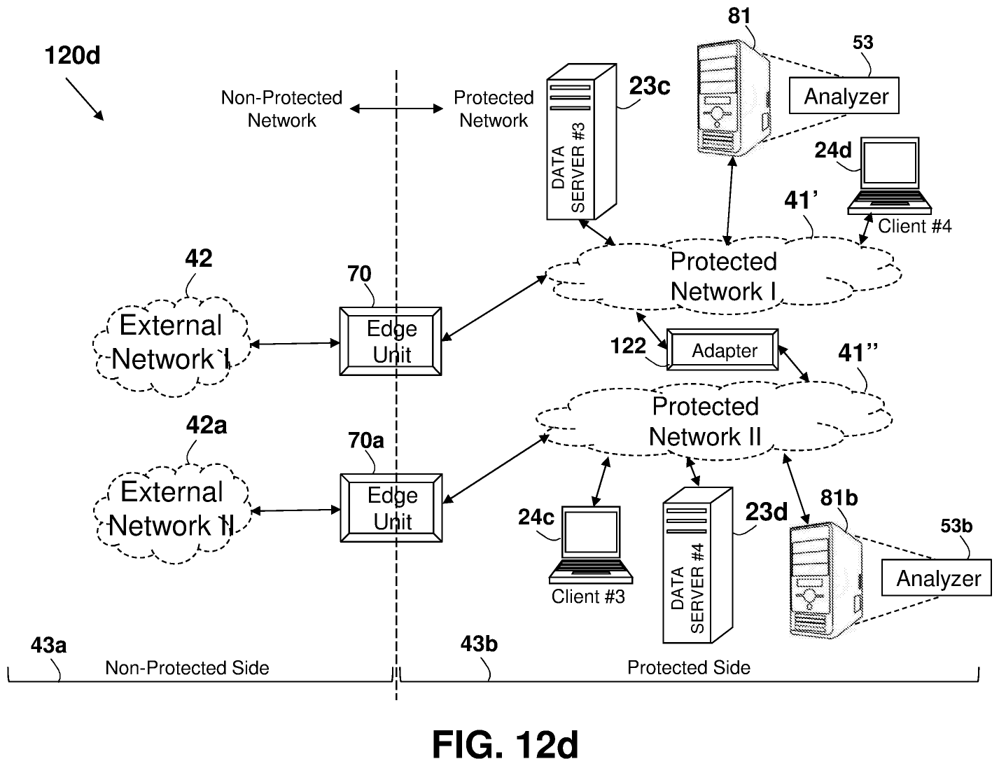

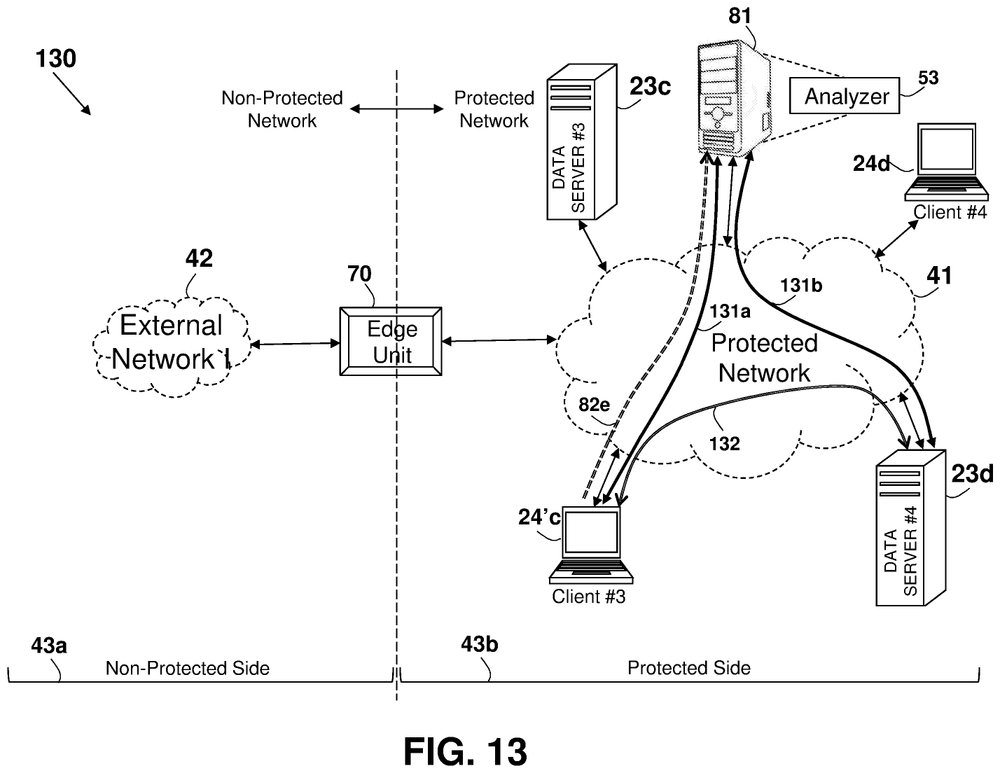

An example of an authentication based scheme is illustrated in an arrangement 130 shown in FIG. 13. In this example, the suspected client #3 24′c initiates communication session with the data server #4 23d by sending a message. The message is redirected, as part of the “Redirect To Analyzer” step 92, over the tunnel 82e to the analyzer server 81, to be analyzed therein, such as using part or all of the steps of the flow chart 90. The analyzer functionality 53 in the analyzer server 81 identifies the two entities that wish to communicate, namely the suspected client #3 24′c and the data server #4 23d. In response, the analyzer server 81 initiates an authentication session with the suspected client #3 24′c over the path 131a. The path 131a may be identical to, similar to, or different from, the tunnel 82e connecting the suspected client #3 24′c and the analyzer server 81. If the authentication scheme fails, the analyzer functionality 53 in the analyzer server 81 take action as part of the “Take Action” step 96. If the authentication scheme succeeds, the client #3 24′c is considered authenticated. Similarly, the analyzer server 81 initiates an authentication session with the destination device, namely the data server #4 23d over the path 131b. The path 131b may be identical to, similar to, or different from, the tunnel 82k connecting the data server #4 23d and the analyzer server 81, as shown in the arrangement 120a in FIG. 12a. If the authentication scheme fails, the analyzer functionality 53 in the analyzer server 81 take action as part of the “Take Action” step 96. If the authentication scheme succeeds, the data server #4 23d is considered authenticated. Upon recognizing that both the source and the destination parties of the communication are authenticated, a direct communication session over a path 132 therebetween is allowed and enabled.

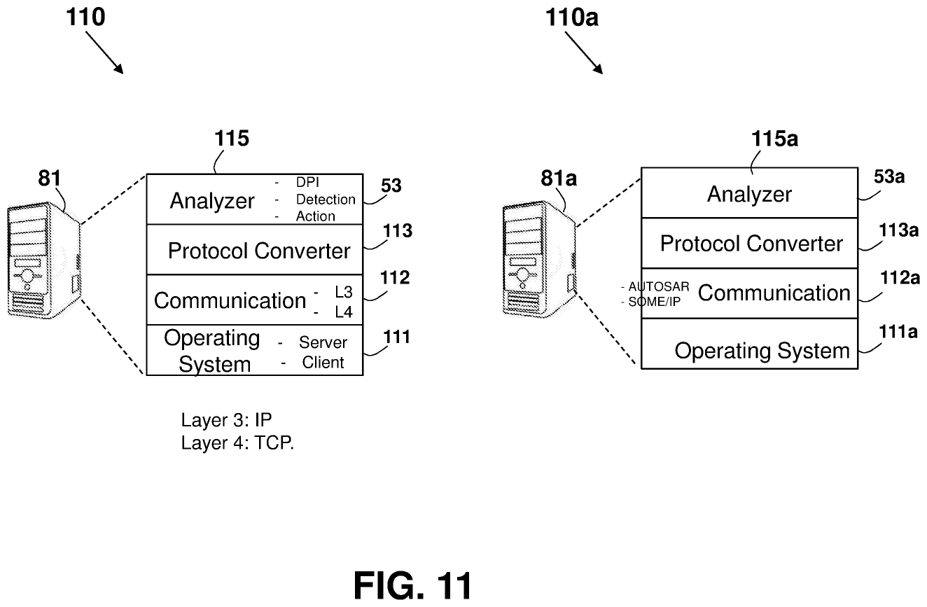

An example of a schematic arrangement of a software stack 115 of the analyzer sever 81 is shown in a view 110 in FIG. 11. An Operating System (OS) 111 is a lower layer that serves the higher layer applications. A communication layer 112 provides support for the communication protocols handled by the analyzer server 81, and provide service to a protocol converter layer 113. An analyzer application 53 provides the application layer functionality of the analyzer server 81, and is in charge of detecting of, and acting upon, a malware.

Similarly, an example of a schematic arrangement of a software stack 115a of the analyzer sever 81a is shown in a view 110a in FIG. 11. The software stack 115a may be identical to, or may comprise part of the software stack 115. In one example, the software stack 115a is oriented to the vehicular environment. An Operating System (OS) 111a is a lower layer that serves the higher layer applications, and may be identical to, or may include part of, the Operating System (OS) 111 that is part of the stack 115. In one example, the operating system 111a is designed or optimized for vehicular environment. Similarly, a communication layer 112a provides support for the communication protocols handled by the analyzer server 81a, and provide service to a protocol converter layer 113a. The communication layer 112a may be identical to, or may include part of, the communication layer 112 that is part of the stack 115, and the protocol converter layer 113a may be identical to, or may include part of, the communication layer 113 that is part of the stack 115. An analyzer application 53a provides the application layer functionality of the analyzer server 81a, and may be identical to, or may include part of, the analyzer functionality 53 that is part of the stack 115.

The analyzer server 81, as well as any other server herein, such as the server #3 23c or the server #4 23d, may be consist of, may be part of, or may comprise, a server device, that may store, operate, or use, a server operating system as part of the operating system 111, which may be based on, comprise, or use, Microsoft Windows Server®, Linux, or UNIX, such as Microsoft Windows Server® 2003 R2, 2008, 2008 R2, 2012, or 2012 R2 variant, Linux™ or GNU/Linux based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, and NetBSD®.

Alternatively or in addition, the analyzer server 81, as well as any other client herein, such as the client #3 24c and or the client #4 24d, may be consist of, may be part of, or may comprise, a client device, and may store, operate, or use, a client operating system as part of the operating system 111, which may consist of, may comprise, or may be based on, Microsoft Windows 7, Microsoft Windows XP, Microsoft Windows 8, Microsoft Windows 8.1, Linux, or Google Chrome OS. Further, the client operating system may be a mobile operating system, such as Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system.

Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

The communication layer 112, which may be part of the operating system 111, handles the communication of the analyzer server 81. For example, this layer may handle the establishment and the using of any tunnel, such as the tunnel (or other connection) 82a or the tunnel (or other connection) 82b shown in the arrangement 80a. In one example, the communication layer 112 handles the Layer-3 of the Protected Network 41, such as handling the Internet Protocol (IP) is used by the Protected Network 41. Alternatively or in addition, the communication layer 112 handles the Layer-4 of the Protected Network 41, such as handling TCP if used by the Protected Network 41. Further, the communication layer 112 may handle encryption or authentication schemes when used in the Protected Network 41.

In one example, the Protected Network 41 uses or employs SOME/IP, where the control plane messaging, such as service offering or service discovery, may be forwarded/routed only between the various devices communicating over the Protected Network 41, for example under the control of the analyzer server 81. The number and identity of SOME/IP peers may be controlled by the analyzer server 81 via manipulating and/or generating control plane messages. The analyzer server 81 may create MACsec associations to secure the medium, and may configure network bridges, switches, or routers, that form the core of the Protected Network 41 to allocate bandwidth and maintain certain quality of service where AVB/TSN protocols support is lacking in SOME/IP peers or in the bridges or switches (which might be SOME/IP capable). Data plane messaging, such as remote procedure calls, access to variables, event notifications and data streaming, may be forwarded only between devices the Protected Network 41 that are authorized by the analyzer server 81. Some or all these messages may be forced to be forwarded or routed through the analyzer server 81 for security benefits or for performance benefits, such as compression of data.

In one example, the Protected Network 41 uses or employs Transmission Control Protocol (TCP). In such a case, the analyzer server 81 may could mitigate Denial-of-Service (DoS) attacks by controlling the use of TCP flags such as PSH, SYN and ACK. In one example, such DoS attack may include SYN flooding, for which mitigations are discussed in IETF RFC 4987 dated August 2007 and entitled: “TCP SYN Flooding Attacks and Common Mitigations”, which is incorporated in its entirety for all purposes as if fully set forth herein. The mitigation the analyzer server 81 may be according to Chapter 3.8 of the IETF RFC 4987 (Firewalls and Proxies), such as preventing sending multiple SYN messages without ACK. Other examples of TCP related security offering by the analyzer server 81 may comprise limiting the use of TCP, such as only for devices (peers) authenticated by the analyzer server 81 and only to be used under IPsec or MACsec. In such a scenario, the analyzer server 81 may configure the Protected Network 41 to selectively reroute TCP traffic, such as data transfer acknowledgements may be routed directly between a client (such as the client #3 24c) and a server (such as the server #3 23c) without any handling or involvement of the analyzer server 81. If the TCP peers have security-oriented features, such as limiting the duration of FIN-WAIT-2 state or the number of ongoing connections, the analyzer server 81 may be used to configure and control them provided suitable interface. Further, the analyzer server 81 may prevent unauthorized or malicious use of TCP reset messages (RST flag), and may send TCP reset messages to prevent or to shut down unauthorized or suspected/hostile connections.

Any of the devices or network herein may involve using encryption and decryption, such as for authentication or authorization purposes. The communication layer 112 or the protocol converter layer 113 of the stack 115 may be involved in such encryption, decryption, or authentication.

In one example, the external network 42 may use an encryption scheme. In such a case, the edge unit 70 may encrypt data received from the protected network 41, such as data received from the analyzer server 81, before transmitting it to the external network I 42. Alternatively or in addition, the edge unit 70 may decrypt data received from the external network I 42, and transmit the data decrypted over the protected network 41, such as to the analyzer server 81 over the tunnel 82a. Further, the protected network 41 may use an encryption scheme. In such a case, the edge unit 70 may decrypt data received from the protected network 41, such as data received from the analyzer server 81, before transmitting it to the external network I 42. Alternatively or in addition, the edge unit 70 may encrypt data received from the external network I 42, and transmit the data encrypted over the protected network 41, such as to the analyzer server 81 over the tunnel 82a.

Further, the analyzer server 81 may be involved in encrypting or decrypting data. For example, encrypted data may be received from the edge unit 70, or from any of the devices connected to the protected network 41 (such as the client #4 24d or the server #3 23c), such as over the tunnel 82e from the client #3 24′c, and be decrypted by the analyzer server 81. Alternatively or in addition, the analyzer server 81 may receive non-encrypted data, such as from the edge unit 70 over the tunnel 82a or from any of the devices connected to the protected network 41 (such as the client #4 24d or the server #3 23c), such as over the tunnel 82e from the client #3 24′c, and encrypt it for further handling or forwarding.

In one example, an authentication mechanism may be used, which may be according to, based on, or compatible with, IEEE 802.1X or IEEE 802.1AE. In one example, a node transmitting data over the external network I 42 may serve as the Supplicant, the edge unit 70 may serve as the authenticator, and the analyzer server 81 may serve as the authentication server. In such a scheme, the communication between the transmitting node over the external network 42 I uses EAPOL mechanism for encapsulation of EAP, and the communication between edge unit 70 and the analyzer server 81, such as over the tunnel 82a, is based on using RADIUS or Diameter schemes over an EAP protocol. Alternatively or in addition, the node transmitting data over the external network I 42 may serve as the Supplicant, and the analyzer server 81 may serve as the authenticator, as the authentication server, or both. In such a scheme, the communication between the transmitting node over the external network I 42 and the analyzer server 81, such as over the tunnel path 82a, uses EAPOL mechanism for encapsulation of EAP. Alternatively or in addition, the node transmitting the message over the external network I 42 may serve as the Supplicant, and the destination for the message, such as the server #4 23d in the example of arrangement 80a, serves as the authenticator. In such a scheme, the communication between the transmitting node over the external network I 42 and the destination server #4 23d, such as over the tunnel path 82a, the tunnel path 82b, or both, may use EAPOL mechanism for encapsulation of EAP.

Further, the edge unit 70 may serve as the Supplicant, and the analyzer sever 81 may serve as the authenticator. Furthermore, the analyzer server 81 may also serve as the authentication server. In such a scheme, the communication between the edge unit 70 and the analyzer server 81, such as over the tunnel 82a, may use EAPOL mechanism for encapsulation of EAP. Alternatively or in addition, the edge unit 70 may serve as the Supplicant, and the destination for the message, such as the server #4 23d in the example of arrangement 80a, may serve as the authenticator. In such a scheme, the communication between the edge unit 70 and the destination server #4 23d, such as over the tunnel path 82a, the tunnel path 82b, or both, may use EAPOL mechanism for encapsulation of EAP, and the analyzer sever 81 may serve as the authentication server. Alternatively or in addition, an authentication mechanism may be used for messages transfer between devices connected over the protected network 41, such as for a path shown in the arrangement 80d, describing message transfer from the client #3 24′c and the client #4 24d.

In one example, the client #3 24′c may serve as the Supplicant, and the analyzer server 81 may serve as the authenticator. Further, the analyzer server 81 may serve as the authentication server. In such a scheme, the communication between the client #3 24′c and the analyzer server 81, such as over the tunnel path 82e, may use EAPOL mechanism for encapsulation of EAP. Similarly, the client #3 24′c may serve as the Supplicant, and the destination device, the client #4 24d may serve as the authenticator. In such a case, the analyzer server 81 may serve as the authentication server. In such a scheme, the communication between the client #3 24′c and the analyzer server 81, such as over the tunnel path 82e, may use EAPOL mechanism for encapsulation of EAP, and similarly the communication between the analyzer server 81 and the client #4 24d, such as over the tunnel path 82f, may use EAPOL mechanism for encapsulation of EAP.

In general, the analyzer server 81 may serve as an authentication server, or as a secure relay or proxy or gateway to authentication server (or servers). Alternatively or in addition, the analyzer server 81 may serve as a key server. The analyzer server 81 may further define entities in the network as secured (such as according to IEEE 802.1AR), which may be used in conjunction with the 802.1X protocol. For example, the scheme may derive local identities from manufacturer-provided identities. Further, the analyzer server 81 may be used to mitigate the risks of spoofed peers, controlling the possible use and abuse of shared key (such as by restricting communication in specific directions), support end to end associations where switches or bridges do not participate and perform deep packet inspections, manage bounded delay functionality (such as by generating and monitoring keep alive messages), enhance out-of-standard cryptographic algorithms, provide some degree of non-repudiation, provide some degree of connection-oriented functionalities such as error recovery and acknowledgments, or add non-MACsec-capable peers to security associations of capable ones.

In case where key-based encryption is used, the analyzer application 53 may provide key management services and procedures, such as key generation, distribution, renewal, change/roll/derivation, storage, revocation, exchange, agreement, or synchronization, centrally managed, orchestrated, authorized, monitored or triggered in the analyzer server 81. Further, the analyzer application 53 may be used for partially or totally enhancing or replacing existing key management infrastructure (such as cryptographic modules, services, servers and managers such as software libraries, hardware engines, hardware extensions, key servers, key masters, or authentication servers). Furthermore, any device may serve to offload or supplement the analyzer server 81 in performing computations, security checks, extend to its own capabilities (such as to securely store keys), or otherwise contribute to and enhance the various key management services and procedure. In addition to a basic functionality of acting as a trusted proxy or monitor (that is not necessarily a proper component of the defined PM), the analyzer application 53 may play various roles in operating or enhancing a Public Key Infrastructure (PKI) functionality relating to any lifecycle, management and communication aspects of relevant PKI components, including keys, identities, certificates, certificate databases, certificate stores, policies, revocation lists, various authorities (such as certificate authorities or registration authorities), which could be organized in any trust structure or hierarchy scheme. Further, automotive PKI solutions may be used not only for in-vehicle communication but also for V2X/C2X communications, in which case some of the PKI infrastructure support may reside inside the vehicle, as is exemplified in the U.S. Department of Transportation Security Credential Management System (USDOT SCMS).

Since the analyzer server 81 is positioned at a superior position in the network, it may serve a trusted intermediate or middleman device (similar to a man-in-the-middle) between networks (such as between the protected network 41 and the external network I 42) or between devices (such as between any two clients (such as between the Client #3 24c and the Client #4 24d), between two servers (such as between the server #3 23c and the server #4 23d), between a client device and a server device (such as between the Client #3 24c and the server #4 23d), or between any two entities in the protected network 41, it may provide further functionalities, such as serving as a proxy, performing any translations, serving as a switch/router/gateway, or otherwise performing protocol conversion, such as by the protocol converter layer 113. The conversion may be between any two Layer-2, Layer-3, or Layer-4 protocols. For example, the protocol converter 113 may convert between protocols in any layer that do not conform to the same standard, specification, or implementation, or between different versions, variants, flavors, subsets, or options, of the same protocol standard. In one example, the protocol converter 113 may convert between diagnostic DoIP to XCP, between different versions of the IEEE 802.1X protocol standards, such as TLS1.1-to-TLS1.2, or between synchronization PTP-to-gPTP). In another example, the protocol converter layer 113 may convert between a device (or a network) that is capable of a feature, and another device (or network) that is not capable of that feature, such as authentication and/or encryption according to IEEE 802.1AE/MACsec or IEEE 802.1X standards. Such capability allows for overcoming a compromised device along the path from the analyzer server 81 and another device (or network) that is capable of such feature.

The analyzer server 81, by the analyzer 53 functionality, basically offers centralized security governance, meaning that unless pre-configured or pre-exempted, any governed security routines would need to be authorized by it. In one example, the analyzer 53 layer functionality may comprise any firewall functionality, such as the firewall 50 functionality. However, in one example, trust could be delegated to network devices/peers/services (e.g., Ethernet bridges or other interconnecting devices), possibly subject to some initial authentication and authorization. Further, analyzer 53 functionality may offer specialization and simplification in the design, implementation and configuration of the network, services and devices, and performance enhancement for their operation. The core functionality of the analyzer layer 53 is to detect, and act upon, a malware or a malware related activity, and corresponds to the “Analyze Message” step 93, the “Suspected?” step 94, the “Take Action” step 96, the “Send to Destination” step 95, and the “Routing Control” step 97, of the flow chart 90 shown in FIG. 9. The malware may consist of, may include, or may be based on, a computer virus, spyware, DoS (Denial of Service), rootkit, ransomware, adware, backdoor, Trojan horse, or a destructive malware.

Since the analyzer server 81 is positioned at a superior position in the network, it may serve a trusted middleman (or as man-in-the-middle) between networks (such as between the protected network 41 and the external network I 42) or between devices (such as between any two clients (such as between the Client #3 24c and the Client #4 24d), between two servers (such as between the server #3 23c and the server #4 23d), between a client device and a server device (such as between the Client #3 24c and the server #4 23d), or between any two entities in the protected network 41, it may provide further functionalities, such as additional security assurances. In one example, the analyzer layer 53 may provide different levels of security assurance depending on the level of trust in the device and/or the bridged protocols. In the example or incapable peers, some assumptions might be required and some risks taken, e.g., authenticate a device by non-cryptographic identifiers/means, but still this would provide better security compared to where incompatibility persists. Various security and performance enhancements such as crypto libraries, security modules, hardware extensions, or accelerators, may be added/included/securely-attached to the analyzer functionality 53, possibly offloading them from other network devices, thus improving costs, performance and security reliability.

The analyzer functionality 53 may derive the decisions (such as when performing the “Suspected?” step 94 of the flow chart 90) or actions (such as when performing the “Take Action” step 96 of the flow chart 90) not only by monitoring messages and other forms of data routed through it (such as via any tunnel), but also from a variety of other decision factors such as policies, databases, rules, statistics, counters, states, alerts, message tags, or any metadata. These decision factors can be managed or hosted on the analyzer server 81 itself, or on any other devices connected thereto, such as any of the devices connected to the protected network 41, allowing for expanding the analyzer functionality 53 modularity and flexibility. Further, the design and capabilities of any of the devices herein may serve to enhance to the capabilities of the analyzer server 81, and may thus support the decisions made by the analyzer functionality 53, so the offering of flexibility extends to also include the design, implementation and configuration of the entire network or arrangement that includes the analyzer server 81.

Although such extensibility of the analyzer functionality 53 to the rest of the network is not a pure web of trust, it could be implemented to support some independence of the trusted devices cooperating with, or controlled by, the analyzer server 81, allowing for the security functionalities not to be purely centralized. Hence, such concept may provide the benefit of reserving the security or other related functionalities even if functionalities served by the analyzer functionality 53 are not available due to unavailability of the communication with the analyzer server 81, such as when the protected network 41 fails to route data from, or to, the analyzer server 81, for example due to communication failures or errors. Where or when the analyzer functionality 53 is not available or where or when analyzer server 81 is non operative, is off-line, or is compromised, trusted devices, such as peers (e.g. bridges, gateways) may change their operating mode to continue to operate more independently (but possibly less securely), such as to shut down sensitive aspects of their monitored host while being disconnected from the analyzer functionality 53 or from the analyzer server 81. Allowing such arrangement is associated with a risk, such operation, functionality or behavior may be pre-determined or pre-configured. Further, in order to enhance such extensibility offering, where existing capabilities of networked devices are perceived as lacking or having place for improvement, modifications/additions can be made to the device or application, via a hardware, software, or both. Such modifications or additions may be external to the device, such as in the form of a hardware extension module or a dongle, and may be as an after-market offering, such as an addition to the analyzer functionality 53 software or to the analyzer server 81.

In a vehicular environment, further utilization and maintenance of the decision factors that may be included in the analyzer functionality 53 may be performed during the operational phase of the vehicle or the vehicle networks via various manual or automated means. Manual means may involve various user interfaces. Automated means may involve periodic sampling of other network devices, push notifications, a derivate from the monitored network traffic, and other data inputs. Sophisticated learning mechanisms may as well be employed to this end. Thus, the analyzer functionality 53 operation may be dynamic and adaptive, and may serve not only a specific vehicle, network, services, applications and driving scenarios, but may further be used to support evolving security threats by using updated threat databases, detection algorithms or parameters, or detection policies.

When processing any network communication by the analyzer functionality 53, such as in the “Analyze Message” step 93 or the “Suspected?” step 94, various non-manipulating actions may be performed, related to logs, alerts, notifications, feeding of logical or mathematical calculations, extraction of actionable or otherwise relevant information, or updates of various rules and states.

Various manipulating actions may be performed on the received messages by the Protocol converter layer 113 or the Analyzer functionality 53, independently or in cooperation with other devices (such as the clients, servers, or edge units. Such manipulating actions may include modification, addition, or removal of headers, trailers, or payloads, as well as reformatting, tagging, dropping, shaping, delaying, replicating, tags handling. Further, the manipulating action may include detection and mitigation of attacks (in their various phases), securing of communications and protocols (such confidentiality, integrity, or authenticity), security filtering, Quality-of-Service (QoS), firewall functionality, sanitization, or security tunneling. Furthermore, the manipulation may include rejecting or blocking insecure protocols or algorithms (or their versions/variants), such as by not allowing DES cipher to be negotiated as part of TLS/SSH transaction. Sanitization and filtering of protocols may be possible, such as allowing SOME/IP video streams but not remote procedure calls, or allowing DoIP to ‘get entity status’ functionality but not ‘get entities’ functionality.

In one example, the protected network 41 serves as a backbone or is positioned and act as a bridge between other networks (such as between the external network I 42 and the external network II 42a). Further, the protected network 41 may use a protocol that encapsulates or tunnels other protocols or data structures. In such a case, the analyzer functionality 53 may further apply a Deep Packet Inspection (DPI) to monitors and act upon the encapsulated protocols or data. For example, the protected network 41 may serve as an Ethernet backbone carrying encapsulated CAN bus messages, such as according to IEEE 1722 or IEEE 1722a, and the encapsulating traffic may be routed the protected network 41 through the analyzer server 81, where the analyzer functionality 53 may analyze and sanitize the encapsulating traffic providing CAN bus protection, such as by using any CAN bus IDS/IPS.

The analyzer functionality 53 may further be used as authenticator, verifier, or sanitizer, for mitigating or patching various vulnerabilities of devices and protocols, and may further use security updates. By routing various traffic in the protected network 41, the analyzer server 81 may act as proxy, man-in-the-middle, trusted advisor, or any other relevant role in the update routine among participating peers, such as target devices or applications, gateways, wireless capable device, update servers, or authentication servers. Further, the analyzer functionality 53 may use translation and manipulation capabilities, on data or control planes (or both), to patch or update any vulnerable components. On the data plane, the analyzer functionality 53 may add longer verification fields, change the encryption algorithm, sanitize the data payload, such as to mitigate known exploit payloads. On the control plane, the analyzer functionality 53 may prevent or supplement on-the-fly vulnerable control flows such as key agreement algorithms and key management routines.

In order to notify a human user of a status or otherwise alert for any detected or identified attack, as part of the “Notify User” step 96b the analyzer server 81 may include the annunciator 84 (shown as part of the arrangement 80), which may be activated by a processor that is part of the analyzer server 81. The annunciator 84 may consist of one or more visual or audible signaling component, or any other devices that indicate a status to the person. The annunciator may include a visual signaling device. In one example, the device illuminates a visible light, such as a Light-Emitting-Diode (LED), or uses a Liquid Crystal Display (LCD) that uses changes in the reflectivity in an applied electric field. The LED may be a multi-color LED, such as LED Part No. 08L5015RGBC available from RSR Electronics, Inc. from NJ, U.S.A., described in data-sheet Multi Color LED Part No. 08L5015RGBC, which is incorporated in its entirety for all purposes as if fully set forth herein.

However, any type of visible electric light emitter such as a flashlight, an incandescent lamp, and compact fluorescent lamps can be used. Multiple light emitters may be used, and the illumination may be steady, blinking or flashing. Further, a single-state visual indicator may be used to provide multiple indications, such as by using different colors (of the same visual indicator), different intensity levels, variable duty-cycle and so forth. Further, the visual signaling may be associated with the analyzer server 81 function. Such conceptual relationships may include, for example, the light emitters' brightness, appearance, location, type, color and steadiness that are influenced by the estimated value.

In one example, the annunciator operation is based on a numerical digital display that provides readings in the form of numbers of the estimated value of any value derived thereof. For example, the annunciator may use the quadruple digits, seven-segments, LED display Part No.: LTC-3610G available from Lite-On Electronics, Inc., and described in Lite-On Electronics, Inc., Publication BNS-OD-C131/A4 downloaded March 2011, which is incorporated in its entirety for all purposes as if fully set forth herein. Similarly, the annunciator may be based on an alphanumerical digital display that provides readings in the form of characters, including numbers, letters or symbols. For example, the annunciator may use the quadruple digits, seven-segments, LED display Part No.: LTM-8647AC available from Lite-On Electronics, Inc., and described in Lite-On Electronics, Inc., Publication BNS-OD-C131/A4 downloaded March 2011, which is incorporated in its entirety for all purposes as if fully set forth herein.

The scheme can be similarly used to display word messages in a variety of fashions and formats, such as scrolling, static, bold, and flashing. The device may further display visual display material beyond words and characters, such as arrows, symbols, ASCII and non-ASCII characters, still images such as pictures and video. The annunciator may use any electronic display or any other output device used for the presentation of visual information. The display may be a digital or analog video display, and may use technologies such as LCD (Liquid Crystal Display), TFT (Thin-Film Transistor), FED (Field Emission Display), CRT (Cathode Ray Tube) or any other electronic screen technology that visually shows information such as graphics or text. In many cases, an adaptor (not shown) is required in order to connect an analog display to the digital data. For example, the adaptor may convert to composite video (PAL, NTSC) or S-Video or HDTV signal. Analog displays commonly use interfaces such as composite video such as NTSC, PAL or SECAM formats. Similarly, analog RGB, VGA (Video Graphics Array), SVGA (Super Video Graphics Array), SCART, S-video and other standard analog interfaces can be used. Further, personal computer monitors, plasma or flat panel displays, CRT, DLP display or a video projector may be equally used. Standard digital interfaces such as an IEEE1394 interface, also known as FireWire™, may be used. Other digital interfaces that can be used are USB, SDI (Serial Digital Interface), FireWire, HDMI (High-Definition Multimedia Interface), DVI (Digital Visual Interface), UDI (Unified Display Interface), DisplayPort, Digital Component Video and DVB (Digital Video Broadcast).

In one example, the annunciator 84 may affect sound or voice generation. The estimated value may be associated with a musical tune (or a tone) or any other single sound, which is played upon activation of the annunciator. The annunciator 84 may include an audible signaling device (sounder) that emits audible sounds that can be heard by a human (having frequency components in the 20-20,000 Hz band). In one example, the device is a buzzer (or beeper), a chime, a whistle or a ringer. Buzzers are known in the art, and are either electromechanical or ceramic-based piezoelectric sounders that make a high-pitch noise. The sounder may emit a single or multiple tones, and can be in continuous or intermittent operation. In another example, the sounder simulates the voice of a human, typically by using an electronic circuit having a memory for storing the sounds (e.g., click, gong, music, song, voice message, etc.), a digital to analog converter to reconstruct the electrical representation of the sound and driver for driving a loudspeaker, which is an electro-acoustical transducer that converts an electrical signal to sound. An example of a greeting card providing music and mechanical movement is disclosed in U.S. Patent Application 2007/0256337 to Segan entitled: “User Interactive Greeting Card”, which is incorporated in its entirety for all purposes as if fully set forth herein. A ‘Gong’ sound may be generated using SAE 800 from Siemens, described in Data-sheet “Programmable Single-/Dual-/Triple-Tone Gong, SAE 800, Siemens semiconductor Group, 02.05”, which is incorporated in its entirety for all purposes as if fully set forth herein.

In one example, a human voice talking is played by the annunciator 84. The sound may be a syllable, a word, a phrase, a sentence, a short story or a long story, and can be based on speech synthesis or pre-recorded. Male or female voice can be used, being young or old. The text sounded is preferably associated with the shape or theme. For example, an estimated value or quality associated value derived thereof of the system can be heard, such as ‘Alert’, ‘Attach detected’ and ‘Alarm’. A tone, voice, melody or song sounder typically contains a memory storing a digital representation of the pre-recorder or synthesized voice or music, a digital to analog (D/A) converter for creating an analog signal, a speaker and a driver for feeding the speaker. An annunciator, which includes a sounder, may be based on Holtek HT3834 CMOS VLSI Integrated Circuit (IC) named ‘36 Melody Music Generator’ available from Holtek Semiconductor Inc., headquartered in Hsinchu, Taiwan, and described with application circuits in a data sheet Rev. 1.00 dated Nov. 2, 2006, which is incorporated in their entirety for all purposes as if fully set forth herein.

Similarly, the sounder may be based on EPSON 7910 series ‘Multi-Melody IC’ available from Seiko-Epson Corporation, Electronic Devices Marketing Division located in Tokyo, Japan, and described with application circuits in a data sheet PF226-04 dated 1998, which is incorporated in its entirety for all purposes as if fully set forth herein. A human voice synthesizer may be based on Magnevation SpeakJet chip available from Magnevation LLC and described in ‘Natural Speech & Complex Sound Synthesizer’ described in User's Manual Revision 1.0 Jul. 27, 2004, which is incorporated in its entirety for all purposes as if fully set forth herein. A general audio controller may be based on OPTi 82C931 ‘Plug and Play Integrated Audio Controller’ described in Data Book 912-3000-035 Revision: 2.1 published on Aug. 1, 1997, which is incorporated in its entirety for all purposes as if fully set forth herein. Similarly, a music synthesizer may be based on YMF721 OPL4-ML2 FM+Wavetable Synthesizer LSI available from Yamaha Corporation described in YMF721 Catalog No. LSI-4MF721A20, which is incorporated in its entirety for all purposes as if fully set forth herein.

Alternatively or in addition, tactile (or haptic) stimuli may be used, where the annunciator 84 may is configured to generate a tactile sensation, preferably the device comprises a motor, e.g., a vibration motor such as a pancake vibration motor or linear actuator or off-center motor. The motor may, for example, be configured to generate a single type of vibration or pulsation or to generate a plurality of types of vibrations and/or pulsations that vary based on pattern and/or intensity or other parameter or features. Other types of tactile stimulation that the signaling assembly may be configured to generate include, but are not limited to, pressure by causing a blunt or other element to extend through the housing when activated.

As part of the “Transmit Notification” step 96d, in response to suspected intrusion or attack, a message is sent, either to another device over the protected network 41, or over another network. The message sent may include identification of the sending analyzer server 81, such as its IP address, the time of sending the message, and the status. A notifying message may be sent periodically, such as every 1, 2, 5, or 10 seconds, every 1, 2, 5, or 10 minutes, every 1, 2, 5, or 10 hours, or every 1, 2, 5, or 10 days. Alternatively or in addition, the user may be notified by using an event-driven messaging. For example, a message may be transmitted upon detecting a suspected signal as part of the “Suspected?” step 94. The message may further include the content of the suspected frame or packet, and the address or identification of the transmitting device according to the content received. Further, the criterion and reasoning used for declaring the signal as ‘suspected’ may also be included in the transmitted message.

The message may be sent using XMPP, SIMPLE, Apple Push Notification Service (APNs), or IMPS. The message may be a text-based message, such as by using SMS, or Twitter services, as well as social marketing service such as Facebook. Alternatively or addition, the message may include an audio or video message, and sent using MMS or Enhanced Messaging Service (EMS). Other services such as e-mail, Viber, or Whatsapp may be used.

Further, the analyzer server 81 may send the message, which may be a notification or an alert, to a user. The notification to the user device may be text based, such as an electronic mail (e-mail), website content, fax, or a Short Message Service (SMS). Alternatively or in addition, the notification or alert to the user device may be voice-based, such as a voicemail, a voice message to a telephone device. Alternatively or in addition, the notification or the alert to the user device may activate a vibrator, causing vibrations that are felt by human body touching, or may be based on a Multimedia Message Service (MMS) or Instant Messaging (IM). The messaging, alerting, and notifications may be based on, include part of, or may be according to U.S. Patent Application No. 2009/0024759 to McKibben et al. entitled: “System and Method for Providing Alerting Services”, U.S. Pat. No. 7,653,573 to Hayes, Jr. et al. entitled: “Customer Messaging Service”, U.S. Pat. No. 6,694,316 to Langseth. et al. entitled: “System and Method for a Subject-Based Channel Distribution of Automatic, Real-Time Delivery of Personalized Informational and Transactional Data”, U.S. Pat. No. 7,334,001 to Eichstaedt et al. entitled: “Method and System for Data Collection for Alert Delivery”, U.S. Pat. No. 7,136,482 to Wille entitled: “Progressive Alert Indications in a Communication Device”, U.S. Patent Application No. 2007/0214095 to Adams et al. entitled: “Monitoring and Notification System and Method”, U.S. Patent Application No. 2008/0258913 to Busey entitled: “Electronic Personal Alert System”, or U.S. Pat. No. 7,557,689 to Seddigh et al. entitled: “Customer Messaging Service”, which are all incorporated in their entirety for all purposes as if fully set forth herein.

While explained above regarding using a single analyzer server 81, multiple analyzer servers may be equally employed, or various purposes such as redundancy, backup, offloading, and load balancing. Each of the analyzer servers may secure a single network or multiple networks. Further, in case of multiple networks, the multiplicity of analyzer servers may secure the inter-connectivity between the networks by acting as a gateway, or by enhancing existing gateway (or gateways) functionality. In case of a vehicular environment, such as shown in the arrangement 100 shown in FIG. 10, where multiple networks are employed, multiple analyzer servers, each such as the analyzer server 81a, may be used, each specialized in a specific network or a vehicle domain. To operate in synergy, the multiple analyzer servers may inter-communicate using in-band or out-of-band communication, or even by manipulating the original communication flows, such as by using additional overhead, such as tags. The communication between the multiple analyzer servers may be used to propagate alerts on detected threats or anomalies, share/synchronize databases (such as malware signatures or cryptographic keys), establish secure communication channel between protected networks, or offload computations. In one example, one or more of the multiple analyzer servers may be external to the building 83 (or to the vehicle 105), such as being located in other buildings or vehicle, or otherwise as off-vehicle backend, cloud, or infrastructure. When multiple analyzer gateways are used, hierarchy may possibly be determined among them, assigning priorities and possible intermediate levels.

An exemplary arrangement 120 of using two analyzer servers is shown in FIG. 12, which is based on the arrangement 80b shown in FIG. 8b. An additional analyzer server 81b is added, associated with an additional analyzer 53b functionality, also connected to the protected network 41. The added analyzer server 81b may be identical, similar, or different from the analyzer server 81, and similarly, the analyzer 53b functionality may be identical, similar, or different, from the analyzer 53 functionality. For example, the analyzer server 81b may include part of, or all of, the features or characteristics of the analyzer server 81. Preferably, the two analyzer servers 81 and 81b are interconnected for various cooperation activities, such as updating, load-balancing, or supporting. The communication between the two analyzer servers 81 and 81b may be over a communication link 121a that is part of the protected network 41 (in-band communication). Alternatively or in addition, the two analyzer servers 81 and 81b may communicate over a communication link that is not part of the protected network 41 (out-of-band communication), such as direct connection, or using an external network 41a, where the analyzer server 81 is connected thereto via a communication link 121b, and the analyzer server 81b is connected thereto via a communication link 121c. Using external connection enhance the overall performance since the inter-analyzer communication is not affecting the traffic carried over the protected network 41, and the connection is not vulnerable to any failures in that network. In one example, both connections are used for redundancy purpose.

The operation of the two analyzer servers 81 and 81b is illustrated in an arrangement 120a shown in FIG. 12a. Messages from the external network I 42 via the edge unit 70 are routed to the analyzer server 81 via the path or tunnel 82a, as well as to the analyzer server 81b via a path or tunnel 821. Similarly, messages from the external network II 42a via the edge unit 70a are routed to the analyzer server 81 via the path or tunnel 82c, as well as to the analyzer server 81b via a path or tunnel 82n. Messages originated internal to the protected side 43b, such as from the client #3 24′c are routed to the analyzer server 81 via the path or tunnel 82e, as well as to the analyzer server 81b via a path or tunnel 82m, and similarly messages from the server #4 23d are routed to the analyzer server 81 via the path or tunnel 82k, as well as to the analyzer server 81b via a path or tunnel 82p.

In one example, only a single analyzer server is used at a time for protecting the protected zone 43b, while the other analyzer server is used for a standby redundancy (a.k.a. Backup Redundancy). One of the analyzer servers, such as the analyzer server 81, may be defined as the primary analyzer server and is used as part of the regular and normal system operation, where the other analyzer server, such as the analyzer server 81b, serves as a back-up unit to the primary unit, and is used only when the primary unit cannot properly fulfil its function. When a ‘Cold Standby’ redundancy scheme is employed, the secondary analyzer server 81b is not operative, and the related paths or tunnels, such as the path or tunnel 82o, the path or tunnel 82n, the path or tunnel 82m, and the path or tunnel 82p, are not operative, and no data is thus routed to the secondary analyzer server 81b. Such mechanism may require a watchdog, which monitors the system to decide when a switchover condition is met, and command the system to switch control to the standby unit. Upon detecting or sensing a failure in the primary analyzer server 81 operation, the system switches to operate the spare analyzer server 81b, and to activate its related tunnels or paths, such as the path or tunnel 82o, the path or tunnel 82n, the path or tunnel 82m, and the path or tunnel 82p. Since the standby analyzer server 81b is not kept in-sync with the last system state of the primary unit 81, such approach does lend itself to give a “bump” on transfer, such as requiring a time period for synchronization until the system resumes its regular operation using the secondary analyzer server 81b, rendering a system operation downtime.

In hot standby, the secondary unit is powered up or otherwise kept operational, and can optionally continuously monitor the system. When a ‘Hot Standby’ redundancy scheme is employed, the secondary analyzer server 81b is continuously and fully operative, and may perform some or all of the steps of the flow chart 90 shown in FIG. 9. As such, the downtime is shortened, which in turn increases the availability of the system. In one example, the secondary server 81b is continuously updated and is synchronized with the primary analyzer server 81 using the in-band communication link 121a or the out-of-band communication (or both), which uses the communication links 121b and 121c, as well as the network 41a. Alternatively or in addition, the messages to the primary analyzer server 81, over the various paths or tunnels, are mirrored by using the secondary analyzer server 81b related paths or tunnels, such as the path or tunnel 82o, the path or tunnel 82n, the path or tunnel 82m, and the path or tunnel 82p, are not operative, and no data is thus routed to the secondary analyzer server 81b, which are all activated in addition to the paths or tunnels associated with the primary analyzer server 81. While the action taking, such as in the “Take Action” step 96 or the “Send to Destination” step 95, is performed only by the primary analyzer server 81, the secondary analyzer server 81b is continuously aware of the actions taken (or that are required to be taken) by the primary analyzer server 81. In case of failure of the primary analyzer server 81, the functionality regarding the actions to be performed is assigned to the secondary analyzer server 81b, which is performed quickly since it is aware of the current system configuration and status. Other flavors of ‘Hot Standby’ are similar to Dual Modular Redundancy (DMR) or Parallel Redundancy. The main difference between Hot Standby and DMR is how tightly the primary and the secondary are synchronized. DMR completely synchronizes the primary and secondary units.

While a redundancy of two was exampled above, where two analyzer servers 81 and 81b and two sets of related paths or tunnels were used, a redundancy involving three or more analyzer servers or sets of related paths or tunnels may be equally used. The term ‘N’ Modular Redundancy, (a.k.a. Parallel Redundancy) refers to the approach of having multiply units and related paths (or tunnels) running in parallel. All analyzer servers are highly synchronized and receive the same input information at the same time. Their output values are then compared and a voter decides which output values should be used. This model easily provides bumpless switchovers, and this model typically has faster switchover times than Hot Standby models, thus the system availability is very high, but because all the analyzer servers are powered up and actively engaged with the system operation, the system is at more risk of encountering a common mode failure across all the units. Deciding which unit is correct can be challenging if only two units are used. If more than two units are used, the problem is simpler, usually the majority wins or the two that agree win. In N Modular Redundancy, there are three main typologies: Dual Modular Redundancy, Triple Modular Redundancy, and Quadruple Redundancy. Quadruple Modular Redundancy (QMR) is fundamentally similar to TMR but using four units instead of three to increase the reliability. The obvious drawback is the 4× increase in system cost.

Dual Modular Redundancy (DMR) uses two functional equivalent units, thus either can control or support the system operation. The most challenging aspect of DMR is determining when to switch over to the secondary unit. Because both units are monitoring the application, a mechanism is needed to decide what to do if they disagree. Either a tiebreaker vote or simply the secondary unit may be designated as the default winner, assuming it is more trustworthy than the primary unit. Triple Modular Redundancy (TMR) uses three functionally equivalent units to provide a redundant backup. This approach is very common in aerospace applications where the cost of failure is extremely high. TMR is more reliable than DMR due to two main aspects. The most obvious reason is that two “standby” units are used instead of just one. The other reason is that in a technique called diversity platforms or diversity programming may be applied. In this technique, different software or hardware platforms are used on the redundant systems to prevent common mode failure. The voter decides which unit will actively control the application. With TMR, the decision of which system to trust is made democratically and the majority rules. If three different answers are obtained, the voter must decide which system to trust or shut down the entire system, thus the switchover decision is straightforward and fast.

Another redundancy topology is 1:N Redundancy, where a single backup is used for multiple systems, and this backup is able to function in the place of any single one of the active systems. This technique offers redundancy at a much lower cost than the other models by using one standby unit for several primary units. This approach only works well when the primary units all have very similar functions, thus allowing the standby to back up any of the primary units if one of them fails.

Alternatively or in addition to using multiple analyzer servers for a redundancy purpose, a scheme employing multiple analyzer servers may be used for load balancing, such as where the required functionalities are split between the multiple analyzer servers. In one example, the functionalities partitioning is based on the analysis of messages based on their sources. For example, messages received from sources external to the protected network 41 (typically via edge units) are handled by a first analyzer server, while messages received from sources internal to the protected network 41 (such as internal to the protected side 43b) are handled by a second analyzer server, where each of the analyzer server perform part of, or all of, the flow chart 90 regarding the respective handled messages and sources. Such an arrangement 120b is illustrated in FIG. 12b, where the analyzer server 81 handles the messages received from sources external to the protected network 41, while the analyzer server 81b handles the messages received from sources internal to the protected network 41. Messages from the external network I 42 are tunneled via the path 82a from the corresponding edge unit 70 to the analyzer server 81, and similarly messages from the external network II 42a are tunneled via the path 82c from the corresponding edge unit 70a to the analyzer server 81. However, messages from the client #3 24′c are tunneled via the path 82m to the analyzer server 81b, and similarly messages from the server #4 24d are tunneled via the path 82p to the analyzer server 81b. Hence, the work load relating to messages analysis is split between the two analyzer servers.

While the arrangement 120b exampled work load partition based on partitioning to messages from internal or external sources, any other sources partitioning may equally be applied. A general partitioning is exampled in an arrangement 120c shown in FIG. 12c. Messages from the external network I 42 are tunneled via the path 82a from the corresponding edge unit 70 to the analyzer server 81, and similarly messages from the client #3 24′c are also tunneled via the path 82e to the analyzer server 81. Messages from the external network II 42a are tunneled via the path 82n from the corresponding edge unit 70a to the analyzer server 81b, and similarly messages from the server #4 24d are also tunneled via the path 82p to the analyzer server 81b.

Alternatively or in addition to work load partition based on partitioning of messages based on their sources (such as internal and external sources), the work load partition may be based on identifying two or more sub-networks, where each of the analyzer server handle one or more of the sub-networks. Such an arrangement 120d is shown in FIG. 12d, illustrating a protected network I 41′ and another protected network II 41″, which may both be sub-networks of the protected network 41. For example, the protected network 41 may comprise, or may be composed of, the protected network I 41′ and the protected network II 41″, which are interconnected using an adapter device 122 (or functionality). The adapter device 122 may consists of, may comprise, or may be part of, a bridge, a switch, a router, or a gateway, or may consist of any device operative to connect separate networks. The analyzer server 81 is connected to, and is used to protect, the protected network I 41′, while the analyzer server 81b is connected to, and is used to protect, the protected network II 41″.

The protected network 41 may be formed by, may consist of, or may comprise, one or more communication nodes. A communication node (hereinafter “node”) is an hardware (and software) physical device that typically comprises an active electronic circuitry and serves as a redistribution point that is capable of creating, receiving, or transmitting information over a communications medium or channel. A node may consists of, may comprise, or may be part of, a gateway, a router (such as the router 19 shown in the arrangement 1a), a bridge, a switch, a hub, a repeater, a multilayer switch, a protocol converter, a proxy server, a firewall (such as the firewall 50 shown in the arrangement 40), a multiplexer, or a aggregator. Nodes typically include two or more ports for connecting to endpoint devices or to other nodes. Data traffic, such as frames, packets, or any other messages received in one port typically is forwarded to one or more other ports according to pre-specified policies or rules.

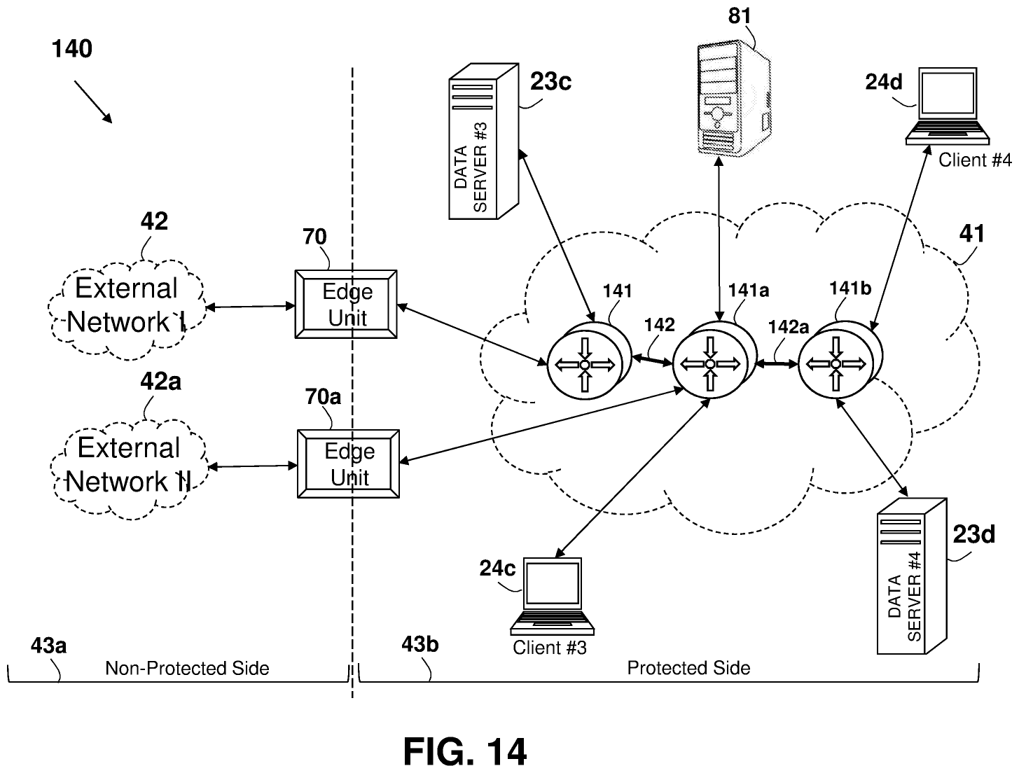

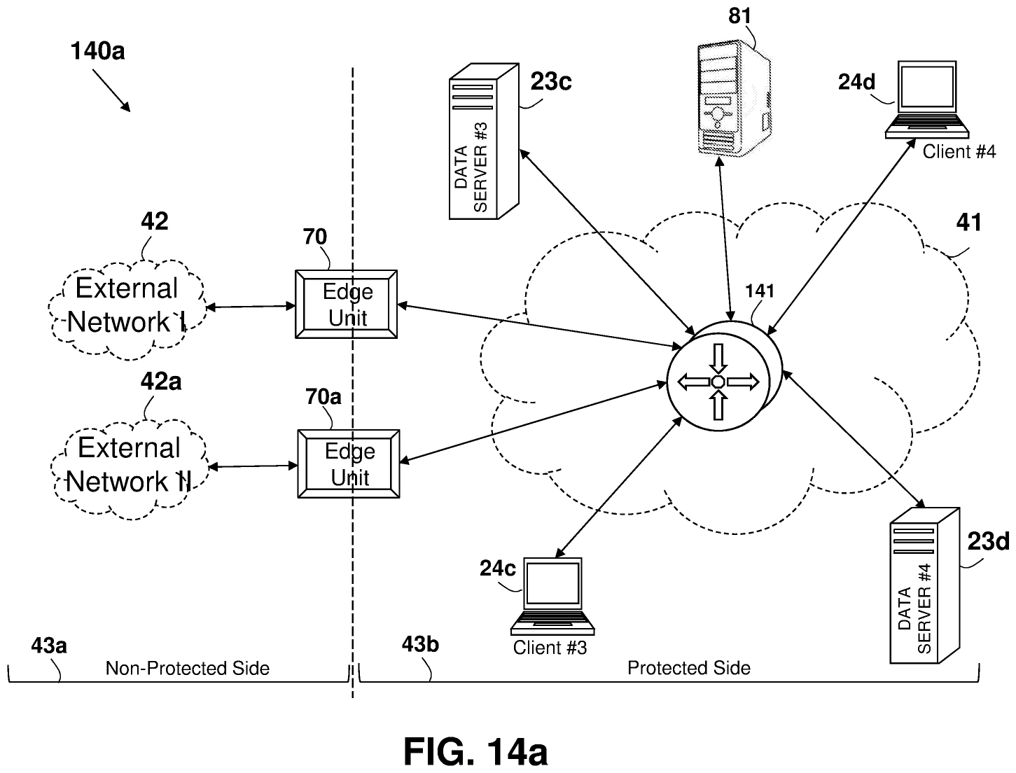

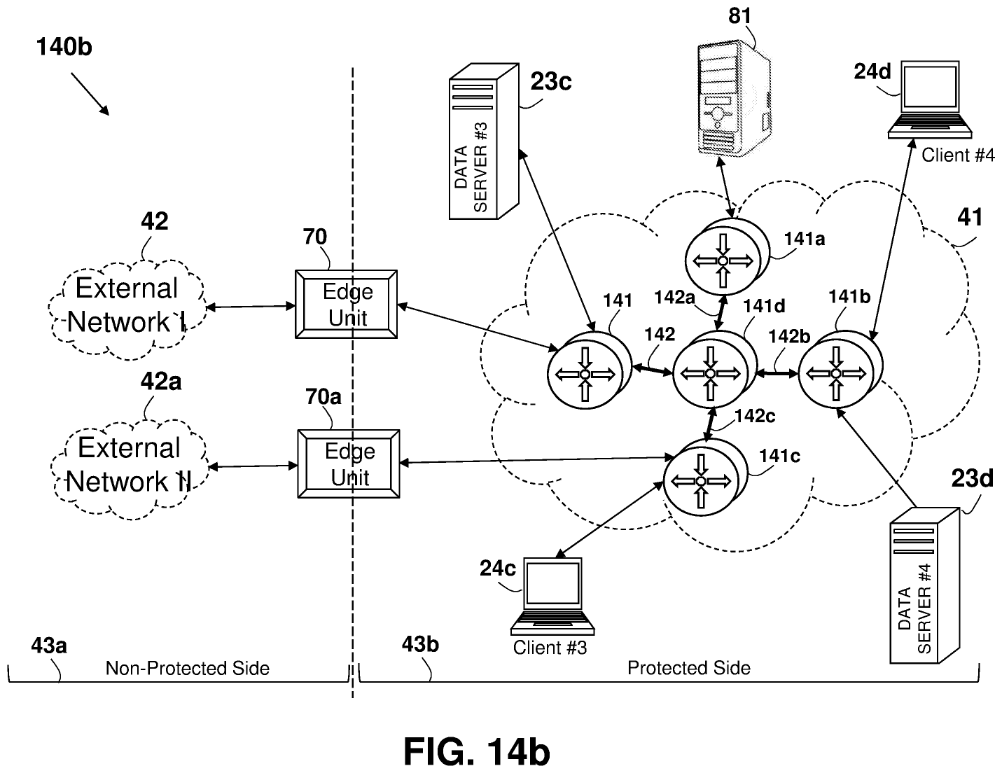

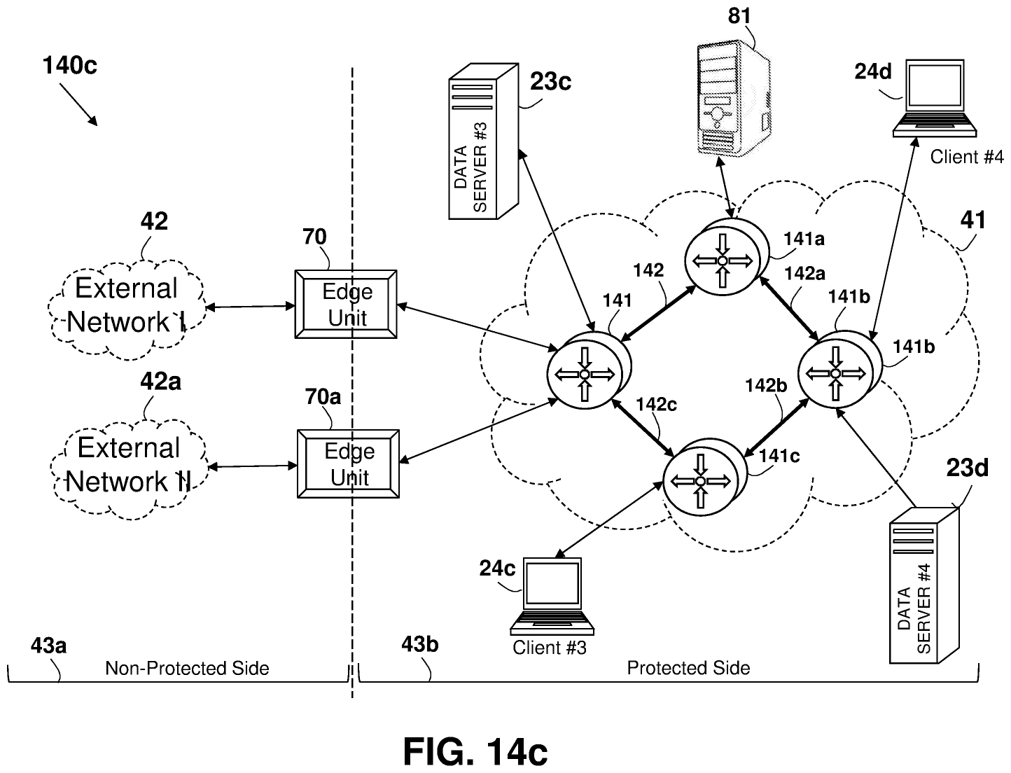

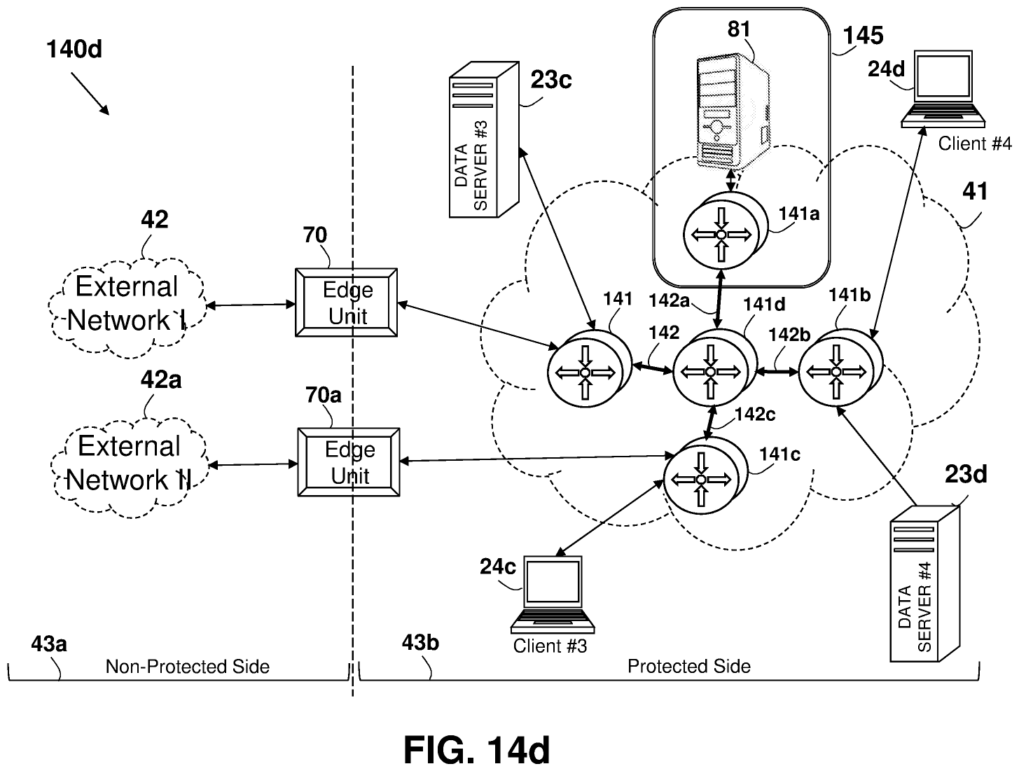

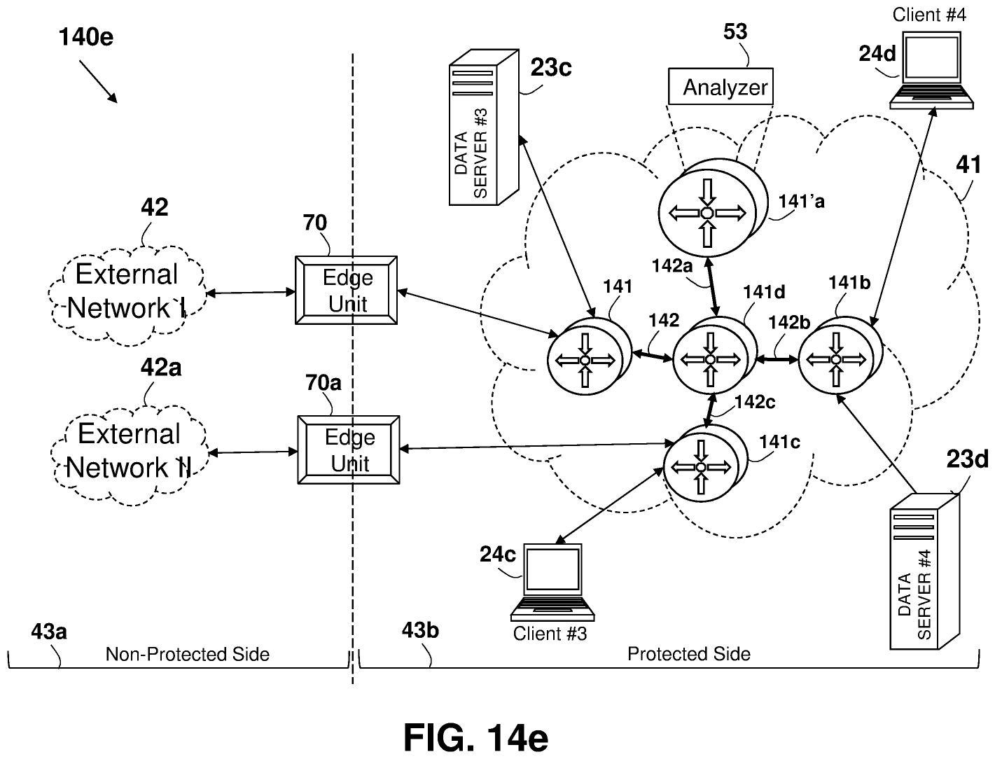

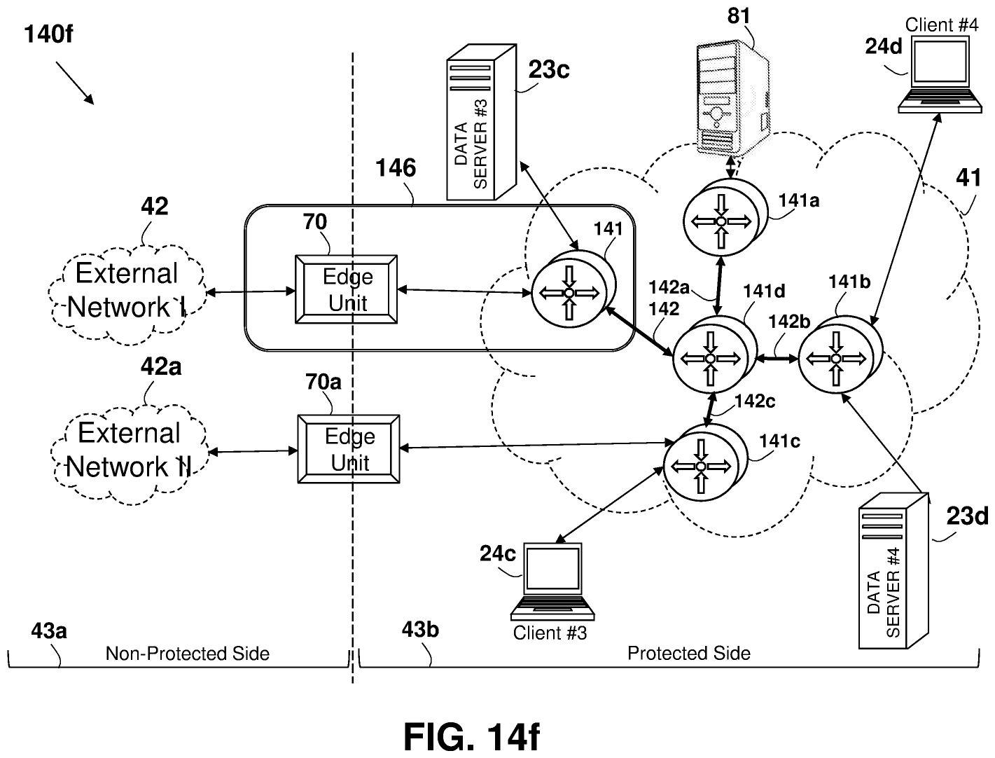

In an exemplary arrangement 140 shown in FIG. 14, the protected network 41 is formed by, consists of, or comprises, three nodes connected in series (‘line’ or ‘linear’ topology). A node 141 comprises three ports, one port connects to the data server #3 23c, one port connects to the edge unit 70, and one port connects over a connection or path 142 to a second node 141a. The second node 141a comprises five ports, one port connects to the analyzer server 81, one port connects to the edge unit 70a, one port connects to the first node 141 over the path 142, one port connects to the client #3 24c, and one port connects over the connection or path 142a to a third node 141b. The third node 141b comprises three ports, one port connects to the client #4 24d, one port connects to the data server #4 23d, and one port connects over the connection or path 142a to the second node 141b. While three nodes are exampled in the arrangement 140, any number of nodes may be equally used, such as 1, 2, 4, 5, 6, 7, 8, 9, 10, or more.

In an exemplary arrangement 140a shown in FIG. 14a, the protected network 41 is formed by, consists of, or comprises, a single node 141, which may consists of, may comprise, or may part of, a switch, a router, or a gateway. The single node 141 connects to all the end units (endpoints), namely to including the edge unit 70, to the edge unit 70a, to the client #3 24c, to the client #4 24d, to the server #3 23c, to the server #4 23d, and to the analyzer server 81.

In an exemplary arrangement 140b shown in FIG. 14b, the protected network 41 is formed by, consists of, or comprises, five nodes connected in a ‘star’ topology, where four nodes connect to the end units, and a central node 141d connects the four nodes to each other. A first node 141 connects to the server #3 23c and to the edge unit 70. A second node 141a connects to the analyzer server 81. A third node 141b connects to the client #4 24d and to the server #4 23d, and a fourth node 141c connects to the edge unit 70a and to the client #3 24c. The central node 141d connects to the first node 141 over a path 142, to the second node 141a over a path 142a, to the third node 141b over a path 142b, and to the fourth node 141c over a path 142c. Preferably, the peripheral nodes handle lower layers than the layers handled by the central node. For example, the nodes 141, 141a, 141b, and 141c may consists of, or comprises, a switch that handles Layer-2, while the central node 141d may consists of, or comprises, a router that handles Layer-3. Similarly, the nodes 141, 141a, 141b, and 141c may consists of, or comprises, a router that handles Layer-3, while the central node 141d may consists of, or comprises, a gateway that handles Layer-4 or above.

In an exemplary arrangement 140c shown in FIG. 14c, the protected network 41 is formed by, consists of, or comprises, four nodes connected in a ‘ring’ topology. In such a topology, each of the nodes that form the ring use two ports for connecting to neighboring nodes in the ring. The first node 141 connects to a second node 141a over a path 142 and to a fourth node 141c over a path 142c, the second node 141a connects to the first node 141 over the path 142 and to a third node 141b over a path 142a, the third node 141b connects to the second node 141a over the path 142a and to the fourth node 141c over a path 142b, and the fourth node 141c connects to the third node 141b over the path 142b and to the first node 141 over the path 142c. The first node 141 connects the server #3 23c, the edge unit 70, and the edge unit 70a to the network, the second node 141a connects the analyzer server 81 to the network, the third node 141b connects the client #4 24d and the server #4 23d to the network, and the fourth node 141c connects the client #3 24c to the network. In one example, the ring in the arrangement 140c is based on, or uses, Ethernet Ring Protection Switching (ERPS), such as according to ITU-T G.8032v1 or ITU-T G.8032v2.

While linear topology was exampled in the arrangement 140, start topology was exampled in the arrangement 140b, and ring topology was exampled in the arrangement 140c, any other topology may equally be used, such as ‘tree’ topology. Further, any combination of the basic topologies described may equally be used.

Each node used as part of the protected network 41, such as the node 141, the node 141a, the node 141b, the node 141c, or the node 141d, may consists of, may comprise, or may be part of, a gateway, a router, a bridge, a switch, a hub, a repeater, a multilayer switch, a protocol converter, a proxy server, a firewall, a multiplexer, or a aggregator. Further, any two nodes used to form the protected network 41 may be identical to, similar to, or different from, each other, and any combination of node types may be used.

In a vehicular environment, such as in the case of the protected vehicular network 41a shown as part of the arrangement 100, each node used as part of the protected network 41, such as the node 141, the node 141a, the node 141b, the node 141c, or the node 141d, may consists of, may comprise, or may be part of, a vehicular node suitable to, or designed for, operation within a vehicle, and where at least part of the ports of a respective node are adapted to interface a vehicular network.

In the arrangement 140c shown in FIG. 14c, the node 141a and the analyzer server 81 connected thereto are described as separate, independent, or distinct devices. Alternatively or in addition, the node 141a and the analyzer server 81 may be integrated to form an integrated entity 145, as illustrated in an arrangement 140d shown in FIG. 14d. The integrated entity 145 may comprise part of, or whole of, the components or functionalities of the analyzer server 81 and the node 141a. The integration may involve sharing a hardware or software component, such as being housed in the same enclosure, sharing the same processor, mounting on the same surface, powering from the same power supply, or sharing the same connector (such as power connector for connecting to a power source). Alternatively or in addition, the analyzer functionality 53 and the node 141a may be integrated to form an integrated entity of a node 141′a, as illustrated in an arrangement 140e shown in FIG. 14e. The integrated node 141′a may comprise part of, or whole of, the components or functionalities of the analyzer server 81 and the analyzer functionality or software 53. The integration may involve sharing a hardware or software component, such as being housed in the same enclosure, sharing the same processor, mounting on the same surface, powering from the same power supply, or sharing the same connector (such as power connector for connecting to a power source).

Similarly, in the arrangement 140c shown in FIG. 14c, the node 141 and the edge unit 70 connected thereto are described as separate, independent, or distinct devices. Alternatively or in addition, the node 141 and the edge unit 70 may be integrated to form an integrated entity 146, as illustrated in an arrangement 140f shown in FIG. 14f. The integrated entity 146 may comprise part of, or whole of, the components or functionalities of the edge unit 70 and the node 141. The integration may involve sharing a hardware or software component, such as being housed in the same enclosure, sharing the same processor, mounting on the same surface, powering from the same power supply, or sharing the same connector (such as power connector for connecting to a power source).

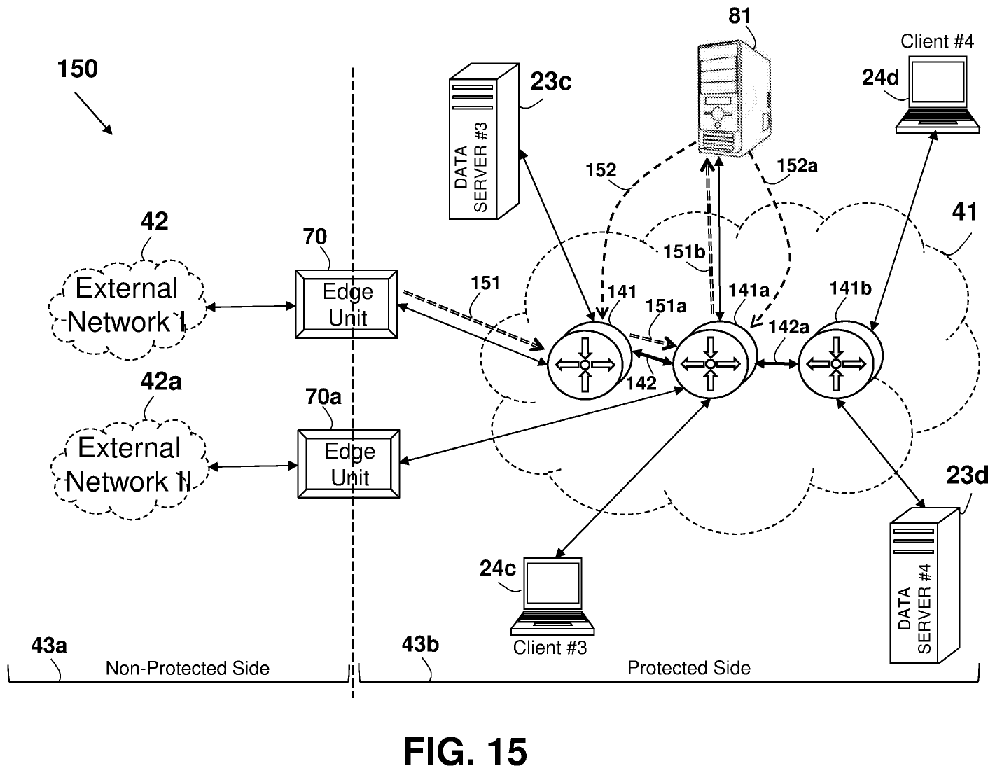

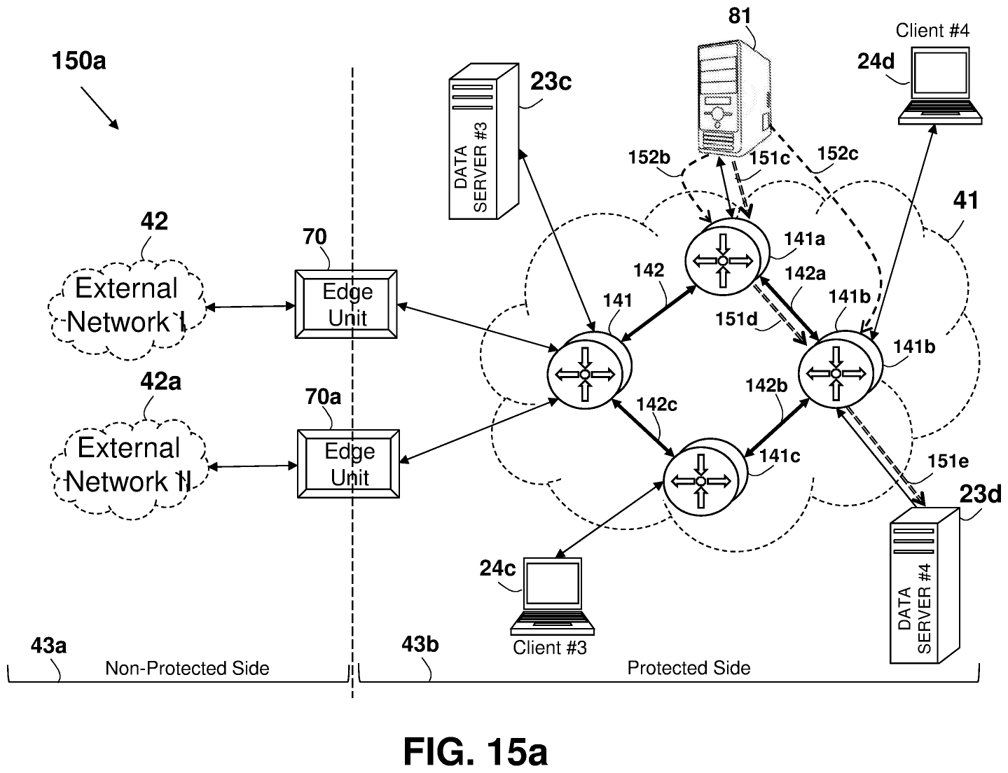

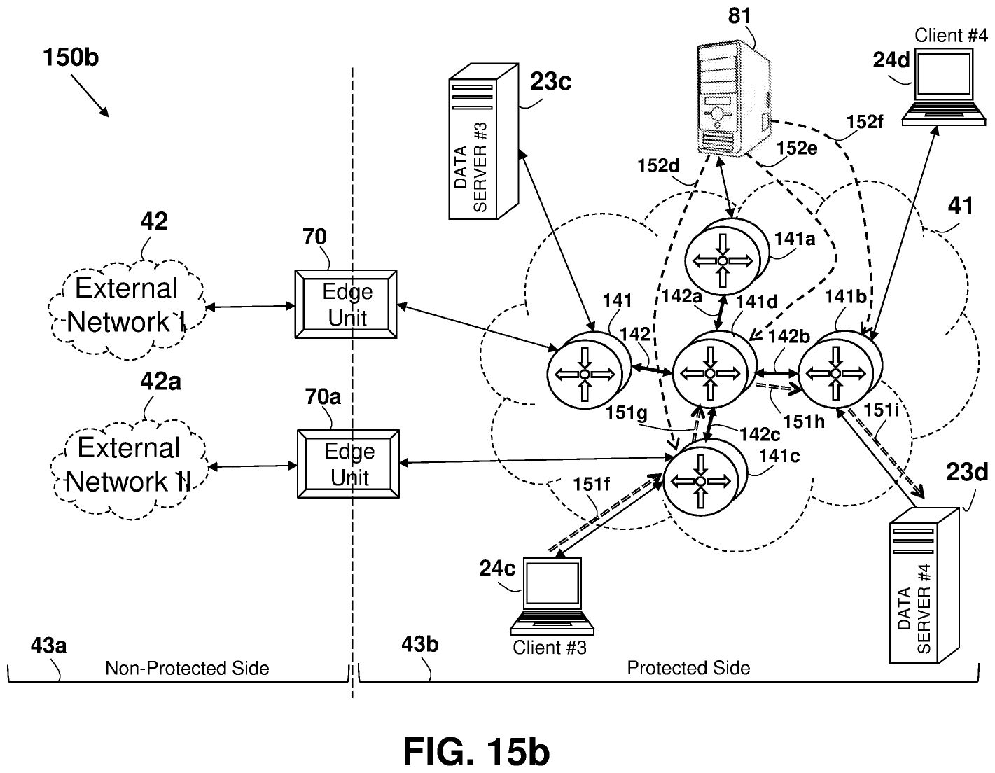

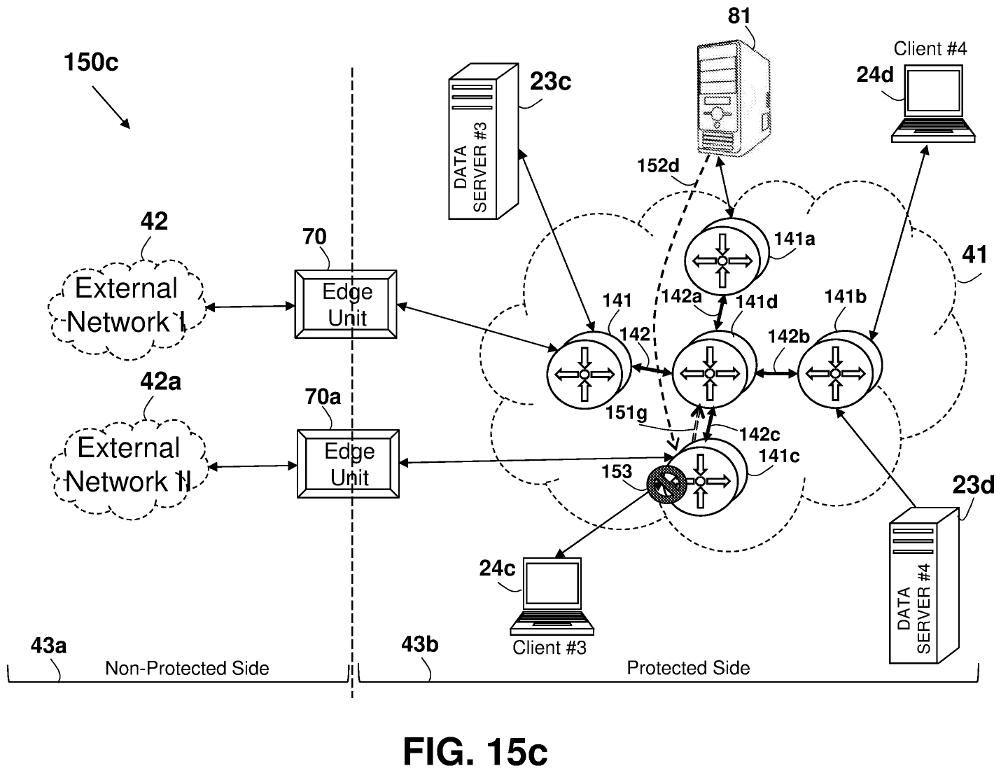

The nodes forming the protected network 41 handle the traffic flow, and the messages exchange, between the end units. Preferably, such network traffic routing is along the best available path, such as via minimum intermediate units (hops) or nodes. An arrangement 150 shown in FIG. 15 is based on the linear topology illustrated in the arrangement 140 shown in FIG. 14, an arrangement 150a shown in FIG. 15a is based on the ring topology illustrated in the arrangement 140c shown in FIG. 14c, and an arrangement 150b shown in FIG. 15b is based on the star topology illustrated in the arrangement 140b shown in FIG. 14b.

The arrangement 150 illustrates a preferred path for implementing the path or tunnel 82a shown in the arrangement 80a shown in FIG. 8a. The path includes sending the received message from the edge unit 70 to the node 141 over a connection 151, then from the node 141 to the node 141a over a connection 151a, and finally from the node 141a to the analyzer server 81 over a connection 151b.

In order to ensure or perform these connections to implement the path 82a, the nodes 141 and 141a needs to be instructed or configured. In one example, the nodes are pre-configured to forward the message along the requested route, so that messages received via the port connected to the link 151 from the edge unit 70 are always forwarded to the port that connects to the link 151a towards the node 141a, and similarly the node 141a needs to be instructed or configured to forward messages received from the link 151a (originated at the edge unit 70) to the analyzer server 81 via the port that connects to the link 151b. In one example, the nodes may be pre-configured, such as by a user. Alternatively or in addition, the nodes may be configured (such as by a control plane) by a device connected thereto. In one example, the nodes may receive configuration instruction from the analyzer server 81. For example, the analyzer server 81 may communicate to configure the node 141 over a connection 152 and may communicate to configure the node 141a over a connection 152a. The connections 152 and 152a may use the available routing capabilities of the protected network 41 for communicating with the respective nodes 141 and 141a (in-band signaling), such as using the link 151b for the connection 152a and connecting to the node 141 via the connections 151b and 151a. Alternatively or in addition, the connections 152 and 152a may not be combined with the protected network 41 traffic, and may use direct, separated and dedicated connections, or may a network other than the protected network 41 (out-of-band signaling).

Similarly, the arrangement 150a illustrate a preferred path for implementing the path or tunnel 82b shown in the arrangement 80a shown in FIG. 8a. The path includes sending the received message from the analyzer server 81 to the node 141a over a connection 151c, then from the node 141a to the node 141b over a connection 151d (using the connection 142a), and finally from the node 141b to the data server #4 23d over a connection 151e.

As illustrated in the arrangement 150a shown in FIG. 15a, in order to ensure or perform these connections to implement the path 82b, the nodes 141a and 141b needs to be instructed or configured. In one example, the nodes are pre-configured to forward the message along the requested route, so that messages received via the port connected to the link 151c from the analyzer server 81 to the data server #4 23d are always forwarded to the port that connects to the link 151d towards the node 141b, and similarly the node 141b needs to be instructed or configured to forward messages received from the link 151d (originated at the analyzer server 81) to the analyzer server 81 via the port that connects to the link 151e. In one example, the nodes 141a and 141b may be pre-configured, such as by a user, or via respective connections 152b and 152c (in-band or out-of-band) by the analyzer server 81.

Further, as illustrated in the arrangement 150b shown in FIG. 15b, in order to implement a path from the client #3 24c to the data server #4 23d, the nodes 141c, 141d, and 141b need to be instructed or configured. In one example, the nodes are pre-configured to forward the message along the requested route, so that messages received by the node 141c via the port connected to a link 151f from the client #3 24c to the data server #4 23d are always forwarded to the port that connects to the link 151g towards the node 141d, and similarly the node 141d needs to be instructed or configured to forward messages received from the link 151g (originated at the client #3 24c) to the data server #4 23d via the port that connects to the link 151h. Then, the node 141b forward the received traffic from the link 151h (using the connection 142b) is forwarded to the port connecting to a link 151i towards the data server #4 23d. In one example, the involved nodes 141c, 141d, and 141b may be pre-configured, such as by a user, or via respective connections 152d, 152e, and 152f (in-band or out-of-band) by the analyzer server 81.

In one example, an end unit may be determined as suspected and the analyzer server 81 may decide to isolate it from any further harmful impact on the protected network 41 by blocking it as part of the “Block” step 96c. Such blocking may be implemented by logically disconnecting the port connected to the suspected device, as exampled in an arrangement 150c shown in FIG. 15c. In this example, the client #3 24c is determined to be suspected, and the blocking is implemented by blocking (shown as no-entry sign 153) the port of the node 141c that connects to the client #3 24c. Hence, any further data or messages sent from the suspected client #3 24c is stopped and discarded at this port of the node 141c, thus affectively disconnecting the client #3 24c from the protected network 41. The node 141c may be configured to block the port by the analyzer server 81, such as via the connection 152d.

In one example, the nodes are VLAN-capable nodes (such as VLAN-cable switches or routers), and the tunnels or paths are implemented using VLAN. Each of the tunnels is associated with a dedicated and unique VLAD ID (VID), and the analyzer server 81 is associated with all the VIDs. For example, the VID of the tunnel 82a may be 100, the VID of the tunnel 82b may be 200, the VID of the tunnel 82e may be 300, and the VID of the tunnel 82f may be 400. The analyzer server 81 is associated with all VIDs, namely 100, 200, 300 and 400. The VIDs and the VLAN tags are added by the end units (such as the edge unit 70, the client device #3 24c, or the server #4 23d), or by the edge nodes that are connected directly to the end units. This structure redirect all traffic via the analyzer server 81, hence forming the described tunnels. In a case where the analysis by the analyzer server 81 authenticate an end unit, and thus allows it to directly connect (without the analyzer server 81 as an intermediary) as part of the “Routing Control” step 97, the VLANs may be updated accordingly. For example, if a direct communication is allowed between the edge unit 70 and the data server #4 23d, the data server #4 23d is further associated with the VID 100, or the edge unit 70 may be associated with the VID 200. Alternatively or in addition, a new VLAN may be formed that includes both authorized devices. Further, the analyzer server 81 may be dis-associated with the authorized devices VIDs, thus their respective traffic is not received and handled by the analyzer server 81, allowing for reduced workload and traffic. Alternatively or in addition, the analyzer server 81 may remain associated with the authorized devices VIDs, for example for mirroring of the traffic therebetween for monitoring or logging purposes.

Further, in the case where a messages in determined to be suspected, such as containing malware or being part of a malware activity, the VLAN mechanism may be used to block the suspected source, as part of the “Routing Control” step 97a. For example, if a message from the external network I 42 is found to be suspected as part of the ““Suspected?” step 94, the analyzer server 81 may configure the edge unit 70, the node connected thereto (such as node 141 in the arrangement 150b), or other nodes in the protected network 41, to block or discard messages having the associated VLAN, such as 100 in the above example.

Alternatively or in addition, the routing of traffic, such as messages or flows in the protected network 41, such as the implementation of any of, or all of, the tunnels, is implemented using Multiprotocol Label Switching (MPLS), where at least one node may consist of, or may comprise, a Label Edge Router (LER), and at least one another node may consist of, or may comprise, a Label Switch Router (LSR), which implement a tunnel using a Label-Switched Path (LSP).

Alternatively or in addition, the routing of traffic, such as messages or flows in the protected network 41, such as the implementation of any of, or all of, the tunnels, is implemented using Software-Defined Networking (SDN) technology. In one example, the analyzer server 81 serves as an SDN controller, and part of, or all of, the nodes forming the protected network 41 serve to form an SDN Datapath. Further, the SDN may be based on OpenFlow protocol, where part of, or all of, the nodes forming the protected network 41 are OpenFlow-capable nodes (such as OpenFlow-capable switches), and the analyzer server 81 serves as an OpenFlow controller.

Any wired network herein may be a Personal Area Network (PAN), any connector herein may be a PAN connector, and any transceiver herein may be a PAN transceiver. Alternatively or in addition, any network herein may be a Local Area Network (LAN) that may be Ethernet-based, ant connector herein may be a LAN connector, and any transceiver herein may be a LAN transceiver. The LAN may be according to, may be compatible with, or may be based on, IEEE 802.3-2008 standard. Alternatively or in addition, the LAN may be according to, may be compatible with, or may be based on, 10Base-T, 100Base-T, 100Base-TX, 100Base-T2, 100Base-T4, 1000Base-T, 1000Base-TX, 10GBase-CX4, or 10GBase-T; and the LAN connector may be an RJ-45 type connector. Alternatively or in addition, the LAN may be according to, may be compatible with, or may be based on, 10Base-FX, 100Base-SX, 100Base-BX, 100Base-LX10, 1000Base-CX, 1000Base-SX, 1000Base-LX, 1000Base-LX10, 1000Base-ZX, 1000Base-BX10, 10GBase-SR, 10GBase-LR, 10GBase-LRM, 10GBase-ER, 10GBase-ZR, or 10GBase-LX4, and the LAN connector may be a fiber-optic connector. Alternatively or in addition, any network herein may be a packet-based or switched-based Wide Area Network (WAN), any connector herein may be a WAN connector, and any transceiver herein may be a WAN transceiver. WAN is described in chapter 3 entitled: “Introduction to WAN Technologies” of The Internetworking Technology Overview by Cisco Systems, Inc. [published June 1999, Document No. 1-58705-001-3], which is incorporated in its entirety for all purposes as if fully set forth herein.

Any one of the apparatuses described herein, such as a device, module, or system, may be integrated or communicating with, or connected to, the vehicle self-diagnostics and reporting capability, commonly referred to as On-Board Diagnostics (OBD), to a Malfunction Indicator Light (MIL), or to any other vehicle network, sensors, or actuators that may provide the vehicle owner or a repair technician access to health or state information of the various vehicle sub-systems and to the various computers in the vehicle. Common OBD systems, such as the OBD-II and the EOBD (European On-Board Diagnostics), employ a diagnostic connector, allowing for access to a list of vehicle parameters, commonly including Diagnostic Trouble Codes (DTCs) and Parameters IDentification numbers (PIDs). The OBD-II is described in the presentation entitled: “Introduction to On Board Diagnostics (II)” downloaded on November 2012 from: http://groups.engin.umd.umich.edu/vi/w2_workshops/OBD_ganesan_w2.pdf, which is incorporated in its entirety for all purposes as if fully set forth herein. The diagnostic connector commonly includes pins that provide power for the scan tool from the vehicle battery, thus eliminating the need to connect a scan tool to a power source separately. The status and faults of the various sub-systems accessed via the diagnostic connector may include fuel and air metering, ignition system, misfire, auxiliary emission control, vehicle speed and idle control, transmission, and the on-board computer. The diagnostics system may provide access and information about the fuel level, relative throttle position, ambient air temperature, accelerator pedal position, air flow rate, fuel type, oxygen level, fuel rail pressure, engine oil temperature, fuel injection timing, engine torque, engine coolant temperature, intake air temperature, exhaust gas temperature, fuel pressure, injection pressure, turbocharger pressure, boost pressure, exhaust pressure, exhaust gas temperature, engine run time, NOx sensor, manifold surface temperature, and the Vehicle Identification Number (VIN). The OBD-II specifications defines the interface and the physical diagnostic connector to be according to the Society of Automotive Engineers (SAE) J1962 standard, the protocol may use SAE J1850 and may be based on, or may be compatible with, SAE J1939 Surface Vehicle Recommended Practice entitled: “Recommended Practice for a Serial Control and Communication Vehicle Network” or SAE J1939-01 Surface Vehicle Standard entitled: “Recommended Practice for Control and Communication Network for On-Highway Equipment”, and the PIDs are defined in SAE International Surface Vehicle Standard J1979 entitled: “E/E Diagnostic Test Modes”, which are all incorporated in their entirety for all purposes as if fully set forth herein. Vehicle diagnostics systems are also described in the International Organization for Standardization (ISO) 9141 standard entitled: “Road vehicles—Diagnostic systems”, and the ISO 15765 standard entitled: “Road vehicles—Diagnostics on Controller Area Networks (CAN)”, which are all incorporated in their entirety for all purposes as if fully set forth herein.

The physical layer of the in-vehicle network may be based on, compatible with, or according to, J1939-11 Surface Vehicle Recommended Practice entitled: “Physical Layer, 250K bits/s, Twisted Shielded Pair” or J1939-15 Surface Vehicle Recommended Practice entitled: “Reduced Physical Layer, 250K bits/s, Un-Shielded Twisted Pair (UTP)”, the data link may be based on, compatible with, or according to, J1939-21 Surface Vehicle Recommended Practice entitled: “Data Link Layer”, the network layer may be based on, compatible with, or according to, J1939-31 Surface Vehicle Recommended Practice entitled: “Network Layer”, the network management may be based on, compatible with, or according to, J1939-81 Surface Vehicle Recommended Practice entitled: “Network Management”, and the application layer may be based on, compatible with, or according to, J1939-71 Surface Vehicle Recommended Practice entitled: “Vehicle Application Layer (through December 2004)”, J1939-73 Surface Vehicle Recommended Practice entitled: “Application Layer—Diagnostics”, J1939-74 Surface Vehicle Recommended Practice entitled: “Application—Configurable Messaging”, or J1939-75 Surface Vehicle Recommended Practice entitled: “Application Layer—Generator Sets and Industrial”, which are all incorporated in their entirety for all purposes as if fully set forth herein.

Any wired network herein may be a Local Area Network (LAN) to provide a data communication connection to a compatible LAN. For example, Ethernet connection based on IEEE802.3 standard may be used, such as 10/100BaseT, 1000BaseT (gigabit Ethernet), 10 gigabit Ethernet (10GE or 10 GbE or 10 GigE per IEEE Std. 802.3ae-2002as standard), 40 Gigabit Ethernet (40 GbE), or 100 Gigabit Ethernet (100 GbE as per Ethernet standard IEEE P802.3ba). These technologies are described in Cisco Systems, Inc. Publication number 1-587005-001-3 (June 1999), “Internetworking Technologies Handbook”, Chapter 7: “Ethernet Technologies”, pages 7-1 to 7-38, which is incorporated in its entirety for all purposes as if fully set forth herein. In such a case, a LAN transceiver or a modem may be used, such as a Standard Microsystems Corporation (SMSC) LAN91C111 10/100 Ethernet transceiver, described in the Standard Microsystems Corporation (SMSC) data-sheet “LAN91C111 10/100 Non-PCI Ethernet Single Chip MAC+PHY” Data-Sheet, Rev. 15 (Feb. 20, 2004), which is incorporated in its entirety for all purposes as if fully set forth herein.

The topology of any wired network herein may be based on, or may use, point-to-point, bus, star, ring or circular, mesh, tree, hybrid, or daisy chain topology. Any two nodes may be connected in a point-to-point topology, and any communication herein between two nodes may be unidirectional, half-duplex, or full-duplex. Any medium herein may comprise, or may consist of, an unbalanced line, and any signals herein may be carried over the medium employing single-ended signaling, that may be based on, may be according to, or may be compatible with, RS-232 or RS-423 standards. Alternatively or in addition, any medium herein may comprises, or may consist of, a balanced line, and any signals herein may be carried over the medium employing differential signaling, that may be based on, may be according to, or may be compatible with, RS-232 or RS-423 standards. Any communication over a medium herein may use serial or parallel transmission.

Any vehicle herein may be a ground vehicle adapted to travel on land, such as a bicycle, a car, a motorcycle, a train, an electric scooter, a subway, a train, a trolleybus, and a tram. Any ground vehicle herein may consist of, or may comprise, an autonomous car, that may be according to levels 0, 1, 2, 3, 4, 5, or 6, of the Society of Automotive Engineers (SAE) J3016 standard. Alternatively or in addition, the vehicle may be a buoyant or submerged watercraft adapted to travel on or in water, and the watercraft may be a ship, a boat, a hovercraft, a sailboat, a yacht, or a submarine. Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV). Any apparatus or device herein may be used for measuring or estimating an altitude, a pitch, or a roll of the aircraft, and may be operative to notify or indicate to a person that may be the vehicle operator or controller.

Any vehicle herein may further comprise an Advanced Driver Assistance Systems (ADAS) functionality or an Advanced Driver Assistance System Interface Specification (ADASIS) system, or scheme, and any device of network herein, such as the first network, one of the multiple devices, the adapter device, or the analyzer device, may be part of, may be integrated with, may communicate with, or may be coupled to, the ADAS or ADASIS functionality, system, or scheme. The ADAS functionality, system, or scheme may be selected from a group consisting of Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system, Pre-crash system, Collision Imminent Braking (CM), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), and Wrong-way driving warning.

Any apparatus or device herein may be operative to connected to, coupled to, communicating with, an automotive electronics in a vehicle, or may be part of, or may be integrated with, an automotive electronics in a vehicle. Further, any ECU, device, or network herein may be part of, or may comprise, the powertrain, chassis, body and comfort, driver assistance/pedestrian safety, or Human-Machine Interface/Multimedia/Telematics sub-system. An Electronic Control Unit (ECU) may comprise, or may be part of, any apparatus or device herein. Alternatively or in addition, any apparatus or device herein may consist of, may be part of, may be integrated with, may be connectable to, or may be couplable to, an Electronic Control Unit (ECU) in the vehicle, and the Electronic Control Unit (ECU) may be Electronic/engine Control Module (ECM), Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed Control Unit (SCU), Telematic Control Unit (TCU), Transmission Control Unit (TCU), Brake Control Module (BCM; ABS or ESC), Battery management system, control unit, or a control module. Alternatively or in addition, any device herein, such as any Electronic Control Unit (ECU), may comprise, may use, may be based on, or may execute a software, an operating-system, or a middleware, that may comprise, may be based on, may be according to, or may use, OSEK/VDX, International Organization for Standardization (ISO) 17356-1, ISO 17356-2, ISO 17356-3, ISO 17356-4, ISO 17356-5, or AUTOSAR standard. Any software herein may comprise, may use, or may be based on, an operating-system or a middleware, that may comprise, may be based on, may be according to, or may use, OSEK/VDX, International Organization for Standardization (ISO) 17356-1, ISO 17356-2, ISO 17356-3, ISO 17356-4, ISO 17356-5, or AUTOSAR standard.

Any network herein may be a vehicle network, such as a vehicle bus or any other in-vehicle network. A connected element comprises a transceiver for transmitting to, and receiving from, the network. The physical connection typically involves a connector coupled to the transceiver. The vehicle bus may consist of, may comprise, may be compatible with, may be based on, or may use a Controller Area Network (CAN) protocol, specification, network, or system. The bus medium may consist of, or comprise, a single wire, or a two-wire such as an UTP or a STP. The vehicle bus may employ, may use, may be compatible with, or may be based on, a multi-master, serial protocol using acknowledgement, arbitration, and error-detection schemes, and may further use synchronous, frame-based protocol.

The network data link and physical layer signaling may be according to, compatible with, based on, or use, ISO 11898-1:2015. The medium access may be according to, compatible with, based on, or use, ISO 11898-2:2003. The vehicle bus communication may further be according to, compatible with, based on, or use, any one of, or all of, ISO 11898-3:2006, ISO 11898-2:2004, ISO 11898-5:2007, ISO 11898-6:2013, ISO 11992-1:2003, ISO 11783-2:2012, SAE J1939/11_201209, SAE J1939/15_201508, or SAE J2411_200002 standards. The CAN bus may consist of, may be according to, may be compatible with, may be based on, or may use a CAN with Flexible Data-Rate (CAN FD) protocol, specification, network, or system.

Alternatively or in addition, the vehicle bus may consist of, may comprise, may be based on, may be compatible with, or may use a Local Interconnect Network (LIN) protocol, network, or system, and may be according to, may be compatible with, may be based on, or may use any one of, or all of, ISO 9141-2:1994, ISO 9141:1989, ISO 17987-1, ISO 17987-2, ISO 17987-3, ISO 17987-4, ISO 17987-5, ISO 17987-6, or ISO 17987-7 standards. The battery power-lines or a single wire may serve as the network medium, and may use a serial protocol where a single master controls the network, while all other connected elements serve as slaves.

Alternatively or in addition, the vehicle bus may consist of, may comprise, be compatible with, may be based on, or may use a FlexRay protocol, specification, network or system, and may be according to, may be compatible with, may be based on, or may use any one of, or all of, ISO 17458-1:2013, ISO 17458-2:2013, ISO 17458-3:2013, ISO 17458-4:2013, or ISO 17458-5:2013 standards. The vehicle bus may support a nominal data rate of 10 Mb/s, and may support two independent redundant data channels, as well as independent clock for each connected element.

Alternatively or in addition, any vehicle bus herein may consist of, may comprise, or may be based on, an avionics data bus standard, such as Aircraft Data Network (ADN), Avionics Full-Duplex Switched Ethernet (AFDX), Aeronautical Radio INC. (ARINC) 664, ARINC 629, ARINC 708, ARINC 717, ARINC 825, MIL-STD-1553, MIL-STD-1760, or Time-Triggered Protocol (TTP).

Alternatively or in addition, the vehicle bus may consist of, comprise, be compatible with, may be based on, or may use a Media Oriented Systems Transport (MOST) protocol, network or system, and may be according to, may be compatible with, may be based on, or may use any one of, or all of, MOST25, MOST50, or MOST150. The vehicle bus may employ a ring topology, where one connected element may be the timing master that continuously transmits frames where each comprises a preamble used for synchronization of the other connected elements. The vehicle bus may support both synchronous streaming data as well as asynchronous data transfer. The network medium may be wires (such as UTP or STP), or may be an optical medium such as Plastic Optical Fibers (POF) connected via an optical connector. In one example, the vehicle bus may consists of, comprises, or may be based on, automotive Ethernet, may use only a single twisted pair, and may consist of, employ, use, may be based on, or may be compatible with, IEEE802.3 100BaseT1, IEEE802.3 1000BaseT1, BroadR-Reach®, IEEE 802.3bw-2015, IEEE Std 802.3bv-2017, or IEEE Std 802.3 bp-2016 standards.

The method and steps described herein may be used for detecting malware such as a firmware virus, a computer virus, spyware, DoS (Denial of Service), rootkit, ransomware, adware, backdoor, Trojan horse, or a destructive malware. Further, by stopping a malware related message from passing through the system (such as to, or from, a peripheral), a damage that may be caused by the malware is avoided.

Electronic circuits and components are described in a book by Wikipedia entitled: “Electronics” downloaded from en.wikibooks.org dated Mar. 15, 2015, and in a book authored by Owen Bishop entitled: “Electronics—Circuits and Systems” Fourth Edition, published 2011 by Elsevier Ltd. [ISBN—978-0-08-096634-2], which are both incorporated in their entirety for all purposes as if fully set forth herein.

The term ‘message’ is used herein to include any type of information or one or more datagram, handled as a single, as a set or as a group of datagrams. The datagram may be a packet (such as an IP packet), a frame (such as an Ethernet frame), a collection of consecutive datagrams, such as a flow (an TCP session, for example), or any other type of group of data bytes (or bits) which represent an information unit.

Any part of, or the whole of, any of the methods described herein may be provided as part of, or used as, an Application Programming Interface (API), defined as an intermediary software serving as the interface allowing the interaction and data sharing between an application software and the application platform, across which few or all services are provided, and commonly used to expose or use a specific software functionality, while protecting the rest of the application. The API may be based on, or according to, Portable Operating System Interface (POSIX) standard, defining the API along with command line shells and utility interfaces for software compatibility with variants of Unix and other operating systems, such as POSIX.1-2008 that is simultaneously IEEE STD. 1003.1™—2008 entitled: “Standard for Information Technology—Portable Operating System Interface (POSIX(R)) Description”, and The Open Group Technical Standard Base Specifications, Issue 7, IEEE STD. 1003.1™, 2013 Edition.

Any part of, or whole of, any of the methods described herein may be implemented by a processor such as the processor 12, and may further be used in conjunction with various devices and systems, for example a device may be a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, or a non-mobile or non-portable device.

Any device herein, such as the analyzer server 81, may be integrated with a part of or in an entire appliance. The primary function of the appliance may be associated with food storage, handling, or preparation, such as microwave oven, an electric mixer, a stove, an oven, or an induction cooker for heating food, or the appliance may be a refrigerator, a freezer, a food processor, a dishwasher, a food blender, a beverage maker, a coffee-maker, or an iced-tea maker. Alternatively or in addition, the primary function of the appliance may be associated with an environmental control such as temperature control, and the appliance may consist of, or may be part of, an HVAC system, an air conditioner or a heater. Alternatively or in addition, the primary function of the appliance may be associated with a cleaning action, such as a washing machine, a clothes dryer for cleaning clothes, or a vacuum cleaner. Alternatively or in addition, the primary function of the appliance may be associated with water control or water heating. The appliance may be an answering machine, a telephone set, a home cinema system, a HiFi system, a CD or DVD player, an electric furnace, a trash compactor, a smoke detector, a light fixture, or a dehumidifier. The appliance may be a handheld computing device or a battery-operated portable electronic device, such as a notebook or laptop computer, a media player, a cellular phone, a Personal Digital Assistant (PDA), an image processing device, a digital camera, or a video recorder. The integration with the appliance may involve sharing a component such as housing in the same enclosure, sharing the same connector such as sharing a power connector for connecting to a power source, where the integration involves sharing the same connector for being powered from the same power source. The integration with the appliance may involve sharing the same power supply, sharing the same processor, or mounting onto the same surface.

The steps described herein may be sequential, and performed in the described order. For example, in a case where a step is performed in response to another step, or upon completion of another step, the steps are executed one after the other. However, in the case where two or more steps are not explicitly described as being sequentially executed, these steps may be executed in any order or may be simultaneously performed. Two or more steps may be executed by two different network elements, or in the same network element, and may be executed in parallel using multiprocessing or multitasking.

A tangible machine-readable medium (such as a storage) may have a set of instructions detailing part (or all) of the methods and steps described herein stored thereon, so that when executed by one or more processors, may cause the one or more processors to perform part of, or all of, the methods and steps described herein. Any of the network elements may be a computing device that comprises a processor and a computer-readable memory (or any other tangible machine-readable medium), and the computer-readable memory may comprise computer-readable instructions such that, when read by the processor, the instructions cause the processor to perform the one or more of the methods or steps described herein. Any of the disclosed flow charts or methods, or any step thereof, may be implemented in the form of software stored on a memory or a computer-readable non-transitory information storage medium such as an optical or magnetic disk, a non-volatile memory (e.g., Flash or ROM), RAM, and other forms of volatile memory. The information storage medium may be an internal part of the computer, a removable external element coupled to the computer, or unit that is remotely accessible via a wired or wireless network.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Throughout the description and claims of this specification, the word “couple”, and variations of that word such as “coupling”, “coupled”, and “couplable”, refer to an electrical connection (such as a copper wire or soldered connection), a logical connection (such as through logical devices of a semiconductor device), a virtual connection (such as through randomly assigned memory locations of a memory device) or any other suitable direct or indirect connections (including combination or series of connections), for example for allowing the transfer of power, signal, or data, as well as connections formed through intervening devices or elements.

The arrangements and methods described herein may be implemented using hardware, software or a combination of both. The term “integration” or “software integration” or any other reference to the integration of two programs or processes herein refers to software components (e.g., programs, modules, functions, processes etc.) that are (directly or via another component) combined, working or functioning together or form a whole, commonly for sharing a common purpose or set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “integration” or “hardware integration” or integration of hardware components herein refers to hardware components that are (directly or via another component) combined, working or functioning together or form a whole, commonly for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled by the same software or hardware. The term “integration” herein refers (as applicable) to a software integration, hardware integration, or any combination thereof.

Any network herein may be frame or packet based. Any networking protocol may be utilized for exchanging information between the network elements (e.g., clients, and servers) within the network (such as the Internet). For example, it is contemplated that communications can be performed using TCP/IP. Generally, HTTP and HTTPS are utilized on top of TCP/IP as the message transport envelope. These two protocols can deal with firewall technology better than other message management techniques. However, partners may choose to use a message-queuing system instead of HTTP and HTTPS if greater communications reliability is needed. A non-limiting example of a message queuing system is IBM's MQ-Series or the Microsoft Message Queue (MSMQ). The system described herein is suited for both HTTP/HTTPS, message-queuing systems, and other communications transport protocol technologies. Furthermore, depending on the differing business and technical requirements of the various partners within the network, the physical network may embrace and utilize multiple communication protocol technologies.

A tangible machine-readable medium (such as a storage) may have a set of instructions detailing part (or all) of the methods and steps described herein stored thereon, so that when executed by one or more processors, may cause the one or more processors to perform part of, or all of, the methods and steps described herein. Any of the network elements may be a computing device that comprises a processor and a computer-readable memory (or any other tangible machine-readable medium), and the computer-readable memory may comprise computer-readable instructions such that, when read by the processor, the instructions causes the processor to perform the one or more of the methods or steps described herein.

Any device or network element herein may comprise, consists of, or include a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or a non-portable device. Further, any device or network element herein may comprise, consist of, or include a major appliance (white goods) and may be an air conditioner, dishwasher, clothes dryer, drying cabinet, freezer, refrigerator, kitchen stove, water heater, washing machine, trash compactor, microwave oven and induction cooker. The appliance may similarly be a ‘small’ appliance such as TV set, CD or DVD player, camcorder, still camera, clock, alarm clock, video game console, HiFi or home cinema, telephone or answering machine.

The term “port” refers to a place of access to a device, electrical circuit or network, where energy or signal may be supplied or withdrawn. The term “interface” of a networked device refers to a physical interface, a logical interface (e.g., a portion of a physical interface or sometimes referred to in the industry as a sub-interface—for example, such as, but not limited to a particular VLAN associated with a network interface), and/or a virtual interface (e.g., traffic grouped together based on some characteristic—for example, but not limited to, a tunnel interface). As used herein, the term “independent” relating to two (or more) elements, processes, or functionalities, refers to a scenario where one does not affect nor preclude the other. For example, independent communication such as over a pair of independent data routes means that communication over one data route does not affect nor preclude the communication over the other data routes.

As used herein, the term “Integrated Circuit” (IC) shall include any type of integrated device of any function where the electronic circuit is manufactured by the patterned diffusion of trace elements into the surface of a thin substrate of semiconductor material (e.g., Silicon), whether single or multiple die, or small or large scale of integration, and irrespective of process or base materials (including, without limitation Si, SiGe, CMOS and GAs) including without limitation applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs. The circuits in an IC are typically contained in a silicon piece or in a semiconductor wafer, and commonly packaged as a unit. The solid-state circuits commonly include interconnected active and passive devices, diffused into a single silicon chip. Integrated circuits can be classified into analog, digital and mixed signal (both analog and digital on the same chip). Digital integrated circuits commonly contain many of logic gates, flip-flops, multiplexers, and other circuits in a few square millimeters. The small size of these circuits allows high speed, low power dissipation, and reduced manufacturing cost compared with board-level integration. Further, a multi-chip module (MCM) may be used, where multiple integrated circuits (ICs), the semiconductor dies, or other discrete components are packaged onto a unifying substrate, facilitating their use as a single component (as though a larger IC).

The term “computer” is used generically herein to describe any number of computers, including, but not limited to personal computers, embedded processing elements and systems, control logic, ASICs, chips, workstations, mainframes, etc. Any computer herein may consist of, or be part of, a handheld computer, including any portable computer, which is small enough to be held and operated while holding in one hand, or fit into a pocket. Such a device, also referred to as a mobile device, typically has a display screen with a touch input and/or a miniature keyboard. Non-limiting examples of such devices include Digital Still Camera (DSC), Digital video Camera (DVC or digital camcorder), Personal Digital Assistant (PDA), and mobile phones and Smartphones.

Any element or entity herein may be implemented as virtualized entity. Any virtualization may include, may be based on, or may use, desktop virtualization, network virtualization, storage virtualization, application virtualization, server virtualization, or any combination thereof. Further, any virtualization herein may include, may be based on, or may use, full virtualization, para-virtualization, or hardware assisted virtualization. Further, any virtualization herein may include, may be based on, or may use, a virtual machine (VM) on a host computer that executes a hypervisor or Virtual Machine Monitor (VMM), and wherein the operating system is a guest operating system that may use or interface a virtual hardware.

The mobile devices may combine video, audio and advanced communications capabilities, such as PAN and WLAN. A mobile phone (also known as a cellular phone, cell phone and a hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

As used herein, the terms “program”, “programmable”, and “computer program” are meant to include any sequence or human or machine cognizable steps that perform a function. Such programs are not inherently related to any particular computer or other apparatus, and may be rendered in virtually any programming language or environment including, for example, C/C++, Fortran, COBOL, PASCAL, assembly language, markup languages (e.g., HTML, SGML, XML, VoXML), and the likes, as well as object-oriented environments such as the Common Object Request Broker Architecture (CORBA), Java™ (including J2ME, Java Beans, etc.) and the like, as well as in firmware or other implementations. Generally, program modules include routines, programs, objects, components, data structures, etc., that performs particular tasks or implement particular abstract data types.

The terms “task” and “process” are used generically herein to describe any type of running programs, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing the value—the value must be obtained prior to processing it, although some of the associated processing may be performed prior to, concurrently with, and/or after the read operation). Where certain process steps are described in a particular order or where alphabetic and/or alphanumeric labels are used to identify certain steps, the embodiments of the invention are not limited to any particular order of carrying out such steps. In particular, the labels are used merely for convenient identification of steps, and are not intended to imply, specify or require a particular order for carrying out such steps. Furthermore, other embodiments may use more or less steps than those discussed herein. The invention may also be practiced in distributed computing environments where tasks are performed by remote processing devices that are linked through a communications network. In a distributed computing environment, program modules may be located in both local and remote memory storage devices.

Any wired network herein may be based on a LAN communication, such as Ethernet, and may be partly or in full in accordance with the IEEE802.3 standard. For example, Gigabit Ethernet (GbE or 1 GigE) may be used, describing various technologies for transmitting Ethernet frames at a rate of a gigabit per second (1,000,000,000 bits per second), as defined by the IEEE 802.3-2008 standard. There are five physical layer standards for gigabit Ethernet using optical fiber (1000BASE-X), twisted pair cable (1000BASE-T), or balanced copper cable (1000BASE-CX). The IEEE 802.3z standard includes 1000BASE-SX for transmission over multi-mode fiber, 1000BASE-LX for transmission over single-mode fiber, and the nearly obsolete 1000BASE-CX for transmission over balanced copper cabling. These standards use 8b/10b encoding, which inflates the line rate by 25%, from 1000 Mbit/s to 1250 Mbit/s, to ensure a DC balanced signal. The symbols are then sent using NRZ. The IEEE 802.3ab, which defines the widely used 1000BASE-T interface type, uses a different encoding scheme in order to keep the symbol rate as low as possible, allowing transmission over twisted pair. Similarly, The 10 gigabit Ethernet (10GE or 10 GbE or 10 GigE may be used, which is a version of Ethernet with a nominal data rate of 10 Gbit/s (billion bits per second), ten times faster than gigabit Ethernet. The 10 Gigabit Ethernet standard only defines full duplex point-to-point links that are generally connected by network switches. The 10 Gigabit Ethernet standard encompasses a number of different physical layers (PHY) standards. A networking device may support different PHY types through pluggable PHY modules, such as those based on SFP+.

As used herein, the terms “network”, “communication link” and “communications mechanism” are used generically to describe one or more networks, communications media or communications systems, including, but not limited to, the Internet, private or public telephone, cellular, wireless, satellite, cable, data networks. Data networks include, but not limited to, Metropolitan Area Networks (MANs), Wide Area Networks (WANs), Local Area Networks (LANs), Personal Area networks (PANs), WLANs (Wireless LANs), Internet, internets, NGN, intranets, Hybrid Fiber Coax (HFC) networks, satellite networks, and Telco networks. Communication media include, but not limited to, a cable, an electrical connection, a bus, and internal communications mechanisms such as message passing, interprocess communications, and shared memory. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.). While exampled herein with regard to secured communication between a pair of network endpoint devices (host-to-host), the described method can equally be used to protect the data flow between a pair of gateways or any other networking-associated devices (network-to-network), or between a network device (e.g., security gateway) and a host (network-to-host).

Each of the network elements herein, such as any of the servers, may store, operate, or use, a server operating system, that may be based on, comprise, or use, Microsoft Windows Server®, Linux, or UNIX, such as Microsoft Windows Server® 2003 R2, 2008, 2008 R2, 2012, or 2012 R2 variant, Linux™ or GNU/Linux based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, and NetBSD®. Each of the network elements herein, such as the client device or any of the tunnel devices, may store, operate, or use, a client operating system, that may consist or, comprise of, or may be based on, Microsoft Windows 7, Microsoft Windows XP, Microsoft Windows 8, Microsoft Windows 8.1, Linux, or Google Chrome OS. The client operating system may be a mobile operating system, such as Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive, or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

All publications, standards, patents, and patent applications cited in this specification are incorporated herein by reference as if each individual publication, patent, or patent application were specifically and individually indicated to be incorporated by reference and set forth in its entirety herein.

1-480. (canceled)

481. A method for protecting a first network that interconnect multiple devices and a first analyzer device, for use with a second network that is coupled to the first network via an adapter device, the method comprising:
receiving, by the adapter device, a message from the second network addressed to a first device in the first network;
sending, by the adapter device, the message, or a part thereof, to the analyzer device via a tunnel over the first network;
receiving, by the analyzer device, the message, or the part thereof;
determining, by the analyzer device, if the message, or the part thereof, satisfies a criterion;
sending, in response to the determining that the message or the part thereof is not satisfying the criterion, the message or the part thereof by the analyzer device to the first device over the first network; and
acting, by the analyzer device, in response to the determining that the message or the part thereof is satisfying the criterion.

482. The method according to claim 481, wherein the message is a multicast message associated with a plurality of devices connected over the first network, and wherein the sending of the message or the part thereof by the analyzer device comprises sending the multicast message to the plurality of devices over the first network.

483. The method according to claim 481, wherein the message is a broadcast message, and wherein the sending of the message or the part thereof by the analyzer device comprises sending the broadcast message to all devices connected to the first network.

484. The method according to claim 481, wherein the adapter device and the first device are the same device.

485. The method according to claim 481, further comprising blocking, in response to the message satisfying the criterion, the message from being sent over the first network.

486. The method according to claim 481, wherein the message comprises one or more frames or packets.

487. The method according to claim 486, wherein the message comprises one or more Ethernet frames one or more Internet Protocol (IP) packets, or a Transmission Control Protocol (TCP) stream.

488. The method according to claim 486, wherein the message comprises one or more multicast or broadcast frames or packets.

489. A non-transitory computer readable media having computer executable instructions stored thereon, wherein the instructions include the method according to claim 481.

490. The method according to claim 481, wherein the first and second networks use, or are based on, the same protocol.

491. The method according to claim 481, wherein the first and second networks use, or are based on, different protocols, and the method further comprising adapting, by the adapter device, between the different protocols.

492. The method according to claim 481, wherein the first network topology is based on, or uses, a point-to-point, bus, star, ring or circular, mesh, tree, hybrid, or daisy chain topology.

493. The method according to claim 492, wherein the second network topology is identical to the first network topology.

494. The method according to claim 492, wherein the second network topology is different from the first network topology.

495. The method according to claim 481, wherein the criterion comprises detecting a malware or a malware activity, wherein the malware consists of, includes, or is based on, a computer virus, spyware, DoS (Denial of Service), rootkit, ransomware, adware, backdoor, Trojan horse, or a destructive malware.

496. The method according to claim 481, for use with an enclosed environment, wherein the first network is within the enclosed environment, and wherein the second network is at least in part external to the enclosed environment.

497. The method according to claim 496, wherein the enclosed environment consists of, or comprises, a building, an apartment, a floor in a building, a room in a building, or a vehicle.

498. The method according to claim 481, for use with a third network that is coupled to the first network via an additional adapter device, the method further comprising:
receiving, by the additional adapter device, an additional message from the third network destined to a second device in the first network;
sending, by the additional adapter device, the additional message, or a part thereof, to the analyzer device via an additional tunnel over the first network;
receiving, by the analyzer device, the additional message, or the part thereof;
determining, by the analyzer device, if the additional message, or the part thereof, satisfies the criterion;
sending, in response to the determining that the additional message or the part thereof is not satisfying the criterion, the additional message or the part thereof by the analyzer device to the second device over the first network; and
acting, in response to the determining that the additional message or the part thereof is satisfying the criterion, by the analyzer device.

499. The method according to claim 481, wherein the tunnel consists of, uses, is compatible with, or is based on, an Open Systems Interconnection (OSI) Layer-2 tunnel.

500. The method according to claim 499, wherein the tunnel consists of, uses, is compatible with, or is based on, a Virtual Local Area Network (VLAN).

501. The method according to claim 499, wherein the tunnel consists of, uses, is compatible with, or is based on, a Virtual Private Network (VPN).

502. The method according to claim 501, wherein the VPN consists of, uses, is compatible with, or is based on, Frame-Relay (FR), Asynchronous Transfer Mode (ATM), ITU-T X.25, or Open Systems Interconnection (OSI) Layer 2 Tunneling Protocol (L2TP).

503. The method according to claim 499, wherein the first network supports, or uses, Multiprotocol Label Switching (MPLS), and wherein the tunnel consists of, uses, is compatible with, or is based on, Label-Switched Path (LSP).

504. The method according to claim 481, wherein the tunnel consists of, uses, is compatible with, or is based on, an Open Systems Interconnection (OSI) Layer-3 tunnel.

505. The method according to claim 504, wherein the tunnel consists of, uses, is compatible with, or is based on, a Virtual Private Network (VPN).

506. The method according to claim 505, wherein the VPN consists of, uses, is compatible with, or is based on, Generic Routing Encapsulation (GRE) or Internet Protocol Security (IPsec).

507. The method according to claim 481, wherein the tunnel consists of, uses, is compatible with, or is based on, an Open Systems Interconnection (OSI) Layer-4 or above tunnel.

508. The method according to claim 481, wherein the first network consists of, comprises, or is based on, multiple nodes that comprise multiple ports for connecting to at least one of the multiple devices, to the analyzer device, or to the adapter device, and wherein each one of the multiple nodes stores a collection of forwarding rules associated an output port for forwarding for each received messages or for each received port, and wherein the tunnel is implemented by the at least part of the forwarding rules in at least part of the multiple nodes.

509. The method according to claim 508, further comprising implementing the tunnel by setting forwarding rules in one or more of the nodes, or wherein the sending of the message or path thereof by the analyzer device to the first device is implemented by setting forwarding rules in one or more of the nodes.

510. The method according to claim 508, further comprising receiving, by at least one of the multiple node, the forwarding rules.

511. The method according to claim 510, wherein the forwarding rules are received from the analyzer device.

512. The method according to claim 511, wherein the forwarding rules are received from the analyzer device over the first network.

513. The method according to claim 511, wherein the forwarding rules are received from the analyzer device over a network that is other than the first network.

514. The method according to claim 508, wherein the multiple nodes are Virtual Local Area Network (VLAN) capable, and wherein the tunnel is implemented by forming a first VLAN using a first VLAN identification (VID) to the messages from the adapter device to the analyzer device, and associating the first VID with the adapter device and the analyzer device.

515. The method according to claim 481, for use with a vehicle, wherein the multiple devices and the first network are in the vehicle.

516. The method according to claim 515, wherein the second network is in the vehicle or external to the vehicle.

517. The method according to claim 515, wherein the vehicle is a ground vehicle adapted to travel on land.

518. The method according to claim 517, wherein the ground vehicle is selected from the group consisting of a bicycle, a car, a motorcycle, a train, an electric scooter, a subway, a train, a trolleybus, and a tram.

519. The method according to claim 517, wherein the ground vehicle consists of, or comprises, is an autonomous car.

520. The method according to claim 519, wherein the autonomous car is according to levels 0, 1, or 2 of the Society of Automotive Engineers (SAE) J3016 standard.

521. The method according to claim 519, wherein the autonomous car is according to levels 3, 4, or 5 of the Society of Automotive Engineers (SAE) J3016 standard.

522. The method according to claim 515, wherein the vehicle is a buoyant or submerged watercraft adapted to travel on or in water.

523. The method according to claim 522, wherein the watercraft is selected from the group consisting of a ship, a boat, a hovercraft, a sailboat, a yacht, and a submarine.

524. The method according to claim 515, wherein the vehicle is an aircraft adapted to fly in air.

525. The method according to claim 524, wherein the aircraft is a fixed wing or a rotorcraft aircraft.

526. The method according to claim 524, wherein the aircraft is selected from the group consisting of an airplane, a spacecraft, a glider, a drone, or an Unmanned Aerial Vehicle (UAV).

527. The method according to claim 515, wherein the adapter device or the analyzer device is mounted onto, is attached to, is part of, or is integrated with a rear or front view camera, chassis, lighting system, headlamp, door, car glass, windscreen, side or rear window, glass panel roof, hood, bumper, cowling, dashboard, fender, quarter panel, rocker, or a spoiler of the vehicle.

528. The method according to claim 515, wherein the vehicle further comprises an Advanced Driver Assistance Systems (ADAS) functionality, system, or scheme.

529. The method according to claim 528, wherein the first network, one of the multiple devices, the adapter device, or the analyzer device, is part of, integrated with, communicates with, or coupled to, the ADAS functionality, system, or scheme.

530. The method according to claim 528, wherein the ADAS functionality, system, or scheme is selected from a group consisting of Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system, Pre-crash system, Collision Imminent Braking (CIB), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), and Wrong-way driving warning.
